(19) United States
(12) Patent Application Publication
(10) Pub. No.: US 2013/0253012 A1
(43) Pub. Date: Sep. 26, 2013

(54) Pyrazole Compounds for Controlling Invertebrate Pests

(71) Applicants: Sebastian Soergel, Ludwigshafen (DE); Christian Defieber, Mannheim (DE); Ronan Le Vezouet, Mannheim (DE); Daniel Saelinger, Ludwigshafen (DE); Steffen Gross, Ludwigshafen (DE); Karsten Koerber, Eppelheim (DE); Deborah L. Culbertson, Fuquay Varina, NC (US); Douglas D. Anspaugh, Apex, NC (US); Koshi Gunjima, Cary, NC (US)

(72) Inventors: Sebastian Soergel, Ludwigshafen (DE); Christian Defieber, Mannheim (DE); Ronan Le Vezouet, Mannheim (DE); Daniel Saelinger, Ludwigshafen (DE); Steffen Gross, Ludwigshafen (DE); Karsten Koerber, Eppelheim (DE); Deborah L. Culbertson, Fuquay Varina, NC (US); Douglas D. Anspaugh, Apex, NC (US); Koshi Gunjima, Cary, NC (US)

(73) Assignee: BASF SE, Ludwigshafen (DE)

(21) Appl. No.: 13/992,108

(22) PCT Filed: Dec. 9, 2011
(86) PCT No.: PCT/EP2011/072363

§ 371 Date: Jun. 6, 2013

Related U.S. Application Data
(60) Provisional application No. 61/421,666, filed on Dec. 10, 2010.

(51) Int. Cl. A01N 43/82; A01N 43/56; A01N 43/78; A01N 43/653; A01N 43/76

(52) U.S. Cl. CPC A01N 43/82; A01N 43/653; A01N 43/76; A01N 43/78; A01N 43/56
USPC 514/341; 546/272.4; 546/271.4; 546/270.4; 546/269.4; 546/268.7; 546/274.1; 546/256

(57) ABSTRACT

The present invention relates to a method for controlling invertebrate pests, in particular arthropod pests and nematodes, by using pyrazole compounds of formula I and the salts thereof, the tautomers thereof, the N-oxides thereof and the salts of the tautomers or N-oxides thereof,

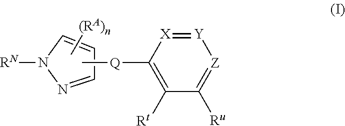

wherein
X is N or CH, Y is N or CH, Z is N or CH, provided that either only one of X, Y and Z is N or only two adjacent groups of X, Y and Z are N; and wherein Q is a bivalent 5- or 6-membered carbocyclic radical or a 5- or 6-membered heterocyclic radical having one heteroatom moiety which is selected from the group consisting of O, S, N or N—R^{QN} as ring member and 0, 1 or 2 further heteroatom moieties N as ring members, wherein 0, 1, 2 or 3 of the ring members that are carbon atoms may carry a radical R^{Q}, provided that the pyrazole radical and the 6-membered heteroaromatic radical are bound in ortho- or meta-position of Q with respect to each other, if Q is a 6-membered radical; and wherein R^{A}, if present, is C₁-C₃-alkyl, C₁-C₃-haloalkyl or the like; n is 0, 1 or 2; R^{N} is C₁-C₃-alkyl, C₁-C₂-haloalkyl, C₁-C₂-alkoxy-C₁-C₂-alkyl or the like; R^{t} and R^{u} are independently of each other selected from hydrogen, methyl and the like; R^{QN} is hydrogen, C₁-C₄-alkyl or the like; R^{Q} is hydrogen, halogen, C₁-C₄-alkyl or the like.

The present invention further relates to a method for protecting plant propagation material and/or the plants which grow therefrom, to plant propagation material, comprising at least one compound of formula I, their salts or N-oxides, and to pyrazole compounds of formula I.

The present invention relates to pyrazole compounds, to their salts, to their tautomers, to their N-oxides, and the salts of these N-oxides or tautomers, in particular to their use for combating or controlling invertebrate pests, in particular arthropod pests and nematodes and to a method for controlling invertebrate pests including the use of these compounds. The invention further relates to a method for protecting plant propagation material and/or the plants which grow therefrom by using these compounds. The present invention further relates to plant propagation material and to agricultural and/or veterinary compositions comprising said compounds.

WO 2004/089303 describes inter alia 1-pyridin-2yl-pyrazoles carrying a diaryl substituent at the pyrozole ring. The compounds are mentioned to be useful as modulators of metabotropic glutamate receptor-5.

WO 2006/028029 discloses inter alia N-unsubstituted and N-alkyl-substituted pyrazoles carrying a pyrid-2-yl substituent in position 3 and a pyridyl-phenyl substituent in position 4. The compounds are mentioned to be useful as inhibitors of collagen synthesis.

DE 10 2008 000 872 describes inter alia pyridazines that are substituted with a pyrazole radical in position 3 and with a pyridine radical in position 4. The compounds are mentioned to have fungicidal activity.

WO 2009/149188 describes inter alia derivatives of 5-pyrazol-3-yl-pyridon-1-yl-4-pyridine for treating inflammatory and fibrotic disorders.

WO 2006/114400 discloses inter alia 3-[5-(1H-pyrazol-4-yl)-[1,2,4]-oxadiazol-3-yl]-pyridine and its medical use.

EP 0431421 discloses inter alia 2-pyridin-2-yl-pyrimidine that carries in position 4 of the pyrimidine a 1-phenyl-pyrazol-4-yl substituent. The compounds described are mentioned to have fungicidal activity.

I. M. EI-Deeb et al., Bioorg. Med. Chem. Lett. 19 (2009) 5622-5626, describe, as synthetical intermediates, pyrazole derivatives carrying a pyridyl-pyridyl substituent and a phenyl substituent in positions 4 and 3, respectively, of the pyrazole ring.

EP 0480258 describes inter alia N-hetarylcarboxamides of 2-mercapto-nicotinic acids and their use for combating endoparasites.

WO 2002/094765 describes N-(6-membered hetaryl) carboxamides of 6-membered heteroaromatic carboxylic acids, which carry an oxazoline or carboxamide radical in the ortho position. The compounds are mentioned to be useful as insecticides.

WO 2002/070483 and WO 2002/094791 describe inter alia hetarylcarbonylamino substituted (het)arenes which carry a carboxamide group in the ortho-position of the carbonylamino substituent. The compounds are mentioned to be useful for controlling invertebrate pests.

WO 2009/077197 describes hetarylcarbonylamino substituted six-membered hetarenes which carry an isoxazoline moiety in the meta-position of the carbonylamino substituent. The compounds are mentioned to be useful for combating invertebrate pests

WO 2005/073165, WO 2006/137376, WO 2006/137395, WO 2008/000438, WO 2008/031534, WO 2008/074427, WO 2008/075454, WO 2009/049844 and WO 2009/080203 describe inter alia hetarylcarbonylamino substituted six-membered hetarenes which carry a carboxamide group in the meta-position of the carbonylamino substituent. The compounds are mentioned to be useful for combating invertebrate pests.

WO 2009/027393 and WO 2010/034737 describe pyrazolylcarbonylamino substituted pyridines, pyrimidines and triazines, which are mentioned to be useful for controlling invertebrate pests.

WO 2010/034738 describes compounds similar to those of WO 2009/027393 and WO 2010/034737 that have a heterocycle fused to the pyrazole moiety and that are also mentioned for controlling invertebrate pests.

Invertebrate pests and in particular arthropods and nematodes destroy growing and harvested crops and attack wooden dwelling and commercial structures, thereby causing large economic loss to the food supply and to property. While a large number of pesticidal agents are known, due to the ability of target pests to develop resistance to said agents, there is an ongoing need for new agents for combating invertebrate pests such as insects, arachnids and nematodes.

It is therefore an object of the present invention to provide methods for controlling invertebrate pests by using compounds that have a good pesticidal activity, in particular insecticidal activity, and show a broad activity spectrum against a large number of different invertebrate pests, especially against difficult to control arthropod pests and/or nematodes.

It has been found that these objectives can be achieved by methods that comprise treatment with compounds of the formula I, as defined below, including any possible stereoisomers of formula I, by their salts, by their tautomers and by their N-oxides and by the salts of said tautomers and N-oxides, in particular their agriculturally or veterinarily acceptable salts.

Therefore, in a first aspect the present invention relates to a method for controlling invertebrate pests which method comprises treating the pests, their food supply, their habitat or their breeding ground or a plant, seed, soil, area, material or environment in which the pests are growing or may grow, or the materials, plants, seeds, soils, surfaces or spaces to be protected from pest attack or infestation with a pesticidally effective amount of a pyrazole compound of the formula I, a salt thereof, an N-oxide thereof or a tautomer thereof, or a salt of said N-oxide or tautomer:

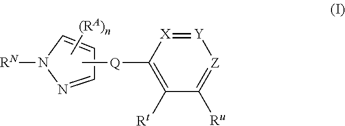

wherein
X is N or CH;
Y is N or CH;
Z is N or CH;
provided that either only one of X, Y and Z is N or only two adjacent groups of X, Y and Z are N,
R^{A} is selected from the group consisting of halogen, CN, NO₂, C₁-C₁₀-alkyl, C₂-C₁₀-alkenyl and C₂-C₁₀-alkynyl, wherein the last three mentioned radicals may be unsubstituted, may be partially or fully halogenated or may carry 1, 2 or 3 identical or different substituents R^{x},
   and also from the group consisting of OR^{a}, C(V)R^{b}, C(V)OR^{c}, S(O)ₘR^{d} with m being 0, 1 or 2, NR^{e}R^{f}, heterocyclyl, phenyl, hetaryl, C₃-C₁₀-cycloalkyl and C₅-C₁₀-cycloalkenyl, wherein the last five mentioned radicals may be unsubstituted or may carry 1, 2, 3, 4 or 5 identical or different substituents R^{y};
n is 0, 1 or 2; and
R^{N} is selected from the group consisting of hydrogen, CN, NO₂, C₁-C₁₀-alkyl, C₂-C₁₀-alkenyl and C₂-C₁₀-alkynyl, wherein the three last mentioned radicals may be unsubstituted, may be partially or fully halogenated or may carry 1, 2 or 3 identical or different substituents R^{x},
   and also from the group consisting of OR^{a}, C(V)R^{b}, C(V)OR^{c}, S(O)ₘR^{d}, NR^{e}R^{f}, C(V)NR^{g}R^{h}, S(O)ₘNR^{e}R^{f}, C(V)NRⁱNR^{e}R^{f}, C₁-C₅-alkylen-OR^{a}, C₁-C₅-alkylen-CN, C₁-C₅-alkylen-C(V)R^{b}, C₁-C₅-alkylen-C(V)OR^{c}, C₁-C₅-alkylen-NR^{e}R^{f}, C₁-C₅-alkylen-C(V)NR^{g}R^{h}, C₁-C₅-alkylen-S(O)ₘR^{d}, C₁-C₅-alkylen-S(O)ₘNR^{e}R^{f}, C₁-C₅-alkylen-NRⁱNR^{e}R^{f}, heterocyclyl, hetaryl, C₃-C₁₀-cycloalkyl, C₅-C₁₀-cycloalkenyl, heterocyclyl-C₁-C₅-alkyl, hetaryl-C₁-C₅-alkyl, C₃-C₁₀-cycloalkyl-C₁-C₅-alkyl, C₅-C₁₀-cycloalkenyl-C₁-C₅-alkyl, phenyl-C₁-C₅-alkyl and phenyl, wherein the rings of the ten last mentioned radicals may be unsubstituted or may carry 1, 2, 3, 4 or 5 identical or different substituents R^{y};
m is 0, 1 or 2;
10
V is O or S;
Q is a bivalent 5- or 6-membered carbocyclic radical or a 5- or 6-membered heterocyclic radical having one heteroatom moiety which is selected from the group consisting of O, S, N or N—R^{QN} as ring member and 0, 1 or 2 further heteroatom moieties N as ring members and also having 2, 3, 4 or 5 carbon atoms as ring members where the carbon atom ring members may be unsubstituted or 1, 2 or 3 of the carbon atom ring members carry a radical R^{Q} as a substituent, provided that the pyrazole radical and the 6-membered heteroaromatic radical are bound in ortho- or meta-position of Q with respect to each other, if Q is a 6-membered radical, and where
   R^{QN} is selected from the group consisting of hydrogen, C₁-C₄-alkyl and C₁-C₄-haloalkyl,
   R^{Q} is selected from the group consisting of hydrogen, halogen, CN, C₁-C₄-alkyl, C₁-C₄-haloalkyl, C₁-C₄-alkoxy and C₁-C₄-haloalkoxy or together with the carbon atom, to which it is bound, may form a carbonyl group or a thio-carbonyl group;
R^{u} and R^{t} are independently of each other selected from hydrogen, halogen, C₁-C₄-alkyl, C₁-C₃-haloalkyl, C₁-C₄-alkoxy, C₁-C₃-haloalkoxy, C₁-C₃-haloalkylthio, C₁-C₄-alkylsulfinyl, C₁-C₃-haloalkylsulfinyl, C₁-C₄-alkylsulfonyl, C₁-C₃-haloalkylsulfonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
and wherein
R^{a}, R^{b}, R^{c} are independently of each other selected from hydrogen, C₁-C₄-alkyl, haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or substituents which, independently of each other, are selected from halogen, cyano, nitro, C₁-C₄-alkyl, C₁-C₄-haloalkyl, C₁-C₄-alkoxy and C₁-C₄-haloalkoxy;
R^{d} is selected from C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from O, S and N as a ring member atom and wherein the heterocycle may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{g}, R^{h} are independently of each other selected from hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
Rⁱ is selected from hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{x} are independently of each other selected from cyano, nitro, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₁₀-alkylcarbonyl, C₃-C₆-cycloalkyl, 5- to 7-membered heterocyclyl, phenyl, C₃-C₆-cycloalkoxy, 3- to 6-membered heterocyclyloxy and phenoxy, wherein the last 6 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy;

R^{y} is selected from halogen, cyano, nitro, C₁-C₄-alkyl, C₁-C₄-haloalkyl, C₁-C₄-alkoxy, C₁-C₄-haloalkoxy, S(O)ₘR^{d}, S(O)ₘNR^{e}R^{f}, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₃-C₆-cycloalkyl, 5- to 7-membered heterocyclyl, hetaryl, phenyl, C₃-C₆-cycloalkoxy, 3- to 6-membered heterocyclyloxy, hetaryloxy and phenoxy, wherein the last 8 mentioned radicals may be unsubstituted or may carry 1, 2, 3, 4 or 5 radicals selected from halogen, cyano, nitro, C₁-C₄-alkyl, C₁-C₄-haloalkyl, C₁-C₄-alkoxy and C₁-C₄-haloalkoxy.

The methods of the present invention are particularly useful for controlling invertebrate pests, in particular for controlling arthropods and nematodes, especially for controlling insects, in particular for controlling insects of the order homoptera. Therefore, the invention also relates to the use of a pyrazole compound of the formula I, a tautomer or an N-oxide thereof or a salt thereof, in particular an agriculturally or veterinarily acceptable salt thereof, for combating invertebrate pests, in particular for combating arthropod pests and/or nematodes, especially for combating insects, in particular for combating insects of the order Homoptera.

A further aspect of the present invention relates to a method for protecting plants from infestation with arthropod pests, which method comprises treating the plants with a pesticidally effective amount of a pyrazole compound of the formula I according to the present invention or an agriculturally acceptable salt, a tautomer or an N-oxide thereof or an agriculturally acceptable salt of said N-oxide or of said tautomer.

A further aspect of the present invention relates to a method for protecting plant propagation material, in particular seed and/or the plants which grow therefrom, which method comprises treating the plant propagation material with a pesticidally effective amount of a pyrazole compound of the formula I according to the present invention or an agriculturally acceptable salt, a tautomer or an N-oxide thereof or an agriculturally acceptable salt of said N-oxide or of said tautomer.

A further aspect of the present invention relates to plant propagation material, comprising at least one pyrazole compound of formula I according to the present invention and/or an agriculturally acceptable salt, a tautomer or an N-oxide thereof or an agriculturally acceptable salt of said N-oxide or of said tautomer.

A further aspect of the present invention relates to methods and uses comprising a pyrazole compound of formula I according to the present invention or a veterinarily acceptable salt thereof or a tautomer or an N-oxide thereof or a salt of said N-oxide or tautomer for the use in a method for treating or protecting a human or in particular a non-human animal from infestation or infection by parasites especially ectoparasites.

A further aspect of the present invention relates to a method for treating or protecting an animal, in particular a non-human animal, from infestation or infection by parasites especially ectoparasites which comprises bringing the animal in contact with a parasiticidally effective amount of a pyrazole compound of the formula I or a veterinarily acceptable salt thereof or an N-oxide or tautomer thereof or with a veterinarily acceptable salt of said tautomer or N-oxide. Bringing the animal in contact with a pyrazole compound of formula I, a tautomer, an N-oxide or salt thereof or with a veterinary composition containing a compound of the invention, means to apply or to administer it to the animal.

A further aspect of the present invention relates to an agricultural composition containing at least one pyrazole compound of formula I according to the present invention and/or an agriculturally acceptable salt thereof or an N-oxide or tautomer thereof and/or an agriculturally acceptable salt of said N-oxide or said tautomer and at least one liquid or solid carrier.

A further aspect of the present invention relates to pyrazole compounds of formula I, the salts thereof, the N-oxides thereof, the tautomers thereof and the salts of said N-oxides or tautomers, wherein the variables X, Y, Z, R^{A}, n, R^{N}, Q, R^{u} and R^{t} have the meanings mentioned herein, in particular the meanings mentioned as preferred, provided that the pyrazole radical and the 6-membered heteroaromatic radical are bound in meta-position of Q with respect to each other, if Q is a pyridazine radical, provided further that the pyrazole radical and the 6-membered heteroaromatic radical are bound in ortho-position of Q with respect to each other, if Q is a phenyl radical, the pyrazole radical carries a pyridyl radical as substituent R^{A} or R^{N} and only one of X, Y and Z is N, provided further that the pyrazole radical and the 6-membered heteroaromatic radical are bound in ortho-position of Q with respect to each other, if Q and the 6-membered heteroaromatic radical together form a 1-pyridin-4-yl-pyridin-2-on-5-yl radical,

except for 3-[5-(1H-pyrazol-4-yl)-[1,2,4]-oxadiazol-3-yl]-pyridine, 2-[3-(2-pyridin-2-yl-5-methyl-2,3-dihydro-1H-pyrazol-3-on-4-yl)-5-methyl-2H-pyrazol-2-yl]-pyridine, 3-{4-[3-(3-methoxy-5-methyl-phenyl)-1-cyanomethyl-1H-pyrazol-4-yl]-pyridin-2-yl}-pyridine, 3-{4-[5-(3-methoxy-5-methyl-phenyl)-1-cyanomethyl-1H-pyrazol-4-yl]-pyridin-2-yl}-pyridine and 2-[4-(1-phenyl-1H-pyrazol-4-yl)-pyrimidin-2-yl]pyridine, the salts thereof, the N-oxides thereof, the tautomers thereof and the salts of said N-oxides or tautomers.

Depending on the substitution pattern, the compounds of the formula I may have one or more centers of chirality, in which case they are present as mixtures of enantiomers or diastereomers. The invention provides the use according to the invention of both the pure enantiomers or pure diastereomers of the formula I and their mixtures. Suitable compounds of the formula I also include all possible geometrical stereoisomers (cis/trans isomers) and mixtures thereof.

Depending on the substitution pattern, the compounds of the formula I may be present in the form of their tautomers. Hence the invention also relates to methods and uses comprising the tautomers of the formula I and the salts of said tautomers.

The compounds of formula I as well as their N-oxides and tautomers may be amorphous or may exist in one or more different crystalline states (polymorphs) which may have different macroscopic properties such as stability or show different biological properties such as activities. The present invention includes both amorphous and crystalline compounds of formula I, their tautomers or N-oxides, mixtures of different crystalline states of the respective compound of formula I, its tautomers or N-oxides, as well as amorphous or crystalline salts thereof.

Salts of the compounds of the formula I, their tautomers or N-oxides, are preferably agriculturally and veterinarily acceptable salts. They can be formed in a customary method, e.g. by reacting the compound with an acid if the compound of formula I has a basic functionality or by reacting the compound with a suitable base if the compound of formula I has an acidic functionality.

Suitable agriculturally acceptable salts are especially the salts of those cations or the acid addition salts of those acids whose cations and anions, respectively, do not have any adverse effect on the pesticidal action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethylammonium, bis(2-hydroxyethyl)ammonium, benzyltrimethylammonium and benzl-triethylammonium. Further suitable cations are phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting compounds of formula I with an acid of the corresponding anion, preferably of hydrochloric acid, hydrobromic acid, sulfuric acid, phosphoric acid or nitric acid.

Veterinarily acceptable salts of the compounds of formula I encompass especially the acid addition salts which are known and accepted in the art for the formation of salts for veterinary use. Suitable acid addition salts, e.g. formed by compounds of formula I containing a basic nitrogen atom, e.g. an amino group, include salts with inorganic acids, for example hydrochlorids, sulphates, phosphates, and nitrates and salts of organic acids for example acetic acid, maleic acid, e.g. the monoacid salts or diacid salts of maleic acid, dimaleic acid, fumaric acid, e.g. the monoacid salts or diacid salts of fumaric acid, difumaric acid, methane sulfenic acid, methane sulfonic acid, and succinic acid.

The term “N-oxide” includes any compound of the formula I which has at least one tertiary nitrogen atom that is oxidized to an N-oxide moiety.

The term “invertebrate pest” as used herein encompasses animal populations, such as arthropode pests, including insects and arachnids, as well as nematodes, which may attack plants thereby causing substantial damage to the plants attacked, as well as ectoparasites which may infest animals, in particular warm blooded animals such as e.g. mammals or birds, or other higher animals such as reptiles, amphibians or fish, thereby causing substantial damage to the animals infested.

The term “plant propagation material” as used herein includes all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “plants” comprises any types of plants including “non-cultivated plants” and in particular “cultivated plants”.

The term “non-cultivated plants” refers to any wild type species or related species or related genera of a cultivated plant.

The term “cultivated plants” as used herein includes plants which have been modified by breeding, mutagenesis or genetic engineering. Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s) (oligo- or polypeptides) poly for example by glycosylation or polymer additions such as prenylated, acetylated or farnesylated moieties or PEG moieties (e.g. as disclosed in Biotechnol Prog. 2001 July-August; 17(4):720-8, Protein Eng Des Sel. 2004 January; 17(1):57-66, Nat. Protoc. 2007; 2(5):1225-35, Curr. Opin. Chem. Biol. 2006 October; 10(5):487-91. Epub 2006 Aug. 28, Biomaterials. 2001 March; 22(5):405-17, Bioconjug. Chem. 2005 January-February; 16(1):113-21).

The term “cultivated plants” as used herein further includes plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A-0242236, EP-A-242246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e.g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” as used herein further includes plants that are by the use of recombinant DNA techniques capable to synthesize one or more insecticidal proteins, especially those known from the bacterial genus bacillus, particularly from bacillus thuringiensis, such as delta-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are disclosed, for example, in EP-A 374 753, WO 93/007278, WO 95/34656, EP-A 427 529, EP-A 451 878, WO 03/018810 and WO 03/052073.

The methods for producing such genetically modified plants are generally known to the person skilled in the art and are described, for example, in the publications mentioned above. These insecticidal proteins contained in the genetically modified plants impart to the plants producing these proteins protection from harmful pests from certain taxonomic groups of arthropods insects, particularly to beetles (Coleoptera), flies (Diptera), and butterflies and moths (Lepidoptera) and to plant parasitic nematodes (Nematoda).

The term “cultivated plants” as used herein further includes plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora).

The term “cultivated plants” as used herein further includes plants that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

The term “cultivated plants” as used herein further includes plants that contain by the use of recombinant DNA techniques a modified amount of substances of content or new substances of content, specifically to improve human or animal nutrition, for example oil crops that produce health-promoting long-chain omega-3 fatty acids or unsaturated omega-9 fatty acids (e.g. Nexera® rape).

The term “cultivated plants” as used herein further includes plants that contain by the use of recombinant DNA techniques a modified amount of substances of content or new substances of content, specifically to improve raw material production, for example potatoes that produce increased amounts of amylopectin (e.g. Amflora® potato).

The organic moieties mentioned in the above definitions of the variables are—like the term halogen—collective terms for individual listings of the individual group members. The prefix Cₙ-Cₘ indicates in each case the possible number of carbon atoms in the group.

The term “halogen” denotes in each case fluorine, bromine, chlorine or iodine, in particular fluorine, chlorine or bromine.

The term “alkyl” as used herein and in the alkyl moieties of alkoxy, alkylcarbonyl, alkylthio, alkylsulfinyl, alkylsulfonyl and alkoxyalkyl denotes in each case a straight-chain or branched alkyl group having usually from 1 to 10 carbon atoms, frequently from 1 to 6 carbon atoms, preferably 1 to 4 carbon atoms and in particular from 1 to 3 carbon atoms. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 1-methylhexyl, 2-methylhexyl, 3-methylhexyl, 4-methylhexyl, 5-methylhexyl, 1-ethylpentyl, 2-ethylpentyl, 3-ethylpentyl, 1-propylpentyl, n-octyl, 1-methyloctyl, 2-methylheptyl, 1-ethylhexyl, 2-ethylhexyl, 1,2-dimethylhexyl, 1-propylpentyl and 2-propylpentyl.

The term “alkylene” (or alkanediyl) as used herein in each case denotes an alkyl radical as defined above, wherein one hydrogen atom at any position of the carbon backbone is replaced by one further binding site, thus forming a bivalent moiety.

The term “haloalkyl” as used herein and in the haloalkyl moieties of haloalkoxy, haloalkylthio, haloalkylcarbonyl, haloalkylsulfonyl and haloalkylsulfinyl, denotes in each case a straight-chain or branched alkyl group having usually from 1 to 10 carbon atoms, frequently from 1 to 6 carbon atoms, wherein the hydrogen atoms of this group are partially or totally replaced with halogen atoms. Preferred haloalkyl moieties are selected from C₁-C₄-haloalkyl, more preferably from C₁-C₂-haloalkyl, in particular from C₁-C₂-fluoroalkyl such as fluoromethyl, difluoromethyl, trifluoromethyl, 1-fluoroethyl, 2-fluoroethyl, 2,2-difluoroethyl, 2,2,2-trifluoroethyl, pentafluoroethyl, and the like.

The term “alkoxy” as used herein denotes in each case a straight-chain or branched alkyl group usually having from 1 to 10 carbon atoms, frequently from 1 to 6 carbon atoms, preferably 1 to 4 carbon atoms, which is bound to the remainder of the molecule via an oxygen atom. Examples of an alkoxy group are methoxy, ethoxy, n-propoxy, iso-propoxy, n-butyloxy, 2-butyloxy, iso-butyloxy, tert.-butyloxy, and the like.

The term “haloalkoxy” as used herein denotes in each case a straight-chain or branched alkoxy group, as defined above, having from 1 to 10 carbon atoms, frequently from 1 to 4 carbon atoms, preferably 1 to 3 carbon atoms, wherein the hydrogen atoms of this group are partially or totally replaced with halogen atoms, in particular fluorine atoms. Preferred haloalkoxy moieties include C₁-C₄-haloalkoxy, in particular C₁-C₂-fluoroalkoxy, such as fluoromethoxy, difluoromethoxy, trifluoromethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoro-ethoxy, 2,2-dichloro-2-fluorethoxy, 2,2,2-trichloroethoxy, pentafluoroethoxy and the like.

The term “cycloalkyl” as used herein and in the cycloalkyl moieties of cycloalkoxy and cycloalkylalkyl denotes in each case a mono- or bicyclic cycloaliphatic radical having usually from 3 to 10 carbon atoms or 3 to 6 carbon atoms, such as cyclopropyl, cyclobutyl, cyclopentyl, cyclohexyl, cycloheptyl, cyclooctyl, bicyclo[2.1.1]hexyl, bicyclo[3.1.1]heptyl, bicyclo[2.2.1]heptyl, and bicyclo[2.2.2]octyl.

The term “C₅-C₁₀-cycloalkenyl” as used herein and in the C₅-C₁₀-cycloalkenyl moieties of C₅-C₁₀-cycloalkenyl-C₁-C₅-alkyl denotes in each case an aliphatic ring system radical having 5 to 10 carbon that comprises at least one carbon-carbon double bond in the ring. Examples of cycloalkenyl groups include, but are not limited to, cyclopropenyl, cyclopentenyl, cyclohexenyl, cycloheptenyl, and the like.

The term “Cₙ-Cₘ-cycloalkyl-Cₒ-Cₚ-alkyl” as used herein refers to a cycloalkyl group, as defined above, having n to m carbon atoms, which is bound to the remainder of the molecule via an alkylene group, as defined above, having o to p carbon atoms. Examples are cyclopropylmethyl, cyclopropylethyl, cyclopropylpropyl, cyclobutylmethyl, cyclobutylethyl, cyclobutylpropyl, cyclopentylmethyl, cyclopentylethyl, cyclopentylpropyl, cyclohexylmethyl, cyclohexylethyl, cyclohexylpropyl, and the like.

The term “C₃-C₆-cycloalkoxy” as used herein refers to a cycloalkyl group, as defined above, having 3 to 6 carbon atoms, which is bound to the remainder of the molecule via an oxygen atom. Examples of C₃-C₆-cycloalkoxy groups include cycloproppyloxy, cyclopentyloxy, cyclohexyloxy and the like.

The term “C₅-C₁₀-cycloalkenyl-C₁-C₅-alkyl” refers to cycloalkenyl as defined above which is bound via an alkylene group, as defined above, having 1 to 5 carbon atoms to the remainder of the molecule. Examples include but are not limited to cyclopentenylmethyl, cyclopentenylethyl, cyclohexenylpropyl, cyclohexenylpentyl, cycloheptenylmethyl, and the like.

The term “halocycloalkyl” as used herein and in the halocycloalkyl moieties of halocycloalkylmethyl denotes in each case a mono- or bicyclic cycloaliphatic radical having usually from 3 to 10 carbon atoms or 3 to 6 carbon atoms, wherein at least one, e.g. 1, 2, 3, 4 or 5 of the hydrogen atoms are replaced by halogen, in particular by fluorine or chlorine. Examples are 1- and 2-fluorocyclopropyl, 1,2-, 2,2- and 2,3-difluorocyclopropyl, 1,2,2-trifluorocyclopropyl, 2,2,3,3-tetrafluorocyclpropyl, 1- and 2-chlorocyclopropyl, 1,2-, 2,2- and 2,3-dichlorocyclopropyl, 1,2,2-trichlorocyclopropyl, 2,2,3,3-tetrachlorocyclpropyl, 1-, 2- and 3-fluorocyclopentyl, 1,2-, 2,2-, 2,3-, 3,3-, 3,4-, 2,5-difluorocyclopentyl, 1-, 2- and 3-chlorocyclopentyl, 1,2-, 2,2-, 2,3-, 3,3-, 3,4-, 2,5-dichlorocyclopentyl and the like.

The term “alkenyl” as used herein denotes in each case a singly unsaturated hydrocarbon radical having usually 2 to 10, preferably 2 to 4 carbon atoms, e.g. vinyl, allyl (2-propen-1-yl), 1-propen-1-yl, 2-propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl and the like.

The term “haloalkenyl” as used herein, which may also expressed as “alkenyl which may be substituted by halogen”, and the haloalkenyl moieties in haloalkenyloxy, haloalkenylcarbonyl and the like refers to unsaturated straight-chain or branched hydrocarbon radicals having 2 to 10 (“C₂-C₁₀-haloalkenyl”) or 2 to 4 (“C₂-C₄-haloalkenyl”) carbon atoms and a double bond in any position, where some or all of the hydrogen atoms in these groups are replaced by halogen atoms as mentioned above, in particular fluorine, chlorine and bromine, for example chlorovinyl, chloroallyl and the like.

The term “alkynyl” as used herein refers to unsaturated straight-chain or branched hydrocarbon radicals having usually 2 to 10, preferably 2 to 4 carbon atoms and one or two triple bonds in any position, e.g. ethynyl, propargyl (2-propyn-1-yl), 1-propyn-1-yl, 1-methylprop-2-yn-1-yl), 2-butyn-1-yl, 3-butyn-1-yl, 1-pentyn-1-yl, 3-pentyn-1-yl, 4-pentyn-1-yl, 1-methylbut-2-yn-1-yl, 1-ethylprop-2-yn-1-yl and the like.

The term “alkoxyalkyl” as used herein refers to alkyl usually comprising 1 to 4 carbon atoms, wherein 1 carbon atom carries an alkoxy radical usually comprising 1 to 10, in particular 1 to 4, carbon atoms as defined above. Examples are CH₂OCH₃, CH₂—OC₂H₅, n-propoxymethyl, CH₂—OCH(CH₃)₂, n-butoxymethyl, (1-methylpropoxy)-methyl, (2-methylpropoxy)methyl, CH₂—OC(CH₃)₃, 2-(methoxy)ethyl, 2-(ethoxy)ethyl, 2-(n-propoxy)-ethyl, 2-(1-methylethoxy)-ethyl, 2-(n-butoxy)ethyl, 2-(1-methylpropoxy)-ethyl, 2-(2-methylpropoxy)-ethyl, 2-(1,1-dimethylethoxy)-ethyl, 2-(methoxy)-propyl, 2-(ethoxy)-propyl, 2-(n-propoxy)-propyl, 2-(1-methylethoxy)-propyl, 2-(n-butoxy)-propyl, 2-(1-methylpropoxy)-propyl, 2-(2-methylpropoxy)-propyl, 2-(1,1-dimethylethoxy)-propyl, 3-(methoxy)-propyl, 3-(ethoxy)-propyl, 3-(n-propoxy)-propyl, 3-(1-methylethoxy)-propyl, 3-(n-butoxy)-propyl, 3-(1-methylpropoxy)-propyl, 3-(2-methylpropoxy)-propyl, 3-(1,1-dimethylethoxy)-propyl, 2-(methoxy)-butyl, 2-(ethoxy)-butyl, 2-(n-propoxy)-butyl, 2-(1-methylethoxy)-butyl, 2-(n-butoxy)-butyl, 2-(1-methylpropoxy)-butyl, 2-(2-methyl-propoxy)-butyl, 2-(1,1-dimethylethoxy)-butyl, 3-(methoxy)-butyl, 3-(ethoxy)-butyl, 3-(n-propoxy)-butyl, 3-(1-methylethoxy)-butyl, 3-(n-butoxy)-butyl, 3-(1-methylpropoxy)-butyl, 3-(2-methylpropoxy)-butyl, 3-(1,1-dimethylethoxy)-butyl, 4-(methoxy)-butyl, 4-(ethoxy)-butyl, 4-(n-propoxy)-butyl, 4-(1-methylethoxy)-butyl, 4-(n-butoxy)-butyl, 4-(1-methylpropoxy)-butyl, 4-(2-methylpropoxy)-butyl, 4-(1,1-dimethylethoxy)-butyl and the like.

The term “alkylcarbonyl” (alkyl-C(═O)—), as used herein refers to a straight-chain or branched saturated alkyl group as define above comprising 1 to 10 carbon atoms (═C₁-C₁₀-alkylcarbonyl), preferably 1 to 4 carbon atoms (═C₁-C₄-alkylcarbonyl) attached through the carbon atom of the carbonyl group at any position in the alkyl group.

The term “haloalkylcarbonyl” as used herein refers to an alkylcarbonyl group as defined above wherein the hydrogen atoms are partially or fully substituted by fluorine, chlorine, bromine and/or iodine.

The term “alkylthio “(also alkylsulfanyl or alkyl-S—)” as used herein refers to a straight-chain or branched saturated alkyl group comprising 1 to 10 carbon atoms (═C₁-C₁₀-alkylthio), preferably 1 to 4 carbon atoms (═C₁-C₄-alkylthio) as defined above, which is attached via a sulfur atom at any position in the alkyl group.

The term “haloalkylthio” as used herein refers to an alkylthio group as defined above wherein the hydrogen atoms are partially or fully substituted by fluorine, chlorine, bromine and/or iodine.

The term “alkylsulfinyl” (also alkylsulfoxyl or alkyl-S(═O)—), as used herein refers to a straight-chain or branched saturated alkyl group as define above comprising 1 to 10 carbon atoms (═C₁-C₁₀-alkylsulfinyl), preferably 1 to 4 carbon atoms (═C₁-C₄-alkylsulfinyl) attached through the sulfur atom of the sulfinyl group at any position in the alkyl group.

The term “haloalkylsulfinyl” as used herein refers to an alkylsulfinyl group as defined above wherein the hydrogen atoms are partially or fully substituted by fluorine, chlorine, bromine and/or iodine.

The term “alkylsulfonyl” (also alkyl-S(═O)₂—) as used herein refers to a straight-chain or branched saturated alkyl group comprising 1 to 10 carbon atoms (═C₁-C₁₀-alkylsulfonyl), preferably 1 to 4 carbon atoms (═C₁-C₄-alkylsulfonyl), as defined above, which is attached via the sulfur atom of the sulfonyl group at any position in the alkyl group.

The term “haloalkylsulfonyl” as used herein refers to an alkylsulfonyl group as defined above wherein the hydrogen atoms are partially or fully substituted by fluorine, chlorine, bromine and/or iodine.

The term “heterocyclyl” includes in general 3-, 4-, 5-, 6-, 7- or 8-membered, in particular 5-, 6-, 7- or 8-membered monocyclic heterocyclic non-aromatic radicals and 8 to 10 membered bicyclic heterocyclic non-aromatic radicals, the mono- and bicyclic non-aromatic radicals may be saturated or unsaturated. The mono- and bicyclic heterocyclic non-aromatic radicals usually comprise 1, 2, 3 or 4 heteroatoms, in particular 1 or 2 heteroatoms selected from N, O and S as ring members, where S-atoms as ring members may be present as S, SO or SO₂. Examples of saturated or unsaturated 3-, 4-, 5-, 6-, 7- or 8-membered heterocyclic radicals comprise saturated or unsaturated, non-aromatic heterocyclic rings, such as oxiranyl, oxetanyl, thietanyl, thietanyl-5-oxid (S-oxothietanyl), thietanyl-5-dioxid (S-dioxothiethanyl), pyrrolidinyl, pyrazolinyl, imidazolinyl, pyrrolinyl, pyrazolinyl, imidazolinyl, tetrahydrofuranyl, dihydrofuranyl, 1,3-dioxolanyl, dioxolenyl, thiolanyl, S-oxothiolanyl, S-dioxothiolanyl, dihydrothienyl, S-oxodihydrothienyl, S-dioxodihydrothienyl, oxazolidinyl, isoxazolidinyl, oxazolinyl, isoxazolinyl, thiazolinyl, isothiazolinyl, thiazolidinyl, isothiazolidinyl, oxathiolanyl, piperidinyl, piperazinyl, pyranyl, dihydropyranyl, tetrahydropyranyl, 1,3- and 1,4-dioxanyl, thiopyranyl, S-oxothiopyranyl, S-dioxothiopyranyl, dihydrothiopyranyl, S-oxodihydrothiopyranyl, S-dioxodihydrothiopyranyl, tetrahydrothiopyranyl, S-oxotetrahydrothiopyranyl, S-dioxotetrahydrothiopyranyl, morpholinyl, thiomorpholinyl, S-oxothiomorpholinyl, S-dioxothiomorpholinyl, thiazinyl and the like. Examples for heterocyclic ring also comprising 1 or 2 carbonyl groups as ring members comprise pyrrolidin-2-onyl, pyrrolidin-2,5-dionyl, imidazolidin-2-onyl, oxazolidin-2-onyl, thiazolidin-2-onyl and the like.

The term “hetaryl” includes in general 5- or 6-membered unsaturated monocyclic heterocyclic radicals and 8 to 10 membered unsaturated bicyclic heterocyclic radicals which are aromatic, i.e. they comply with Hückel's rule (4n+2 rule). Hetaryl usually comprise 1, 2, 3 or 4 heteroatoms selected from N, O and S as ring members. Examples of 5- or 6-membered heteroaromatic radicals include pyridyl, i.e. 2-, 3-, or 4-pyridyl, pyrimidinyl, i.e. 2-, 4- or 5-pyrimidinyl, pyrazinyl, pyridazinyl, i.e. 3- or 4-pyridazinyl, thienyl, i.e. 2- or 3-thienyl, furyl, i.e. 2- or 3-furyl, pyrrolyl, i.e. 2- or 3-pyrrolyl, oxazolyl, i.e. 2-, 3- or 5-oxazolyl, isoxazolyl, i.e. 3-, 4- or 5-isoxazolyl, thiazolyl, i.e. 2-, 3- or 5-thiazolyl, isothiazolyl, i.e. 3-, 4- or 5-isothiazolyl, pyrazolyl, i.e. 1-, 3-, 4- or 5-pyrazolyl, i.e. 1-, 2-, 4- or 5-imidazolyl, oxadiazolyl, e.g. 2- or 5-[1,3,4]oxadiazolyl, 4- or 5-(1,2,3-oxadiazol)yl, 3- or 5-(1,2,4-oxadiazol)yl, 2- or 5-(1,3,4-thiadiazol)yl, thiadiazolyl, e.g. 2- or 5-(1,3,4-thiadiazol)yl, 4- or 5-(1,2,3-thiadiazol)yl, 3- or 5-(1,2,4-thiadiazol)yl, triazolyl, e.g. 1H-, 2H- or 3H-1,2,3-triazol-4-yl, 2H-triazol-3-yl, 1H-, 2H-, or 4H-1,2,4-triazolyl and tetrazolyl, i.e. 1H- or 2H-tetrazolyl.

The term “hetaryl” also includes bicyclic 8- to 10-membered heteroaromatic radicals comprising as ring members 1, 2 or 3 heteroatoms selected from N, O and S, wherein a 5- or 6-membered heteroaromatic ring is fused to a phenyl ring or to a 5- or 6-membered heteroaromatic radical. Examples of a 5- or 6-membered heteroaromatic ring fused to a phenyl ring or to a 5- or 6-membered heteroaromatic radical include benzofuranyl, benzothienyl, indolyl, indazolyl, benzimidazolyl, benzoxathiazolyl, benzoxadiazolyl, benzothiadiazolyl, benzoxazinyl, chinolinyl, isochinolinyl, purinyl, 1,8-naphthyridyl, pteridyl, pyrido[3,2-d]pyrimidyl or pyridoimidazolyl and the like. These fused hetaryl radicals may be bonded to the remainder of the molecule via any ring atom of 5- or 6-membered heteroaromatic ring or via a carbon atom of the fused phenyl moiety.

The terms “phenyl-C₁-C₅-alkyl” refers to phenyl which is bound via a C₁-C₅-alkylene group, in particular a methylene group (=phenylmethyl), to the remainder of the molecule, examples including benzyl, 1-phenylethyl, 2-phenylethyl, 3-phenylpropyl, 3-phenylpentyl and the like.

The terms “heterocyclyl-C₁-C₄-alkyl” and “hetaryl-C₁-C₄-alkyl” refer to heterocyclyl or hetaryl, respectively, as defined above, which are bound via a C₁-C₄-alkylene group, in particular a methylene group (=heterocyclylmethyl or hetarylmethyl, respectively) or an 1,1-ethandiyl or 1,2-ethandiyl group (=1-heterocyclylethyl, 2-heterocyclylethyl, 1-hetarylethyl or 2-hetarylethyl, respectively), to the remainder of the molecule.

The term “phenylcarbonyl” (phenyl-C(═O)—), as used herein refers to a phenyl group that is bound to the remainder of the molecule via the carbon atom of the carbonyl group.

The term “hetarylcarbonyl” (hetaryl-C(═O)—) and “heterocyclylcarbonyl” (heterocyclyl-C(═O)—) refer to a hetaryl or heterocyclyl, respectively, as defined above, which are bound via the carbon atom of the carbonyl group to the remainder of the molecule, wherein the carbon atom of the carbonyl group is attached through any one of the carbon atoms of the hetaryl or heterocyclyl, respectively.

The term “phenylsulfonyl” (also phenyl-S(═O)₂—) as used herein refers to phenyl group that is bound to the remainder of the molecule via the sulfur atom of the sulfonyl group.

The term “hetarylsulfonyl” (hetaryl-S(═O)₂—) and “heterocyclylsulfonyl” (heterocyclyl-S(═O)₂—) refer to a hetaryl or heterocyclyl, respectively, as defined above, which are bound via the sulfur atom of the sulfonyl group to the remainder of the molecule, wherein the sulfur atom of the sulfonyl group is attached through any one of the carbon atoms of the hetaryl or heterocyclyl, respectively.

The remarks made below as to preferred embodiments of the variables (substituents) of the compounds of formula I are valid on their own as well as preferably in combination with each other.

The remarks made below concerning preferred embodiments of the variables further are valid concerning the compounds of formula I as well as concerning the uses and methods according to the invention and the composition according to the present invention.

A first preferred embodiment of the invention relates to compounds, methods and uses wherein Q in formula I is a 5-membered heterocyclic radical having the formula Q-1, Q-2, Q-3, Q-4 or Q-5,

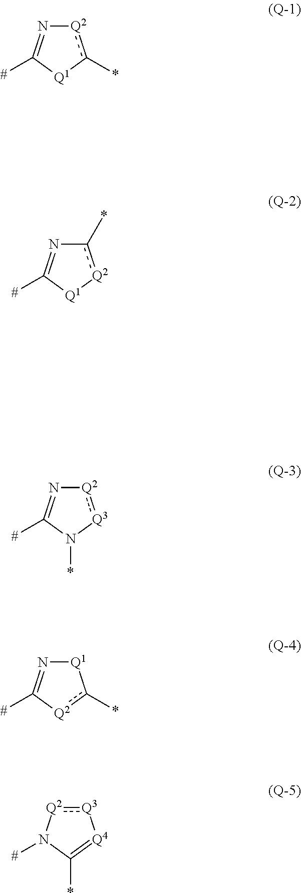

wherein
# denotes the point of attachment to the pyrazole radical of formula I and
* denotes the point of attachment to the 6-membered heteroaromatic radical of formula I, and wherein
[symbol] indicates a single bond or a double bond
Q¹ is O, S or N—R^{QN}, where R^{QN} is as defined herein,
Q² is N or C—R^{Q2}, if [symbol] indicates a double bond, or Q² is O, a carbonyl group or CH—R^{Q2}, if [symbol] indicates a single bond;
Q³ is N or C—R^{Q3}, if [symbol] indicates a double bond, or Q³ is a carbonyl group or CH—R^{Q3}, if [symbol] indicates a single bond;
Q⁴ is N or C—R^{Q4},
where R^{Q2}, R^{Q3} and R^{Q4} are independently of each other hydrogen or are as defined for R^{Q} herein.

In the context of this embodiment preference is given to those compounds, methods and uses wherein Q is selected from Q1, Q2 and Q3, particularly from Q1 and Q3.

Amongst the compounds of formula I with Q being a moiety Q-1, preference is given to those compounds wherein the variable Q² is N and the variable Q¹ is selected from O, S or N—R^{QN}, with R^{QN} being as defined herein, preferably being hydrogen or C₁-C₃-alkyl and more preferably hydrogen or methyl. Particularly preferred the moiety Q-1 is selected from 4H-[1,2,4]-triazol-3,5-diyl, 4-methyl-[1,2,4]-triazol-3,5-diyl, [1,3,4]-oxadiazol-2,5-diyl and [1,3,4]-thiadiazol-2,5-diyl.

Amongst the compounds of formula I with Q being a moiety Q-2, preference is given to those compounds wherein the variable Q² is C—R^{Q2} and the variable Q¹ is selected from O and S, with R^{Q2} being as defined herein, preferably being hydrogen, halogen, CN, C₁-C₃-alkyl or C₁-C₂-haloalkyl and more preferably hydrogen or methyl. Particularly preferred the moiety Q-2 is selected from oxazol-2,4-diyl and thiazol-2,4-diyl.

Amongst the compounds of formula I with Q being a moiety Q-3, preference is given to those compounds wherein the variable Q³ is C—R^{Q3} and the variable Q² is selected from N, O or C—R^{Q2}, with R^{Q3} and R^{Q2} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-3 is selected from [1,2,4]-triazol-3,4-diyl, 5-methyl-[1,2,4]-triazol-3,4-diyl, imidazol-1,2-diyl, 4,5-dihydro-imidazol-1,2-diyl and 4,5-dihydro-[1,2,4]oxadiazol-3,4-diyl.

Amongst the compounds of formula I with Q being a moiety Q-4, preference is given to those compounds wherein the variable Q¹ is N—R^{QN} and the variable Q² is selected from N and C—R^{Q2}, with R^{QN} being as defined herein, preferably being hydrogen or C₁-C₃-alkyl and more preferably hydrogen or methyl, and with R^{Q2} being as defined herein and preferably being hydrogen, halogen, CN, C₁-C₃-alkyl or C₁-C₂-haloalkyl and more preferably hydrogen. Particularly preferred the moiety Q-4 is selected from 1H-pyrazol-3,5-diyl, 1-methyl-pyrazol-3,5-diyl, 1H-[1,2,4]-triazol-3,5-diyl and 1-methyl-[1,2,4]-triazol-3,5-diyl.

Amongst the compounds of formula I with Q being a moiety Q-5, preference is given to those compounds wherein the variable Q² is C—R^{Q2}, the variable Q³ is selected from N and C—R^{Q3} and the variable Q⁴ is selected from N and C—R^{Q4}, with R^{Q2}, R^{Q3} and R^{Q4} being as defined herein, preferably being independently of each other selected from hydrogen, halogen, CN, C₁-C₃-alkyl and C₁-C₂-haloalkyl and more preferably from hydrogen and methyl. Particularly preferred the moiety Q-5 is selected from [1,2,4]-triazol-3,4-diyl and 5-methyl-[1,2,4]-triazol-3,4-diyl.

A further preferred embodiment of the invention relates to compounds, methods and uses wherein Q in formula I is a 6-membered cyclic or heterocyclic radical having the formula Q-6, Q-7, Q-8, Q-9, Q-10, Q-11, Q-12 or Q-13,

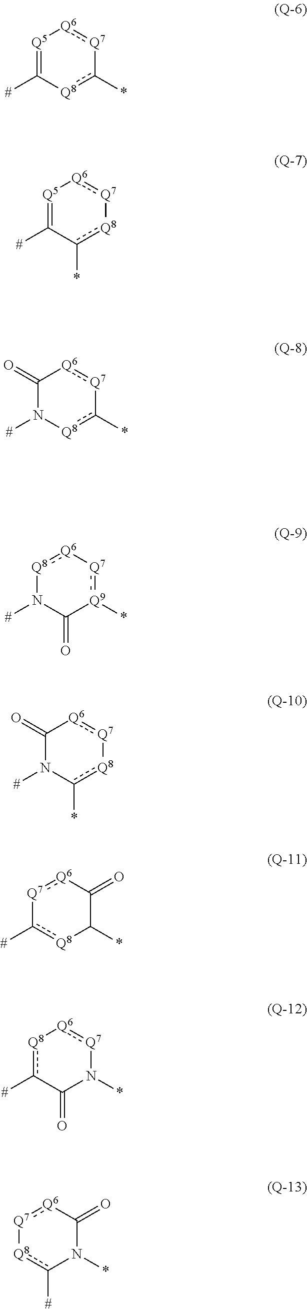

wherein
# denotes the point of attachment to the pyrazole radical of formula I and
* denotes the point of attachment to the 6-membered heteroaromatic radical of formula I, and wherein
[symbol] indicates a single bond or a double bond
Q⁵ is N or C—R^{Q5},
Q⁶ is N or C—R^{Q6}, if [symbol] indicates a double bond, or Q⁶ is a carbonyl group or CH—R^{Q6}, if [symbol] indicates a single bond;
Q⁷ is N or C—R^{Q7}, if [symbol] indicates a double bond, or Q⁷ is a carbonyl group or CH—R^{Q7}, if [symbol] indicates a single bond;
Q⁸ is N or C—R^{Q8}, if [symbol] indicates a double bond, or Q⁸ is a carbonyl group or CH—R^{Q8}, if [symbol] indicates a single bond;
Q⁹ is C, if [symbol] indicates a double bond, or Q⁹ is N or CH, if [symbol] indicates a single bond;
provided that only one of Q⁶, Q⁷ and Q⁸ is N or a carbonyl group,
where R^{Q5}, R^{Q6}, R^{Q7} and R^{Q8} are independently of each other hydrogen or are as defined for R^{Q} claim 1.

In the context of this embodiment preference is given to those compounds, methods and uses wherein Q is selected from Q6 and Q7.

Amongst the compounds of formula I with Q being a moiety Q-6, preference is given to those compounds wherein the variable Q⁵ is N or C—R^{Q5}, Q⁶ is N or C—R^{Q6}, Q⁷ is N or C—R^{Q7} and Q⁸ is N or C—R^{Q8}, provided that only one or none of Q⁵, Q⁶, Q⁷ and Q⁸ is N, with R^{Q5}, R^{Q6}, R^{Q7} and R^{Q8} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-6 is selected from 1,3-phenylen, pyridin-2,6-diyl, pyridin-3,5-diyl, pyridin-2,4-diyl and pyridin-4,2-diyl.

Amongst the compounds of formula I with Q being a moiety Q-7, preference is given to those compounds wherein the variable Q⁵ is N or C—R^{Q5}, Q⁶ is N or C—R^{Q6}, Q⁷ is N or C—R^{Q7} and Q⁸ is N or C—R^{Q8}, provided that only one or none of Q⁵, Q⁶, Q⁷ and Q⁸ is N, with R^{Q5}, R^{Q6}, R^{Q7} and R^{Q8} being as defended herein preferably being independently of each other selected from hydrogen, halogen, CN, C₁-C₃-alkyl and C₁-C₂-haloalkyl, and more preferably from hydrogen and methyl. Particularly preferred the moiety Q-7 is selected from 1,2-phenylen, pyridin-2,3-diyl, pyridin-3,2-diyl, pyridin-3,4-diyl and pyridin-4,3-diyl.

Amongst the compounds of formula I with Q being a moiety Q-8, preference is given to those compounds wherein the variable Q⁶ is N or C—R^{Q6}, Q⁷ is N or C—R^{Q7} and Q⁸ is N or C—R^{Q8}, provided that only one or none of Q⁶, Q⁷ and Q⁸ is N, with R^{Q5}, R^{Q6}, R^{Q7} and R^{Q8} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-8 is selected from pyridon-1,5-diyl, pyrimidin-2-on-1,5-diyl and pyrazin-2-on-1,5-diyl.

Amongst the compounds of formula I with Q being a moiety Q-9, preference is given to those compounds wherein the variable Q⁶ is N or C—R^{Q6}, Q⁷ is N or C—R^{Q7}, Q⁸ is N or C—R^{Q8} and Q⁹ is C, provided that only one or none of Q⁶, Q⁷ and Q⁸ is N, with R^{Q6}, R^{Q7} and R^{Q8} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-9 is selected from pyridon-1,3-diyl, pyrimidin-6-on-1,5-diyl and pyrazin-6-on-1,5-diyl.

Amongst the compounds of formula I with Q being a moiety Q-10, preference is given to those compounds wherein the variable Q⁶ is N or C—R^{Q6}, Q⁷ is N or C—R^{Q7} and Q⁸ is N or C—R^{Q8}, provided that only one or none of Q⁶, Q⁷ and Q⁸ is N, with R^{Q5}, R^{Q6}, R^{Q7} and R^{Q8} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-10 is selected from pyridon-1,6-diyl, pyrimidin-6-on-1,2-diyl and pyrazin-2-on-1,6-diyl.

Amongst the compounds of formula I with Q being a moiety Q-11, preference is given to those compounds wherein the variable Q⁶ is N or C—R^{Q6}, Q⁷ is N or C—R^{Q7} and Q⁸ is N or C—R^{Q8}, provided that only one or none of Q⁶, Q⁷ and Q⁸ is N, with R^{Q5}, R^{Q6}, R^{Q7} and R^{Q8} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-11 is selected from pyridon-1,5-diyl, pyrimidin-2-on-1,5-diyl and pyrazin-2-on-1,5-diyl.

Amongst the compounds of formula I with Q being a moiety Q-12, preference is given to those compounds wherein the variable Q⁶ is N or C—R^{Q6}, Q⁷ is N or C—R^{Q7} and Q⁸ is N or C—R^{Q8}, provided that only one or none of Q⁶, Q⁷ and Q⁸ is N, with R^{Q5}, R^{Q6}, R^{Q7} and R^{Q8} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-12 is selected from pyridon-1,3-diyl, pyrimidin-6-on-1,5-diyl and pyrazin-2-on-1,3-diyl.

Amongst the compounds of formula I with Q being a moiety Q-13, preference is given to those compounds wherein the variable Q⁶ is N or C—R^{Q6}, Q⁷ is N or C—R^{Q7} and Q⁸ is N or C—R^{Q8}, provided that only one or none of Q⁶, Q⁷ and Q⁸ is N, with R^{Q5}, R^{Q6}, R^{Q7} and R^{Q8} being as defined herein, preferably being independently of each other selected from hydrogen, halogen, CN, C₁-C₃-alkyl and C₁-C₂-haloalkyl, and more preferably from hydrogen and methyl. Particularly preferred the moiety Q-13 is selected from pyridon-1,6-diyl, pyrimidin-6-on-1,2-diyl and pyrazin-2-on-1,6-diyl.

Among the compounds according to the present invention, preference is given to those wherein R^{N} in formula I is selected from the group consisting of C₁-C₁₀-alkyl, C₂-C₁₀-alkenyl and C₂-C₁₀-alkynyl, wherein the three last mentioned radicals may be unsubstituted, may be partially or fully halogenated or may carry 1, 2 or 3 identical or different substituents R^{x}, or wherein R^{N} is further selected from OR^{a}, C(V)R^{b}, C(V)OR^{c}, S(O)ₘR^{d}, NR^{e}R^{f}, C(V)NR^{g}R^{h}, S(O)ₘNR^{e}R^{f}, C(V)NRⁱNR^{e}R^{f}, C₁-C₅-alkylene-OR^{a}, C₁-C₅-alkylene-CN, C₁-C₅-alkylene-C(V)R^{b}, C₁-C₅-alkylene-C(V)OR^{c}, C₁-C₅-alkylene-NR^{e}R^{f}, C₁-C₅-alkylene-C(V)NR^{g}R^{h}, C₁-C₅-alkylene-S(O)ₘR^{d}, C₁-C₅-alkylene-S(O)ₘNR^{e}R^{f}, C₁-C₅-alkylene-NRⁱNR^{e}R^{f}, heterocyclyl, hetaryl, C₃-C₁₀-cycloalkyl, C₅-C₁₀-cycloalkenyl, heterocyclyl-C₁-C₅-alkyl, hetaryl-C₁-C₅-alkyl, C₃-C₁₀-cycloalkyl-C₁-C₅-alkyl, C₅-C₁₀-cycloalkenyl-C₁-C₅-alkyl, phenyl-C₁-C₅-alkyl and phenyl, wherein the rings of the ten last mentioned radicals may be unsubstituted or may carry 1, 2, 3, 4 or 5 identical or different substituents R^{y}.

Among the compounds according to the present invention, particular preference is given to those wherein R^{N} is selected from the group consisting of hydrogen, C₁-C₁₀-alkyl, C₂-C₁₀-alkenyl and C₂-C₁₀-alkynyl, wherein the three last mentioned radicals may be unsubstituted, may be partially or fully halogenated or may carry 1, 2 or 3 identical or different substituents R^{x}, C₁-C₄-alkoxy-C₂-C₄-alkyl, C₁-C₄-alkylene-CN, heterocyclyl, hetaryl, C₃-C₁₀-cycloalkyl, C₅-C₁₀-cycloalkenyl, heterocyclyl-C₁-C₅-alkyl, hetaryl-C₁-C₅-alkyl, C₃-C₁₀-cycloalkyl-C₁-C₅-alkyl, C₅-C₁₀-cycloalkenyl-C₁-C₅-alkyl, where the rings in the 8 last mentioned radicals may be unsubstituted or may carry 1, 2 or 3 identical or different substituents R. More preferably R^{N} is selected from hydrogen, C₁-C₆-alkyl, C₁-C₆-haloalkyl, C₃-C₁₀-cycloalkyl, C₃-C₆-cycloalkyl-C₁-C₄-alkyl, where the cycloalkyl moiety in the last two mentioned radicals is unsubstituted or carries 1 or 2 radicals selected from halogen, CN and C₁-C₂-haloalkyl, heterocyclyl-C₁-C₄-alkyl, C₁-C₄-alkoxy-C₁-C₄-alkyl and C₁-C₄-alkylene-CN. Even more preferably R^{N} is selected from hydrogen, C₁-C₄-alkyl, C₁-C₄-haloalkyl, C₁-C₂-alkoxy-C₂-C₄-alkyl, C₁-C₄-alkylene-CN, C₃-C₆-cycloalkyl and C₃-C₆-cycloalkyl-C₁-C₄-alkyl, where the cycloalkyl moiety in the last two mentioned radicals is unsubstituted or carries 1 or 2 radicals selected from halogen, CN and C₁-C₂-haloalkyl. In particular R^{N} is selected from C₁-C₃-alkyl, such as methyl or ethyl, C₁-C₂-haloalkyl, such as fluoromethyl, difluoromethyl, trifluoromethyl, 2-fluoroeth-1-yl, 2,2-difluoroeth-1-yl, 2,2,2-trifluoroeth-1-yl, 1-fluoroeth-1-yl, 1,2-difluoroeth-1-yl or 1,2,2-trifluoroeth-1-yl, C₁-C₂-alkoxy-C₁-C₂-alkyl, such as methoxymethyl, and C₁-C₂-alkylene-CN, such as 2-cyanoeth-1-yl. Especially, R^{N} is methyl, ethyl, 2-fluoroeth-1-yl, 2,2,2-trifluoroeth-1-yl or methoxymethyl, in particular methyl or 2,2,2-trifluoroeth-1-yl.

Among the compounds according to the present invention, preference is further given to those wherein the radical R^{A} in formula I, if present, is selected from the group consisting of halogen, CN, NO₂, C₁-C₄-alkyl and C₂-C₁₀-alkenyl, wherein the two last mentioned radicals may be unsubstituted, may be partially or fully halogenated or may carry 1, 2 or 3 identical or different substituents selected from C₁-C₄-alkoxy, haloalkoxy, C₃-C₆-cycloalkyl, hetaryl, phenyl and phenoxy, wherein the last three mentioned radicals may be unsubstituted or may carry 1, 2, 3, 4 or 5 radicals selected from halogen, C₁-C₄-alkyl, C₁-C₄-alkoxy, C₁-C₄-haloalkoxy, C₁-C₄-alkylsulfonyl and C₁-C₄-haloalkylsulfonyl, or wherein R^{A} is further selected from C₃-C₆-cycloalkyl, C₅-C₆-hetaryl and phenyl, wherein the three last mentioned radicals may be unsubstituted or may carry 1, 2, 3, 4 or 5 identical or different substituents selected from halogen, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl. In particular, the radical R^{A}, if present, is selected from halogen, CN, NO₂, C₁-C₄-haloalkyl, C₃-C₆-cycloalkyl C₃-C₆-halocycloalkyl and phenyl, wherein phenyl may be unsubstituted or may carry 1, 2, 3, 4 or 5 radicals selected from halogen, C₁-C₄-alkyl, C₁-C₄-haloalkyl, C₁-C₄-alkoxy and C₁-C₄-haloalkoxy. More preferably, the radical R^{A}, if present, is selected from halogen, CN, NO₂, C₃-C₆-cycloalkyl and C₃-C₆-halocycloalkyl. Even more preferably, R^{A}, if present, is selected from halogen, NO₂, C₁-C₄-haloalkyl, C₃-C₆-cycloalkyl and C₃-C₆-halocycloalkyl. Particularly R^{A}, if present, is selected from C₁-C₃-alkyl, such as methyl or ethyl, and C₁-C₂-haloalkyl, such as fluoromethyl, difluoromethyl, trifluoromethyl, 2-fluoroeth-1-yl or 2,2,2-trifluoroeth-1-yl. Especially R^{A} is methyl, ethyl, fluoromethyl, difluoromethyl or trifluoromethyl.

The variable n in formula I is preferably 0 or 1 and in particular is 1.

Among the compounds according to the present invention, preference is further given to those wherein the radicals R^{t} and R^{u} are selected independently of each other from hydrogen, fluorine, chlorine, bromine, methyl, difluoromethyl, trifluoromethyl, methoxy, difluoromethoxy and trifluoromethoxy, and in particular from hydrogen, methyl, chlorine, difluoromethyl and trifluoromethyl. More preferably R^{t} and R^{u} are both hydrogen.

A further preferred embodiment of the invention relates to compounds, methods and uses, where in formula I one of the variables X, Y and Z is N and the remaining two variables are both CH. According to a particular preferred aspect of this embodiment X is CH, Y is N and Z is CH.

A further preferred embodiment of the invention relates to compounds, methods and uses, where in formula I the variable X is CH and the variables Y and Z are both N.

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-1, as defined herein. According to a particular preferred aspect of this embodiment Q-1 is selected from the radicals of the following formulae:

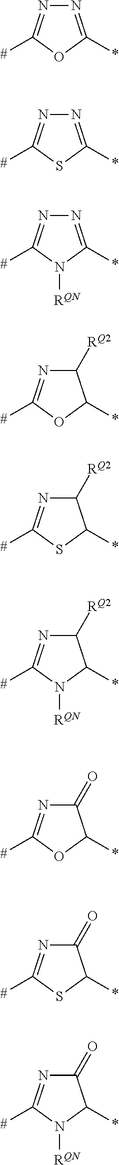

wherein #, *, R^{Q2} and R^{QN} are as defined herein.

Among the compounds of formula I wherein Q is Q-1, preference is given to those compounds, wherein R^{QN} is selected from the group consisting of hydrogen, C₁-C₃-alkyl and C₁-C₃-haloalkyl, more preferably from the group consisting of hydrogen, C₁-C₃-alkyl and C₁-C₂-fluoroalkyl.

In particular, R^{QN} is selected from hydrogen, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl and 2,2,2-trifluoroeth-1-yl.

Among the compounds of formula I wherein Q is Q-1, preference is given to those compounds, wherein R^{Q2} is selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q2} is selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl.

Examples of suitable radicals Q-1 are the radicals of formulae Q-1.1 to Q-1.121, as defined in Table Q1. Of the two attachment points identified in the names of radicals Q-1 given in Table Q1 the first number represents the position to which the pyrazole radical is linked and the second number represents the position to which the 6-membered heteroaromatic radical is linked. By way of example, [1,3,4]oxadiazol-2,5-diyl is bound to the pyrazole radical and the 6-membered heteroaromatic radical via its positions 2 and 5, respectively.

TABLE Q1

| | |
|---|---|
| [1,3,4]oxadiazol-2,5-diyl | (Q-1.1) |
| [1,3,4]-thiadiazol-2,5-diyl | (Q-1.2) |
| 4H-[1,2,4]-triazol-3,5-diyl | (Q-1.3) |
| 4-methyl-[1,2,4]-triazol-3,5-diyl | (Q-1.4) |
| 4-ethyl-[1,2,4]-triazol-3,5-diyl | (Q-1.5) |
| 4-fluoromethyl-[1,2,4]-triazol-3,5-diyl | (Q-1.6) |
| 4-difluoromethyl-[1,2,4]-triazol-3,5-diyl | (Q-1.7) |
| 4-trifluoromethyl-[1,2,4]-triazol-3,5-diyl | (Q-1.8) |
| 4-(2-fluoroeth-1-yl)[1,2,4]-triazol-3,5-diyl | (Q-1.9) |
| 4-(2,2-difluoroeth-1-yl)[1,2,4]-triazol-3,5-diyl | (Q-1.10) |
| 4-(2,2,2-trifluoroeth-1-yl)-[1,2,4]-triazol-3,5-diyl | (Q-1.11) |
| 4,5-dihydro-oxazol-2,5-diyl | (Q-1.12) |
| 4-chloro-4,5-dihydro-oxazol-2,5-diyl | (Q-1.13) |
| 4-cyano-4,5-dihydro-oxazol-2,5-diyl | (Q-1.14) |
| 4-methyl-4,5-dihydro-oxazol-2,5-diyl | (Q-1.15) |
| 4-ethyl-4,5-dihydro-oxazol-2,5-diyl | (Q-1.16) |
| 4-fluoromethyl-4,5-dihydro-oxazol-2,5-diyl | (Q-1.17) |
| 4-difluoromethyl-4,5-dihydro-oxazol-2,5-diyl | (Q-1.18) |
| 4-trifluoromethyl-4,5-dihydro-oxazol-2,5-diyl | (Q-1.19) |
| 4-(2,2,2-trifluoroeth-1-yl)-4,5-dihydro-oxazol-2,5-diyl | (Q-1.20) |
| 4,5-dihydro-thiazol-2,5-diyl | (Q-1.21) |
| 4-chloro-4,5-dihydro-thiazol-2,5-diyl | (Q-1.22) |
| 4-cyano-4,5-dihydro-thiazol-2,5-diyl | (Q-1.23) |
| 4-methyl-4,5-dihydro-thiazol-2,5-diyl | (Q-1.24) |
| 4-ethyl-4,5-dihydro-thiazol-2,5-diyl | (Q-1.25) |
| 4-fluoromethyl-4,5-dihydro-thiazol-2,5-diyl | (Q-1.26) |
| 4-difluoromethyl-4,5-dihydro-thiazol-2,5-diyl | (Q-1.27) |
| 4-trifluoromethyl-4,5-dihydro-thiazol-2,5-diyl | (Q-1.28) |
| 4-(2,2,2-trifluoroeth-1-yl)-4,5-dihydro-thiazol-2,5-diyl | (Q-1.29) |
| 1H-4,5-dihydro-imidazol-2,5-diyl | (Q-1.30) |
| 1H-4-chloro-4,5-dihydro-imidazol-2,5-diyl | (Q-1.31) |
| 1H-4-cyano-4,5-dihydro-imidazol-2,5-diyl | (Q-1.32) |
| 1H-4-methyl-4,5-dihydro-imidazol-2,5-diyl | (Q-1.33) |
| 1H-4-ethyl-4,5-dihydro-imidazol-2,5-diyl | (Q-1.34) |
| 1H-4-fluoromethyl-4,5-dihydro-imidazol-2,5-diyl | (Q-1.35) |
| 1H-4-difluoromethyl-4,5-dihydro-imidazol-2,5-diyl | (Q-1.36) |
| 1H-4-trifluoromethyl-4,5-dihydro-imidazol-2,5-diyl | (Q-1.37) |
| 1H-4-(2,2,2-trifluoroeth-1-yl)-4,5-dihydro-imidazol-2,5-diyl | (Q-1.38) |
| 1-methyl-4,5-dihydro-imidazol-2,5-diyl | (Q-1.39) |
| 1-methyl-4-chloro-4,5-dihydro-imidazol-2,5-diyl | (Q-1.40) |
| 1-methyl-4-cyano-4,5-dihydro-imidazol-2,5-diyl | (Q-1.41) |
| 1-methyl-4-methyl-4,5-dihydro-imidazol-2,5-diyl | (Q-1.42) |
| 1-methyl-4-ethyl-4,5-dihydro-imidazol-2,5-diyl | (Q-1.43) |
| 1-methyl-4-fluoromethyl-4,5-dihydro-imidazol-2,5-diyl | (Q-1.44) |
| 1-methyl-4-difluoromethyl-4,5-dihydro-imidazol-2,5-diyl | (Q-1.45) |
| 1-methyl-4-trifluoromethyl-4,5-dihydro-imidazol-2,5-diyl | (Q-1.46) |
| 1-methyl-4-(2,2,2-trifluoroeth-1-yl)-4,5-dihydro-imidazol-2,5-diyl | (Q-1.47) |
| 1-ethyl-4,5-dihydro-imidazol-2,5-diyl | (Q-1.48) |
| 1-ethyl-4-chloro-4,5-dihydro-imidazol-2,5-diyl | (Q-1.49) |
| 1-ethyl-4-cyano-4,5-dihydro-imidazol-2,5-diyl | (Q-1.50) |
| 1-ethyl-4-methyl-4,5-dihydro-imidazol-2,5-diyl | (Q-1.51) |
| 1-ethyl-4-ethyl-4,5-dihydro-imidazol-2,5-diyl | (Q-1.52) |
| 1-ethyl-4-fluoromethyl-4,5-dihydro-imidazol-2,5-diyl | (Q-1.53) |
| 1-ethyl-4-difluoromethyl-4,5-dihydro-imidazol-2,5-diyl | (Q-1.54) |
| 1-ethyl-4-trifluoromethyl-4,5-dihydro-imidazol-2,5-diyl | (Q-1.55) |
| 1-ethyl-4-(2,2,2-trifluoroeth-1-yl)-4,5-dihydro-imidazol-2,5-diyl | (Q-1.56) |
| 1-fluoromethyl-4,5-dihydro-imidazol-2,5-diyl | (Q-1.57) |
| 1-fluoromethyl-4-chloro-4,5-dihydro-imidazol-2,5-diyl | (Q-1.58) |
| 1-fluoromethyl-4-cyano-4,5-dihydro-imidazol-2,5-diyl | (Q-1.59) |
| 1-fluoromethyl-4-methyl-4,5-dihydro-imidazol-2,5-diyl | (Q-1.60) |
| 1-fluoromethyl-4-ethyl-4,5-dihydro-imidazol-2,5-diyl | (Q-1.61) |
| 1-fluoromethyl-4-fluoromethyl-4,5-dihydro-imidazol-2,5-diyl | (Q-1.62) |
| 1-fluoromethyl-4-difluoromethyl-4,5-dihydro-imidazol-2,5-diyl | (Q-1.63) |
| 1-fluoromethyl-4-trifluoromethyl-4,5-dihydro-imidazol-2,5-diyl | (Q-1.64) |
| 1-fluoromethyl-4-(2,2,2-trifluoroeth-1-yl)-4,5-dihydro-imidazol-2,5-diyl | (Q-1.65) |
| 1-difluoromethyl-4,5-dihydro-imidazol-2,5-diyl | (Q-1.66) |
| 1-difluoromethyl-4-chloro-4,5-dihydro-imidazol-2,5-diyl | (Q-1.67) |
| 1-difluoromethyl-4-cyano-4,5-dihydro-imidazol-2,5-diyl | (Q-1.68) |
| 1-difluoromethyl-4-methyl-4,5-dihydro-imidazol-2,5-diyl | (Q-1.69) |
| 1-difluoromethyl-4-ethyl-4,5-dihydro-imidazol-2,5-diyl | (Q-1.70) |
| 1-difluoromethyl-4-fluoromethyl-4,5-dihydro-imidazol-2,5-diyl | (Q-1.71) |
| 1-difluoromethyl-4-difluoromethyl-4,5-dihydro-imidazol-2,5-diyl | (Q-1.72) |
| 1-difluoromethyl-4-trifluoromethyl-4,5-dihydro-imidazol-2,5-diyl | (Q-1.73) |
| 1-difluoromethyl-4-(2,2,2-trifluoroeth-1-yl)-4,5-dihydro-imidazol-2,5-diyl | (Q-1.74) |
| 1-trifluoromethyl-4,5-dihydro-imidazol-2,5-diyl | (Q-1.75) |
| 1-trifluoromethyl-4-chloro-4,5-dihydro-imidazol-2,5-diyl | (Q-1.76) |
| 1-trifluoromethyl-4-cyano-4,5-dihydro-imidazol-2 ,5-diyl | (Q-1.77) |
| 1-trifluoromethyl-4-methyl-4,5-d ihydro-imidazol-2 ,5-diyl | (Q-1.78) |
| 1-trifluoromethyl-4-ethyl-4,5-dihydro-imidazol-2,5-diyl | (Q-1.79) |
| 1-trifluoromethyl-4-fluoromethyl-4,5-dihydro-imidazol-2,5-diyl | (Q-1.80) |
| 1-trifluoromethyl-4-difluoromethyl-4,5-dihydro-imidazol-2,5-diyl | (Q-1.81) |
| 1-trifluoromethyl-4-trifluoromethyl-4,5-dihydro-imidazol-2,5-diyl | (Q-1.82) |
| 1-trifluoromethyl-4-(2,2,2-trifluoroeth-1-yl)-4,5-dihydro-imidazol-2,5-diyl | (Q-1.83) |
| 1-(2-fluoroeth-1-yl)-4,5-dihydro-imidazol-2,5-diyl | (Q-1.84) |
| 1-(2-fluoroeth-1-yl)-4-chloro-4,5-dihydro-imidazol-2,5-diyl | (Q-1.85) |
| 1-(2-fluoroeth-1-yl)-4-cyano-4,5-dihydro-imidazol-2,5-diyl | (Q-1.86) |
| 1-(2-fluoroeth-1-yl)--4-methyl-4,5-dihydro-imidazol-2,5-diyl | (Q-1.87) |
| 1-(2-fluoroeth-1-yl)-4-ethyl-4,5-dihydro-imidazol-2 ,5-diyl | (Q-1.88) |
| 1-(2-fluoroeth-1-yl)-4-fluoromethyl-4,5-dihydro-imidazol-2,5-diyl | (Q-1.89) |
| 1-(2-fluoroeth-1-yl)-4-difluoromethyl-4,5-dihydro-imidazol-2,5-diyl | (Q-1.90) |
| 1-(2-fluoroeth-1-yl)-4-trifluoromethyl-4,5-dihydro-imidazol-2,5-diyl | (Q-1.91) |
| 1-(2-fluoroeth-1-yl)-4-(2,2,2-trifluoroeth-1-yl)-4,5-dihydro-imidazol-2,5-diyl | (Q-1.92) |
| 1-(2,2-difluoroeth-1-yl)-4,5-dihydro-imidazol-2,5-diyl | (Q-1.93) |
| 1-(2,2-difluoroeth-1-yl)-4-chloro-4,5-dihydro-imidazol-2,5-diyl | (Q-1.94) |
| 1-(2,2-difluoroeth-1-yl)-4-cyano-4,5-dihydro-imidazol-2,5-diyl | (Q-1.95) |
| 1-(2,2-difluoroeth-1-yl)-4-methyl-4,5-dihydro-imidazol-2,5-diyl | (Q-1.96) |
| 1-(2,2-difluoroeth-1-yl)-4-ethyl-4,5-dihydro-imidazol-2,5-diyl | (Q-1.97) |
| 1-(2,2-difluoroeth-1-yl)-4-fluoromethyl-4,5-dihydro-imidazol-2,5-diyl | (Q-1.98) |
| 1-(2,2-difluoroeth-1-yl)-4-difluoromethyl-4,5-d ihydro-imidazol-2 ,5-diyl | (Q-1.99) |
| 1-(2,2-difluoroeth-1-yl)-4-trifluoromethyl-4,5-dihydro-imidazol-2,5-diyl | (Q-1.100) |
| 1-(2,2-difluoroeth-1-yl)-4-(2,2,2-trifluoroeth-1-yl)-4,5-dihydro-imidazol-2,5-diyl | (Q-1.101) |
| 1-(2,2,2-trifluoroeth-1-yl)-4,5-dihydro-imidazol-2,5-diyl | (Q-1.102) |
| 1-(2,2,2-trifluoroeth-1-yl)-4-chloro-4,5-dihydro-imidazol-2,5-diyl | (Q-1.103) |
| 1-(2,2,2-trifluoroeth-1-yl)-4-cyano-4,5-dihydro-imidazol-2,5-diyl | (Q-1.104) |
| 1-(2,2,2-trifluoroeth-1-yl)-4-methyl-4,5-dihydro-imidazol-2,5-diyl | (Q-1.105) |
| 1-(2,2,2-trifluoroeth-1-yl)-4-ethyl-4,5-dihydro-imidazol-2,5-diyl | (Q-1.106) |
| 1-(2,2,2-trifluoroeth-1-yl)-4-fluoromethyl-4,5-dihydro-imidazol-2,5-diyl | (Q-1.107) |
| 1-(2,2,2-trifluoroeth-1-yl)-4-difluoromethyl-4,5-dihydro-imidazol-2,5-diyl | (Q-1.108) |
| 1-(2,2,2-trifluoroeth-1-yl)-4-trifluoromethyl-4,5-dihydro-imidazol-2,5-diyl | (Q-1.109) |
| 1-(2,2,2-trifluoroeth-1-yl)-4-(2,2,2-trifluoroeth-1-yl)-4,5-dihydro-imidazol-2,5-diyl | (Q-1.110) |
| 4,5-dihydro-oxazol-4-on-2,5-diyl | (Q-1.111) |
| 4,5-dihydro-thiazol-4-on-2,5-diyl | (Q-1.112) |
| 4,5-dihydro-1H-imidazol-4-on-2,5-diyl | (Q-1.113) |
| 1-methyl-4,5-dihydro-imidazol-4-on-2,5-diyl | (Q-1.114) |
| 1-ethyl-4,5-dihydro-imidazol-4-on-2,5-diyl | (Q-1.115) |
| 1-fluoromethyl-4,5-dihydro-imidazol-4-on-2,5-diyl | (Q-1.116) |
| 1-difluoromethyl-4,5-dihydro-imidazol-4-on-2,5-diyl | (Q-1.117) |
| 1-trifluoromethyl-4,5-dihydro-imidazol-4-on-2,5-diyl | (Q-1.118) |
| 1-(2-fluoroeth-1-yl)-4,5-dihydro-imidazol-4-on-2,5-diyl | (Q-1.119) |
| 1-(2,2-difluoroeth-1-yl)-4,5-dihydro-imidazol-4-on-2,5-diyl | (Q-1.120) |
| 1-(2,2,2-trifluoroeth-1-yl)-4,5-dihydro-imidazol-4-on-2,5-diyl | (Q-1.121) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-2, as defined herein. According to a particular preferred aspect of this embodiment Q-2 is selected from the radicals of the following formulae:

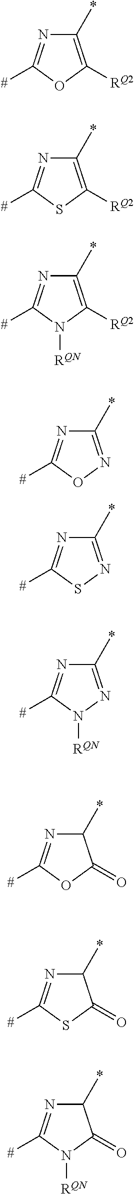

wherein #, *, R^{Q2} and R^{QN} are as defined herein.

Among the compounds of formula I wherein Q is Q-2, preference is given to those compounds, wherein R^{QN} is selected from the group consisting of hydrogen, C₁-C₃-alkyl and C₁-C₃-haloalkyl, more preferably from the group consisting of hydrogen, C₁-C₃-alkyl and C₁-C₂-fluoroalkyl.

In particular, R^{QN} is selected from hydrogen, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl and 2,2,2-trifluoroeth-1-yl.

Among the compounds of formula I wherein Q is Q-2, preference is given to those compounds, wherein R^{Q2} is selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q2} is selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl.

Examples of suitable radicals Q-2 are the radicals of formulae Q-2.1 to Q-2.121, as defined in Table Q2. Of the two attachment points identified in the names of radicals Q-2 given in Table Q2 the first number represents the position to which the pyrazole radical is linked and the second number represents the position to which the 6-membered heteroaromatic radical is linked. By way of example, oxazol-2,4-diyl is bound to the pyrazole radical and the 6-membered heteroaromatic radical via its positions 2 and 4, respectively.

TABLE Q2

| | |
|---|---|
| oxazol-2,4-diyl | (Q-2.1) |
| 5-chloro-oxazol-2,4-diyl | (Q-2.2) |
| 5-cyano-oxazol-2,4-diyl | (Q-2.3) |
| 5-methyl-oxazol-2,4-diyl | (Q-2.4) |
| 5-ethyl-oxazol-2,4-diyl | (Q-2.5) |
| 5-fluoromethyl-oxazol-2,4-diyl | (Q-2.6) |
| 5-difluoromethyl-oxazol-2,4-diyl | (Q-2.7) |
| 5-trifluoromethyl-oxazol-2,4-diyl | (Q-2.8) |
| 5-(2,2,2-trifluoroeth-1-yl)-oxazol-2,4-diyl | (Q-2.9) |
| thiazol-2,4-diyl | (Q-2.10) |
| 5-chloro-thiazol-2,4-diyl | (Q-2.11) |
| 5-cyano-thiazol-2,4-diyl | (Q-2.12) |
| 5-methyl-thiazol-2,4-diyl | (Q-2.13) |
| 5-ethyl-thiazol-2,4-diyl | (Q-2.14) |
| 5-fluoromethyl-thiazol-2,4-diyl | (Q-2.15) |
| 5-difluoromethyl-thiazol-2,4-diyl | (Q-2.16) |
| 5-trifluoromethyl-thiazol-2,4-diyl | (Q-2.17) |
| 5-(2,2,2-trifluoroeth-1-yl)-thiazol-2,4-diyl | (Q-2.18) |
| 1H-imidazol-2,4-diyl | (Q-2.19) |
| 5-chloro-1H-imidazol-2,4-diyl | (Q-2.20) |
| 5-cyano-1H-imidazol-2,4-diyl | (Q-2.21) |
| 5-methyl-1H-imidazol-2,4-diyl | (Q-2.22) |
| 5-ethyl-1H-imidazol-2,4-diyl | (Q-2.23) |
| 5-fluoromethyl-1H-imidazol-2,4-diyl | (Q-2.24) |
| 5-difluoromethyl-1H-imidazol-2,4-diyl | (Q-2.25) |
| 5-trifluoromethyl-1H-imidazol-2,4-diyl | (Q-2.26) |
| 5-(2,2,2-trifluoroeth-1-yl)-1H-imidazol-2,4-diyl | (Q-2.27) |
| 1-methyl-imidazol-2,4-diyl | (Q-2.28) |
| 1-methyl-5-chloro-imidazol-2,4-diyl | (Q-2.29) |
| 1-methyl-5-cyano-imidazol-2,4-diyl | (Q-2.30) |
| 1-methyl-5-methyl-imidazol-2,4-diyl | (Q-2.31) |
| 1-methyl-5-ethyl-imidazol-2,4-diyl | (Q-2.32) |
| 1-methyl-5-fluoromethyl-imidazol-2,4-diyl | (Q-2.33) |
| 1-methyl-5-difluoromethyl-imidazol-2,4-diyl | (Q-2.34) |
| 1-methyl-5-trifluoromethyl-imidazol-2,4-diyl | (Q-2.35) |
| 1-methyl-5-(2,2,2-trifluoroeth-1-yl)- imidazol-2,4-diyl | (Q-2.36) |
| 1-ethyl-imidazol-2,4-diyl | (Q-2.37) |
| 1-ethyl-5-chloro-imidazol-2,4-diyl | (Q-2.38) |
| 1-ethyl-5-cyano-imidazol-2,4-diyl | (Q-2.39) |
| 1-ethyl-5-methyl-imidazol-2,4-diyl | (Q-2.40) |
| 1-ethyl-5-ethyl-imidazol-2,4-diyl | (Q-2.41) |
| 1-ethyl-5-fluoromethyl-imidazol-2,4-diyl | (Q-2.42) |
| 1-ethyl-5-difluoromethyl-imidazol-2,4-diyl | (Q-2.43) |
| 1-ethyl-5-trifluoromethyl-imidazol-2,4-diyl | (Q-2.44) |
| 1-ethyl-5-(2,2,2-trifluoroeth-1-yl)- imidazol-2,4-diyl | (Q-2.45) |
| 1-fluoromethyl-imidazol-2,4-diyl | (Q-2.46) |
| 1-fluoromethyl-5-chloro-imidazol-2,4-diyl | (Q-2.47) |
| 1-fluoromethyl-5-cyano-imidazol-2,4-diyl | (Q-2.48) |
| 1-fluoromethyl-5-methyl-imidazol-2,4-diyl | (Q-2.49) |
| 1-fluoromethyl-5-ethyl-imidazol-2,4-diyl | (Q-2.50) |
| 1-fluoromethyl-5-fluoromethyl-imidazol-2,4-diyl | (Q-2.51) |
| 1-fluoromethyl-5-difluoromethyl-imidazol-2,4-diyl | (Q-2.52) |
| 1-fluoromethyl-5-trifluoromethyl-imidazol-2,4-diyl | (Q-2.53) |
| 1-fluoromethyl-5-(2,2,2-trifluoroeth-1-yl)- imidazol-2,4-diyl | (Q-2.54) |
| 1-difluoromethyl-imidazol-2,4-diyl | (Q-2.55) |
| 1-difluoromethyl-5-chloro-imidazol-2,4-diyl | (Q-2.56) |
| 1-difluoromethyl-5-cyano-imidazol-2,4-diyl | (Q-2.57) |
| 1-difluoromethyl-5-methyl-imidazol-2,4-diyl | (Q-2.58) |
| 1-difluoromethyl-5-ethyl-imidazol-2,4-diyl | (Q-2.59) |
| 1-difluoromethyl-5-fluoromethyl-imidazol-2,4-diyl | (Q-2.60) |
| 1-difluoromethyl-5-difluoromethyl-imidazol-2,4-diyl | (Q-2.61) |
| 1-difluoromethyl-5-trifluoromethyl-imidazol-2,4-diyl | (Q-2.62) |
| 1-difluoromethyl-5-(2,2,2-trifluoroeth-1-yl)- imidazol-2,4-diyl | (Q-2.63) |
| 1-trifluoromethyl-imidazol-2,4-diyl | (Q-2.64) |
| 1-trifluoromethyl-5-chloro-imidazol-2,4-diyl | (Q-2.65) |
| 1-trifluoromethyl-5-cyano-imidazol-2,4-diyl | (Q-2.66) |
| 1-trifluoromethyl-5-methyl-imidazol-2,4-diyl | (Q-2.67) |
| 1-trifluoromethyl-5-ethyl-imidazol-2,4-diyl | (Q-2.68) |
| 1-trifluoromethyl-5-fluoromethyl-imidazol-2,4-diyl | (Q-2.69) |
| 1-trifluoromethyl-5-difluoromethyl-imidazol-2,4-diyl | (Q-2.70) |
| 1-trifluoromethyl-5-trifluoromethyl-imidazol-2,4-diyl | (Q-2.71) |
| 1-trifluoromethyl-5-(2,2,2-trifluoroeth-1-yl)- imidazol-2,4-diyl | (Q-2.72) |
| 1-(2-fluoroeth-1-yl)-imidazol-2,4-diyl | (Q-2.73) |
| 1-(2-fluoroeth-1-yl)-5-chloro-imidazol-2,4-diyl | (Q-2.74) |
| 1-(2-fluoroeth-1-yl)-5-cyano-imidazol-2,4-diyl | (Q-2.75) |
| 1-(2-fluoroeth-1-yl)-5-methyl-imidazol-2,4-diyl | (Q-2.76) |
| 1-(2-fluoroeth-1-yl)-5-ethyl-imidazol-2,4-diyl | (Q-2.77) |
| 1-(2-fluoroeth-1-yl)-5-fluoromethyl-imidazol-2,4-diyl | (Q-2.78) |
| 1-(2-fluoroeth-1-yl)-5-d ifluoromethyl-imidazol-2,4-diyl | (Q-2.79) |
| 1-(2-fluoroeth-1-yl)-5-trifluoromethyl-imidazol-2,4-diyl | (Q-2.80) |
| 1-(2-fluoroeth-1-yl)-5-(2,2,2-trifluoroeth-1-yl)- | (Q-2.81) |
| imidazol-2,4-diyl | |
| 1-(2,2-difluoroeth-1-yl)-imidazol-2,4-diyl | (Q-2.82) |
| 1-(2,2-difluoroeth-1-yl)-5-chloro-imidazol-2,4-diyl | (Q-2.83) |
| 1-(2,2-difluoroeth-1-yl)-5-cyano-imidazol-2,4-diyl | (Q-2.84) |
| 1-(2,2-difluoroeth-1-yl)-5-methyl-im idazol-2,4-diyl | (Q-2.85) |
| 1-(2,2-difluoroeth-1-yl)-5-ethyl-imidazol-2,4-diyl | (Q-2.86) |
| 1-(2,2-difluoroeth-1-yl)-5-fluoromethyl-imidazol-2,4-diyl | (Q-2.87) |
| 1-(2,2-difluoroeth-1-yl)-5-difluoromethyl-imidazol-2,4-diyl | (Q-2.88) |
| 1-(2,2-difluoroeth-1-yl)-5-trifluoromethyl-imidazol-2,4-diyl | (Q-2.89) |
| 1-(2,2-difluoroeth-1-yl)-5-(2,2,2-trifluoroeth-1-yl)- | (Q-2.90) |
| imidazol-2,4-diyl | |
| 1-(2,2,2-trifluoroeth-1-yl)-imidazol-2,4-diyl | (Q-2.91) |
| 1-(2,2,2-trifluoroeth-1-yl)-5-chloro-imidazol-2,4-diyl | (Q-2.92) |
| 1-(2,2,2-trifluoroeth-1-yl)-5-cyano-imidazol-2,4-diyl | (Q-2.93) |
| 1-(2,2,2-trifluoroeth-1-yl)-5-methyl-imidazol-2,4-diyl | (Q-2.94) |
| 1-(2,2,2-trifluoroeth-1-yl)-5-ethyl-imidazol-2,4-diyl | (Q-2.95) |
| 1-(2,2,2-trifluoroeth-1-yl)-5-fluoromethyl-imidazol-2,4-diyl | (Q-2.96) |
| 1-(2,2,2-trifluoroeth-1-yl)-5-difluoromethyl-imidazol-2,4-diyl | (Q-2.97) |
| 1-(2,2,2-trifluoroeth-1-yl)-5-trifluoromethyl-imidazol-2,4-diyl | (Q-2.98) |
| 1-(2,2,2-trifluoroeth-1-yl)-5-(2,2,2-trifluoroeth-1-yl)- | (Q-2.99) |
| imidazol-2,4-diyl | |
| [1,2,4]oxadiazol-5,3-diyl | (Q-2.100) |
| [1,2,4]-thiadiazol-5,3-diyl | (Q-2.101) |
| 1H-[1,2,4]-triazol-5,3-diyl | (Q-2.102) |
| 1-methyl-[1,2,4]-triazol-5,3-diyl | (Q-2.103) |
| 1-ethyl-[1,2,4]-triazol-5,3-diyl | (Q-2.104) |
| 1-fluoromethyl-[1,2,4]-triazol-5,3-diyl | (Q-2.105) |
| 1-difluoromethyl-[1,2,4]-triazol-5,3-diyl | (Q-2.106) |
| 1-trifluoromethyl-[1,2,4]-triazol-5,3-diyl | (Q-2.107) |
| 1-(2-fluoroeth-1-yl)[1,2,4]-triazol-5,3-diyl | (Q-2.108) |
| 1-(2,2-difluoroeth-1-yl)[1,2,4]-triazol-5,3-diyl | (Q-2.109) |
| 1-(2,2,2-trifluoroeth-1-yl)-[1,2,4]-triazol-5,3-diyl | (Q-2.110) |
| 4,5-dihydro-oxazol-5-on-2,4-diyl | (Q-2.111) |
| 4,5-dihydro-thiazol-5-on-2,4-diyl | (Q-2.112) |
| 4,5-dihydro-1H-imidazol-5-on-2,4-diyl | (Q-2.113) |
| 1-methyl-4,5-dihydro-imidazol-5-on-2,4-diyl | (Q-2.114) |
| 1-ethyl-4,5-dihydro-imidazol-5-on-2,4-diyl | (Q-2.115) |
| 1-fluoromethyl-4,5-dihydro-imidazol-5-on-2,4-diyl | (Q-2.116) |
| 1-difluoromethyl-4,5-dihydro-imidazol-5-on-2,4-diyl | (Q-2.117) |
| 1-trifluoromethyl-4,5-dihydro-imidazol-5-on-2,4-diyl | (Q-2.118) |
| 1-(2-fluoroeth-1-yl)-4,5-dihydro-imidazol-5-on-2,4-diyl | (Q-2.119) |
| 1-(2,2-difluoroeth-1-yl)-4,5-dihydro-imidazol-5-on-2,4-diyl | (Q-2.120) |
| 1-(2,2,2-trifluoroeth-1-yl)-4,5-dihydro-imidazol-5-on-2,4-diyl | (Q-1.121) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-3, as defined herein. According to a particular preferred aspect of this embodiment Q-3 is selected from the radicals of the following formulae:

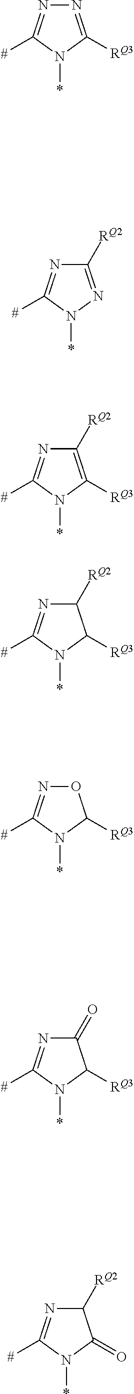

wherein #, *, R^{Q2} and R^{Q3} are as defined herein.

Among the compounds of formula I wherein Q is Q-3, preference is given to those compounds, wherein R^{Q2} and R^{Q3} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q2} and R^{Q3} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl.

Examples of suitable radicals Q-3 are the radicals of formulae Q-3.1 to Q-3.137, as defined in Table Q3. Of the two attachment points identified in the names of radicals Q-3 given in Table Q3 the first number represents the position to which the pyrazole radical is linked and the second number represents the position to which the 6-membered heteroaromatic radical is linked. By way of example, [1,2,4]-triazol-3,4-diyl is bound to the pyrazole radical and the 6-membered heteroaromatic radical via its positions 3 and 4, respectively.

TABLE Q3

| | |
|---|---|
| [1,2,4]-triazol-3,4-diyl | (Q-3.1) |
| 5-chloro-[1,2,4]-triazol-3,4-diyl | (Q-3.2) |
| 5-cyano-[1,2,4]-triazol-3,4-diyl | (Q-3.3) |
| 5-methyl-[1,2,4]-triazol-3,4-diyl | (Q-3.4) |
| 5-ethyl-[1,2,4]-triazol-3,4-diyl | (Q-3.5) |
| 5-fluoromethyl-[1,2,4]-triazol-3,4-diyl | (Q-3.6) |
| 5-difluoromethyl-[1,2,4]-triazol-3,4-diyl | (Q-3.7) |
| 5-trifluoromethyl-[1,2,4]-triazol-3,4-diyl | (Q-3.8) |
| 5-(2,2,2-trifluoroeth-1-yl)- [1,2,4]-triazol-3,4-diyl | (Q-3.9) |
| [1,2,4]-triazol-3,2-diyl | (Q-3.10) |
| 5-chloro-[1,2,4]-triazol-3,2-diyl | (Q-3.11) |
| 5-cyano-[1,2,4]-triazol-3,2-diyl | (Q-3.12) |
| 5-methyl-[1,2,4]-triazol-3,2-diyl | (Q-3.13) |
| 5-ethyl-[1,2,4]-triazol-3,2-diyl | (Q-3.14) |
| 5-fluoromethyl-[1,2,4]-triazol-3,2-diyl | (Q-3.15) |
| 5-difluoromethyl-[1,2,4]-triazol-3,2-diyl | (Q-3.16) |
| 5-trifluoromethyl-[1,2,4]-triazol-3,2-diyl | (Q-3.17) |
| 5-(2,2,2-trifluoroeth-1-yl)[1,2,4]-triazol-3,2-diyl | (Q-3.18) |
| imidazol-2,1-diyl | (Q-3.19) |
| 5-chloro-imidazol-2,1-diyl | (Q-3.20) |
| 5-methyl-imidazol-2,1-diyl | (Q-3.21) |
| 5-ethyl-imidazol-2,1-diyl | (Q-3.22) |
| 5-fluoromethyl-imidazol-2,1-diyl | (Q-3.23) |
| 5-difluoromethyl-imidazol-2,1-diyl | (Q-3.24) |
| 5-trifluoromethyl-imidazol-2,1-diyl | (Q-3.25) |
| 4-chloro-imidazol-2,1-diyl | (Q-3.26) |
| 4,5-dichloro-imidazol-2,1-diyl | (Q-3.27) |
| 4-chloro-5-methyl-imidazol-2,1-diyl | (Q-3.28) |
| 4-chloro-5-ethyl-imidazol-2,1-diyl | (Q-3.29) |
| 4-chloro-5-fluoromethyl-imidazol-2,1-diyl | (Q-3.30) |
| 4-chloro-5-difluoromethyl-imidazol-2,1-diyl | (Q-3.31) |
| 4-chloro-5-trifluoromethyl-imidazol-2,1-diyl | (Q-3.32) |
| 4-methyl-imidazol-2,1-diyl | (Q-3.33) |
| 4-methyl-5-chloro-imidazol-2,1-diyl | (Q-3.34) |
| 4-methyl-5-methyl-imidazol-2,1-diyl | (Q-3.35) |
| 4-methyl-5-ethyl-imidazol-2,1-diyl | (Q-3.36) |
| 4-methyl-5-fluoromethyl-imidazol-2,1-diyl | (Q-3.37) |
| 4-methyl-5-difluoromethyl-imidazol-2,1-diyl | (Q-3.38) |
| 4-methyl-5-trifluoromethyl-imidazol-2,1-diyl | (Q-3.39) |
| 4-ethyl-imidazol-2,1-diyl | (Q-3.40) |
| 4-ethyl-5-chloro-imidazol-2,1-diyl | (Q-3.41) |
| 4-ethyl-5-methyl-imidazol-2,1-diyl | (Q-3.42) |
| 4-ethyl-5-ethyl-imidazol-2,1-diyl | (Q-3.43) |
| 4-ethyl-5-fluoromethyl-imidazol-2,1-diyl | (Q-3.44) |
| 4-ethyl-5-difluoromethyl-imidazol-2,1-diyl | (Q-3.45) |
| 4-ethyl-5-trifluoromethyl-imidazol-2,1-diyl | (Q-3.46) |
| 4-fluoromethyl-imidazol-2,1-diyl | (Q-3.47) |
| 4-fluoromethyl-5-chloro-imidazol-2,1-diyl | (Q-3.48) |
| 4-fluoromethyl-5-methyl-imidazol-2,1-diyl | (Q-3.49) |
| 4-fluoromethyl-5-ethyl-imidazol-2,1-diyl | (Q-3.50) |
| 4-fluoromethyl-5-fluoromethyl-imidazol-2,1-diyl | (Q-3.51) |
| 4-fluoromethyl-5-difluoromethyl-imidazol-2,1-diyl | (Q-3.52) |
| 4-fluoromethyl-5-trifluoromethyl-imidazol-2,1-diyl | (Q-3.53) |
| 4-difluoromethyl-imidazol-2,1-diyl | (Q-3.54) |
| 4-difluoromethyl-5-chloro-imidazol-2,1-diyl | (Q-3.55) |
| 4-difluoromethyl-5-methyl-imidazol-2,1-diyl | (Q-3.56) |
| 4-difluoromethyl-5-ethyl-imidazol-2,1-diyl | (Q-3.57) |
| 4-difluoromethyl-5-fluoromethyl-imidazol-2,1-diyl | (Q-3.58) |
| 4-difluoromethyl-5-difluoromethyl-imidazol-2,1-diyl | (Q-3.59) |
| 4-difluoromethyl-5-trifluoromethyl-imidazol-2,1-diyl | (Q-3.60) |
| 4-trifluoromethyl-imidazol-2,1-diyl | (Q-3.61) |
| 4-trifluoromethyl-5-chloro-imidazol-2,1-diyl | (Q-3.62) |
| 4-trifluoromethyl-5-methyl-imidazol-2,1-diyl | (Q-3.63) |
| 4-trifluoromethyl-5-ethyl-imidazol-2,1-diyl | (Q-3.64) |
| 4-trifluoromethyl-5-fluoromethyl-imidazol-2,1-diyl | (Q-3.65) |
| 4-trifluoromethyl-5-difluoromethyl-imidazol-2,1-diyl | (Q-3.66) |
| 4-trifluoromethyl-5-trifluoromethyl-imidazol-2,1-diyl | (Q-3.67) |
| 4,5-dihydro-imidazol-2,1-diyl | (Q-3.68) |
| 5-chloro-4,5-dihydro-imidazol-2,1-diyl | (Q-3.69) |
| 5-methyl-4,5-dihydro-imidazol-2,1-diyl | (Q-3.70) |
| 5-ethyl-4,5-dihydro-imidazol-2,1-diyl | (Q-3.71) |
| 5-fluoromethyl-4,5-dihydro-imidazol-2,1-diyl | (Q-3.72) |
| 5-difluoromethyl-4,5-dihydro-imidazol-2,1-diyl | (Q-3.73) |
| 5-trifluoromethyl-4,5-dihydro-imidazol-2,1-diyl | (Q-3.74) |
| 4-chloro-4,5-dihydro-imidazol-2,1-diyl | (Q-3.75) |
| 4,5-dichloro-4,5-dihydro-imidazol-2,1-diyl | (Q-3.76) |
| 4-chloro-5-methyl-4,5-dihydro-imidazol-2,1-diyl | (Q-3.77) |
| 4-chloro-5-ethyl-4,5-dihydro-imidazol-2,1-diyl | (Q-3.78) |
| 4-chloro-5-fluoromethyl-4,5-dihydro-imidazol-2,1-diyl | (Q-3.79) |
| 4-chloro-5-difluoromethyl-4,5-dihydro-imidazol-2,1-diyl | (Q-3.80) |
| 4-chloro-5-trifluoromethyl-4,5-dihydro-imidazol-2,1-diyl | (Q-3.81) |
| 4-methyl-4,5-dihydro-imidazol-2,1-diyl | (Q-3.82) |
| 4-methyl-5-chloro-4,5-dihydro-imidazol-2,1-diyl | (Q-3.83) |
| 4-methyl-5-methyl-4,5-dihydro-imidazol-2,1-diyl | (Q-3.84) |
| 4-methyl-5-ethyl-4,5-dihydro-imidazol-2,1-diyl | (Q-3.85) |
| 4-methyl-5-fluoromethyl-4,5-dihydro-imidazol-2,1-diyl | (Q-3.86) |
| 4-methyl-5-difluoromethyl-4,5-dihydro-imidazol-2,1-diyl | (Q-3.87) |
| 4-methyl-5-trifluoromethyl-4,5-dihydro-imidazol-2,1-diyl | (Q-3.88) |
| 4-ethyl-4,5-dihydro-imidazol-2,1-diyl | (Q-3.89) |
| 4-ethyl-5-chloro-4,5-dihydro-imidazol-2,1-diyl | (Q-3.90) |
| 4-ethyl-5-methyl-4,5-dihydro-imidazol-2,1-diyl | (Q-3.91) |
| 4-ethyl-5-ethyl-4,5-dihydro-imidazol-2,1-diyl | (Q-3.92) |
| 4-ethyl-5-fluoromethyl-4,5-dihydro-imidazol-2,1-diyl | (Q-3.93) |
| 4-ethyl-5-difluoromethyl-4,5-dihydro-imidazol-2,1-diyl | (Q-3.94) |
| 4-ethyl-5-trifluoromethyl-4,5-dihydro-imidazol-2,1-diyl | (Q-3.95) |
| 4-fluoromethyl-4,5-dihydro-imidazol-2,1-diyl | (Q-3.96) |
| 4-fluoromethyl-5-chloro-4,5-dihydro-imidazol-2,1-diyl | (Q-3.97) |
| 4-fluoromethyl-5-methyl-4,5-dihydro-imidazol-2,1-diyl | (Q-3.98) |
| 4-fluoromethyl-5-ethyl-4,5-dihydro-imidazol-2,1-diyl | (Q-3.99) |
| 4-fluoromethyl-5-fluoromethyl-4,5-dihydro-imidazol-2,1-diyl | (Q-3.100) |
| 4-fluoromethyl-5-difluoromethyl-4,5-dihydro-imidazol-2,1-diyl | (Q-3.101) |
| 4-fluoromethyl-5-trifluoromethyl-4,5-dihydro-imidazol-2,1-diyl | (Q-3.102) |
| 4-difluoromethyl-4,5-dihydro-imidazol-2,1-diyl | (Q-3.103) |
| 4-difluoromethyl-5-chloro-4,5-dihydro-imidazol-2,1-diyl | (Q-3.104) |
| 4-difluoromethyl-5-methyl-4,5-dihydro-imidazol-2,1-diyl | (Q-3.105) |
| 4-difluoromethyl-5-ethyl-4,5-dihydro-imidazol-2,1-diyl | (Q-3.106) |
| 4-difluoromethyl-5-fluoromethyl-4,5-dihydro-imidazol-2,1-diyl | (Q-3.107) |
| 4-difluoromethyl-5-difluoromethyl-4,5-dihydro-imidazol-2,1-diyl | (Q-3.108) |
| 4-difluoromethyl-5-trifluoromethyl-4,5-dihydro-imidazol-2,1-diyl | (Q-3.109) |
| 4-trifluoromethyl-4,5-dihydro-imidazol-2,1-diyl | (Q-3.110) |
| 4-trifluoromethyl-5-chloro-4,5-dihydro-imidazol-2,1-diyl | (Q-3.111) |
| 4-trifluoromethyl-5-methyl-4,5-dihydro-imidazol-2,1-diyl | (Q-3.112) |
| 4-trifluoromethyl-5-ethyl-4,5-dihydro-imidazol-2,1-diyl | (Q-3.113) |
| 4-trifluoromethyl-5-fluoromethyl-4,5-dihydro-imidazol-2,1-diyl | (Q-3.114) |
| 4-trifluoromethyl-5-difluoromethyl-4,5-dihydro-imidazol-2,1-diyl | (Q-3.115) |
| 4-trifluoromethyl-5-trifluoromethyl-4,5-dihydro-imidazol-2,1-diyl | (Q-3.116) |
| 4,5-dihydro-[1,2,4]oxadiazol-3,4-diyl | (Q-3.117) |
| 5-chloro-4,5-dihydro-[1,2,4]oxadiazol-3,4-diyl | (Q-3.118) |
| 5-methyl-4,5-dihydro-[1,2,4]oxadiazol-3,4-diyl | (Q-3.119) |
| 5-ethyl-4,5-dihydro-[1,2,4]oxadiazol-3,4-diyl | (Q-3.120) |
| 5-fluoromethyl-4,5-dihydro-[1,2,4]oxadiazol-3,4-diyl | (Q-3.121) |
| 5-difluoromethyl-4,5-dihydro-[1,2,4]oxadiazol-3,4-diyl | (Q-3.122) |
| 5-trifluoromethyl-4,5-dihydro-[1,2,4]oxadiazol-3,4-diyl | (Q-3.123) |
| 4,5-dihydro-imidazol-4-on-2,1-diyl | (Q-3.124) |
| 5-chloro-4,5-dihydro-imidazol-4-on-2,1-diyl | (Q-3.125) |
| 5-methyl-4,5-dihydro-imidazol-4-on-2,1-diyl | (Q-3.126) |
| 5-ethyl-4,5-dihydro-imidazol-4-on-2,1-diyl | (Q-3.127) |
| 5-fluoromethyl-4,5-dihydro-imidazol-4-on-2,1-diyl | (Q-3.128) |
| 5-difluoromethyl-4,5-dihydro-imidazol-4-on-2,1-diyl | (Q-3.129) |
| 5-trifluoromethyl-4,5-dihydro-imidazol-4-on-2,1-diyl | (Q-3.130) |
| 4,5-dihydro-imidazol-5-on-2,1-diyl | (Q-3.131) |
| 4-chloro-4,5-dihydro-imidazol-5-on-2,1-diyl | (Q-3.132) |
| 4-methyl-4,5-dihydro-imidazol-5-on-2,1-diyl | (Q-3.133) |
| 4-ethyl-4,5-dihydro-imidazol-5-on-2,1-diyl | (Q-3.134) |
| 4-fluoromethyl-4,5-dihydro-imidazol-5-on-2,1-diyl | (Q-3.135) |
| 4-difluoromethyl-4,5-dihydro-imidazol-5-on-2,1-diyl | (Q-3.136) |
| 4-trifluoromethyl-4,5-dihydro-imidazol-5-on-2,1-diyl | (Q-3.137) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-4, as defined herein. According to a particular preferred aspect of this embodiment Q-4 is selected from the radicals of the following formulae:

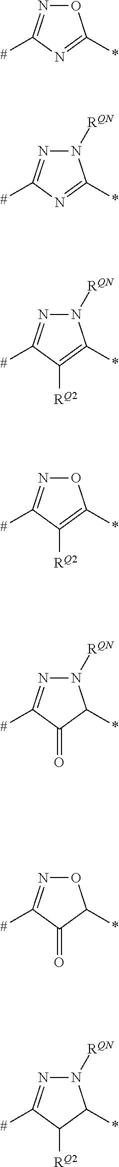

wherein #, *, R^{Q2} and R^{QN} are as defined herein.

Among the compounds of formula I wherein Q is Q-4, preference is given to those compounds, wherein R^{QN} is selected from the group consisting of hydrogen, C₁-C₃-alkyl and C₁-C₃-haloalkyl, more preferably from the group consisting of hydrogen, C₁-C₃-alkyl and C₁-C₂-fluoroalkyl.

In particular, R^{QN} is selected from hydrogen, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl and 2,2,2-trifluoroeth-1-yl.

Among the compounds of formula I wherein Q is Q-4, preference is given to those compounds, wherein R^{Q2} is selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q2} is selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl.

Examples of suitable radicals Q-1 are the radicals of formulae Q-4.1 to Q-4.127, as defined in Table Q4. Of the two attachment points identified in the names of radicals Q-4 given in Table Q4 the first number represents the position to which the pyrazole radical is linked and the second number represents the position to which the 6-membered heteroaromatic radical is linked. By way of example, [1,2,4]oxadiazol-3,5-diyl is bound to the pyrazole radical and the 6-membered heteroaromatic radical via its positions 3 and 5, respectively.

TABLE Q4

| | |
|---|---|
| [1,2,4]-oxadiazol-3,5-diyl | (Q-4.1) |
| 1H-[1,2,4]-triazol-3,5-diyl | (Q-4.2) |
| 1-methyl-[1,2,4]-triazol-3,5-diyl | (Q-4.3) |
| 1-ethyl-[1,2,4]-triazo I-3,5-diyl | (Q-4.4) |
| 1-fluoromethyl-[1,2,4]-triazol-3,5-diyl | (Q-4.5) |
| 1-difluoromethyl-[1 ,2,4]-triazol-3,5-diyl | (Q-4.6) |
| 1-trifluoromethyl-[1,2,4]-triazo I-3,5-diyl | (Q-4.7) |
| 1-(2-fluoroeth-1 -yl)-[1,2,4]-triazol-3,5-diyl | (Q-4.8) |
| 1-(2,2-difluoroeth-1-yl)-[1,2,4]-triazol-3,5-diyl | (Q-4.9) |
| 1-(2,2,2-trifluoroeth-1-yl)-[1,2,4]-triazol-3,5-diyl | (Q-4.10) |
| 1H-pyrazol-3,5-diyl | (Q-4.11) |
| 4-chloro-1H-pyrazol-3,5-diyl | (Q-4.12) |
| 4-methyl-1H-pyrazol-3,5-diyl | (Q-4.13) |
| 4-ethyl-1H-pyrazol-3,5-diyl | (Q-4.14) |
| 4-fluoromethyl-1H-pyrazol-3,5-diyl | (Q-4.15) |
| 4-difluoromethyl-1H-pyrazol-3,5-diyl | (Q-4.16) |
| 4-trifluoromethyl-1H-pyrazol-3,5-diyl | (Q-4.17) |
| 1-methyl-pyrazol-3,5-diyl | (Q-4.18) |
| 1-methyl-4-chloro-pyrazol-3,5-diyl | (Q-4.19) |
| 1-methyl-4-methyl-pyrazol-3,5-diyl | (Q-4.20) |
| 1-methyl-4-ethyl-pyrazol-3,5-diyl | (Q-4.21) |
| 1-methyl-4-fluoromethyl-pyrazol-3,5-diyl | (Q-4.22) |
| 1-methyl-4-difluoromethyl-pyrazol-3,5-diyl | (Q-4.23) |
| 1-methyl-4-trifluoromethyl-pyrazol-3,5-diyl | (Q-4.24) |
| 1-ethyl-pyrazol-3,5-diyl | (Q-4.25) |
| 1-ethyl-4-chloro-pyrazol-3,5-diyl | (Q-4.26) |
| 1-ethyl-4-methyl-pyrazol-3,5-diyl | (Q-4.27) |
| 1-ethyl-4-ethyl-pyrazol-3,5-diyl | (Q-4.28) |
| 1-ethyl-4-fluoromethyl-pyrazol-3,5-diyl | (Q-4.29) |
| 1-ethyl-4-difluoromethyl-pyrazol-3,5-diyl | (Q-4.30) |
| 1-ethyl-4-trifluoromethyl-pyrazol-3,5-diyl | (Q-4.31) |
| 1-trifluoromethyl-pyrazol-3,5-diyl | (Q-4.32) |
| 1-trifluoromethyl-4-chloro-pyrazol-3,5-diyl | (Q-4.33) |
| 1-trifluoromethyl-4-methyl-pyrazol-3,5-diyl | (Q-4.34) |
| 1-trifluoromethyl-4-ethyl-pyrazol-3,5-diyl | (Q-4.35) |
| 1-trifluoromethyl-4-fluoromethyl-pyrazol-3,5-diyl | (Q-4.36) |
| 1-trifluoromethyl-4-difluoromethyl-pyrazol-3,5-diyl | (Q-4.37) |
| 1-trifluoromethyl-4-trifluoromethyl-pyrazol-3,5-diyl | (Q-4.38) |
| 1-(2-fluoroeth-1-yl)-pyrazol-3,5-diyl | (Q-4.39) |
| 1-(2-fluoroeth-1-yl)-4-chloro-pyrazol-3,5-diyl | (Q-4.40) |
| 1-(2-fluoroeth-1-yl)-4-methyl-pyrazol-3,5-diyl | (Q-4.41) |
| 1-(2-fluoroeth-1-yl)-4-ethyl-pyrazol-3,5-diyl | (Q-4.42) |
| 1-(2-fluoroeth-1-yl)-4-fluoromethyl-pyrazol-3,5-diyl | (Q-4.43) |
| 1-(2-fluoroeth-1-yl)-4-difluoromethyl-pyrazol-3,5-diyl | (Q-4.44) |
| 1-(2-fluoroeth-1-yl)-4-trifluoromethyl-pyrazol-3,5-diyl | (Q-4.45) |
| 1-(2,2-difluoroeth-1-yl)-pyrazol-3,5-diyl | (Q-4.46) |
| 1-(2,2-difluoroeth-1-yl)-4-chloro-pyrazol-3,5-diyl | (Q-4.47) |
| 1-(2,2-difluoroeth-1-yl)-4-methyl-pyrazol-3,5-diyl | (Q-4.48) |
| 1-(2,2-difluoroeth-1-yl)-4-ethyl-pyrazol-3,5-diyl | (Q-4.49) |
| 1-(2,2-difluoroeth-1-yl)-4-fluoromethyl-pyrazol-3,5-diyl | (Q-4.50) |
| 1-(2,2-difluoroeth-1-yl)-4-difluoromethyl-pyrazol-3,5-diyl | (Q-4.51) |
| 1-(2,2-difluoroeth-1-yl)-4-trifluoromethyl-pyrazol-3,5-diyl | (Q-4.52) |
| 1-(2,2,2-trifluoroeth-1-yl)-pyrazol-3,5-diyl | (Q-4.53) |
| 1-(2,2,2-trifluoroeth-1-yl)-4-chloro-pyrazol-3,5-diyl | (Q-4.54) |
| 1-(2,2,2-trifluoroeth-1-yl)-4-methyl-pyrazol-3,5-diyl | (Q-4.55) |
| 1-(2,2,2-trifluoroeth-1-yl)-4-ethyl-pyrazol-3,5-diyl | (Q-4.56) |
| 1-(2,2,2-trifluoroeth-1-yl)-4-fluoromethyl-pyrazol-3,5-diyl | (Q-4.57) |
| 1-(2,2,2-trifluoroeth-1-yl)-4-difluoromethyl-pyrazol-3,5-diyl | (Q-4.58) |
| 1-(2,2,2-trifluoroeth-1-yl)-4-trifluoromethyl-pyrazol-3,5-diyl | (Q-4.59) |
| isoxazol-3,5-diyl | (Q-4.60) |
| 4-chloro-isoxazol-3,5-diyl | (Q-4.61) |
| 4-cyano-isoxazol-3,5-diyl | (Q-4.62) |
| 4-methyl-isoxazol-3,5-diyl | (Q-4.63) |
| 4-ethyl-isoxazol-3,5-diyl | (Q-4.64) |
| 4-fluoromethyl-isoxazol-3,5-diyl | (Q-4.65) |
| 4-difluoromethyl-isoxazol-3,5-diyl | (Q-4.66) |
| 4-trifluoromethyl-isoxazol-3,5-diyl | (Q-4.67) |
| 4-(2,2,2-trifluoroeth-1-yl)-isoxazol-3,5-diyl | (Q-4.68) |
| 4,5-dihydro-1H-pyrazol-4-on-3,5-diyl | (Q-4.69) |
| 1-methyl-4,5-dihydro-pyrazol-4-on-3,5-diyl | (Q-4.70) |
| 1-ethyl-4,5-dihydro-pyrazol-4-on-3,5-diyl | (Q-4.71) |
| 1-fluoromethyl-4,5-dihydro-pyrazol-4-on-3,5-diyl | (Q-4.72) |
| 1-difluoromethyl-4,5-dihydro-pyrazol-4-on-3,5-diyl | (Q-4.73) |
| 1-trifluoromethyl-4,5-dihydro-pyrazol-4-on-3,5-diyl | (Q-4.74) |
| 1-(2-fluoroeth-1-yl)-4,5-d ihydro-pyrazol-4-on-3,5-diyl | (Q-4.75) |
| 1-(2,2-difluoroeth-1-yl)-4,5-dihydro-pyrazol-4-on-3,5-diyl | (Q-4.76) |
| 1-(2,2,2-trifluoroeth-1-yl)-4,5-dihydro-pyrazol-4-on-3,5-diyl | (Q-4.77) |
| 4,5-dihydro-isoxazol-4-on-3,5-diyl | (Q-4.78) |
| 4,5-dihydro-1H-pyrazol-3,5-diyl | (Q-4.79) |
| 4-chloro-4,5-dihydro-1H-pyrazol-3,5-diyl | (Q-4.80) |
| 4-methyl-4,5-dihydro-1H-pyrazol-3,5-diyl | (Q-4.81) |
| 4-ethyl-4,5-dihydro-1H-pyrazol-3,5-diyl | (Q-4.82) |
| 4-fluoromethyl-4,5-dihydro-1H-pyrazol-3,5-diyl | (Q-4.83) |
| 4-difluoromethyl-4,5-dihydro-1H-pyrazol-3,5-diyl | (Q-4.84) |
| 4-trifluoromethyl-4,5-dihydro-1H-pyrazol-3,5-diyl | (Q-4.85) |
| 1-methyl-4,5-dihydro-pyrazol-3,5-diyl | (Q-4.86) |
| 1-methyl-4-chloro-4,5-dihydro-pyrazol-3,5-diyl | (Q-4.87) |
| 1-methyl-4-methyl-4,5-dihydro-pyrazol-3,5-diyl | (Q-4.88) |
| 1-methyl-4-ethyl-4,5-dihydro-pyrazol-3,5-diyl | (Q-4.89) |
| 1-methyl-4-fluoromethyl-4,5-dihydro-pyrazol-3,5-diyl | (Q-4.90) |
| 1-methyl-4-difluoromethyl-4,5-dihydro-pyrazol-3,5-diyl | (Q-4.91) |
| 1-methyl-4-trifluoromethyl-4,5-d ihydro-pyrazol-3,5-diyl | (Q-4.92) |
| 1-ethyl-4,5-dihydro-pyrazol-3,5-diyl | (Q-4.93) |
| 1-ethyl-4-chloro-4,5-dihydro-pyrazol-3,5-diyl | (Q-4.94) |
| 1-ethyl-4-methyl-4,5-dihydro-pyrazol-3,5-diyl | (Q-4.95) |
| 1-ethyl-4-ethyl-4,5-dihydro-pyrazol-3,5-diyl | (Q-4.96) |
| 1-ethyl-4-fluoromethyl-4,5-dihydro-pyrazol-3,5-diyl | (Q-4.97) |
| 1-ethyl-4-difluoromethyl-4,5-dihydro-pyrazol-3,5-diyl | (Q-4.98) |
| 1-ethyl-4-trifluoromethyl-4,5-dihydro-pyrazol-3,5-diyl | (Q-4.99) |
| 1-trifluoromethyl-4,5-dihydro-pyrazol-3,5-diyl | (Q-4.100) |
| 1-trifluoromethyl-4-chloro-4,5-dihydro-pyrazol-3,5-diyl | (Q-4.101) |
| 1-trifluoromethyl-4-methyl-4,5-dihydro-pyrazol-3,5-diyl | (Q-4.102) |
| 1-trifluoromethyl-4-ethyl-4,5-dihydro-pyrazol-3,5-diyl | (Q-4.103) |
| 1-trifluoromethyl-4-fluoromethyl-4,5-dihydro-pyrazol-3,5-diyl | (Q-4.104) |
| 1-trifluoromethyl-4-difluoromethyl-4,5-dihydro-pyrazol-3,5-diyl | (Q-4.105) |
| 1-trifluoromethyl-4-trifluoromethyl-4,5-dihydro-pyrazol-3,5-diyl | (Q-4.106) |
| 1-(2-fluoroeth-1-yl)-4,5-dihydro-pyrazol-3,5-diyl | (Q-4.107) |
| 1-(2-fluoroeth-1-yl)-4-chloro-4,5-dihydro-pyrazol-3,5-diyl | (Q-4.108) |
| 1-(2-fluoroeth-1-yl)-4-methyl-4,5-dihydro-pyrazol-3,5-diyl | (Q-4.109) |
| 1-(2-fluoroeth-1-yl)-4-ethyl-4,5-dihydro-pyrazol-3,5-diyl | (Q-4.110) |
| 1-(2-fluoroeth-1-yl)-4-fluoromethyl-4,5-dihydro-pyrazol-3,5-diyl | (Q-4.111) |
| 1-(2-fluoroeth-1-yl)-4-difluoromethyl-4,5-dihydro-pyrazol-3,5-diyl | (Q-4.112) |
| 1-(2-fluoroeth-1-yl)-4-trifluoromethyl-4,5-dihydro-pyrazol-3,5-diyl | (Q-4.113) |
| 1-(2,2-difluoroeth-1-yl)-4,5-dihydro-pyrazol-3,5-diyl | (Q-4.114) |
| 1-(2,2-difluoroeth-1-yl)-4-chloro-4,5-dihydro-pyrazol-3,5-diyl | (Q-4.115) |
| 1-(2,2-difluoroeth-1-yl)-4-methyl-4,5-dihydro-pyrazol-3,5-diyl | (Q-4.116) |
| 1-(2,2-difluoroeth-1-yl)-4-ethyl-4,5-dihydro-pyrazol-3,5-diyl | (Q-4.117) |
| 1-(2,2-difluoroeth-1-yl)-4-fluoromethyl-4,5- | (Q-4.118) |
| dihydro-pyrazol-3,5-diyl | |
| 1-(2,2-difluoroeth-1-yl)-4-difluoromethyl-4,5- | (Q-4.119) |
| dihydro-pyrazol-3,5-diyl | |
| 1-(2,2-difluoroeth-1-yl)-4-trifluoromethyl-4,5- | (Q-4.120) |
| dihydro-pyrazol-3,5-diyl | |
| 1-(2,2,2-trifluoroeth-1-yl)-4,5-dihydro-pyrazol-3,5-diyl | (Q-4.121) |
| 1-(2,2,2-trifluoroeth-1-yl)-4-chloro-4,5-dihydro-pyrazol-3,5-diyl | (Q-4.122) |
| 1-(2,2,2-trifluoroeth-1-yl)-4-methyl-4,5-dihydro-pyrazol-3,5-diyl | (Q-4.123) |
| 1-(2,2,2-trifluoroeth-1-yl)-4-ethyl-4,5-dihydro-pyrazol-3,5-diyl | (Q-4.124) |
| 1-(2,2,2-trifluoroeth-1-yl)-4-fluoromethyl-4,5- | (Q-4.125) |
| dihydro-pyrazol-3,5-diyl | |
| 1-(2,2,2-trifluoroeth-1-yl)-4-difluoromethyl-4,5- | (Q-4.126) |
| dihydro-pyrazol-3,5-diyl | |
| 1-(2,2,2-trifluoroeth-1-yl)-4-trifluoromethyl-4,5- | (Q-4.127) |
| dihydro-pyrazol-3,5-diyl | |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-5, as defined herein. According to a particular preferred aspect of this embodiment Q-5 is selected from the radicals of the following formulae:

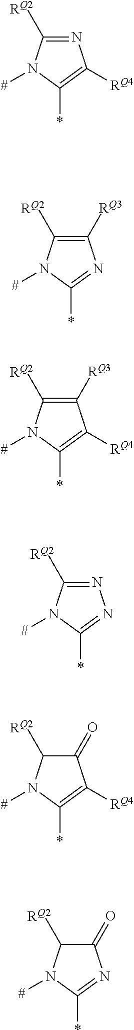

wherein #, *, R^{Q2} and R^{Q3} are as defined herein.

Among the compounds of formula I wherein Q is Q-5, preference is given to those compounds, wherein R^{Q2}, R^{Q3} and R^{Q4} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q2}, R^{Q3} and R^{Q4} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl.

Examples of suitable radicals Q-5 are the radicals of formulae Q-5.1 to Q-5.227, as defined in Table Q5. Of the two attachment points identified in the names of radicals Q-5 given in Table Q5 the first number represents the position to which the pyrazole radical is linked and the second number represents the position to which the 6-membered heteroaromatic radical is linked. By way of example, imidazol-1,5-diylis bound to the pyrazole radical and the 6-membered heteroaromatic radical via its positions 1 and 5, respectively.

TABLE Q5

| | |
|---|---|
| imidazol-1,5-diyl | (Q-5.1) |
| 2-chloro-imidazol-1,5-diyl | (Q-5.2) |
| 2-methyl-imidazol-1,5-diyl | (Q-5.3) |
| 2-ethyl-imidazol-1,5-diyl | (Q-5.4) |
| 2-fluoromethyl-imidazol-1,5-diyl | (Q-5.5) |
| 2-difluoromethyl-imidazol-1,5-diyl | (Q-5.6) |
| 2-trifluoromethyl-imidazol-1,5-diyl | (Q-5.7) |
| 4-chloro-imidazol-1,5-diyl | (Q-5.8) |
| 2,4-dichloro-imidazol-1,5-diyl | (Q-5.9) |
| 4-chloro-2-methyl-imidazol-1,5-diyl | (Q-5.10) |
| 4-chloro-2-ethyl-imidazol-1,5-diyl | (Q-5.11) |
| 4-chloro-2-fluoromethyl-imidazol-1,5-diyl | (Q-5.12) |
| 4-chloro-2-difluoromethyl-imidazol-1,5-diyl | (Q-5.13) |
| 4-chloro-2-trifluoromethyl-imidazol-1,5-diyl | (Q-5.14) |
| 4-methyl-imidazol-1,5-diyl | (Q-5.15) |
| 4-methyl-2-chloro-imidazol-1,5-diyl | (Q-5.16) |
| 2,4-dimethyl-imidazol-1,5-diyl | (Q-5.17) |
| 4-methyl-2-ethyl-imidazol-1,5-diyl | (Q-5.18) |
| 4-methyl-2-fluoromethyl-imidazol-1,5-diyl | (Q-5.19) |
| 4-methyl-2-difluoromethyl-imidazol-1,5-diyl | (Q-5.20) |
| 4-methyl-2-trifluoromethyl-imidazol-1,5-diyl | (Q-5.21) |
| 4-ethyl-imidazol-1,5-diyl | (Q-5.22) |
| 4-ethyl-2-chloro-imidazol-1,5-diyl | (Q-5.23) |
| 4-ethyl-2-methyl-imidazol-1,5-diyl | (Q-5.24) |
| 2,4-diethyl-imidazol-1,5-diyl | (Q-5.25) |
| 4-ethyl-2-fluoromethyl-imidazol-1,5-diyl | (Q-5.26) |
| 4-ethyl-2-difluoromethyl-imidazol-1,5-diyl | (Q-5.27) |
| 4-ethyl-2-trifluoromethyl-imidazol-1,5-diyl | (Q-5.28) |
| 4-fluoromethyl-imidazol-1,5-diyl | (Q-5.29) |
| 4-fluoromethyl-2-chloro-imidazol-1,5-diyl | (Q-5.30) |
| 4-fluoromethyl-2-methyl-imidazol-1,5-diyl | (Q-5.31) |
| 4-fluoromethyl-2-ethyl-imidazol-1,5-diyl | (Q-5.32) |
| 2,4-di-(fluoromethyl)-imidazol-1,5-diyl | (Q-5.33) |
| 4-fluoromethyl-2-difluoromethyl-imidazol-1,5-diyl | (Q-5.34) |
| 4-fluoromethyl-2-trifluoromethyl-imidazol-1,5-diyl | (Q-5.35) |
| 4-difluoromethyl-imidazol-1,5-diyl | (Q-5.36) |
| 4-difluoromethyl-2-chloro-imidazol-1,5-diyl | (Q-5.37) |
| 4-difluoromethyl-2-methyl-imidazol-1,5-diyl | (Q-5.38) |
| 4-difluoromethyl-2-ethyl-imidazol-1,5-diyl | (Q-5.39) |
| 4-difluoromethyl-2-fluoromethyl-imidazol-1,5-diyl | (Q-5.40) |
| 2,4-di-(difluoromethyl)-imidazol-1,5-diyl | (Q-5.41) |
| 4-difluoromethyl-2-trifluoromethyl-imidazol-1,5-diyl | (Q-5.42) |
| 4-trifluoromethyl-imidazol-1,5-diyl | (Q-5.43) |
| 4-trifluoromethyl-2-chloro-imidazol-1,5-diyl | (Q-5.44) |
| 4-trifluoromethyl-2-methyl-imidazol-1,5-diyl | (Q-5.45) |
| 4-trifluoromethyl-2-ethyl-imidazol-1,5-diyl | (Q-5.46) |
| 4-trifluoromethyl-2-fluoromethyl-imidazol-1,5-diyl | (Q-5.47) |
| 4-trifluoromethyl-2-difluoromethyl-imidazol-1,5-diyl | (Q-5.48) |
| 2,4-di-(trifluoromethyl)-imidazol-1,5-diyl | (Q-5.49) |
| imidazol-1,2-diyl | (Q-5.50) |
| 5-chloro-imidazol-1,2-diyl | (Q-5.51) |
| 5-methyl-imidazol-1,2-diyl | (Q-5.52) |
| 5-ethyl-imidazol-1,2-diyl | (Q-5.53) |
| 5-fluoromethyl-imidazol-1,2-diyl | (Q-5.54) |
| 5-difluoromethyl-imidazol-1,2-diyl | (Q-5.55) |
| 5-trifluoromethyl-imidazol-1,2-diyl | (Q-5.56) |
| 4-chloro-imidazol-1,2-diyl | (Q-5.57) |
| 4,5-dichloro-imidazol-1,2-diyl | (Q-5.58) |
| 4-chloro-5-methyl-imidazol-1,2-diyl | (Q-5.59) |
| 4-chloro-5-ethyl-imidazol-1,2-diyl | (Q-5.60) |
| 4-chloro-5-fluoromethyl-imidazol-1,2-diyl | (Q-5.61) |
| 4-chloro-5-difluoromethyl-imidazol-1,2-diyl | (Q-5.62) |
| 4-chloro-5-trifluoromethyl-imidazol-1,2-diyl | (Q-5.63) |
| 4-methyl-imidazol-1,2-diyl | (Q-5.64) |
| 4-methyl-5-chloro-imidazol-1,2-diyl | (Q-5.65) |
| 4,5-dimethyl-imidazol-1,2-diyl | (Q-5.66) |
| 4-methyl-5-ethyl-imidazol-1,2-diyl | (Q-5.67) |
| 4-methyl-5-fluoromethyl-imidazol-1,2-diyl | (Q-5.68) |
| 4-methyl-5-difluoromethyl-imidazol-1,2-diyl | (Q-5.69) |
| 4-methyl-5-trifluoromethyl-imidazol-1,2-diyl | (Q-5.70) |
| 4-ethyl-imidazol-1,2-diyl | (Q-5.71) |
| 4-ethyl-5-chloro-imidazol-1,2-diyl | (Q-5.72) |
| 4-ethyl-5-methyl-imidazol-1,2-diyl | (Q-5.73) |
| 4,5-diethyl-imidazol-1,2-diyl | (Q-5.74) |
| 4-ethyl-5-fluoromethyl-imidazol-1,2-diyl | (Q-5.75) |
| 4-ethyl-5-difluoromethyl-imidazol-1,2-diyl | (Q-5.76) |
| 4-ethyl-5-trifluoromethyl-imidazol-1,2-diyl | (Q-5.77) |
| 4-fluoromethyl-imidazol-1,2-diyl | (Q-5.78) |
| 4-fluoromethyl-5-chloro-imidazol-1,2-diyl | (Q-5.79) |
| 4-fluoromethyl-5-methyl-imidazol-1,2-diyl | (Q-5.80) |
| 4-fluoromethyl-5-ethyl-imidazol-1,2-diyl | (Q-5.81) |
| 4,5-di-(fluoromethyl)-imidazol-1,2-diyl | (Q-5.82) |
| 4-fluoromethyl-5-difluoromethyl-imidazol-1,2-diyl | (Q-5.83) |
| 4-fluoromethyl-5-trifluoromethyl-imidazol-1,2-diyl | (Q-5.84) |
| 4-difluoromethyl-imidazol-1,2-diyl | (Q-5.85) |
| 4-difluoromethyl-5-chloro-imidazol-1,2-diyl | (Q-5.86) |
| 4-difluoromethyl-5-methyl-imidazol-1,2-diyl | (Q-5.87) |
| 4-difluoromethyl-5-ethyl-imidazol-1,2-diyl | (Q-5.88) |
| 4-difluoromethyl-5-fluoromethyl-imidazol-1,2-diyl | (Q-5.89) |
| 4,5-di-(difluoromethyl)-imidazol-1,2-diyl | (Q-5.90) |
| 4-difluoromethyl-5-trifluoromethyl-imidazol-1,2-diyl | (Q-5.91) |
| 4-trifluoromethyl-imidazol-1,2-diyl | (Q-5.92) |
| 4-trifluoromethyl-5-chloro-imidazol-1,2-diyl | (Q-5.93) |
| 4-trifluoromethyl-5-methyl-imidazol-1,2-diyl | (Q-5.94) |
| 4-trifluoromethyl-5-ethyl-imidazol-1,2-diyl | (Q-5.95) |
| 4-trifluoromethyl-5-fluoromethyl-imidazol-1,2-diyl | (Q-5.96) |
| 4-trifluoromethyl-5-difluoromethyl-imidazol-1,2-diyl | (Q-5.97) |
| 4,5-di-(trifluoromethyl)-imidazol-1,2-diyl | (Q-5.98) |
| pyrrol-1,2-diyl | (Q-5.99) |
| 3-methyl-pyrrol-1,2-diyl | (Q-5.100) |
| 3-difluoromethyl-pyrrol-1,2-diyl | (Q-5.101) |
| 3-trifluoromethyl-pyrrol-1,2-diyl | (Q-5.102) |
| 4-methyl-pyrrol-1,2-diyl | (Q-5.103) |
| 3,4-dimethyl-pyrrol-1,2-diyl | (Q-5.104) |
| 4-methyl-3-difluoromethyl-pyrrol-1,2-diyl | (Q-5.105) |
| 4-methyl-3-trifluoromethyl-pyrrol-1,2-diyl | (Q-5.106) |
| 4-difluoromethyl-pyrrol-1,2-diyl | (Q-5.107) |
| 4-difluoromethyl-3-methyl-pyrrol-1,2-diyl | (Q-5.108) |
| 3,4-di-(difluoromethyl)-pyrrol-1,2-diyl | (Q-5.109) |
| 4-difluoromethyl-3-trifluoromethyl-pyrrol-1,2-diyl | (Q-5.110) |
| 4-trifluoromethyl-pyrrol-1,2-diyl | (Q-5.111) |
| 4-trifluoromethyl-3-methyl-pyrrol-1,2-diyl | (Q-5.112) |
| 4-trifluoromethyl-3-difluoromethyl-pyrrol-1,2-diyl | (Q-5.113) |
| 3,4-di-(trifluoromethyl)-pyrrol-1,2-diyl | (Q-5.114) |
| 5-methyl-pyrrol-1,2-diyl | (Q-5.115) |
| 5-methyl-3-methyl-pyrrol-1,2-diyl | (Q-5.116) |
| 5-methyl-3-difluoromethyl-pyrrol-1,2-diyl | (Q-5.117) |
| 5-methyl-3-trifluoromethyl-pyrrol-1,2-diyl | (Q-5.118) |
| 4,5-dimethyl-pyrrol-1,2-diyl | (Q-5.119) |
| 3,4,5-trimethyl-pyrrol-1,2-diyl | (Q-5.120) |
| 4,5-dimethyl-3-difluoromethyl-pyrrol-1,2-diyl | (Q-5.121) |
| 4,5-dimethyl-3-trifluoromethyl-pyrrol-1,2-diyl | (Q-5.122) |
| 5-methyl-4-difluoromethyl-pyrrol-1,2-diyl | (Q-5.123) |
| 5-methyl-4-difluoromethyl-3-methyl-pyrrol-1,2-diyl | (Q-5.124) |
| 5-methyl-4-difluoromethyl-3-difluoromethyl-pyrrol-1,2-diyl | (Q-5.125) |
| 5-methyl-4-difluoromethyl-3-trifluoromethyl-pyrrol-1,2-diyl | (Q-5.126) |
| 5-methyl-4-trifluoromethyl-pyrrol-1,2-diyl | (Q-5.127) |
| 5-methyl-4-trifluoromethyl-3-methyl-pyrrol-1,2-diyl | (Q-5.128) |
| 5-methyl-4-trifluoromethyl-3-difluoromethyl-pyrrol-1,2-diyl | (Q-5.129) |
| 5-methyl-4-trifluoromethyl-3-trifluoromethyl-pyrrol-1,2-diyl | (Q-5.130) |
| 5-difluoromethyl-pyrrol-1,2-diyl | (Q-5.131) |
| 5-difluoromethyl-3-methyl-pyrrol-1,2-diyl | (Q-5.132) |
| 5-difluoromethyl-3-difluoromethyl-pyrrol-1,2-diyl | (Q-5.133) |
| 5-difluoromethyl-3-trifluoromethyl-pyrrol-1,2-diyl | (Q-5.134) |
| 5-difluoromethyl-4-methyl-pyrrol-1,2-diyl | (Q-5.135) |
| 5-difluoromethyl-4-methyl-3-methyl-pyrrol-1,2-diyl | (Q-5.136) |
| 5-difluoromethyl-4-methyl-3-difluoromethyl-pyrrol-1,2-diyl | (Q-5.137) |
| 5-difluoromethyl-4-methyl-3-trifluoromethyl-pyrrol-1,2-diyl | (Q-5.138) |
| 4,5-di-(difluoromethyl)-pyrrol-1,2-diyl | (Q-5.139) |
| 4,5-di-(difluoromethyl)-3-methyl-pyrrol-1,2-diyl | (Q-5.140) |
| 3,4,5-tri-(difluoromethyl)-pyrrol-1,2-diyl | (Q-5.141) |
| 4,5-di-(difluoromethyl)-3-trifluoromethyl-pyrrol-1,2-diyl | (Q-5.142) |
| 5-difluoromethyl-4-trifluoromethyl-pyrrol-1,2-diyl | (Q-5.143) |
| 5-difluoromethyl-4-trifluoromethyl-3-methyl-pyrrol-1,2-diyl | (Q-5.144) |
| 5-difluoromethyl-4-trifluoromethyl-3- | (Q-5.145) |
| difluoromethyl-pyrrol-1,2-diyl | |
| 5-difluoromethyl-4-trifluoromethyl-3- | (Q-5.146) |
| trifluoromethyl-pyrrol-1,2-diyl | |
| 5-trifluoromethyl-pyrrol-1,2-diyl | (Q-5.147) |
| 5-trifluoromethyl-3-methyl-pyrrol-1,2-diyl | (Q-5.148) |
| 5-trifluoromethyl-3-difluoromethyl-pyrrol-1,2-diyl | (Q-5.149) |
| 5-trifluoromethyl-3-trifluoromethyl-pyrrol-1,2-diyl | (Q-5.150) |
| 5-trifluoromethyl-4-methyl-pyrrol-1,2-diyl | (Q-5.151) |
| 5-trifluoromethyl-4-methyl-3-methyl-pyrrol-1,2-diyl | (Q-5.152) |
| 5-trifluoromethyl-4-methyl-3-difluoromethyl-pyrrol-1,2-diyl | (Q-5.153) |
| 5-trifluoromethyl-4-methyl-3-trifluoromethyl-pyrrol-1,2-diyl | (Q-5.154) |
| 5-trifluoromethyl-4-difluoromethyl-pyrrol-1,2-diyl | (Q-5.155) |
| 5-trifluoromethyl-4-difluoromethyl-3-methyl-pyrrol-1,2-diyl | (Q-5.156) |
| 5-trifluoromethyl-4-difluoromethyl-3- | (Q-5.157) |
| difluoromethyl-pyrrol-1,2-diyl | |
| 5-trifluoromethyl-4-difluoromethyl-3- | (Q-5.158) |
| trifluoromethyl-pyrrol-1,2-diyl | |
| 4,5-di-(trifluoromethyl)-pyrrol-1,2-diyl | (Q-5.159) |
| 4,5-di-(trifluoromethyl)-3-methyl-pyrrol-1,2-diyl | (Q-5.160) |
| 4,5-di-(trifluoromethyl)-3-difluoromethyl-pyrrol-1,2-diyl | (Q-5.161) |
| 3,4,5-tri-(trifluoromethyl)-pyrrol-1,2-diyl | (Q-5.162) |
| [1,2,4]-triazol-4,3-diyl | (Q-5.163) |
| 5-chloro-[1,2,4]-triazol-4,3-diyl | (Q-5.164) |
| 5-cyano-[1,2,4]-triazol-4, 3-diyl | (Q-5.165) |
| 5-methyl-[1,2,4]-triazol-4,3-diyl | (Q-5.166) |
| 5-ethyl-[1,2,4]-triazol-4,3-diyl | (Q-5.167) |
| 5-fluoromethyl-[1,2,4]-triazol-4,3-diyl | (Q-5.168) |
| 5-difluoromethyl-[1,2,4]-triazol-4,3-diyl | (Q-5.169) |
| 5-trifluoromethyl-[1,2,4]-triazol-4,3-diyl | (Q-5.170) |
| 5-(2,2,2-trifluoroeth-1-yl)-[1,2,4]-triazol-4,3-diyl | (Q-5.171) |
| 2,3-dihydro-pyrrol-3-on-1,5-diyl | (Q-5.172) |
| 4-chloro-2,3-dihydro-pyrrol-3-on-1,5-diyl | (Q-5.173) |
| 4-methyl-2,3-dihydro-pyrrol-3-on-1,5-diyl | (Q-5.174) |
| 4-ethyl-2,3-dihydro-pyrrol-3-on-1,5-diyl | (Q-5.175) |
| 4-fluoromethyl-2,3-dihydro-pyrrol-3-on-1,5-diyl | (Q-5.176) |
| 4-difluoromethyl-2,3-dihydro-pyrrol-3-on-1,5-diyl | (Q-5.177) |
| 4-trifluoromethyl-2,3-dihydro-pyrrol-3-on-1,5-diyl | (Q-5.178) |
| 2-chloro-2,3-dihydro-pyrrol-3-on-1,5-diyl | (Q-5.179) |
| 2,4-dichloro-2,3-dihydro-pyrrol-3-on-1,5-diyl | (Q-5.180) |
| 2-chloro-4-methyl-2,3-dihydro-pyrrol-3-on-1,5-diyl | (Q-5.181) |
| 2-chloro-4-ethyl-2,3-dihydro-pyrrol-3-on-1,5-diyl | (Q-5.182) |
| 2-chloro-4-fluoromethyl-2,3-dihydro-pyrrol-3-on-1,5-diyl | (Q-5.183) |
| 2-chloro-4-difluoromethyl-2,3-dihydro-pyrrol-3-on-1,5-diyl | (Q-5.184) |
| 2-chloro-4-trifluoromethyl-2,3-dihydro-pyrrol-3-on-1,5-diyl | (Q-5.185) |
| 2-methyl-2,3-dihydro-pyrrol-3-on-1,5-diyl | (Q-5.186) |
| 2-methyl-4-chloro-2,3-dihydro-pyrrol-3-on-1,5-diyl | (Q-5.187) |
| 2,4-dimethyl-2,3-dihydro-pyrrol-3-on-1,5-diyl | (Q-5.188) |
| 2-methyl-4-ethyl-2,3-dihydro-pyrrol-3-on-1,5-diyl | (Q-5.189) |
| 2-methyl-4-fluoromethyl-2,3-dihydro-pyrrol-3-on-1,5-diyl | (Q-5.190) |
| 2-methyl-4-difluoromethyl-2,3-dihydro-pyrrol-3-on-1,5-diyl | (Q-5.191) |
| 2-methyl-4-trifluoromethyl-2,3-dihydro-pyrrol-3-on-1,5-diyl | (Q-5.192) |
| 2-ethyl-2,3-dihydro-pyrrol-3-on-1,5-diyl | (Q-5.193) |
| 2-ethyl-4-chloro-2,3-dihydro-pyrrol-3-on-1,5-diyl | (Q-5.194) |
| 2-ethyl-4-methyl-2,3-dihydro-pyrrol-3-on-1,5-diyl | (Q-5.195) |
| 2,4-diethyl-2,3-dihydro-pyrrol-3-on-1,5-diyl | (Q-5.196) |
| 2-ethyl-4-fluoromethyl-2,3-dihydro-pyrrol-3-on-1,5-diyl | (Q-5.197) |
| 4-ethyl-4-difluoromethyl-2,3-dihydro-pyrrol-3-on-1,5-diyl | (Q-5.198) |
| 2-ethyl-4-trifluoromethyl-2,3-dihydro-pyrrol-3-on-1,5-diyl | (Q-5.199) |
| 2-fluoromethyl-2,3-dihydro-pyrrol-3-on-1,5-diyl | (Q-5.200) |
| 2-fluoromethyl-4-chloro-2,3-dihydro-pyrrol-3-on-1,5-diyl | (Q-5.201) |
| 2-fluoromethyl-4-methyl-2,3-dihydro-pyrrol-3-on-1,5-diyl | (Q-5.202) |
| 2-fluoromethyl-4-ethyl-2,3-dihydro-pyrrol-3-on-1,5-diyl | (Q-5.203) |
| 2,4-di-(fluoromethyl)-2,3-dihydro-pyrrol-3-on-1,5-diyl | (Q-5.204) |
| 2-fluoromethyl-4-difluoromethyl-2,3- | (Q-5.205) |
| dihydro-pyrrol-3-on-1,5-diyl | |
| 2-fluoromethyl-4-trifluoromethyl-2,3- | (Q-5.206) |
| dihydro-pyrrol-3-on-1,5-diyl | |
| 2-difluoromethyl-2,3-dihydro-pyrrol-3-on-1,5-diyl | (Q-5.207) |
| 2-difluoromethyl-4-chloro-2,3-dihydro-pyrrol-3-on-1,5-diyl | (Q-5.208) |
| 2-difluoromethyl-4-methyl-2,3-dihydro-pyrrol-3-on-1,5-diyl | (Q-5.209) |
| 2-difluoromethyl-4-ethyl-2,3-dihydro-pyrrol-3-on-1,5-diyl | (Q-5.210) |
| 2-difluoromethyl-4-fluoromethyl-2,3- | (Q-5.211) |
| dihydro-pyrrol-3-on-1,5-diyl | |
| 2,4-di-(difluoromethyl)-2,3-dihydro-pyrrol-3-on-1,5-diyl | (Q-5.212) |
| 2-difluoromethyl-4-trifluoromethyl-2,3- | (Q-5.213) |
| dihydro-pyrrol-3-on-1,5-diyl | |
| 2-trifluoromethyl-2,3-dihydro-pyrrol-3-on-1,5-diyl | (Q-5.214) |
| 2-trifluoromethyl-4-chloro-2,3-dihydro-pyrrol-3-on-1,5-diyl | (Q-5.215) |
| 2-trifluoromethyl-4-methyl-2,3-dihydro-pyrrol-3-on-1,5-diyl | (Q-5.216) |
| 2-trifluoromethyl-4-ethyl-2,3-dihydro-pyrrol-3-on-1,5-diyl | (Q-5.217) |
| 2-trifluoromethyl-4-fluoromethyl-2,3- | (Q-5.218) |
| dihydro-pyrrol-3-on-1,5-diyl | |
| 2-trifluoromethyl-4-difluoromethyl-2,3- | (Q-5.219) |
| dihydro-pyrrol-3-on-1,5-diyl | |
| 2,4-di-(trifluoromethyl)-2,3-dihydro-pyrrol-3-on-1,5-diyl | (Q-5.220) |
| 4,5-dihydro-imidazol-4-on-1,2-diyl | (Q-5.221) |
| 5-chloro-4,5-dihydro-imidazol-4-on-1,2-diyl | (Q-5.222) |
| 5-methyl-4,5-dihydro-imidazol-4-on-1,2-diyl | (Q-5.223) |
| 5-ethyl-4,5-dihydro-imidazol-4-on-1,2-diyl | (Q-5.224) |
| 5-fluoromethyl-4,5-dihydro-imidazol-4-on-1,2-diyl | (Q-5.225) |
| 5-difluoromethyl-4,5-dihydro-imidazol-4-on-1,2-diyl | (Q-5.226) |
| 5-trifluoromethyl-4,5-dihydro-imidazol-4-on-1,2-diyl | (Q-5.227) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-6, as defined herein. According to a particular preferred aspect of this embodiment Q-6 is selected from the radicals of the following formulae:

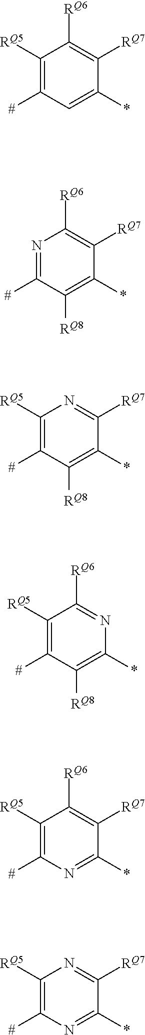

wherein #, *, R^{Q5}, R^{Q6}, R^{Q7} and R^{Q8} are as defined herein.

Among the compounds of formula I wherein Q is Q-6, preference is given to those compounds, wherein R^{Q5}, R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q5}, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-6 are the radicals of formulae Q-6.1 to Q-6.144, as defined in Table Q6. Of the two attachment points identified in the names of radicals Q-6 given in Table Q6 the first number represents the position to which the pyrazole radical is linked and the second number represents the position to which the 6-membered heteroaromatic radical is linked. By way of example, phenyl-1,3-diyl is bound to the pyrazole radical and the 6-membered heteroaromatic radical via its positions 1 and 3, respectively.

TABLE Q6

| | |
|---|---|
| phenyl-1,3-diyl | (Q-6.1) |
| 6-methyl-phenyl-1,3-diyl | (Q-6.2) |
| 6-trifluoromethyl-phenyl-1,3-diyl | (Q-6.3) |
| 5-methyl-phenyl-1,3-diyl | (Q-6.4) |
| 5,6-dimethyl-phenyl-1,3-diyl | (Q-6.5) |
| 5-methyl-6-trifluoromethyl-phenyl-1,3-diyl | (Q-6.6) |
| 5-trifluoromethyl-phenyl-1,3-diyl | (Q-6.7) |
| 5-trifluoromethyl-6-methyl-phenyl-1,3-diyl | (Q-6.8) |
| 5,6-di-(trifluoromethyl)-phenyl-1,3-diyl | (Q-6.9) |
| 4-methyl-phenyl-1,3-diyl | (Q-6.10) |
| 4,6-dimethyl-phenyl-1,3-diyl | (Q-6.11) |
| 4-methyl-6-trifluoromethyl-phenyl-1,3-diyl | (Q-6.12) |
| 4,5-dimethyl-phenyl-1,3-diyl | (Q-6.13) |
| 4,5,6-trimethyl-phenyl-1,3-diyl | (Q-6.14) |
| 4,5-dimethyl-6-trifluoromethyl-phenyl-1,3-diyl | (Q-6.15) |
| 4-methyl-5-trifluoromethyl-phenyl-1,3-diyl | (Q-6.16) |
| 4,6-dimethyl-5-trifluoromethyl-phenyl-1,3-diyl | (Q-6.17) |
| 4-methyl-5,6-di-(trifluoromethyl)-phenyl-1,3-diyl | (Q-6.18) |
| 4-trifluoromethyl-phenyl-1,3-diyl | (Q-6.19) |
| 4-trifluoromethyl-6-methyl-phenyl-1,3-diyl | (Q-6.20) |
| 4,6-di-(trifluoromethyl)-phenyl-1,3-diyl | (Q-6.21) |
| 4-trifluoromethyl-5-methyl-phenyl-1,3-diyl | (Q-6.22) |
| 4-trifluoromethyl-5,6-dimethyl-phenyl-1,3-diyl | (Q-6.23) |
| 4,6-di-(trifluoromethyl)-5-methyl-phenyl-1,3-diyl | (Q-6.24) |
| 4,5-di-(trifluoromethyl)-phenyl-1,3-diyl | (Q-6.25) |
| 4,5-di-(trifluoromethyl)-6-methyl-phenyl-1,3-diyl | (Q-6.26) |
| 4,5,6-tri-(trifluoromethyl)-phenyl-1,3-diyl | (Q-6.27) |
| pyridyl-2,4-diyl | (Q-6.28) |
| 6-methyl-pyridyl-2,4-diyl | (Q-6.29) |
| 6-trifluoromethyl-pyridyl-2,4-diyl | (Q-6.30) |
| 5-methyl-pyridyl-2,4-diyl | (Q-6.31) |
| 5,6-dimethyl-pyridyl-2,4-diyl | (Q-6.32) |
| 5-methyl-6-trifluoromethyl-pyridyl-2,4-diyl | (Q-6.33) |
| 5-trifluoromethyl-pyridyl-2,4-diyl | (Q-6.34) |
| 5-trifluoromethyl-6-methyl-pyridyl-2,4-diyl | (Q-6.35) |
| 5,6-di-(trifluoromethyl)-pyridyl-2,4-diyl | (Q-6.36) |
| 3-methyl-pyridyl-2,4-diyl | (Q-6.37) |
| 3,6-dimethyl-pyridyl-2,4-diyl | (Q-6.38) |
| 3-methyl-6-trifluoromethyl-pyridyl-2,4-diyl | (Q-6.39) |
| 3,5-dimethyl-pyridyl-2,4-diyl | (Q-6.40) |
| 3,5,6-trimethyl-pyridyl-2,4-diyl | (Q-6.41) |
| 3,5-dimethyl-6-trifluoromethyl-pyridyl-2,4-diyl | (Q-6.42) |
| 3-methyl-5-trifluoromethyl-pyridyl-2,4-diyl | (Q-6.43) |
| 3,6-dimethyl-5-trifluoromethyl-pyridyl-2,4-diyl | (Q-6.44) |
| 3-methyl-5,6-di-(trifluoromethyl)-pyridyl-2,4-diyl | (Q-6.45) |
| 3-trifluoromethyl-pyridyl-2,4-diyl | (Q-6.46) |
| 3-trifluoromethyl-6-methyl-pyridyl-2,4-diyl | (Q-6.47) |
| 3,6-di-(trifluoromethyl)-pyridyl-2,4-diyl | (Q-6.48) |
| 3-trifluoromethyl-5-methyl-pyridyl-2,4-diyl | (Q-6.49) |
| 3-trifluoromethyl-5,6-dimethyl-pyridyl-2,4-diyl | (Q-6.50) |
| 3,6-di-(trifluoromethyl)-5-methyl-pyridyl-2,4-diyl | (Q-6.51) |
| 3,5-di-(trifluoromethyl)-pyridyl-2,4-diyl | (Q-6.52) |
| 3,5-di-(trifluoromethyl)-6-methyl-pyridyl-2,4-diyl | (Q-6.53) |
| 3,5,6-tri-(trifluoromethyl)-pyridyl-2,4-diyl | (Q-6.54) |
| pyridyl-3,5-diyl | (Q-6.55) |
| 6-methyl-pyridyl-3,5-diyl | (Q-6.56) |
| 6-trifluoromethyl-pyridyl-3,5-diyl | (Q-6.57) |
| 4-methyl-pyridyl-3,5-diyl | (Q-6.58) |
| 4,6-dimethyl-pyridyl-3,5-diyl | (Q-6.59) |
| 4-methyl-6-trifluoromethyl-pyridyl-3,5-diyl | (Q-6.60) |
| 4-trifluoromethyl-pyridyl-3,5-diyl | (Q-6.61) |
| 4-trifluoromethyl-6-methyl-pyridyl-3,5-diyl | (Q-6.62) |
| 4,6-di-(trifluoromethyl)-pyridyl-3,5-diyl | (Q-6.63) |
| 2-methyl-pyridyl-3,5-diyl | (Q-6.64) |
| 2,6-dimethyl-pyridyl-3,5-diyl | (Q-6.65) |
| 2-methyl-6-trifluoromethyl-pyridyl-3,5-diyl | (Q-6.66) |
| 2,4-dimethyl-pyridyl-3,5-diyl | (Q-6.67) |
| 2,4,6-trimethyl-pyridyl-3,5-diyl | (Q-6.68) |
| 2,4-dimethyl-6-trifluoromethyl-pyridyl-3,5-diyl | (Q-6.69) |
| 2-methyl-4-trifluoromethyl-pyridyl-3,5-diyl | (Q-6.70) |
| 2,6-dimethyl-4-trifluoromethyl-pyridyl-3,5-diyl | (Q-6.71) |
| 2-methyl-4,6-di-(trifluoromethyl)-pyridyl-3,5-diyl | (Q-6.72) |
| 2-trifluoromethyl-pyridyl-3,5-diyl | (Q-6.73) |
| 2-trifluoromethyl-6-methyl-pyridyl-3,5-diyl | (Q-6.74) |
| 2,6-di-(trifluoromethyl)-pyridyl-3,5-diyl | (Q-6.75) |
| 2-trifluoromethyl-4-methyl-pyridyl-3,5-diyl | (Q-6.76) |
| 2-trifluoromethyl-4,6-dimethyl-pyridyl-3,5-diyl | (Q-6.77) |
| 2,6-di-(trifluoromethyl)-4-methyl-pyridyl-3,5-diyl | (Q-6.78) |
| 2,4-di-(trifluoromethyl)-pyridyl-3,5-diyl | (Q-6.79) |
| 2,4-di-(trifluoromethyl)-6-methyl-pyridyl-3,5-diyl | (Q-6.80) |
| 2,4,6-tri-(trifluoromethyl)-pyridyl-3,5-diyl | (Q-6.81) |
| pyridyl-4,2-diyl | (Q-6.82) |
| 6-methyl-pyridyl-4,2-diyl | (Q-6.83) |
| 6-trifluoromethyl-pyridyl-4,2-diyl | (Q-6.84) |
| 5-methyl-pyridyl-4,2-diyl | (Q-6.85) |
| 5,6-dimethyl-pyridyl-4,2-diyl | (Q-6.86) |
| 5-methyl-6-trifluoromethyl-pyridyl-4,2-diyl | (Q-6.87) |
| 5-trifluoromethyl-pyridyl-4,2-diyl | (Q-6.88) |
| 5-trifluoromethyl-6-methyl-pyridyl-4,2-diyl | (Q-6.89) |
| 5,6-di-(trifluoromethyl)-pyridyl-4,2-diyl | (Q-6.90) |
| 3-methyl-pyridyl-4,2-diyl | (Q-6.91) |
| 3,6-dimethyl-pyridyl-4,2-diyl | (Q-6.92) |
| 3-methyl-6-trifluoromethyl-pyridyl-4,2-diyl | (Q-6.93) |
| 3,5-dimethyl-pyridyl-4,2-diyl | (Q-6.94) |
| 3,5,6-trimethyl-pyridyl-4,2-diyl | (Q-6.95) |
| 3,5-dimethyl-6-trifluoromethyl-pyridyl-4,2-diyl | (Q-6.96) |
| 3-methyl-5-trifluoromethyl-pyridyl-4,2-diyl | (Q-6.97) |
| 3,6-dimethyl-5-trifluoromethyl-pyridyl-4,2-diyl | (Q-6.98) |
| 3-methyl-5,6-di-(trifluoromethyl)-pyridyl-4,2-diyl | (Q-6.99) |
| 3-trifluoromethyl-pyridyl-4,2-diyl | (Q-6.100) |
| 3-trifluoromethyl-6-methyl-pyridyl-4,2-diyl | (Q-6.101) |
| 3,6-di-(trifluoromethyl)-pyridyl-4,2-diyl | (Q-6.102) |
| 3-trifluoromethyl-5-methyl-pyridyl-4,2-diyl | (Q-6.103) |
| 3-trifluoromethyl-5,6-dimethyl-pyridyl-4,2-diyl | (Q-6.104) |
| 3,6-di-(trifluoromethyl)-5-methyl-pyridyl-4,2-diyl | (Q-6.105) |
| 3,5-di-(trifluoromethyl)-pyridyl-4,2-diyl | (Q-6.106) |
| 3,5-di-(trifluoromethyl)-6-methyl-pyridyl-4,2-diyl | (Q-6.107) |
| 3,5,6-tri-(trifluoromethyl)-pyridyl-4,2-diyl | (Q-6.108) |
| pyridyl-2,6-diyl | (Q-6.109) |
| 5-methyl-pyridyl-2,6-diyl | (Q-6.110) |
| 5-trifluoromethyl-pyridyl-2,6-diyl | (Q-6.111) |
| 5-methyl-pyridyl-2,6-diyl | (Q-6.112) |
| 4,5-dimethyl-pyridyl-2,6-diyl | (Q-6.113) |
| 4-methyl-5-trifluoromethyl-pyridyl-2,6-diyl | (Q-6.114) |
| 4-trifluoromethyl-pyridyl-2,6-diyl | (Q-6.115) |
| 4-trifluoromethyl-5-methyl-pyridyl-2,6-diyl | (Q-6.116) |
| 4,5-di-(trifluoromethyl)-pyridyl-2,6-diyl | (Q-6.117) |
| 3-methyl-pyridyl-2,6-diyl | (Q-6.118) |
| 3,5-dimethyl-pyridyl-2,6-diyl | (Q-6.119) |
| 3-methyl-5-trifluoromethyl-pyridyl-2,6-diyl | (Q-6.120) |
| 3,4-dimethyl-pyridyl-2,6-diyl | (Q-6.121) |
| 3,4,5-trimethyl-pyridyl-2,6-diyl | (Q-6.122) |
| 3,4-dimethyl-5-trifluoromethyl-pyridyl-2,6-diyl | (Q-6.123) |
| 3-methyl-4-trifluoromethyl-pyridyl-2,6-diyl | (Q-6.124) |
| 3,5-dimethyl-4-trifluoromethyl-pyridyl-2,6-diyl | (Q-6.125) |
| 3-methyl-4,5-di-(trifluoromethyl)-pyridyl-2,6-diyl | (Q-6.126) |
| 3-trifluoromethyl-pyridyl-2,6-diyl | (Q-6.127) |
| 3-trifluoromethyl-5-methyl-pyridyl-2,6-diyl | (Q-6.128) |
| 3,5-di-(trifluoromethyl)-pyridyl-2,6-diyl | (Q-6.129) |
| 3-trifluoromethyl-4-methyl-pyridyl-2,6-diyl | (Q-6.130) |
| 3-trifluoromethyl-4,5-dimethyl-pyridyl-2,6-diyl | (Q-6.131) |
| 3,5-di-(trifluoromethyl)-4-methyl-pyridyl-2,6-diyl | (Q-6.132) |
| 3,4-di-(trifluoromethyl)-pyridyl-2,6-diyl | (Q-6.133) |
| 3,4-di-(trifluoromethyl)-5-methyl-pyridyl-2,6-diyl | (Q-6.134) |
| 3,4,5-tri-(trifluoromethyl)-pyridyl-2,6-diyl | (Q-6.135) |
| pyrazinyl-3,5-diyl | (Q-6.136) |
| 6-methyl-pyrazinyl-3,5-diyl | (Q-6.137) |
| 6-trifluoromethyl-pyrazinyl-3,5-diyl | (Q-6.138) |
| 6-methyl-pyrazinyl-3,5-diyl | (Q-6.139) |
| 2,6-dimethyl-pyrazinyl-3,5-diyl | (Q-6.140) |
| 2-methyl-6-trifluoromethyl-pyrazinyl-3,5-diyl | (Q-6.141) |
| 2-trifluoromethyl-pyrazinyl-3,5-diyl | (Q-6.142) |
| 2-trifluoromethyl-6-methyl-pyrazinyl-3,5-diyl | (Q-6.143) |
| 2,6-di-(trifluoromethyl-pyrazinyl-3,5-diyl | (Q-6.144) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical 0-7, as defined herein. According to a particular preferred aspect of this embodiment Q-7 is selected from the radicals of the following formulae:

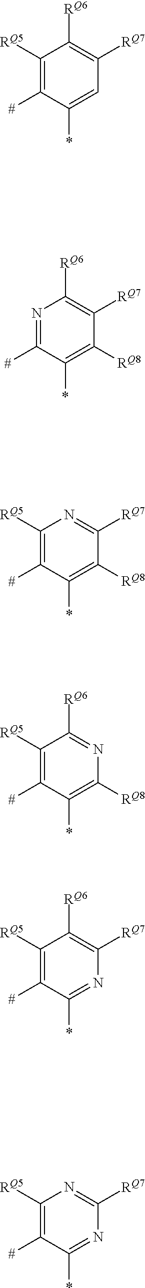

wherein #, *, R^{Q5}, R^{Q6}, R^{Q7} and R^{Q8} are as defined herein.

Among the compounds of formula I wherein Q is Q-7, preference is given to those compounds, wherein R^{Q5}, R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q5}, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-7 are the radicals of formulae Q-7.1 to Q-7.144, as defined in Table Q7. Of the two attachment points identified in the names of radicals Q-7 given in Table Q7 the first number represents the position to which the pyrazole radical is linked and the second number represents the position to which the 6-membered heteroaromatic radical is linked. By way of example, phenyl-1,2-diyl is bound to the pyrazole radical and the 6-membered heteroaromatic radical via its positions 1 and 2, respectively.

TABLE Q7

| | |
|---|---|
| phenyl-1,2-diyl | (Q-7.1) |
| 5-methyl-phenyl-1,2-diyl | (Q-7.2) |
| 5-trifluoromethyl-phenyl-1,2-diyl | (Q-7.3) |
| 4-methyl-phenyl-1,2-diyl | (Q-7.4) |
| 4,5-dimethyl-phenyl-1,2-diyl | (Q-7.5) |
| 4-methyl-5-trifluoromethyl-phenyl-1,2-diyl | (Q-7.6) |
| 4-trifluoromethyl-phenyl-1,2-diyl | (Q-7.7) |
| 4-trifluoromethyl-5-methyl-phenyl-1,2-diyl | (Q-7.8) |
| 4,5-di-(trifluoromethyl)-phenyl-1,2-diyl | (Q-7.9) |
| 3-methyl-phenyl-1,2-diyl | (Q-7.10) |
| 3,5-dimethyl-phenyl-1,2-diyl | (Q-7.11) |
| 3-methyl-5-trifluoromethyl-phenyl-1,2-diyl | (Q-7.12) |
| 3,4-dimethyl-phenyl-1,2-diyl | (Q-7.13) |
| 3,4,5-trimethyl-phenyl-1,2-diyl | (Q-7.14) |
| 3,4-dimethyl-5-trifluoromethyl-phenyl-1,2-diyl | (Q-7.15) |
| 3-methyl-4-trifluoromethyl-phenyl-1,2-diyl | (Q-7.16) |
| 3,5-dimethyl-4-trifluoromethyl-phenyl-1,2-diyl | (Q-7.17) |
| 3-methyl-4,5-di-(trifluoromethyl)-phenyl-1,2-diyl | (Q-7.18) |
| 3-trifluoromethyl-phenyl-1,2-diyl | (Q-7.19) |
| 3-trifluoromethyl-5-methyl-phenyl-1,2-diyl | (Q-7.20) |
| 3,5-di-(trifluoromethyl)-phenyl-1,2-diyl | (Q-7.21) |
| 3-trifluoromethyl-4-methyl-phenyl-1,2-diyl | (Q-7.22) |
| 3-trifluoromethyl-4,5-dimethyl-phenyl-1,2-diyl | (Q-7.23) |
| 3,5-di-(trifluoromethyl)-4-methyl-phenyl-1,2-diyl | (Q-7.24) |
| 3,4-di-(trifluoromethyl)-phenyl-1,2-diyl | (Q-7.25) |
| 3,4-di-(trifluoromethyl)-5-methyl-phenyl-1,2-diyl | (Q-7.26) |
| 3,4,5-tri-(trifluoromethyl)-phenyl-1,2-diyl | (Q-7.27) |
| pyridyl-2,3-diyl | (Q-7.28) |
| 6-methyl-pyridyl-2,3-diyl | (Q-7.29) |
| 6-trifluoromethyl-pyridyl-2,3-diyl | (Q-7.30) |
| 5-methyl-pyridyl-2,3-diyl | (Q-7.31) |
| 5,6-dimethyl-pyridyl-2,3-diyl | (Q-7.32) |
| 5-methyl-6-trifluoromethyl-pyridyl-2,3-diyl | (Q-7.33) |
| 5-trifluoromethyl-pyridyl-2,3-diyl | (Q-7.34) |
| 5-trifluoromethyl-6-methyl-pyridyl-2,3-diyl | (Q-7.35) |
| 5,6-di-(trifluoromethyl)-pyridyl-2,3-diyl | (Q-7.36) |
| 4-methyl-pyridyl-2,3-diyl | (Q-7.37) |
| 4,6-dimethyl-pyridyl-2,3-diyl | (Q-7.38) |
| 4-methyl-6-trifluoromethyl-pyridyl-2,3-diyl | (Q-7.39) |
| 4,5-dimethyl-pyridyl-2,3-diyl | (Q-7.40) |
| 4,5,6-trimethyl-pyridyl-2,3-diyl | (Q-7.41) |
| 4,5-dimethyl-6-trifluoromethyl-pyridyl-2,3-diyl | (Q-7.42) |
| 4-methyl-5-trifluoromethyl-pyridyl-2,3-diyl | (Q-7.43) |
| 4,6-dimethyl-5-trifluoromethyl-pyridyl-2,3-diyl | (Q-7.44) |
| 4-methyl-5,6-di-(trifluoromethyl)-pyridyl-2,3-diyl | (Q-7.45) |
| 4-trifluoromethyl-pyridyl-2,3-diyl | (Q-7.46) |
| 4-trifluoromethyl-6-methyl-pyridyl-2,3-diyl | (Q-7.47) |
| 4,6-di-(trifluoromethyl)-pyridyl-2,3-diyl | (Q-7.48) |
| 4-trifluoromethyl-5-methyl-pyridyl-2,3-diyl | (Q-7.49) |
| 4-trifluoromethyl-5,6-dimethyl-pyridyl-2,3-diyl | (Q-7.50) |
| 4,6-di-(trifluoromethyl)-5-methyl-pyridyl-2,3-diyl | (Q-7.51) |
| 4,5-di-(trifluoromethyl)-pyridyl-2,3-diyl | (Q-7.52) |
| 4,5-di-(trifluoromethyl)-6-methyl-pyridyl-2,3-diyl | (Q-7.53) |
| 4,5,6-tri-(trifluoromethyl)-pyridyl-2,3-diyl | (Q-7.54) |
| pyridyl-3,4-diyl | (Q-7.55) |
| 6-methyl-pyridyl-3,4-diyl | (Q-7.56) |
| 6-trifluoromethyl-pyridyl-3,4-diyl | (Q-7.57) |
| 5-methyl-pyridyl-3,4-diyl | (Q-7.58) |
| 5,6-dimethyl-pyridyl-3,4-diyl | (Q-7.59) |
| 5-methyl-6-trifluoromethyl-pyridyl-3,4-diyl | (Q-7.60) |
| 5-trifluoromethyl-pyridyl-3,4-diyl | (Q-7.61) |
| 5-trifluoromethyl-6-methyl-pyridyl-3,4-diyl | (Q-7.62) |
| 5,6-di-(trifluoromethyl)-pyridyl-3,4-diyl | (Q-7.63) |
| 2-methyl-pyridyl-3,4-diyl | (Q-7.64) |
| 2,6-dimethyl-pyridyl-3,4-diyl | (Q-7.65) |
| 2-methyl-6-trifluoromethyl-pyridyl-3,4-diyl | (Q-7.66) |
| 2,5-dimethyl-pyridyl-3,4-diyl | (Q-7.67) |
| 2,5,6-trimethyl-pyridyl-3,4-diyl | (Q-7.68) |
| 2,5-dimethyl-6-trifluoromethyl-pyridyl-3,4-diyl | (Q-7.69) |
| 2-methyl-5-trifluoromethyl-pyridyl-3,4-diyl | (Q-7.70) |
| 2,6-dimethyl-5-trifluoromethyl-pyridyl-3,4-diyl | (Q-7.71) |
| 2-methyl-5,6-di-(trifluoromethyl)-pyridyl-3,4-diyl | (Q-7.72) |
| 2-trifluoromethyl-pyridyl-3,4-diyl | (Q-7.73) |
| 2-trifluoromethyl-6-methyl-pyridyl-3,4-diyl | (Q-7.74) |
| 2,6-di-(trifluoromethyl)-pyridyl-3,4-diyl | (Q-7.75) |
| 2-trifluoromethyl-5-methyl-pyridyl-3,4-diyl | (Q-7.76) |
| 2-trifluoromethyl-5,6-dimethyl-pyridyl-3,4-diyl | (Q-7.77) |
| 2,6-di-(trifluoromethyl)-5-methyl-pyridyl-3,4-diyl | (Q-7.78) |
| 2,5-di-(trifluoromethyl)-pyridyl-3,4-diyl | (Q-7.79) |
| 2,5-di-(trifluoromethyl)-6-methyl-pyridyl-3,4-diyl | (Q-7.80) |
| 2,5,6-tri-(trifluoromethyl)-pyridyl-3,4-diyl | (Q-7.81) |
| pyridyl-4,3-diyl | (Q-7.82) |
| 6-methyl-pyridyl-4,3-diyl | (Q-7.83) |
| 6-trifluoromethyl-pyridyl-4,3-diyl | (Q-7.84) |
| 5-methyl-pyridyl-4,3-diyl | (Q-7.85) |
| 5,6-dimethyl-pyridyl-4,3-diyl | (Q-7.86) |
| 5-methyl-6-trifluoromethyl-pyridyl-4,3-diyl | (Q-7.87) |
| 5-trifluoromethyl-pyridyl-4,3-diyl | (Q-7.88) |
| 5-trifluoromethyl-6-methyl-pyridyl-4,3-diyl | (Q-7.89) |
| 5,6-di-(trifluoromethyl)-pyridyl-4,3-diyl | (Q-7.90) |
| 2-methyl-pyridyl-4,3-diyl | (Q-7.91) |
| 2,6-dimethyl-pyridyl-4,3-diyl | (Q-7.92) |
| 2-methyl-6-trifluoromethyl-pyridyl-4,3-diyl | (Q-7.93) |
| 2,5-dimethyl-pyridyl-4,3-diyl | (Q-7.94) |
| 2,5,6-trimethyl-pyridyl-4,3-diyl | (Q-7.95) |
| 2,5-dimethyl-6-trifluoromethyl-pyridyl-4,3-diyl | (Q-7.96) |
| 2-methyl-5-trifluoromethyl-pyridyl-4,3-diyl | (Q-7.97) |
| 2,6-dimethyl-5-trifluoromethyl-pyridyl-4,3-diyl | (Q-7.98) |
| 2-methyl-5,6-di-(trifluoromethyl)-pyridyl-4,3-diyl | (Q-7.99) |
| 2-trifluoromethyl-pyridyl-4,3-diyl | (Q-7.100) |
| 2-trifluoromethyl-6-methyl-pyridyl-4,3-diyl | (Q-7.101) |
| 2,6-di-(trifluoromethyl)-pyridyl-4,3-diyl | (Q-7.102) |
| 2-trifluoromethyl-5-methyl-pyridyl-4,3-diyl | (Q-7.103) |
| 2-trifluoromethyl-5,6-dimethyl-pyridyl-4,3-diyl | (Q-7.104) |
| 2,6-di-(trifluoromethyl)-5-methyl-pyridyl-4,3-diyl | (Q-7.105) |
| 2,5-di-(trifluoromethyl)-pyridyl-4,3-diyl | (Q-7.106) |
| 2,5-di-(trifluoromethyl)-6-methyl-pyridyl-4,3-diyl | (Q-7.107) |
| 2,5,6-tri-(trifluoromethyl)-pyridyl-4,3-diyl | (Q-7.108) |
| pyridyl-3,2-diyl | (Q-7.109) |
| 6-methyl-pyridyl-3,2-diyl | (Q-7.110) |
| 6-trifluoromethyl-pyridyl-3,2-diyl | (Q-7.111) |
| 6-methyl-pyridyl-3,2-diyl | (Q-7.112) |
| 5,6-dimethyl-pyridyl-3,2-diyl | (Q-7.113) |
| 5-methyl-6-trifluoromethyl-pyridyl-3,2-diyl | (Q-7.114) |
| 5-trifluoromethyl-pyridyl-3,2-diyl | (Q-7.115) |
| 5-trifluoromethyl-6-methyl-pyridyl-3,2-diyl | (Q-7.116) |
| 5,6-di-(trifluoromethyl)-pyridyl-3,2-diyl | (Q-7.117) |
| 4-methyl-pyridyl-3,2-diyl | (Q-7.118) |
| 4,6-dimethyl-pyridyl-3,2-diyl | (Q-7.119) |
| 4-methyl-6-trifluoromethyl-pyridyl-3,2-diyl | (Q-7.120) |
| 4,5-dimethyl-pyridyl-3,2-diyl | (Q-7.121) |
| 4,5,6-trimethyl-pyridyl-3,2-diyl | (Q-7.122) |
| 4,5-dimethyl-6-trifluoromethyl-pyridyl-3,2-diyl | (Q-7.123) |
| 4-methyl-5-trifluoromethyl-pyridyl-3,2-diyl | (Q-7.124) |
| 4,6-dimethyl-5-trifluoromethyl-pyridyl-3,2-diyl | (Q-7.125) |
| 4-methyl-5,6-di-(trifluoromethyl)-pyridyl-3,2-diyl | (Q-7.126) |
| 4-trifluoromethyl-pyridyl-3,2-diyl | (Q-7.127) |
| 4-trifluoromethyl-6-methyl-pyridyl-3,2-diyl | (Q-7.128) |
| 4,6-di-(trifluoromethyl)-pyridyl-3,2-diyl | (Q-7.129) |
| 4-trifluoromethyl-5-methyl-pyridyl-3,2-diyl | (Q-7.130) |
| 4-trifluoromethyl-5,6-dimethyl-pyridyl-3,2-diyl | (Q-7.131) |
| 4,6-di-(trifluoromethyl)-5-methyl-pyridyl-3,2-diyl | (Q-7.132) |
| 4,5-di-(trifluoromethyl)-pyridyl-3,2-diyl | (Q-7.133) |
| 4,5-di-(trifluoromethyl)-6-methyl-pyridyl-3,2-diyl | (Q-7.134) |
| 4,5,6-tri-(trifluoromethyl)-pyridyl-3,2-diyl | (Q-7.135) |
| pyrimidinyl-4,5-diyl | (Q-7.136) |
| 6-methyl-pyrimidinyl-4,5-diyl | (Q-7.137) |
| 6-trifluoromethyl-pyrimidinyl-4,5-diyl | (Q-7.138) |
| 6-methyl-pyrimidinyl-4,5-diyl | (Q-7.139) |
| 2,6-dimethyl-pyrimidinyl-4,5-diyl | (Q-7.140) |
| 2-methyl-6-trifluoromethyl-pyrimidinyl-4,5-diyl | (Q-7.141) |
| 2-trifluoromethyl-pyrimidinyl-4,5-diyl | (Q-7.142) |
| 2-trifluoromethyl-6-methyl-pyrimidinyl-4,5-diyl | (Q-7.143) |
| 2,6-di-(trifluoromethyl-pyrimidinyl-4,5-diyl | (Q-7.144) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-8, as defined herein. According to a particular preferred aspect of this embodiment Q-8 is selected from the radicals of the following formulae:

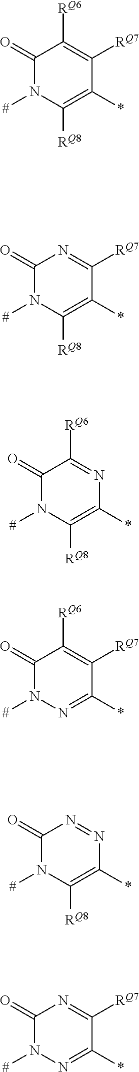

wherein #, *, R^{Q6}, R^{Q7} and R^{Q8} are as defined herein.

Among the compounds of formula I wherein Q is Q-8, preference is given to those compounds, wherein R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-8 are the radicals of formulae Q-8.1 to Q-8.60, as defined in Table Q8. Of the two attachment points identified in the names of radicals Q-8 given in Table Q8 the first number represents the position to which the pyrazole radical is linked and the second number represents the position to which the 6-membered heteroaromatic radical is linked. By way of example, pyridin-2-on-1,5-diyl is bound to the pyrazole radical and the 6-membered heteroaromatic radical via its positions 1 and 5, respectively.

TABLE Q8

| | |
|---|---|
| pyridin-2-on-1,5-diyl | (Q-8.1) |
| 6-methyl-pyridin-2-on-1,5-diyl | (Q-8.2) |
| 6-trifluoromethyl-pyridin-2-on-1,5-diyl | (Q-8.3) |
| 4-methyl-pyridin-2-on-1,5-diyl | (Q-8.4) |
| 4,6-dimethyl-pyridin-2-on-1,5-diyl | (Q-8.5) |
| 4-methyl-6-trifluoromethyl-pyridin-2-on-1,5-diyl | (Q-8.6) |
| 4-trifluoromethyl-pyridin-2-on-1,5-diyl | (Q-8.7) |
| 4-trifluoromethyl-6-methyl-pyridin-2-on-1,5-diyl | (Q-8.8) |
| 4,6-di-(trifluoromethyl)-pyridin-2-on-1,5-diyl | (Q-8.9) |
| 3-methyl-pyridin-2-on-1,5-diyl | (Q-8.10) |
| 3,6-dimethyl-pyridin-2-on-1,5-diyl | (Q-8.11) |
| 3-methyl-6-trifluoromethyl-pyridin-2-on-1,5-diyl | (Q-8.12) |
| 3,4-dimethyl-pyridin-2-on-1,5-diyl | (Q-8.13) |
| 3,4,6-trimethyl-pyridin-2-on-1,5-diyl | (Q-8.14) |
| 3,4-dimethyl-6-trifluoromethyl-pyridin-2-on-1,5-diyl | (Q-8.15) |
| 3-methyl-4-trifluoromethyl-pyridin-2-on-1,5-diyl | (Q-8.16) |
| 3,6-dimethyl-4-trifluoromethyl-pyridin-2-on-1,5-diyl | (Q-8.17) |
| 3-methyl-4,6-di-(trifluoromethyl)-pyridin-2-on-1,5-diyl | (Q-8.18) |
| 3-trifluoromethyl-pyridin-2-on-1,5-diyl | (Q-8.19) |
| 3-trifluoromethyl-6-methyl-pyridin-2-on-1,5-diyl | (Q-8.20) |
| 3,6-di-(trifluoromethyl)-pyridin-2-on-1,5-diyl | (Q-8.21) |
| 3-trifluoromethyl-4-methyl-pyridin-2-on-1,5-diyl | (Q-8.22) |
| 3-trifluoromethyl-4,6-dimethyl-pyridin-2-on-1,5-diyl | (Q-8.23) |
| 3,6-di-(trifluoromethyl)-4-methyl-pyridin-2-on-1,5-diyl | (Q-8.24) |
| 3,4-di-(trifluoromethyl)-pyridin-2-on-1,5-diyl | (Q-8.25) |
| 3,4-di-(trifluoromethyl)-6-methyl-pyridin-2-on-1,5-diyl | (Q-8.26) |
| 3,4,6-tri-(trifluoromethyl)-pyridin-2-on-1,5-diyl | (Q-8.27) |
| pyrimidin-2-on-1,5-diyl | (Q-8.28) |
| 6-methyl-pyrimidin-2-on-1,5-diyl | (Q-8.29) |
| 6-trifluoromethyl-pyrimidin-2-on-1,5-diyl | (Q-8.30) |
| 4-methyl-pyrimidin-2-on-1,5-diyl | (Q-8.31) |
| 4,6-dimethyl-pyrimidin-2-on-1,5-diyl | (Q-8.32) |
| 4-methyl-6-trifluoromethyl-pyrimidin-2-on-1,5-diyl | (Q-8.33) |
| 4-trifluoromethyl-pyrimidin-2-on-1,5-diyl | (Q-8.34) |
| 4-trifluoromethyl-6-methyl-pyrimidin-2-on-1,5-diyl | (Q-8.35) |
| 4,6-di-(trifluoromethyl)-pyrimidin-2-on-1,5-diyl | (Q-8.36) |
| pyrazin-2-on-1,5-diyl | (Q-8.37) |
| 6-methyl-pyrazin-2-on-1,5-diyl | (Q-8.38) |
| 6-trifluoromethyl-pyrazin-2-on-1,5-diyl | (Q-8.39) |
| 3-methyl-pyrazin-2-on-1,5-diyl | (Q-8.40) |
| 3,6-dimethyl-pyrazin-2-on-1,5-diyl | (Q-8.41) |
| 3-methyl-6-trifluoromethyl-pyrazin-2-on-1,5-diyl | (Q-8.42) |
| 3-trifluoromethyl-pyrazin-2-on-1,5-diyl | (Q-8.43) |
| 3-trifluoromethyl-6-methyl-pyrazin-2-on-1,5-diyl | (Q-8.44) |
| 3,6-di-(trifluoromethyl)-pyrazin-2-on-1,5-diyl | (Q-8.45) |
| pyridazin-3-on-2,6-diyl | (Q-8.46) |
| 5-methyl-pyridazin-3-on-2,6-diyl | (Q-8.47) |
| 5-trifluoromethyl-pyridazin-3-on-2,6-diyl | (Q-8.48) |
| 4-methyl-pyridazin-3-on-2,6-diyl | (Q-8.49) |
| 4,5-dimethyl-pyridazin-3-on-2,6-diyl | (Q-8.50) |
| 4-methyl-5-trifluoromethyl-pyridazin-3-on-2,6-diyl | (Q-8.51) |
| 4-trifluoromethyl-pyridazin-3-on-2,6-diyl | (Q-8.52) |
| 4-trifluoromethyl-5-methyl-pyridazin-3-on-2,6-diyl | (Q-8.53) |
| 4,5-di-(trifluoromethyl)-pyridazin-3-on-2,6-diyl | (Q-8.54) |
| [1,2,4]-triazin-3-on-4,6-diyl | (Q-8.55) |
| 6-methyl-[1,2,4]-triazin-3-on-4,6-diyl | (Q-8.56) |
| 6-trifluoromethyl-[1,2,4]-triazin-3-on-4,6-diyl | (Q-8.57) |
| [1,2,4]-triazin-3-on-2,6-diyl | (Q-8.58) |
| 5-methyl-[1,2,4]-triazin-3-on-2,6-diyl | (Q-8.59) |
| 5-trifluoromethyl-[1,2,4]-triazin-3-on-2,6-diyl | (Q-8.60) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-9, as defined herein. According to a particular preferred aspect of this embodiment Q-9 is selected from the radicals of the following formulae:

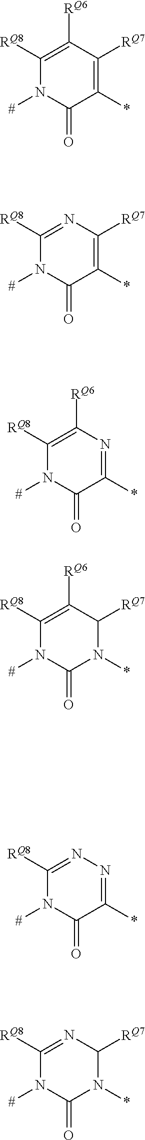

wherein #, *, R^{Q6}, R^{Q7} and R^{Q8} are as defined herein.

Among the compounds of formula I wherein Q is Q-9, preference is given to those compounds, wherein R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-9 are the radicals of formulae Q-9.1 to Q-9.84, as defined in Table Q9. Of the two attachment points identified in the names of radicals Q-9 given in Table Q9 the first number represents the position to which the pyrazole radical is linked and the second number represents the position to which the 6-membered heteroaromatic radical is linked. By way of example, pyridin-2-on-1,3-diyl is bound to the pyrazole radical and the 6-membered heteroaromatic radical via its positions 1 and 3, respectively.

TABLE Q9

| | |
|---|---|
| pyridin-2-on-1,3-diyl | (Q-9.1) |
| 6-methyl-pyridin-2-on-1,3-diyl | (Q-9.2) |
| 6-trifluoromethyl-pyridin-2-on-1,3-diyl | (Q-9.3) |
| 5-methyl-pyridin-2-on-1,3-diyl | (Q-9.4) |
| 5,6-dimethyl-pyridin-2-on-1,3-diyl | (Q-9.5) |
| 5-methyl-6-trifluoromethyl-pyridin-2-on-1,3-diyl | (Q-9.6) |
| 5-trifluoromethyl-pyridin-2-on-1,3-diyl | (Q-9.7) |
| 5-trifluoromethyl-6-methyl-pyridin-2-on-1,3-diyl | (Q-9.8) |
| 5,6-di-(trifluoromethyl)-pyridin-2-on-1,3-diyl | (Q-9.9) |
| 4-methyl-pyridin-2-on-1,3-diyl | (Q-9.10) |
| 4,6-dimethyl-pyridin-2-on-1,3-diyl | (Q-9.11) |
| 4-methyl-6-trifluoromethyl-pyridin-2-on-1,3-diyl | (Q-9.12) |
| 4,5-dimethyl-pyridin-2-on-1,3-diyl | (Q-9.13) |
| 4,5,6-trimethyl-pyridin-2-on-1,3-diyl | (Q-9.14) |
| 4,5-dimethyl-6-trifluoromethyl-pyridin-2-on-1,3-diyl | (Q-9.15) |
| 4-methyl-4-trifluoromethyl-pyridin-2-on-1,3-diyl | (Q-9.16) |
| 4,6-dimethyl-5-trifluoromethyl-pyridin-2-on-1,3-diyl | (Q-9.17) |
| 4-methyl-5,6-di-(trifluoromethyl)-pyridin-2-on-1,3-diyl | (Q-9.18) |
| 4-trifluoromethyl-pyridin-2-on-1,3-diyl | (Q-9.19) |
| 4-trifluoromethyl-6-methyl-pyridin-2-on-1,3-diyl | (Q-9.20) |
| 4,6-di-(trifluoromethyl)-pyridin-2-on-1,3-diyl | (Q-9.21) |
| 4-trifluoromethyl-5-methyl-pyridin-2-on-1,3-diyl | (Q-9.22) |
| 4-trifluoromethyl-5,6-dimethyl-pyridin-2-on-1,3-diyl | (Q-9.23) |
| 4,6-di-(trifluoromethyl)-5-methyl-pyridin-2-on-1,3-diyl | (Q-9.24) |
| 4,5-di-(trifluoromethyl)-pyridin-2-on-1,3-diyl | (Q-9.25) |
| 4,5-di-(trifluoromethyl)-6-methyl-pyridin-2-on-1,3-diyl | (Q-9.26) |
| 4,5,6-tri-(trifluoromethyl)-pyridin-2-on-1,3-diyl | (Q-9.27) |
| pyrimidin-4-on-3,5-diyl | (Q-9.28) |
| 6-methyl-pyrimidin-4-on-3,5-diyl | (Q-9.29) |
| 6-trifluoromethyl-pyrimidin-4-on-3,5-diyl | (Q-9.30) |
| 2-methyl-pyrimidin-4-on-3,5-diyl | (Q-9.31) |
| 2,6-dimethyl-pyrimidin-4-on-3,5-diyl | (Q-9.32) |
| 2-methyl-6-trifluoromethyl-pyrimidin-4-on-3,5-diyl | (Q-9.33) |
| 2-trifluoromethyl-pyrimidin-4-on-3,5-diyl | (Q-9.34) |
| 2-trifluoromethyl-6-methyl-pyrimidin-4-on-3,5-diyl | (Q-9.35) |
| 2,6-di-(trifluoromethyl)-pyrimidin-4-on-3,5-diyl | (Q-9.36) |
| pyrazin-2-on-1,3-diyl | (Q-9.37) |
| 6-methyl-pyrazin-2-on-1,3-diyl | (Q-9.38) |
| 6-trifluoromethyl-pyrazin-2-on-1,3-diyl | (Q-9.39) |
| 5-methyl-pyrazin-2-on-1,3-diyl | (Q-9.40) |
| 5,6-dimethyl-pyrazin-2-on-1,3-diyl | (Q-9.41) |
| 5-methyl-6-trifluoromethyl-pyrazin-2-on-1,3-diyl | (Q-9.42) |
| 5-trifluoromethyl-pyrazin-2-on-1,3-diyl | (Q-9.43) |
| 5-trifluoromethyl-6-methyl-pyrazin-2-on-1,3-diyl | (Q-9.44) |
| 5,6-di-(trifluoromethyl)-pyrazin-2-on-1,3-diyl | (Q-9.45) |
| 3,4-dihydro-pyrimidin-2-on-1,3-diyl | (Q-9.46) |
| 6-methyl-3,4-dihydro-pyrimidin-2-on-1,3-diyl | (Q-9.47) |
| 6-trifluoromethyl-3,4-dihydro-pyrimidin-2-on-1,3-diyl | (Q-9.48) |
| 5-methyl-3,4-dihydro-pyrimidin-2-on-1,3-diyl | (Q-9.49) |
| 5,6-dimethyl-3,4-dihydro-pyrimidin-2-on-1,3-diyl | (Q-9.50) |
| 5-methyl-6-trifluoromethyl-3,4-dihydro-pyrimidin-2-on-1,3-diyl | (Q-9.51) |
| 5-trifluoromethyl-3,4-dihydro-pyrimidin-2-on-1,3-diyl | (Q-9.52) |
| 5-trifluoromethyl-6-methyl-3,4-dihydro-pyrimidin-2-on-1,3-diyl | (Q-9.53) |
| 5,6-di-(trifluoromethyl)-3,4-dihydro-pyrimidin-2-on-1,3-diyl | (Q-9.54) |
| 4-methyl-3,4-dihydro-pyrimidin-2-on-1,3-diyl | (Q-9.55) |
| 4,6-dimethyl-3,4-dihydro-pyrimidin-2-on-1,3-diyl | (Q-9.56) |
| 4-methyl-6-trifluoromethyl-3,4-dihydro-pyrimidin-2-on-1,3-diyl | (Q-9.57) |
| 4,5-dimethyl-3,4-dihydro-pyrimidin-2-on-1,3-diyl | (Q-9.58) |
| 4,5,6-trimethyl-3,4-dihydro-pyrimidin-2-on-1,3-diyl | (Q-9.59) |
| 4,5-dimethyl-6-trifluoromethyl-3,4-dihydro-pyrimidin-2-on-1,3-diyl | (Q-9.60) |
| 4-methyl-5-trifluoromethyl-pyridazin-3,4-dihydro-pyrimidin-2-on-1,3-diyl | (Q-9.61) |
| 4,6-dimethyl-5-trifluoromethyl-3,4-dihydro-pyrimidin-2-on-1,3-diyl | (Q-9.62) |
| 4-methyl-5,6-di-(trifluoromethyl)-3,4-dihydro-pyrimidin-2-on-1,3-diyl | (Q-9.63) |
| 4-trifluoromethyl-3,4-dihydro-pyrimidin-2-on-1,3-diyl | (Q-9.64) |
| 4-trifluoromethyl-6-methyl-3,4-dihydro-pyrimidin-2-on-1,3-diyl | (Q-9.65) |
| 4,6-di-(trifluoromethyl)-3,4-dihydro-pyrimidin-2-on-1,3-diyl | (Q-9.66) |
| 4-trifluoromethyl-5-methyl-3,4-dihydro-pyrimidin-2-on-1,3-diyl | (Q-9.67) |
| 4-trifluoromethyl-5,6-dimethyl-3,4-dihydro-pyrimidin-2-on-1,3-diyl | (Q-9.68) |
| 4,6-di-(trifluoromethyl)-5-methyl-3,4-dihydro-pyrimidin-2-on-1,3-diyl | (Q-9.69) |
| 4,5-di-(trifluoromethyl)-3,4-dihydro-pyrimidin-2-on-1,3-diyl | (Q-9.70) |
| 4,5-di-(trifluoromethyl)-6-methyl-3,4-dihydro-pyrimidin-2-on-1,3-diyl | (Q-9.71) |
| 4,5,6-tri-(trifluoromethyl)-3,4-dihydro-pyrimidin-2-on-1,3-diyl | (Q-9.72) |
| [1,2,4]-triazin-5-on-4,6-diyl | (Q-9.73) |
| 3-methyl-[1,2,4]-triazin-5-on-4,6-diyl | (Q-9.74) |
| 3-trifluoromethyl-[1,2,4]-triazin-5-on-4,6-diyl | (Q-9.75) |
| 3,4-dihydro-[1,3,5]-triazin-2-on-1,3-diyl | (Q-9.76) |
| 6-methyl-3,4-dihydro-[1,3,5]-triazin-2-on-1,3-diyl | (Q-9.77) |
| 6-trifluoromethyl-3,4-dihydro-[1,3,5]-triazin-2-on-1,3-diyl | (Q-9.78) |
| 4-methyl-3,4-dihydro-[1,3,5]-triazin-2-on-1,3-diyl | (Q-9.79) |
| 4,6-dimethyl-3,4-dihydro-[1,3,5]-triazin-2-on-1,3-diyl | (Q-9.80) |
| 4-methyl-6-trifluoromethyl-3,4-dihydro-[1,3,5]-triazin-2-on-1,3-diyl | (Q-9.81) |
| 4-trifluoromethyl-3,4-dihydro-[1,3,5]-triazin-2-on-1,3-diyl | (Q-9.82) |
| 4-trifluoromethyl-6-methyl-3,4-dihydro-[1,3,5]-triazin-2-on-1,3-diyl | (Q-9.83) |
| 4,6-di-(trifluoromethyl)-3,4-dihydro-[1,3,5]-triazin-2-on-1,3-diyl | (Q-9.84) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-10, as defined herein. According to a particular preferred aspect of this embodiment Q-10 is selected from the radicals of the following formulae:

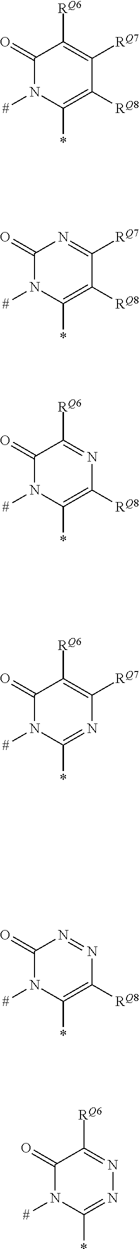

wherein #, *, R^{Q6}, R^{Q7} and R^{Q8} are as defined herein.

Among the compounds of formula I wherein Q is Q-10, preference is given to those compounds, wherein R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-10 are the radicals of formulae Q-10.1 to Q-10.60, as defined in Table Q10. Of the two attachment points identified in the names of radicals Q-10 given in Table Q10 the first number represents the position to which the pyrazole radical is linked and the second number represents the position to which the 6-membered heteroaromatic radical is linked. By way of example, pyridin-2-on-1,6-diyl is bound to the pyrazole radical and the 6-membered heteroaromatic radical via its positions 1 and 6, respectively.

TABLE Q10

| | |
|---|---|
| pyridin-2-on-1,6-diyl | (Q-10.1) |
| 5-methyl-pyridin-2-on-1,6-diyl | (Q-10.2) |
| 5-trifluoromethyl-pyridin-2-on-1,6-diyl | (Q-10.3) |
| 4-methyl-pyridin-2-on-1,6-diyl | (Q-10.4) |
| 4,5-dimethyl-pyridin-2-on-1,6-diyl | (Q-10.5) |
| 4-methyl-5-trifluoromethyl-pyridin-2-on-1,6-diyl | (Q-10.6) |
| 4-trifluoromethyl-pyridin-2-on-1,6-diyl | (Q-10.7) |
| 4-trifluoromethyl-5-methyl-pyridin-2-on-1,6-diyl | (Q-10.8) |
| 4,5-di-(trifluoromethyl)-pyridin-2-on-1,6-diyl | (Q-10.9) |
| 3-methyl-pyridin-2-on-1,6-diyl | (Q-10.10) |
| 3,5-dimethyl-pyridin-2-on-1,6-diyl | (Q-10.11) |
| 3-methyl-5-trifluoromethyl-pyridin-2-on-1,6-diyl | (Q-10.12) |
| 3,4-dimethyl-pyridin-2-on-1,6-diyl | (Q-10.13) |
| 3,4,5-trimethyl-pyridin-2-on-1,6-diyl | (Q-10.14) |
| 3,4-dimethyl-5-trifluoromethyl-pyridin-2-on-1,6-diyl | (Q-10.15) |
| 3-methyl-4-trifluoromethyl-pyridin-2-on-1,6-diyl | (Q-10.16) |
| 3,5-dimethyl-4-trifluoromethyl-pyridin-2-on-1,6-diyl | (Q-10.17) |
| 3-methyl-4,5-di-(trifluoromethyl)-pyridin-2-on-1,6-diyl | (Q-10.18) |
| 3-trifluoromethyl-pyridin-2-on-1,6-diyl | (Q-10.19) |
| 3-trifluoromethyl-5-methyl-pyridin-2-on-1,6-diyl | (Q-10.20) |
| 3,5-di-(trifluoromethyl)-pyridin-2-on-1,6-diyl | (Q-10.21) |
| 3-trifluoromethyl-4-methyl-pyridin-2-on-1,6-diyl | (Q-10.22) |
| 3-trifluoromethyl-4,5-dimethyl-pyridin-2-on-1,6-diyl | (Q-10.23) |
| 3,5-di-(trifluoromethyl)-4-methyl-pyridin-2-on-1,6-diyl | (Q-10.24) |
| 3,4-di-(trifluoromethyl)-pyridin-2-on-1,6-diyl | (Q-10.25) |
| 3,4-di-(trifluoromethyl)-5-methyl-pyridin-2-on-1,6-diyl | (Q-10.26) |
| 3,4,5-tri-(trifluoromethyl)-pyridin-2-on-1,6-diyl | (Q-10.27) |
| pyrimidin-2-on-1,6-diyl | (Q-10.28) |
| 5-methyl-pyrimidin-2-on-1,6-diyl | (Q-10.29) |
| 5-trifluoromethyl-pyrimidin-2-on-1,6-diyl | (Q-10.30) |
| 4-methyl-pyrimidin-2-on-1,6-diyl | (Q-10.31) |
| 4,5-dimethyl-pyrimidin-2-on-1,6-diyl | (Q-10.32) |
| 4-methyl-5-trifluoromethyl-pyrimidin-2-on-1,6-diyl | (Q-10.33) |
| 4-trifluoromethyl-pyrimidin-2-on-1,6-diyl | (Q-10.34) |
| 4-trifluoromethyl-5-methyl-pyrimidin-2-on-1,6-diyl | (Q-10.35) |
| 4,5-di-(trifluoromethyl)-pyrimidin-2-on-1,6-diyl | (Q-10.36) |
| pyrazin-2-on-1,6-diyl | (Q-10.37) |
| 5-methyl-pyrazin-2-on-1,6-diyl | (Q-10.38) |
| 5-trifluoromethyl-pyrazin-2-on-1,6-diyl | (Q-10.39) |
| 3-methyl-pyrazin-2-on-1,6-diyl | (Q-10.40) |
| 3,5-dimethyl-pyrazin-2-on-1,6-diyl | (Q-10.41) |
| 3-methyl-5-trifluoromethyl-pyrazin-2-on-1,6-diyl | (Q-10.42) |
| 3-trifluoromethyl-pyrazin-2-on-1,6-diyl | (Q-10.43) |
| 3-trifluoromethyl-5-methyl-pyrazin-2-on-1,6-diyl | (Q-10.44) |
| 3,5-di-(trifluoromethyl)-pyrazin-2-on-1,6-diyl | (Q-10.45) |
| pyrimidin-4-on-3,2-diyl | (Q-10.46) |
| 6-methyl-pyrimidin-4-on-3,2-diyl | (Q-10.47) |
| 6-trifluoromethyl-pyrimidin-4-on-3,2-diyl | (Q-10.48) |
| 5-methyl-pyrimidin-4-on-3,2-diyl | (Q-10.49) |
| 5,6-dimethyl-pyrimidin-4-on-3,2-diyl | (Q-10.50) |
| 5-methyl-6-trifluoromethyl-pyrimidin-4-on-3,2-diyl | (Q-10.51) |
| 5-trifluoromethyl-pyrimidin-4-on-3,2-diyl | (Q-10.52) |
| 5-trifluoromethyl-6-methyl-pyrimidin-4-on-3,2-diyl | (Q-10.53) |
| 5,6-di-(trifluoromethyl)-pyrimidin-4-on-23,2-diyl | (Q-10.54) |
| [1,2,4]-triazin-3-on-4,5-diyl | (Q-10.55) |
| 6-methyl-[1,2,4]-triazin-3-on-4,5-diyl | (Q-10.56) |
| 6-trifluoromethyl-[1,2,4]-triazin-3-on-4,5-diyl | (Q-10.57) |
| [1,2,4]-triazin-5-on-4,3-diyl | (Q-10.58) |
| 6-methyl-[1,2,4]-triazin-5-on-4,3-diyl | (Q-10.59) |
| 6-trifluoromethyl-[1,2,4]-triazin-5-on-4,3-diyl | (Q-10.60) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-11, as defined herein. According to a particular preferred aspect of this embodiment Q-11 is selected from the radicals of the following formulae:

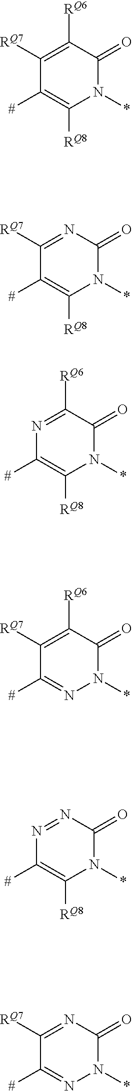

wherein #, *, R^{Q6}, R^{Q7} and R^{Q8} are as defined herein.

Among the compounds of formula I wherein Q is Q-11, preference is given to those compounds, wherein R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-11 are the radicals of formulae Q-11.1 to Q-11.60, as defined in Table Q11. Of the two attachment points identified in the names of radicals Q-11 given in Table Q11 the first number represents the position to which the pyrazole radical is linked and the second number represents the position to which the 6-membered heteroaromatic radical is linked. By way of example, pyridin-2-on-5,1-diyl is bound to the pyrazole radical and the 6-membered heteroaromatic radical via its positions 5 and 1, respectively.

TABLE Q11

| | |
|---|---|
| pyridin-2-on-5,1-diyl | (Q-11.1) |
| 6-methyl-pyridin-2-on-5,1-diyl | (Q-11.2) |
| 6-trifluoromethyl-pyridin-2-on-5,1-diyl | (Q-11.3) |
| 4-methyl-pyridin-2-on-5,1-diyl | (Q-11.4) |
| 4,6-dimethyl-pyridin-2-on-5,1-diyl | (Q-11.5) |
| 4-methyl-6-trifluoromethyl-pyridin-2-on-5,1-diyl | (Q-11.6) |
| 4-trifluoromethyl-pyridin-2-on-5,1-diyl | (Q-11.7) |
| 4-trifluoromethyl-6-methyl-pyridin-2-on-5,1-diyl | (Q-11.8) |
| 4,6-di-(trifluoromethyl)-pyridin-2-on-5,1-diyl | (Q-11.9) |
| 3-methyl-pyridin-2-on-5,1-diyl | (Q-11.10) |
| 3,6-dimethyl-pyridin-2-on-5,1-diyl | (Q-11.11) |
| 3-methyl-6-trifluoromethyl-pyridin-2-on-5,1-diyl | (Q-11.12) |
| 3,4-dimethyl-pyridin-2-on-5,1-diyl | (Q-11.13) |
| 3,4,6-trimethyl-pyridin-2-on-5,1-diyl | (Q-11.14) |
| 3,4-dimethyl-6-trifluoromethyl-pyridin-2-on-5,1-diyl | (Q-11.15) |
| 3-methyl-4-trifluoromethyl-pyridin-2-on-5,1-diyl | (Q-11.16) |
| 3,6-dimethyl-4-trifluoromethyl-pyridin-2-on-5,1-diyl | (Q-11.17) |
| 3-methyl-4,6-di-(trifluoromethyl)-pyridin-2-on-5,1-diyl | (Q-11.18) |
| 3-trifluoromethyl-pyridin-2-on-5,1-diyl | (Q-11.19) |
| 3-trifluoromethyl-6-methyl-pyridin-2-on-5,1-diyl | (Q-11.20) |
| 3,6-di-(trifluoromethyl)-pyridin-2-on-5,1-diyl | (Q-11.21) |
| 3-trifluoromethyl-4-methyl-pyridin-2-on-5,1-diyl | (Q-11.22) |
| 3-trifluoromethyl-4,6-dimethyl-pyridin-2-on-5,1-diyl | (Q-11.23) |
| 3,6-di-(trifluoromethyl)-4-methyl-pyridin-2-on-5,1-diyl | (Q-11.24) |
| 3,4-di-(trifluoromethyl)-pyridin-2-on-5,1-diyl | (Q-11.25) |
| 3,4-di-(trifluoromethyl)-6-methyl-pyridin-2-on-5,1-diyl | (Q-11.26) |
| 3,4,6-tri-(trifluoromethyl)-pyridin-2-on-5,1-diyl | (Q-11.27) |
| pyrimidin-2-on-5,1-diyl | (Q-11.28) |
| 6-methyl-pyrimidin-2-on-5,1-diyl | (Q-11.29) |
| 6-trifluoromethyl-pyrimidin-2-on-5,1-diyl | (Q-11.30) |
| 4-methyl-pyrimidin-2-on-5,1-diyl | (Q-11.31) |
| 4,6-dimethyl-pyrimidin-2-on-5,1-diyl | (Q-11.32) |
| 4-methyl-6-trifluoromethyl-pyrimidin-2-on-5,1-diyl | (Q-11.33) |
| 4-trifluoromethyl-pyrimidin-2-on-5,1-diyl | (Q-11.34) |
| 4-trifluoromethyl-6-methyl-pyrimidin-2-on-5,1-diyl | (Q-11.35) |
| 4,6-di-(trifluoromethyl)-pyrimidin-2-on-5,1-diyl | (Q-11.36) |
| pyrazin-2-on-5,1-diyl | (Q-11.37) |
| 6-methyl-pyrazin-2-on-5,1-diyl | (Q-11.38) |
| 6-trifluoromethyl-pyrazin-2-on-5,1-diyl | (Q-11.39) |
| 3-methyl-pyrazin-2-on-5,1-diyl | (Q-11.40) |
| 3,6-dimethyl-pyrazin-2-on-5,1-diyl | (Q-11.41) |
| 3-methyl-6-trifluoromethyl-pyrazin-2-on-5,1-diyl | (Q-11.42) |
| 3-trifluoromethyl-pyrazin-2-on-5,1-diyl | (Q-11.43) |
| 3-trifluoromethyl-6-methyl-pyrazin-2-on-5,1-diyl | (Q-11.44) |
| 3,6-di-(trifluoromethyl)-pyrazin-2-on-5,1-diyl | (Q-11.45) |
| pyridazin-3-on-6,2-diyl | (Q-11.46) |
| 5-methyl-pyridazin-3-on-6,2-diyl | (Q-11.47) |
| 5-trifluoromethyl-pyridazin-3-on-6,2-diyl | (Q-11.48) |
| 4-methyl-pyridazin-3-on-6,2-diyl | (Q-11.49) |
| 4,5-dimethyl-pyridazin-3-on-6,2-diyl | (Q-11.50) |
| 4-methyl-5-trifluoromethyl-pyridazin-3-on-6,2-diyl | (Q-11.51) |
| 4-trifluoromethyl-pyridazin-3-on-6,2-diyl | (Q-11.52) |
| 4-trifluoromethyl-5-methyl-pyridazin-3-on-6,2-diyl | (Q-11.53) |
| 4,5-di-(trifluoromethyl)-pyridazin-3-on-6,2-diyl | (Q-11.54) |
| [1,2,4]-triazin-3-on-6,4-diyl | (Q-11.55) |
| 6-methyl-[1,2,4]-triazin-3-on-6,4-diyl | (Q-11.56) |
| 6-trifluoromethyl-[1,2,4]-triazin-3-on-6,4-diyl | (Q-11.57) |
| [1,2,4]-triazin-3-on-6,2-diyl | (Q-11.58) |
| 5-methyl-[1,2,4]-triazin-3-on-6,2-diyl | (Q-11.59) |
| 5-trifluoromethyl-[1,2,4]-triazin-3-on-6,2-diyl | (Q-11.60) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-12, as defined herein. According to a particular preferred aspect of this embodiment Q-12 is selected from the radicals of the following formulae:

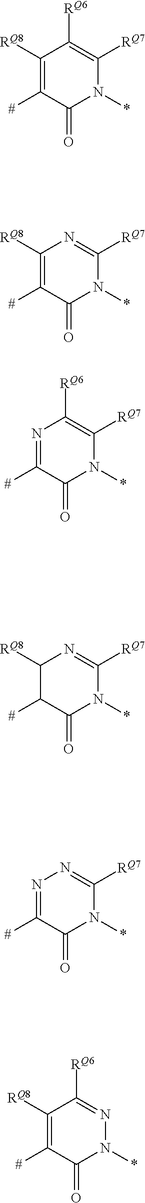

wherein #, *, R^{Q6}, R^{Q7} and R^{Q8} are as defined herein.

Among the compounds of formula I wherein Q is Q-12, preference is given to those compounds, wherein R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-12 are the radicals of formulae Q-12.1 to Q-12.66, as defined in Table Q12. Of the two attachment points identified in the names of radicals Q-12 given in Table Q12 the first number represents the position to which the pyrazole radical is linked and the second number represents the position to which the 6-membered heteroaromatic radical is linked. By way of example, pyridin-2-on-3,1-diyl is bound to the pyrazole radical and the 6-membered heteroaromatic radical via its positions 3 and 1, respectively.

TABLE Q12

| | |
|---|---|
| pyridin-2-on-3,1-diyl | (Q-12.1) |
| 6-methyl-pyridin-2-on-3,1-diyl | (Q-12.2) |
| 6-trifluoromethyl-pyridin-2-on-3,1-diyl | (Q-12.3) |
| 5-methyl-pyridin-2-on-3,1-diyl | (Q-12.4) |
| 5,6-dimethyl-pyridin-2-on-3,1-diyl | (Q-12.5) |
| 5-methyl-6-trifluoromethyl-pyridin-2-on-3,1-diyl | (Q-12.6) |
| 5-trifluoromethyl-pyridin-2-on-3,1-diyl | (Q-12.7) |
| 5-trifluoromethyl-6-methyl-pyridin-2-on-3,1-diyl | (Q-12.8) |
| 5,6-di-(trifluoromethyl)-pyridin-2-on-3,1-diyl | (Q-12.9) |
| 4-methyl-pyridin-2-on-3,1-diyl | (Q-12.10) |
| 4,6-dimethyl-pyridin-2-on-3,1-diyl | (Q-12.11) |
| 4-methyl-6-trifluoromethyl-pyridin-2-on-3,1-diyl | (Q-12.12) |
| 4,5-dimethyl-pyridin-2-on-3,1-diyl | (Q-12.13) |
| 4,5,6-trimethyl-pyridin-2-on-3,1-diyl | (Q-12.14) |
| 4,5-dimethyl-6-trifluoromethyl-pyridin-2-on-3,1-diyl | (Q-12.15) |
| 4-methyl-4-trifluoromethyl-pyridin-2-on-3,1-diyl | (Q-12.16) |
| 4,6-dimethyl-5-trifluoromethyl-pyridin-2-on-3,1-diyl | (Q-12.17) |
| 4-methyl-5,6-di-(trifluoromethyl)-pyridin-2-on-3,1-diyl | (Q-12.18) |
| 4-trifluoromethyl-pyridin-2-on-3,1-diyl | (Q-12.19) |
| 4-trifluoromethyl-6-methyl-pyridin-2-on-3,1-diyl | (Q-12.20) |
| 4,6-di-(trifluoromethyl)-pyridin-2-on-3,1-diyl | (Q-12.21) |
| 4-trifluoromethyl-5-methyl-pyridin-2-on-3,1-diyl | (Q-12.22) |
| 4-trifluoromethyl-5,6-dimethyl-pyridin-2-on-3,1-diyl | (Q-12.23) |
| 4,6-di-(trifluoromethyl)-5-methyl-pyridin-2-on-3,1-diyl | (Q-12.24) |
| 4,5-di-(trifluoromethyl)-pyriclin-2-on-3,1-diyl | (Q-12.25) |
| 4,5-di-(trifluoromethyl)-6-methyl-pyridin-2-on-3,1-diyl | (Q-12.26) |
| 4,5,6-tri-(trifluoromethyl)-pyridin-2-on-3,1-diyl | (Q-12.27) |
| pyrimidin-4-on-5,3-diyl | (Q-12.28) |
| 6-methyl-pyrimidin-4-on-5,3-diyl | (Q-12.29) |
| 6-trifluoromethyl-pyrimidin-4-on-5,3-diyl | (Q-12.30) |
| 2-methyl-pyrimidin-4-on-5,3-diyl | (Q-12.31) |
| 2,6-dimethyl-pyrimidin-4-on-5,3-diyl | (Q-12.32) |
| 2-methyl-6-trifluoromethyl-pyrimidin-4-on-5,3-diyl | (Q-12.33) |
| 2-trifluoromethyl-pyrimidin-4-on-5,3-diyl | (Q-12.34) |
| 2-trifluoromethyl-6-methyl-pyrimidin-4-on-5,3-diyl | (Q-12.35) |
| 2,6-di-(trifluoromethyl)-pyrimidin-4-on-5,3-diyl | (Q-12.36) |
| pyrazin-2-on-3,1-diyl | (Q-12.37) |
| 6-methyl-pyrazin-2-on-3,1-diyl | (Q-12.38) |
| 6-trifluoromethyl-pyrazin-2-on-3,1-diyl | (Q-12.39) |
| 5-methyl-pyrazin-2-on-3,1-diyl | (Q-12.40) |
| 5,6-dimethyl-pyrazin-2-on-3,1-diyl | (Q-12.41) |
| 5-methyl-6-trifluoromethyl-pyrazin-2-on-3,1-diyl | (Q-12.42) |
| 5-trifluoromethyl-pyrazin-2-on-3,1-diyl | (Q-12.43) |
| 5-trifluoromethyl-6-methyl-pyrazin-2-on-3,1-diyl | (Q-12.44) |
| 5,6-di-(trifluoromethyl)-pyrazin-2-on-3,1-diyl | (Q-12.45) |
| 5,6-dihydro-pyrimidin-4-on-5,3-diyl | (Q-12.46) |
| 6-methyl-5,6-dihydro-pyrimidin-4-on-5,3-diyl | (Q-12.47) |
| 6-trifluoromethyl-5,6-dihydro-pyrimidin-4-on-5,3-diyl | (Q-12.48) |
| 5-methyl-5,6-dihydro-pyrimidin-4-on-5,3-diyl | (Q-12.49) |
| 2,6-dimethyl-5,6-dihydro-pyrimidin-4-on-5,3-diyl | (Q-12.50) |
| 2-methyl-6-trifluoromethyl-5,6-dihydro-pyrimidin-4-on-5,3-diyl | (Q-12.51) |
| 2-trifluoromethyl-5,6-dihydro-pyrimidin-4-on-5,3-diyl | (Q-12.52) |
| 2-trifluoromethyl-6-methyl-5,6-dihydro-pyrimidin-4-on-5,3-diyl | (Q-12.53) |
| 2,6-di-(trifluoromethyl)-5,6-dihydro-pyrimidin-4-on-5,3-diyl | (Q-12.54) |
| [1,2,4]-triazin-5-on-6,4-diyl | (Q-12.55) |
| 3-methyl-[1,2,4]-triazin-5-on-6,4-diyl | (Q-12.56) |
| 3-trifluoromethyl-[1,2,4]-triazin-5-on-6,4-diyl | (Q-12.57) |
| pyridazin-3-on-4,2-diyl | (Q-12.58) |
| 6-methyl-pyridazin-3-on-4,2-diyl | (Q-12.59) |
| 6-trifluoromethyl-pyridazin-3-on-4,2-diyl | (Q-12.60) |
| 5-methyl-pyridazin-3-on-4,2-diyl | (Q-12.61) |
| 5,6-dimethyl-pyridazin-3-on-4,2-diyl | (Q-12.62) |
| 5-methyl-6-trifluoromethyl-pyridazin-3-on-4,2-diyl | (Q-12.63) |
| 5-trifluoromethyl-pyridazin-3-on-4,2-diyl | (Q-12.64) |
| 5-trifluoromethyl-6-methyl-pyridazin-3-on-4,2-diyl | (Q-12.65) |
| 5,6-di-(trifluoromethyl-pyridazin-3-on-4,2-diyl | (Q-12.66) |

Another preferred embodiment of the invention relates to compounds, methods and uses, where in formula I the variables R^{N}, R^{A}, n, R^{t}, R^{u}, X, Y and Z are as defined above and in particular have one of the preferred meanings and wherein Q is a radical Q-13, as defined herein. According to a particular preferred aspect of this embodiment Q-13 is selected from the radicals of the following formulae:

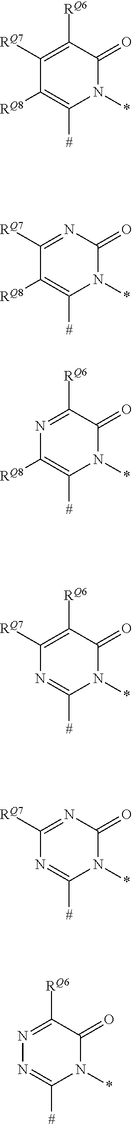

wherein #, *, R^{Q6}, R^{Q7} and R^{Q8} are as defined herein.

Among the compounds of formula I wherein Q is Q-13, preference is given to those compounds, wherein R^{Q6}, R^{Q7} and R^{Q8} independently from each other are selected from the group consisting of hydrogen, halogen, CN, C₁-C₄-alkyl, C₁-C₄-haloalkyl, C₁-C₄-alkoxy and C₁-C₄-haloalkoxy, more preferably from the group consisting of hydrogen, halogen, CN, C₁-C₃-alkyl and C₁-C₂-haloalkyl.

In particular, R^{Q6}, R^{Q7} and R^{Q8} independently from each other are selected from hydrogen, chlorine, bromine, fluorine, CN, methyl, ethyl, n-propyl, isopropyl, fluoromethyl, difluoromethyl, trifluoromethyl, 1-fluoroeth-1-yl, 2-fluoroeth-1-yl, 2,2-difluoroeth-1-yl, 2,2,2-trifluoroeth-1-yl, 1,2-difluoroeth-1-yl, 1,2,2-trifluoroeth-1-yl and 1,2,2,2-tetrafluoroeth-1-yl, especially from methyl, fluoromethyl, difluoromethyl, trifluoromethyl and 2,2,2-trifluoroeth-1-yl, and specifically from methyl and trifluoromethyl.

Examples of suitable radicals Q-13 are the radicals of formulae Q-13.1 to Q-13.60, as defined in Table Q13. Of the two attachment points identified in the names of radicals Q-13 given in Table Q13 the first number represents the position to which the pyrazole radical is linked and the second number represents the position to which the 6-membered heteroaromatic radical is linked. By way of example, pyridin-2-on-6,1-diyl is bound to the pyrazole radical and the 6-membered heteroaromatic radical via its positions 6 and 1, respectively.

TABLE Q13

| | |
|---|---|
| pyridin-2-on-6,1-diyl | (Q-13.1) |
| 5-methyl-pyridin-2-on-6,1-diyl | (Q-13.2) |
| 5-trifluoromethyl-pyridin-2-on-6,1-diyl | (Q-13.3) |
| 4-methyl-pyridin-2-on-6,1-diyl | (Q-13.4) |
| 4,5-dimethyl-pyridin-2-on-6,1-diyl | (Q-13.5) |
| 4-methyl-5-trifluoromethyl-pyridin-2-on-6,1-diyl | (Q-13.6) |
| 4-trifluoromethyl-pyridin-2-on-6,1-diyl | (Q-13.7) |
| 4-trifluoromethyl-5-methyl-pyridin-2-on-6,1-diyl | (Q-13.8) |
| 4,5-di-(trifluoromethyl)-pyridin-2-on-6,1-diyl | (Q-13.9) |
| 3-methyl-pyridin-2-on-6,1-diyl | (Q-13.10) |
| 3,5-dimethyl-pyridin-2-on-6,1-diyl | (Q-13.11) |
| 3-methyl-5-trifluoromethyl-pyridin-2-on-6,1-diyl | (Q-13.12) |
| 3,4-dimethyl-pyridin-2-on-6,1-diyl | (Q-13.13) |
| 3,4,5-trimethyl-pyridin-2-on-6,1-diyl | (Q-13.14) |
| 3,4-dimethyl-5-trifluoromethyl-pyridin-2-on-6,1-diyl | (Q-13.15) |
| 3-methyl-4-trifluoromethyl-pyridin-2-on-6,1-diyl | (Q-13.16) |
| 3,5-dimethyl-4-trifluoromethyl-pyridin-2-on-6,1-diyl | (Q-13.17) |
| 3-methyl-4,5-di-(trifluoromethyl)-pyridin-2-on-6,1-diyl | (Q-13.18) |
| 3-trifluoromethyl-pyridin-2-on-6,1-diyl | (Q-13.19) |
| 3-trifluoromethyl-5-methyl-pyridin-2-on-6,1-diyl | (Q-13.20) |
| 3,5-di-(trifluoromethyl)-pyridin-2-on-6,1-diyl | (Q-13.21) |
| 3-trifluoromethyl-4-methyl-pyridin-2-on-6,1-diyl | (Q-13.22) |
| 3-trifluoromethyl-4,5-dimethyl-pyridin-2-on-6,1-diyl | (Q-13.23) |
| 3,5-di-(trifluoromethyl)-4-methyl-pyridin-2-on-6,1-diyl | (Q-13.24) |
| 3,4-di-(trifluoromethyl)-pyridin-2-on-6,1-diyl | (Q-13.25) |
| 3,4-di-(trifluoromethyl)-5-methyl-pyridin-2-on-6,1-diyl | (Q-13.26) |
| 3,4,5-tri-(trifluoromethyl)-pyridin-2-on-6,1-diyl | (Q-13.27) |
| pyrimidin-2-on-6,1-diyl | (Q-13.28) |
| 5-methyl-pyrimidin-2-on-6,1-diyl | (Q-13.29) |
| 5-trifluoromethyl-pyrimidin-2-on-6,1-diyl | (Q-13.30) |
| 4-methyl-pyrimidin-2-on-6,1-diyl | (Q-13.31) |
| 4,5-dimethyl-pyrimidin-2-on-6,1-diyl | (Q-13.32) |
| 4-methyl-5-trifluoromethyl-pyrimidin-2-on-6,1-diyl | (Q-13.33) |
| 4-trifluoromethyl-pyrimidin-2-on-6,1-diyl | (Q-13.34) |
| 4-trifluoromethyl-5-methyl-pyrimidin-2-on-6,1-diyl | (Q-13.35) |
| 4,5-di-(trifluoromethyl)-pyrimidin-2-on-6,1-diyl | (Q-13.36) |
| pyrazin-2-on-6,1-diyl | (Q-13.37) |
| 5-methyl-pyrazin-2-on-6,1-diyl | (Q-13.38) |
| 5-trifluoromethyl-pyrazin-2-on-6,1-diyl | (Q-13.39) |
| 3-methyl-pyrazin-2-on-6,1-diyl | (Q-13.40) |
| 3,5-dimethyl-pyrazin-2-on-6,1-diyl | (Q-13.41) |
| 3-methyl-5-trifluoromethyl-pyrazin-2-on-6,1-diyl | (Q-13.42) |
| 3-trifluoromethyl-pyrazin-2-on-6,1-diyl | (Q-13.43) |
| 3-trifluoromethyl-5-methyl-pyrazin-2-on-6,1-diyl | (Q-13.44) |
| 3,5-di-(trifluoromethyl)-pyrazin-2-on-6,1-diyl | (Q-13.45) |
| pyrimidin-4-on-2,3-diyl | (Q-13.46) |
| 6-methyl-pyrimidin-4-on-2,3-diyl | (Q-13.47) |
| 6-trifluoromethyl-pyrimidin-4-on-2,3-diyl | (Q-13.48) |
| 5-methyl-pyrimidin-4-on-2,3-diyl | (Q-13.49) |
| 5,6-dimethyl-pyrimidin-4-on-2,3-diyl | (Q-13.50) |
| 5-methyl-6-trifluoromethyl-pyrimidin-4-on-2,3-diyl | (Q-13.51) |
| 5-trifluoromethyl-pyrimidin-4-on-2,3-diyl | (Q-13.52) |
| 5-trifluoromethyl-6-methyl-pyrimidin-4-on-2,3-diyl | (Q-13.53) |
| 5,6-di-(trifluoromethyl)-pyrimidin-4-on-2,3-diyl | (Q-13.54) |
| [1,3,5]-triazin-2-on-6,1-diyl | (Q-13.55) |
| 6-methyl-[1,3,5]-triazin-2-on-6,1-diyl | (Q-13.56) |
| 6-trifluoromethyl-[1,3,5]-triazin-2-on-6,1-diyl | (Q-13.57) |
| [1,2,4]-triazin-5-on-3,4-diyl | (Q-13.58) |
| 6-methyl-[1,2,4]-triazin-5-on-3,4-diyl | (Q-13.59) |
| 6-trifluoromethyl-[1,2,4]-triazin-5-on-3,4-diyl | (Q-13.60) |

Apart from that, the variables V, R^{a}, R^{b}, R^{c}, R^{d}, R^{e}, R^{f}, R^{g}, R^{h}, Rⁱ, R^{x} and R^{y}, independently of each other, preferably have one of the following meanings:
V is O;
R^{a} hydrogen, C₁-C₄-alkyl or C₁-C₄-haloalkyl;
R^{b} C₁-C₄-alkyl, C₁-C₄-haloalkyl, C₃-C₆-cycloalkyl or C₃-C₆-cycloalkylmethyl;
R^{c} hydrogen, C₁-C₄-alkyl, C₃-C₆-cycloalkyl or C₃-C₆-cycloalkylmethyl;
R^{d} C₁-C₄-alkyl or C₁-C₄-haloalkyl;
R^{e} hydrogen or C₁-C₄-alkyl;
R^{f} hydrogen, C₁-C₄-alkyl, C₁-C₄-haloalkyl, benzyl, C₃-C₆-cycloalkyl or C₃-C₆-cycloalkylmethyl;
R^{g} hydrogen or C₁-C₄-alkyl;
R^{h} hydrogen, C₁-C₄-alkyl, C₁-C₄-haloalkyl, benzyl or C₃-C₆-cycloalkyl;
Rᵢ hydrogen or C₁-C₄-alkyl;
R^{x} cyano, nitro, C₁-C₄-alkoxy, C₁-C₄-haloalkoxy, C₁-C₄-alkylthio, C₁-C₄-haloalkylthio, C₁-C₄-alkylsulfonyl or C₁-C₄-haloalkylsulfonyl.
R^{y} halogen, cyano, nitro, C₁-C₄-alkyl, C₁-C₄-haloalkyl, C₁-C₄-alkoxy, C₁-C₄-haloalkoxy, C₁-C₄-alkylsulfonyl or C₁-C₄-haloalkylsulfonyl.

A very preferred embodiment of the invention relates to compounds, methods and uses, where in formula I the radical Q is linked to position 4 of the pyrazole moiety and the radical R^{A}, if present, is linked either to position 3 or 5 of the pyrazole moiety. These compounds are hereinafter also referred to as compounds Ia.

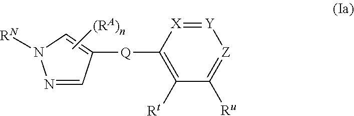

In formula Ia, n is 0 or 1, and R^{N}, R^{A}, R^{t}, R^{u}, Q, X, Y and Z are as defined herein.

Among the compounds of the formula Ia, preference is given to those wherein at least one of the radicals R^{N}, R^{A}, R^{t} and R^{u}, preferably at least two of the radicals R^{N}, R^{A}, R^{t} and R^{u}, more preferably at least three of the radicals R^{N}, R^{A}, R^{t} and R^{u}, and specifically all of the radicals R^{N}, R^{A}, R^{t} and R^{u} have one of the preferred meanings.

Among compounds of the formula Ia, preference is further given to those wherein Q is a radical selected from the radicals Q-1, Q-2, Q-3, Q-4, Q-5, Q-6, Q-7, Q-8, Q-9, Q-10, Q-11, Q-12 and Q-13, and particularly selected from the radicals Q-1.1 to Q-1.121, Q-2.1 to Q-2.121, Q-3.1 to Q-3.137, Q-4.1 to Q-4.127, Q-5.1 to Q-5.227, Q-6.1 to Q-6.144, Q-7.1 to Q-7.144, Q-8.1 to Q-8.60, Q-9.1 to Q-9.84, Q-10.1 to Q-10.60, Q-11.1 to Q-11.60, Q-12.1 to Q-12.66 and Q-13.1 to Q-13.60. Among the compounds of the formula Ia, particular preference is given to those wherein Q is a radical selected from the radicals Q-1, Q-2, Q-3 and Q-5, and particularly selected from the radicals Q-1.1 to Q-1.121, Q-2.1 to Q-2.121, Q-3.1 to Q-3.137 and Q-5.1 to Q-5.227. Among the compounds of the formula Ia particular preference is further given to those compounds, wherein Q is a radical selected from the radicals Q-6 and Q-7, and particularly selected from the radicals Q-6.1 to Q-6.144 and Q-7.1 to Q-7.144.

Among the compounds of the formula Ia, preference is further given to those wherein the radicals R^{N}, R^{A}, R^{t} and R^{u} have one of the preferred meanings and in particular have one of the following meanings:
R^{N} is hydrogen, C₁-C₆-alkyl, C₁-C₆-haloalkyl, C₃-C₁₀-cycloalkyl, C₃-C₆-cycloalkyl-C₁-C₄-alkyl, where the cycloalkyl moiety in the last two mentioned radicals is unsubstituted or carries 1 or 2 radicals selected from halogen, CN and C₁-C₂-haloalkyl, heterocyclyl-C₁-C₄-alkyl, C₁-C₄-alkoxy-C₁-C₄-alkyl or C₁-C₄-alkylene-CN; in particular is hydrogen, C₁-C₄-alkyl, C₁-C₄-haloalkyl, C₁-C₂-alkoxy-C₂-C₄-alkyl, C₁-C₄-alkylene-CN, C₃-C₆-cycloalkyl or C₃-C₆-cycloalkyl-C₁-C₄-alkyl, where the cycloalkyl moiety is in the last two mentioned radicals is unsubstituted or carries 1 or 2 radicals selected from halogen, CN and C₁-C₂-haloalkyl; specifically is C₁-C₃-alkyl, C₁-C₂-haloalkyl, C₁-C₂-alkoxy-C₁-C₂-alkyl or C₁-C₂-alkylene-CN; most preferably is methyl, ethyl, 2-fluoroeth-1-yl, 2,2,2-trifluoroeth-1-yl, methoxymethyl or ethoxymethyl;
R^{A} is selected, if present, from halogen, CN, NO₂, C₁-C₄-alkyl, C₁-C₄-haloalkyl, C₃-C₆-cycloalkyl and C₃-C₆-halocycloalkyl; in particular is selected, if present, from halogen, NO₂, C₁-C₃-alkyl, C₁-C₃-haloalkyl, C₅-C₆-cycloalkyl and C₅-C₆-halocycloalkyl; specifically, if present, is selected from C₁-C₃-alkyl and C₁-C₂-haloalkyl; most preferably, if present, is selected from methyl, ethyl, fluoromethyl, difluoromethyl and trifluoromethyl; and
R^{t} and R^{u} are selected independently of each other from hydrogen, fluorine, chlorine, bromine, methyl, difluoromethyl, trifluoromethyl, methoxy, difluoromethoxy and trifluoromethoxy; in particular from hydrogen, methyl, chlorine, difluoromethyl and trifluoromethyl; most preferably R^{t} and R^{u} are both hydrogen.

A particularly preferred embodiment of the invention relates to compounds Ia that are selected from compounds of the formula Ia.1, their salts, their N-oxides and the salts of their N-oxides, and also to methods and uses comprising these compounds,

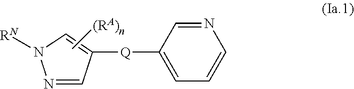

wherein each of the variables n, R^{A}, Q and R^{N} have one of the meanings defined herein and in particular have one of the meanings given for formula Ia.

A further particularly preferred embodiment of the invention relates to compounds Ia that are selected from compounds of the formula Ia.2, their salts, their N-oxides and the salts of their N-oxides, and also to methods and uses comprising these compounds,

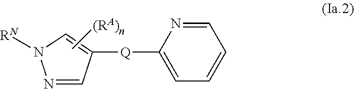

wherein each of the variables n, R^{A}, Q and R^{N} have one of the meanings defined herein and in particular have one of the meanings given for formula Ia.

A further particularly preferred embodiment of the invention relates to compounds Ia that are selected from compounds of the formula Ia.3, their salts, their N-oxides and the salts of their N-oxides, and also to methods and uses comprising these compounds,

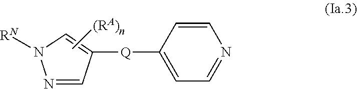

wherein each of the variables n, R^{A}, Q and R^{N} have one of the meanings defined herein and in particular have one of the meanings given for formula Ia.

A further particularly preferred embodiment of the invention relates to compounds Ia that are selected from compounds of the formula Ia.1, their salts, their N-oxides and the salts of their N-oxides, and also to methods and uses comprising these compounds,

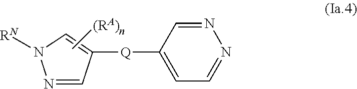

wherein each of the variables n, R^{A}, Q and R^{N} have one of the meanings defined herein and in particular have one of the meanings given for formula Ia.

Examples for compounds of the formulae Ia.1, Ia.2, Ia.3 and Ia.4 that are suitable in the methods and uses of the present invention are the compounds given in the following tables 1 to 156 and also the salts and N-oxides of these compounds. Tables 1 to 156 themselves represent particular embodiments of the compounds Ia according to the invention with regard to the radicals R^{N}, R^{A}, R^{t}, R^{u}, Q, X, Y and Z.
Table 1: Compounds, methods and uses, where in formula Ia.1 R^{N} is 2,2,2-trifluoroeth-1-yl, R^{A} is methyl in position 5 of the pyrazole moiety and Q is a radical Q-1 which has one of the meanings given in Table Q1.
Table 2: Compounds, methods and uses, where in formula Ia.1 R^{N} is 2,2,2-trifluoroeth-1-yl, R^{A} is difluoromethyl in position 5 of the pyrazole moiety and Q is a radical Q-1 which has one of the meanings given in Table Q1.
Table 3: Compounds, methods and uses, where in formula Ia.1 R^{N} is methyl, R^{A} is trifluoromethyl in position 3 of the pyrazole moiety and Q is a radical Q-1 which has one of the meanings given in Table Q1.
Table 4: Compounds, methods and uses, where in formula Ia.1 R^{N} is 2,2,2-trifluoroeth-1-yl, R^{A} is methyl in position 5 of the pyrazole moiety and Q is a radical Q-2 which has one of the meanings given in Table Q2.
Table 5: Compounds, methods and uses, where in formula Ia.1 R^{N} is 2,2,2-trifluoroeth-1-yl, R^{A} is difluoromethyl in position 5 of the pyrazole moiety and Q is a radical Q-2 which has one of the meanings given in Table Q2.
Table 6: Compounds, methods and uses, where in formula Ia.1 R^{N} is methyl, R^{A} is trifluoromethyl in position 3 of the pyrazole moiety and Q is a radical Q-2 which has one of the meanings given in Table Q2.
Table 7: Compounds, methods and uses, where in formula Ia.1 R^{N} is 2,2,2-trifluoroeth-1-yl, R^{A} is methyl in position 5 of the pyrazole moiety and Q is a radical Q-3 which has one of the meanings given in Table Q3.
Table 8: Compounds, methods and uses, where in formula Ia.1 R^{N} is 2,2,2-trifluoroeth-1-yl, R^{A} is difluoromethyl in position 5 of the pyrazole moiety and Q is a radical Q-3 which has one of the meanings given in Table Q3.
Table 9: Compounds, methods and uses, where in formula Ia.1 R^{N} is methyl, R^{A} is trifluoromethyl in position 3 of the pyrazole moiety and Q is a radical Q-3 which has one of the meanings given in Table Q3.
Table 10: Compounds, methods and uses, where in formula Ia.1 R^{N} is 2,2,2-trifluoroeth-1-yl, R^{A} is methyl in position 5 of the pyrazole moiety and Q is a radical Q-4 which has one of the meanings given in Table Q4.
Table 11: Compounds, methods and uses, where in formula Ia.1 R^{N} is 2,2,2-trifluoroeth-1-yl, R^{A} is difluoromethyl in position 5 of the pyrazole moiety and Q is a radical Q-4 which has one of the meanings given in Table Q4.
Table 12: Compounds, methods and uses, where in formula Ia.1 R^{N} is methyl, R^{A} is trifluoromethyl in position 3 of the pyrazole moiety and Q is a radical Q-4 which has one of the meanings given in Table Q4.
Table 13: Compounds, methods and uses, where in formula Ia.1 R^{N} is 2,2,2-trifluoroeth-1-yl, R^{A} is methyl in position 5 of the pyrazole moiety and Q is a radical Q-5 which has one of the meanings given in Table Q5.
Table 14: Compounds, methods and uses, where in formula Ia.1 R^{N} is 2,2,2-trifluoroeth-1-yl, R^{A} is difluoromethyl in position 5 of the pyrazole moiety and Q is a radical Q-5 which has one of the meanings given in Table Q5.
Table 15: Compounds, methods and uses, where in formula Ia.1 R^{N} is methyl, R^{A} is trifluoromethyl in position 3 of the pyrazole moiety and Q is a radical Q-5 which has one of the meanings given in Table Q5.
Table 16: Compounds, methods and uses, where in formula Ia.1 R^{N} is 2,2,2-trifluoroeth-1-yl, R^{A} is methyl in position 5 of the pyrazole moiety and Q is a radical Q-6 which has one of the meanings given in Table Q6.
Table 17: Compounds, methods and uses, where in formula Ia.1 R^{N} is 2,2,2-trifluoroeth-1-yl, R^{A} is difluoromethyl in position 5 of the pyrazole moiety and Q is a radical Q-6 which has one of the meanings given in Table Q6.
Table 18: Compounds, methods and uses, where in formula Ia.1 R^{N} is methyl, R^{A} is trifluoromethyl in position 3 of the pyrazole moiety and Q is a radical Q-6 which has one of the meanings given in Table Q6.
Table 19: Compounds, methods and uses, where in formula Ia.1 R^{N} is 2,2,2-trifluoroeth-1-yl, R^{A} is methyl in position 5 of the pyrazole moiety and Q is a radical Q-7 which has one of the meanings given in Table Q7.
Table 20: Compounds, methods and uses, where in formula Ia.1 R^{N} is 2,2,2-trifluoroeth-1-yl, R^{A} is difluoromethyl in position 5 of the pyrazole moiety and Q is a radical Q-7 which has one of the meanings given in Table Q7.
Table 21: Compounds, methods and uses, where in formula Ia.1 R^{N} is methyl, R^{A} is trifluoromethyl in position 3 of the pyrazole moiety and Q is a radical Q-7 which has one of the meanings given in Table Q7.
Table 22: Compounds, methods and uses, where in formula Ia.1 R^{N} is 2,2,2-trifluoroeth-1-yl, R^{A} is methyl in position 5 of the pyrazole moiety and Q is a radical Q-8 which has one of the meanings given in Table Q8.
Table 23: Compounds, methods and uses, where in formula Ia.1 R^{N} is 2,2,2-trifluoroeth-1-yl, R^{A} is difluoromethyl in position 5 of the pyrazole moiety and Q is a radical Q-8 which has one of the meanings given in Table Q8.
Table 24: Compounds, methods and uses, where in formula Ia.1 R^{N} is methyl, R^{A} is trifluoromethyl in position 3 of the pyrazole moiety and Q is a radical Q-8 which has one of the meanings given in Table Q8.
Table 25: Compounds, methods and uses, where in formula Ia.1 R^{N} is 2,2,2-trifluoroeth-1-yl, R^{A} is methyl in position 5 of the pyrazole moiety and Q is a radical Q-9 which has one of the meanings given in Table Q9.
Table 26: Compounds, methods and uses, where in formula Ia.1 R^{N} is 2,2,2-trifluoroeth-1-yl, R^{A} is difluoromethyl in position 5 of the pyrazole moiety and Q is a radical Q-9 which has one of the meanings given in Table Q9.
Table 27: Compounds, methods and uses, where in formula Ia.1 R^{N} is methyl, R^{A} is trifluoromethyl in position 3 of the pyrazole moiety and Q is a radical Q-9 which has one of the meanings given in Table Q9.
Table 28: Compounds, methods and uses, where in formula Ia.1 R^{N} is 2,2,2-trifluoroeth-1-yl, R^{A} is methyl in position 5 of the pyrazole moiety and Q is a radical Q-10 which has one of the meanings given in Table Q10.
Table 29: Compounds, methods and uses, where in formula Ia.1 R^{N} is 2,2,2-trifluoroeth-1-yl, R^{A} is difluoromethyl in position 5 of the pyrazole moiety and Q is a radical Q-10 which has one of the meanings given in Table Q10.
Table 30: Compounds, methods and uses, where in formula Ia.1 R^{N} is methyl, R^{A} is trifluoromethyl in position 3 of the pyrazole moiety and Q is a radical Q-10 which has one of the meanings given in Table Q10.
Table 31: Compounds, methods and uses, where in formula Ia.1 R^{N} is 2,2,2-trifluoroeth-1-yl, R^{A} is methyl in position 5 of the pyrazole moiety and Q is a radical Q-11 which has one of the meanings given in Table Q11.
Table 32: Compounds, methods and uses, where in formula Ia.1 R^{N} is 2,2,2-trifluoroeth-1-yl, R^{A} is difluoromethyl in position 5 of the pyrazole moiety and Q is a radical Q-11 which has one of the meanings given in Table Q11.
Table 33: Compounds, methods and uses, where in formula Ia.1 R^{N} is methyl, R^{A} is trifluoromethyl in position 3 of the pyrazole moiety and Q is a radical Q-11 which has one of the meanings given in Table Q11.
Table 34: Compounds, methods and uses, where in formula Ia.1 R^{N} is 2,2,2-trifluoroeth-1-yl, R^{A} is methyl in position 5 of the pyrazole moiety and Q is a radical Q-12 which has one of the meanings given in Table Q12.
Table 35: Compounds, methods and uses, where in formula Ia.1 R^{N} is 2,2,2-trifluoroeth-1-yl, R^{A} is difluoromethyl in position 5 of the pyrazole moiety and Q is a radical Q-12 which has one of the meanings given in Table Q12.
Table 36: Compounds, methods and uses, where in formula Ia.1 R^{N} is methyl, R^{A} is trifluoromethyl in position 3 of the pyrazole moiety and Q is a radical Q-12 which has one of the meanings given in Table Q12.
Table 37: Compounds, methods and uses, where in formula Ia.1 R^{N} is 2,2,2-trifluoroeth-1-yl, R^{A} is methyl in position 5 of the pyrazole moiety and Q is a radical Q-13 which has one of the meanings given in Table Q13.
Table 38: Compounds, methods and uses, where in formula Ia.1 R^{N} is 2,2,2-trifluoroeth-1-yl, R^{A} is difluoromethyl in position 5 of the pyrazole moiety and Q is a radical Q-13 which has one of the meanings given in Table Q13.
Table 39: Compounds, methods and uses, where in formula Ia.1 R^{N} is methyl, R^{A} is trifluoromethyl in position 3 of the pyrazole moiety and Q is a radical Q-13 which has one of the meanings given in Table Q13.
Table 40: Compounds, methods and uses, where in formula Ia.2 R^{N} is 2,2,2-trifluoroeth-1-yl, R^{A} is methyl in position 5 of the pyrazole moiety and Q is a radical Q-1 which has one of the meanings given in Table Q1.
Table 41: Compounds, methods and uses, where in formula Ia.2 R^{N} is 2,2,2-trifluoroeth-1-yl, R^{A} is difluoromethyl in position 5 of the pyrazole moiety and Q is a radical Q-1 which has one of the meanings given in Table Ql.
Table 42: Compounds, methods and uses, where in formula Ia.2 R^{N} is methyl, R^{A} is trifluoromethyl in position 3 of the pyrazole moiety and Q is a radical Q-1 which has one of the meanings given in Table Q1.
Table 43: Compounds, methods and uses, where in formula Ia.2 R^{N} is 2,2,2-trifluoroeth-1-yl, R^{A} is methyl in position 5 of the pyrazole moiety and Q is a radical Q-2 which has one of the meanings given in Table Q2.
Table 44: Compounds, methods and uses, where in formula Ia.2 R^{N} is 2,2,2-trifluoroeth-1-yl, R^{A} is difluoromethyl in position 5 of the pyrazole moiety and Q is a radical Q-2 which has one of the meanings given in Table Q2.
Table 45: Compounds, methods and uses, where in formula Ia.2 R^{N} is methyl, R^{A} is trifluoromethyl in position 3 of the pyrazole moiety and Q is a radical Q-2 which has one of the meanings given in Table Q2.
Table 46: Compounds, methods and uses, where in formula Ia.2 R^{N} is 2,2,2-trifluoroeth-1-yl, R^{A} is methyl in position 5 of the pyrazole moiety and Q is a radical Q-3 which has one of the meanings given in Table Q3.
Table 47: Compounds, methods and uses, where in formula Ia.2 R^{N} is 2,2,2-trifluoroeth-1-yl, R^{A} is difluoromethyl in position 5 of the pyrazole moiety and Q is a radical Q-3 which has one of the meanings given in Table Q3.
Table 48: Compounds, methods and uses, where in formula Ia.2 R^{N} is methyl, R^{A} is trifluoromethyl in position 3 of the pyrazole moiety and Q is a radical Q-3 which has one of the meanings given in Table Q3.
Table 49: Compounds, methods and uses, where in formula Ia.2 R^{N} is 2,2,2-trifluoroeth-1-yl, R^{A} is methyl in position 5 of the pyrazole moiety and Q is a radical Q-4 which has one of the meanings given in Table Q4.
Table 50: Compounds, methods and uses, where in formula Ia.2 R^{N} is 2,2,2-trifluoroeth-1-yl, R^{A} is difluoromethyl in position 5 of the pyrazole moiety and Q is a radical Q-4 which has one of the meanings given in Table Q4.
Table 51: Compounds, methods and uses, where in formula Ia.2 R^{N} is methyl, R^{A} is trifluoromethyl in position 3 of the pyrazole moiety and Q is a radical Q-4 which has one of the meanings given in Table Q4.
Table 52: Compounds, methods and uses, where in formula Ia.2 R^{N} is 2,2,2-trifluoroeth-1-yl, R^{A} is methyl in position 5 of the pyrazole moiety and Q is a radical Q-5 which has one of the meanings given in Table Q5.
Table 53: Compounds, methods and uses, where in formula Ia.2 R^{N} is 2,2,2-trifluoroeth-1-yl, R^{A} is difluoromethyl in position 5 of the pyrazole moiety and Q is a radical Q-5 which has one of the meanings given in Table Q5.
Table 54: Compounds, methods and uses, where in formula Ia.2 R^{N} is methyl, R^{A} is trifluoromethyl in position 3 of the pyrazole moiety and Q is a radical Q-5 which has one of the meanings given in Table Q5.
Table 55: Compounds, methods and uses, where in formula Ia.2 R^{N} is 2,2,2-trifluoroeth-1-yl, R^{A} is methyl in position 5 of the pyrazole moiety and Q is a radical Q-6 which has one of the meanings given in Table Q6.
Table 56: Compounds, methods and uses, where in formula Ia.2 R^{N} is 2,2,2-trifluoroeth-1-yl, R^{A} is difluoromethyl in position 5 of the pyrazole moiety and Q is a radical Q-6 which has one of the meanings given in Table Q6.
Table 57: Compounds, methods and uses, where in formula Ia.2 R^{N} is methyl, R^{A} is trifluoromethyl in position 3 of the pyrazole moiety and Q is a radical Q-6 which has one of the meanings given in Table Q6.
Table 58: Compounds, methods and uses, where in formula Ia.2 R^{N} is 2,2,2-trifluoroeth-1-yl, R^{A} is methyl in position 5 of the pyrazole moiety and Q is a radical Q-7 which has one of the meanings given in Table Q7.
Table 59: Compounds, methods and uses, where in formula Ia.2 R^{N} is 2,2,2-trifluoroeth-1-yl, R^{A} is difluoromethyl in position 5 of the pyrazole moiety and Q is a radical Q-7 which has one of the meanings given in Table Q7.
Table 60: Compounds, methods and uses, where in formula Ia.2 R^{N} is methyl, R^{A} is trifluoromethyl in position 3 of the pyrazole moiety and Q is a radical Q-7 which has one of the meanings given in Table Q7.
Table 61: Compounds, methods and uses, where in formula Ia.2 R^{N} is 2,2,2-trifluoroeth-1-yl, R^{A} is methyl in position 5 of the pyrazole moiety and Q is a radical Q-8 which has one of the meanings given in Table Q8.
Table 62: Compounds, methods and uses, where in formula Ia.2 R^{N} is 2,2,2-trifluoroeth-1-yl, R^{A} is difluoromethyl in position 5 of the pyrazole moiety and Q is a radical Q-8 which has one of the meanings given in Table Q8.
Table 63: Compounds, methods and uses, where in formula Ia.2 R^{N} is methyl, R^{A} is trifluoromethyl in position 3 of the pyrazole moiety and Q is a radical Q-8 which has one of the meanings given in Table Q8.
Table 64: Compounds, methods and uses, where in formula Ia.2 R^{N} is 2,2,2-trifluoroeth-1-yl, R^{A} is methyl in position 5 of the pyrazole moiety and Q is a radical Q-9 which has one of the meanings given in Table Q9.
Table 65: Compounds, methods and uses, where in formula Ia.2 R^{N} is 2,2,2-trifluoroeth-1-yl, R^{A} is difluoromethyl in position 5 of the pyrazole moiety and Q is a radical Q-9 which has one of the meanings given in Table Q9.
Table 66: Compounds, methods and uses, where in formula Ia.2 R^{N} is methyl, R^{A} is trifluoromethyl in position 3 of the pyrazole moiety and Q is a radical Q-9 which has one of the meanings given in Table Q9.
Table 67: Compounds, methods and uses, where in formula Ia.2 R^{N} is 2,2,2-trifluoroeth-1-yl, R^{A} is methyl in position 5 of the pyrazole moiety and Q is a radical Q-10 which has one of the meanings given in Table Q10.
Table 68: Compounds, methods and uses, where in formula Ia.2 R^{N} is 2,2,2-trifluoroeth-1-yl, R^{A} is difluoromethyl in position 5 of the pyrazole moiety and Q is a radical Q-10 which has one of the meanings given in Table Q10.
Table 69: Compounds, methods and uses, where in formula Ia.2 R^{N} is methyl, R^{A} is trifluoromethyl in position 3 of the pyrazole moiety and Q is a radical Q-10 which has one of the meanings given in Table Q10.
Table 70: Compounds, methods and uses, where in formula Ia.2 R^{N} is 2,2,2-trifluoroeth-1-yl, R^{A} is methyl in position 5 of the pyrazole moiety and Q is a radical Q-11 which has one of the meanings given in Table Q11.
Table 71: Compounds, methods and uses, where in formula Ia.2 R^{N} is 2,2,2-trifluoroeth-1-yl, R^{A} is difluoromethyl in position 5 of the pyrazole moiety and Q is a radical Q-11 which has one of the meanings given in Table Q11.
Table 72: Compounds, methods and uses, where in formula Ia.2 R^{N} is methyl, R^{A} is trifluoromethyl in position 3 of the pyrazole moiety and Q is a radical Q-11 which has one of the meanings given in Table Q11.
Table 73: Compounds, methods and uses, where in formula Ia.2 R^{N} is 2,2,2-trifluoroeth-1-yl, R^{A} is methyl in position 5 of the pyrazole moiety and Q is a radical Q-12 which has one of the meanings given in Table Q12.
Table 74: Compounds, methods and uses, where in formula Ia.2 R^{N} is 2,2,2-trifluoroeth-1-yl, R^{A} is difluoromethyl in position 5 of the pyrazole moiety and Q is a radical Q-12 which has one of the meanings given in Table Q12.
Table 75: Compounds, methods and uses, where in formula Ia.2 R^{N} is methyl, R^{A} is trifluoromethyl in position 3 of the pyrazole moiety and Q is a radical Q-12 which has one of the meanings given in Table Q12.
Table 76: Compounds, methods and uses, where in formula Ia.2 R^{N} is 2,2,2-trifluoroeth-1-yl, R^{A} is methyl in position 5 of the pyrazole moiety and Q is a radical Q-13 which has one of the meanings given in Table Q13.
Table 77: Compounds, methods and uses, where in formula Ia.2 R^{N} is 2,2,2-trifluoroeth-1-yl, R^{A} is difluoromethyl in position 5 of the pyrazole moiety and Q is a radical Q-13 which has one of the meanings given in Table Q13.
Table 78: Compounds, methods and uses, where in formula Ia.2 R^{N} is methyl, R^{A} is trifluoromethyl in position 3 of the pyrazole moiety and Q is a radical Q-13 which has one of the meanings given in Table Q13.
Table 79: Compounds, methods and uses, where in formula Ia.3 R^{N} is 2,2,2-trifluoroeth-1-yl, R^{A} is methyl in position 5 of the pyrazole moiety and Q is a radical Q-1 which has one of the meanings given in Table Q1.
Table 80: Compounds, methods and uses, where in formula Ia.3 R^{N} is 2,2,2-trifluoroeth-1-yl, R^{A} is difluoromethyl in position 5 of the pyrazole moiety and Q is a radical Q-1 which has one of the meanings given in Table Q1.
Table 81: Compounds, methods and uses, where in formula Ia.3 R^{N} is methyl, R^{A} is trifluoromethyl in position 3 of the pyrazole moiety and Q is a radical Q-1 which has one of the meanings given in Table Q1.
Table 82: Compounds, methods and uses, where in formula Ia.3 R^{N} is 2,2,2-trifluoroeth-1-yl, R^{A} is methyl in position 5 of the pyrazole moiety and Q is a radical Q-2 which has one of the meanings given in Table Q2.
Table 83: Compounds, methods and uses, where in formula Ia.3 R^{N} is 2,2,2-trifluoroeth-1-yl, R^{A} is difluoromethyl in position 5 of the pyrazole moiety and Q is a radical Q-2 which has one of the meanings given in Table Q2.
Table 84: Compounds, methods and uses, where in formula Ia.3 R^{N} is methyl, R^{A} is trifluoromethyl in position 3 of the pyrazole moiety and Q is a radical Q-2 which has one of the meanings given in Table Q2.
Table 85: Compounds, methods and uses, where in formula Ia.3 R^{N} is 2,2,2-trifluoroeth-1-yl, R^{A} is methyl in position 5 of the pyrazole moiety and Q is a radical Q-3 which has one of the meanings given in Table Q3.
Table 86: Compounds, methods and uses, where in formula Ia.3 R^{N} is 2,2,2-trifluoroeth-1-yl, R^{A} is difluoromethyl in position 5 of the pyrazole moiety and Q is a radical Q-3 which has one of the meanings given in Table Q3.
Table 87: Compounds, methods and uses, where in formula Ia.3 R^{N} is methyl, R^{A} is trifluoromethyl in position 3 of the pyrazole moiety and Q is a radical Q-3 which has one of the meanings given in Table Q3.
Table 88: Compounds, methods and uses, where in formula Ia.3 R^{N} is 2,2,2-trifluoroeth-1-yl, R^{A} is methyl in position 5 of the pyrazole moiety and Q is a radical Q-4 which has one of the meanings given in Table Q4.
Table 89: Compounds, methods and uses, where in formula Ia.3 R^{N} is 2,2,2-trifluoroeth-1-yl, R^{A} is difluoromethyl in position 5 of the pyrazole moiety and Q is a radical Q-4 which has one of the meanings given in Table Q4.
Table 90: Compounds, methods and uses, where in formula Ia.3 R^{N} is methyl, R^{A} is trifluoromethyl in position 3 of the pyrazole moiety and Q is a radical Q-4 which has one of the meanings given in Table Q4.
Table 91: Compounds, methods and uses, where in formula Ia.3 R^{N} is 2,2,2-trifluoroeth-1-yl, R^{A} is methyl in position 5 of the pyrazole moiety and Q is a radical Q-5 which has one of the meanings given in Table Q5.
Table 92: Compounds, methods and uses, where in formula Ia.3 R^{N} is 2,2,2-trifluoroeth-1-yl, R^{A} is difluoromethyl in position 5 of the pyrazole moiety and Q is a radical Q-5 which has one of the meanings given in Table Q5.
Table 93: Compounds, methods and uses, where in formula Ia.3 R^{N} is methyl, R^{A} is trifluoromethyl in position 3 of the pyrazole moiety and Q is a radical Q-5 which has one of the meanings given in Table Q5.
Table 94: Compounds, methods and uses, where in formula Ia.3 R^{N} is 2,2,2-trifluoroeth-1-yl, R^{A} is methyl in position 5 of the pyrazole moiety and Q is a radical Q-6 which has one of the meanings given in Table Q6.
Table 95: Compounds, methods and uses, where in formula Ia.3 R^{N} is 2,2,2-trifluoroeth-1-yl, R^{A} is difluoromethyl in position 5 of the pyrazole moiety and Q is a radical Q-6 which has one of the meanings given in Table Q6.
Table 96: Compounds, methods and uses, where in formula Ia.3 R^{N} is methyl, R^{A} is trifluoromethyl in position 3 of the pyrazole moiety and Q is a radical Q-6 which has one of the meanings given in Table Q6.
Table 97: Compounds, methods and uses, where in formula Ia.3 R^{N} is 2,2,2-trifluoroeth-1-yl, R^{A} is methyl in position 5 of the pyrazole moiety and Q is a radical Q-7 which has one of the meanings given in Table Q7.
Table 98: Compounds, methods and uses, where in formula Ia.3 R^{N} is 2,2,2-trifluoroeth-1-yl, R^{A} is difluoromethyl in position 5 of the pyrazole moiety and Q is a radical Q-7 which has one of the meanings given in Table Q7.
Table 99: Compounds, methods and uses, where in formula Ia.3 R^{N} is methyl, R^{A} is trifluoromethyl in position 3 of the pyrazole moiety and Q is a radical Q-7 which has one of the meanings given in Table Q7.
Table 100: Compounds, methods and uses, where in formula Ia.3 R^{N} is 2,2,2-trifluoroeth-1-yl, R^{A} is methyl in position 5 of the pyrazole moiety and Q is a radical Q-8 which has one of the meanings given in Table Q8.
Table 101: Compounds, methods and uses, where in formula Ia.3 R^{N} is 2,2,2-trifluoroeth-1-yl, R^{A} is difluoromethyl in position 5 of the pyrazole moiety and Q is a radical Q-8 which has one of the meanings given in Table Q8.
Table 102: Compounds, methods and uses, where in formula Ia.3 R^{N} is methyl, R^{A} is trifluoromethyl in position 3 of the pyrazole moiety and Q is a radical Q-8 which has one of the meanings given in Table Q8.
Table 103: Compounds, methods and uses, where in formula Ia.3 R^{N} is 2,2,2-trifluoroeth-1-yl, R^{A} is methyl in position 5 of the pyrazole moiety and Q is a radical Q-9 which has one of the meanings given in Table Q9.
Table 104: Compounds, methods and uses, where in formula Ia.3 R^{N} is 2,2,2-trifluoroeth-1-yl, R^{A} is difluoromethyl in position 5 of the pyrazole moiety and Q is a radical Q-9 which has one of the meanings given in Table Q9.
Table 105: Compounds, methods and uses, where in formula Ia.3 R^{N} is methyl, R^{A} is trifluoromethyl in position 3 of the pyrazole moiety and Q is a radical Q-9 which has one of the meanings given in Table Q9.
Table 106: Compounds, methods and uses, where in formula Ia.3 R^{N} is 2,2,2-trifluoroeth-1-yl, R^{A} is methyl in position 5 of the pyrazole moiety and Q is a radical Q-10 which has one of the meanings given in Table Q10.
Table 107: Compounds, methods and uses, where in formula Ia.3 R^{N} is 2,2,2-trifluoroeth-1-yl, R^{A} is difluoromethyl in position 5 of the pyrazole moiety and Q is a radical Q-10 which has one of the meanings given in Table Q10.
Table 108: Compounds, methods and uses, where in formula Ia.3 R^{N} is methyl, R^{A} is trifluoromethyl in position 3 of the pyrazole moiety and Q is a radical Q-10 which has one of the meanings given in Table Q10.
Table 109: Compounds, methods and uses, where in formula Ia.3 R^{N} is 2,2,2-trifluoroeth-1-yl, R^{A} is methyl in position 5 of the pyrazole moiety and Q is a radical Q-11 which has one of the meanings given in Table Q11.
Table 110: Compounds, methods and uses, where in formula Ia.3 R^{N} is 2,2,2-trifluoroeth-1-yl, R^{A} is difluoromethyl in position 5 of the pyrazole moiety and Q is a radical Q-11 which has one of the meanings given in Table Q11.
Table 111: Compounds, methods and uses, where in formula Ia.3 R^{N} is methyl, R^{A} is trifluoromethyl in position 3 of the pyrazole moiety and Q is a radical Q-11 which has one of the meanings given in Table Q11.
Table 112: Compounds, methods and uses, where in formula Ia.3 R^{N} is 2,2,2-trifluoroeth-1-yl, R^{A} is methyl in position 5 of the pyrazole moiety and Q is a radical Q-12 which has one of the meanings given in Table Q12.
Table 113: Compounds, methods and uses, where in formula Ia.3 R^{N} is 2,2,2-trifluoroeth-1-yl, R^{A} is difluoromethyl in position 5 of the pyrazole moiety and Q is a radical Q-12 which has one of the meanings given in Table Q12.
Table 114: Compounds, methods and uses, where in formula Ia.3 R^{N} is methyl, R^{A} is trifluoromethyl in position 3 of the pyrazole moiety and Q is a radical Q-12 which has one of the meanings given in Table Q12.
Table 115: Compounds, methods and uses, where in formula Ia.3 R^{N} is 2,2,2-trifluoroeth-1-yl, R^{A} is methyl in position 5 of the pyrazole moiety and Q is a radical Q-13 which has one of the meanings given in Table Q13.
Table 116: Compounds, methods and uses, where in formula Ia.3 R^{N} is 2,2,2-trifluoroeth-1-yl, R^{A} is difluoromethyl in position 5 of the pyrazole moiety and Q is a radical Q-13 which has one of the meanings given in Table Q13.
Table 117: Compounds, methods and uses, where in formula Ia.3 R^{N} is methyl, R^{A} is trifluoromethyl in position 3 of the pyrazole moiety and Q is a radical Q-13 which has one of the meanings given in Table Q13.
Table 118: Compounds, methods and uses, where in formula Ia.4 R^{N} is 2,2,2-trifluoroeth-1-yl, R^{A} is methyl in position 5 of the pyrazole moiety and Q is a radical Q-1 which has one of the meanings given in Table Q1.
Table 119: Compounds, methods and uses, where in formula Ia.4 R^{N} is 2,2,2-trifluoroeth-1-yl, R^{A} is difluoromethyl in position 5 of the pyrazole moiety and Q is a radical Q-1 which has one of the meanings given in Table Ql.
Table 120: Compounds, methods and uses, where in formula Ia.4 R^{N} is methyl, R^{A} is trifluoromethyl in position 3 of the pyrazole moiety and Q is a radical Q-1 which has one of the meanings given in Table Q1.
Table 121: Compounds, methods and uses, where in formula Ia.4 R^{N} is 2,2,2-trifluoroeth-1-yl, R^{A} is methyl in position 5 of the pyrazole moiety and Q is a radical Q-2 which has one of the meanings given in Table Q2.
Table 122: Compounds, methods and uses, where in formula Ia.4 R^{N} is 2,2,2-trifluoroeth-1-yl, R^{A} is difluoromethyl in position 5 of the pyrazole moiety and Q is a radical Q-2 which has one of the meanings given in Table Q2.
Table 123: Compounds, methods and uses, where in formula Ia.4 R^{N} is methyl, R^{A} is trifluoromethyl in position 3 of the pyrazole moiety and Q is a radical Q-2 which has one of the meanings given in Table Q2.
Table 124: Compounds, methods and uses, where in formula Ia.4 R^{N} is 2,2,2-trifluoroeth-1-yl, R^{A} is methyl in position 5 of the pyrazole moiety and Q is a radical Q-3 which has one of the meanings given in Table Q3.
Table 125: Compounds, methods and uses, where in formula Ia.4 R^{N} is 2,2,2-trifluoroeth-1-yl, R^{A} is difluoromethyl in position 5 of the pyrazole moiety and Q is a radical Q-3 which has one of the meanings given in Table Q3.
Table 126: Compounds, methods and uses, where in formula Ia.4 R^{N} is methyl, R^{A} is trifluoromethyl in position 3 of the pyrazole moiety and Q is a radical Q-3 which has one of the meanings given in Table Q3.
Table 127: Compounds, methods and uses, where in formula Ia.4 R^{N} is 2,2,2-trifluoroeth-1-yl, R^{A} is methyl in position 5 of the pyrazole moiety and Q is a radical Q-4 which has one of the meanings given in Table Q4.
Table 128: Compounds, methods and uses, where in formula Ia.4 R^{N} is 2,2,2-trifluoroeth-1-yl, R^{A} is difluoromethyl in position 5 of the pyrazole moiety and Q is a radical Q-4 which has one of the meanings given in Table Q4.
Table 129: Compounds, methods and uses, where in formula Ia.4 R^{N} is methyl, R^{A} is trifluoromethyl in position 3 of the pyrazole moiety and Q is a radical Q-4 which has one of the meanings given in Table Q4.
Table 130: Compounds, methods and uses, where in formula Ia.4 R^{N} is 2,2,2-trifluoroeth-1-yl, R^{A} is methyl in position 5 of the pyrazole moiety and Q is a radical Q-5 which has one of the meanings given in Table Q5.
Table 131: Compounds, methods and uses, where in formula Ia.4 R^{N} is 2,2,2-trifluoroeth-1-yl, R^{A} is difluoromethyl in position 5 of the pyrazole moiety and Q is a radical Q-5 which has one of the meanings given in Table Q5.
Table 132: Compounds, methods and uses, where in formula Ia.4 R^{N} is methyl, R^{A} is trifluoromethyl in position 3 of the pyrazole moiety and Q is a radical Q-5 which has one of the meanings given in Table Q5.
Table 133: Compounds, methods and uses, where in formula Ia.4 R^{N} is 2,2,2-trifluoroeth-1-yl, R^{A} is methyl in position 5 of the pyrazole moiety and Q is a radical Q-6 which has one of the meanings given in Table Q6.
Table 134: Compounds, methods and uses, where in formula Ia.4 R^{N} is 2,2,2-trifluoroeth-1-yl, R^{A} is difluoromethyl in position 5 of the pyrazole moiety and Q is a radical Q-6 which has one of the meanings given in Table Q6.
Table 135: Compounds, methods and uses, where in formula Ia.4 R^{N} is methyl, R^{A} is trifluoromethyl in position 3 of the pyrazole moiety and Q is a radical Q-6 which has one of the meanings given in Table Q6.
Table 136: Compounds, methods and uses, where in formula Ia.4 R^{N} is 2,2,2-trifluoroeth-1-yl, R^{A} is methyl in position 5 of the pyrazole moiety and Q is a radical Q-7 which has one of the meanings given in Table Q7.
Table 137: Compounds, methods and uses, where in formula Ia.4 R^{N} is 2,2,2-trifluoroeth-1-yl, R^{A} is difluoromethyl in position 5 of the pyrazole moiety and Q is a radical Q-7 which has one of the meanings given in Table Q7.
Table 138: Compounds, methods and uses, where in formula Ia.4 R^{N} is methyl, R^{A} is trifluoromethyl in position 3 of the pyrazole moiety and Q is a radical Q-7 which has one of the meanings given in Table Q7.
Table 139: Compounds, methods and uses, where in formula Ia.4 R^{N} is 2,2,2-trifluoroeth-1-yl, R^{A} is methyl in position 5 of the pyrazole moiety and Q is a radical Q-8 which has one of the meanings given in Table Q8.
Table 140: Compounds, methods and uses, where in formula Ia.4 R^{N} is 2,2,2-trifluoroeth-1-yl, R^{A} is difluoromethyl in position 5 of the pyrazole moiety and Q is a radical Q-8 which has one of the meanings given in Table Q8.
Table 141: Compounds, methods and uses, where in formula Ia.4 R^{N} is methyl, R^{A} is trifluoromethyl in position 3 of the pyrazole moiety and Q is a radical Q-8 which has one of the meanings given in Table Q8.
Table 142: Compounds, methods and uses, where in formula Ia.4 R^{N} is 2,2,2-trifluoroeth-1-yl, R^{A} is methyl in position 5 of the pyrazole moiety and Q is a radical Q-9 which has one of the meanings given in Table Q9.
Table 143: Compounds, methods and uses, where in formula Ia.4 R^{N} is 2,2,2-trifluoroeth-1-yl, R^{A} is difluoromethyl in position 5 of the pyrazole moiety and Q is a radical Q-9 which has one of the meanings given in Table Q9.
Table 144: Compounds, methods and uses, where in formula Ia.4 R^{N} is methyl, R^{A} is trifluoromethyl in position 3 of the pyrazole moiety and Q is a radical Q-9 which has one of the meanings given in Table Q9.
Table 145: Compounds, methods and uses, where in formula Ia.4 R^{N} is 2,2,2-trifluoroeth-1-yl, R^{A} is methyl in position 5 of the pyrazole moiety and Q is a radical Q-10 which has one of the meanings given in Table Q10.
Table 146: Compounds, methods and uses, where in formula Ia.4 R^{N} is 2,2,2-trifluoroeth-1-yl, R^{A} is difluoromethyl in position 5 of the pyrazole moiety and Q is a radical Q-10 which has one of the meanings given in Table Q10.
Table 147: Compounds, methods and uses, where in formula Ia.4 R^{N} is methyl, R^{A} is trifluoromethyl in position 3 of the pyrazole moiety and Q is a radical Q-10 which has one of the meanings given in Table Q10.
Table 148: Compounds, methods and uses, where in formula Ia.4 R^{N} is 2,2,2-trifluoroeth-1-yl, R^{A} is methyl in position 5 of the pyrazole moiety and Q is a radical Q-11 which has one of the meanings given in Table Q11.
Table 149: Compounds, methods and uses, where in formula Ia.4 R^{N} is 2,2,2-trifluoroeth-1-yl, R^{A} is difluoromethyl in position 5 of the pyrazole moiety and Q is a radical Q-11 which has one of the meanings given in Table Q11.
Table 150: Compounds, methods and uses, where in formula Ia.4 R^{N} is methyl, R^{A} is trifluoromethyl in position 3 of the pyrazole moiety and Q is a radical Q-11 which has one of the meanings given in Table Q11.
Table 151: Compounds, methods and uses, where in formula Ia.4 R^{N} is 2,2,2-trifluoroeth-1-yl, R^{A} is methyl in position 5 of the pyrazole moiety and Q is a radical Q-12 which has one of the meanings given in Table Q12.
Table 152: Compounds, methods and uses, where in formula Ia.4 R^{N} is 2,2,2-trifluoroeth-1-yl, R^{A} is difluoromethyl in position 5 of the pyrazole moiety and Q is a radical Q-12 which has one of the meanings given in Table Q12.
Table 153: Compounds, methods and uses, where in formula Ia.4 R^{N} is methyl, R^{A} is trifluoromethyl in position 3 of the pyrazole moiety and Q is a radical Q-12 which has one of the meanings given in Table Q12.
Table 154: Compounds, methods and uses, where in formula Ia.4 R^{N} is 2,2,2-trifluoroeth-1-yl, R^{A} is methyl in position 5 of the pyrazole moiety and Q is a radical Q-13 which has one of the meanings given in Table Q13.
Table 155: Compounds, methods and uses, where in formula Ia.4 R^{N} is 2,2,2-trifluoroeth-1-yl, R^{A} is difluoromethyl in position 5 of the pyrazole moiety and Q is a radical Q-13 which has one of the meanings given in Table Q13.
Table 156: Compounds, methods and uses, where in formula Ia.4 R^{N} is methyl, R^{A} is trifluoromethyl in position 3 of the pyrazole moiety and Q is a radical Q-13 which has one of the meanings given in Table Q13.

The compounds of the formula I can be prepared by the standard methods of organic chemistry, e.g. by the methods described hereinafter in schemes 1 to 8 and in the synthesis descriptions of the working examples. The variables X, Y, Z, Q, R^{N}, R^{t}, R^{u}, n and R^{A} in schemes 1 to 8 are as defined above for formula I.

The compounds of the formula I can be prepared e.g. by employing transition metal-catalyzed cross coupling reactions, such as the Suzuki reaction, the Negishi reaction or the Heck reaction which can be carried out in analogy to known processes, as described for example in J.-P. Corbet et al., Chem. Rev., 2006, 106, 2651 (and references cited therein). For instance, a pyrazole derivative II, wherein LG¹ is a leaving group such as Cl, Br, I or triflate, in particular Br or I, can be reacted with a organoboronic acid compound III in the presence of a palladium catalyst. Alternatively, instead of the organoboronic acid compound III a corresponding organoboron compound can be used that in place of the B(OH)₂-group comprises a boronic ester group, such as a pinacolato-boronate group, a 9-borabicyclo[3.3.1]nonyl (9-BBN) group, a potassium tri-fluoroborate group or the like. Suitable palladium catalysts are in particular complexes of Pd(0) and ligands such as phosphines, N-heterocyclic carbenes or bidentate ligands comprising N, O and/or S as coordinating atoms. Examples of suitable bases are alkali metal carbonates (e.g. sodium carbonate, potassium carbonate, cesium carbonate), alkali metal hydroxide (e.g. sodium hydroxide, potassium hydroxide), tri-alkali metal phosphates (e.g. tripotassium phosphate), alkali metal fluorides (e.g. potassium fluoride), alkali metal alkoxides (e.g. sodium tert-butoxide) or suitable amines (e.g. diisopropylamine, tert-butylamine). The reaction can be carried out in a variety of solvents, such as water, alcohols (e.g. tert-butanol, isopropanol), toluene, xylene, tetrahydrofuran, dioxane, dimethylsulfoxide, dimethylformamide, acetone or mixtures thereof. The reaction temperature is not very critical and can range, for example, from −10 to +150° C., preferably from +10 to +120° C.

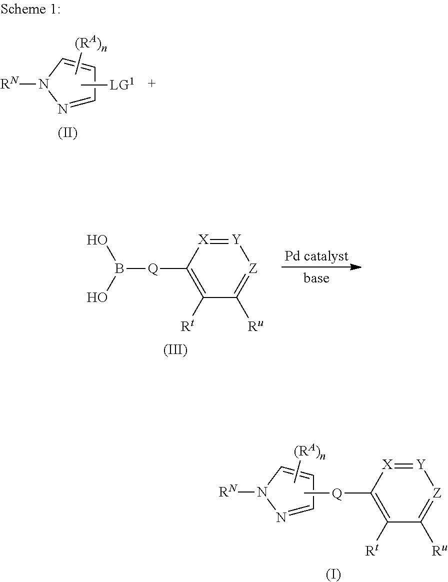

The compounds I can also be prepared by modifying the procedure of scheme 1, in that educts with interchanged reactive groups, namely a pyrazole compound carrying a B(OH)₂-group or a corresponding boronic ester group and a modified compound III that instead of the B(OH)₂-group comprises a leaving group LG¹, are employed.

This procedure of scheme 1 or the mentioned modification thereof is exemplified for the preparation examples 22, 24 to 34 and 36 in the experimental section below.

The organoboronic acid compound of formula III, wherein Q is a moiety that is α,β-unsaturated in relation to the B(OH)₂ group, such as a (het)aryl moiety, can be prepared in analogy to known methods, as described for example in J. Morgan et al., J. Chem. Soc., Perkin Trans. 1, 1990, 715 and M. Skowronska et al., J. Org. Chem., 1988, 53, 5484. For instance, as outlined in scheme 2, the bromide of formula IV can be treated with butyl lithium to convert it into the corresponding lithiated compound which is then in situ reacted with the boric acid ester of formula V, wherein R is preferably lower alkyl, such as methyl or ethyl. The resulting (het)aryl boronic ester is then hydrolyzed, usually with an aqueous base, to yield the boronic acid of formula III. Alternatively, the bromide IV can be transferred into the corresponding Grignard reagent which is subsequently reacted with an the boric acid ester V and hydrolyzed to give the boronic acid of III.

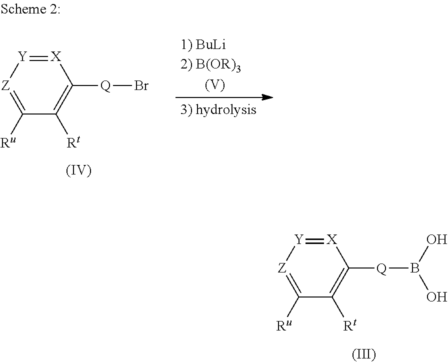

The bromide of formula IV, in turn, can be prepared for example by employing transition metal-catalyzed cross coupling reactions, such as the Suzuki reaction, the Negishi reaction or the Heck reaction, e.g. according to the above-described method that is depicted in Scheme 1. For instance, as outlined in Scheme 3 the (het)aryl compound of formula VI, wherein LG² is a leaving group such as Cl, Br, I or triflate, in particular Br or I, can be reacted with a organoboronic acid compound V in the presence of a palladium catalyst. The specifics and conditions of this conversion are similar to those discussed above. In addition, the aforementioned alternative organoboron compound can also be employed in this case.

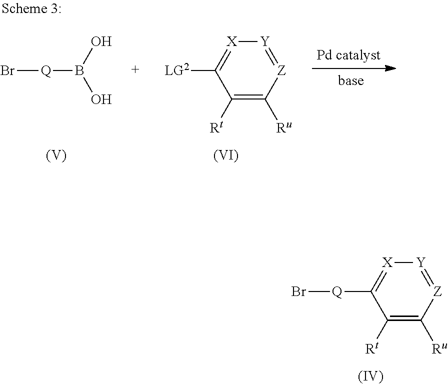

Pyrazole derivatives of formula II, bromides of formula V as well as (het)aryl compounds of formula VI are known in the art or are commercially available or can be prepared by methods known from the literature.

Alternatively, the compounds of the formula I, wherein Q is a 5- or 6-membered heterocyclic radical, may be prepared by establishing the moiety Q via a cyclocondensation reaction in analogy to known procedures as described e.g. in J. A. Joule, K. Mills, Heterocyclic Chemistry, 4^{th} edition, 2000, Blackwell Science (and literature cited therein).

For instance, compounds I wherein Q is a [1,2,4]-triazol-3,4-diyl moiety, hereunder called compounds I′, can be prepared according to the procedure outlined in Scheme 4 by reacting the hydrazide IV with the amine V and an ortho ester, such as triethyl orthoformate, under acidic conditions.

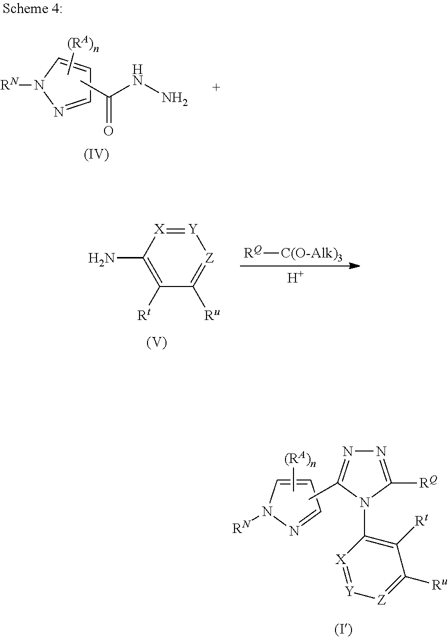

This procedure of scheme 4 is exemplified for the preparation examples 1 to 3, 5, 7 to 13 and 23 in the experimental section below.

Compounds I with Q being an oxazol-2,4-diyl or thiazol-2,4-diyl moiety, that are called hereunder compounds I″, are also accessible via cyclocondensation reactions. For instance, compounds I″ can be prepared according to the procedure depicted in Scheme 5 by reacting the (thio)amide VI, wherein T is oxygen or sulfur, with the α-bromo ketone VII.

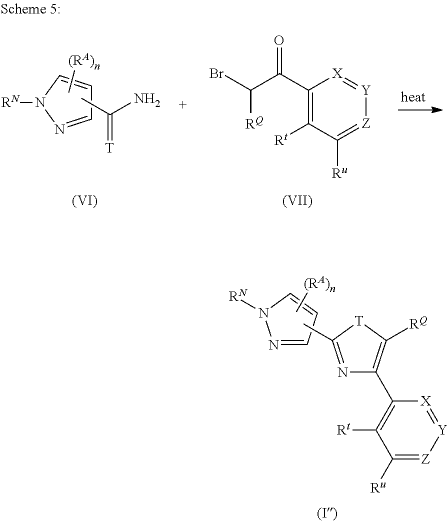

The thioamide variant of compound VI can be obtained by thiation of the corresponding amide VI, for example by employing Lawesson's reagent.

This procedure of scheme 5 is exemplified for the preparation examples 4 and 6 in the experimental section below.

In addition, compounds I with Q being a [1,3,4]oxadiazol-2,5-diyl or a [1,3,4]-thiadiazol-2,5-diyl moiety, hereunder called compounds I′″a and I′″b, are also accessible via cyclocondensation reactions. For instance, as shown in scheme 6, the reaction of the diacyl hydrazine X with a dehydrating agent, such as e.g. phosphoryl chloride, yields the oxadiazole derivative I′″a, whereas the conversion with a thiation agent, in particular the Lawesson's reagent, affords the corresponding thiadiazole derivative I′″b. The diacyl hydrazine X in turn can be prepared e.g. as also shown in scheme 6 by acylation of the hydrazide IX with the pyrazole carboxylic acid derivative VIII, wherein LG² is a leaving group such as Cl, Br, I or triflate, in particular Cl or Br.

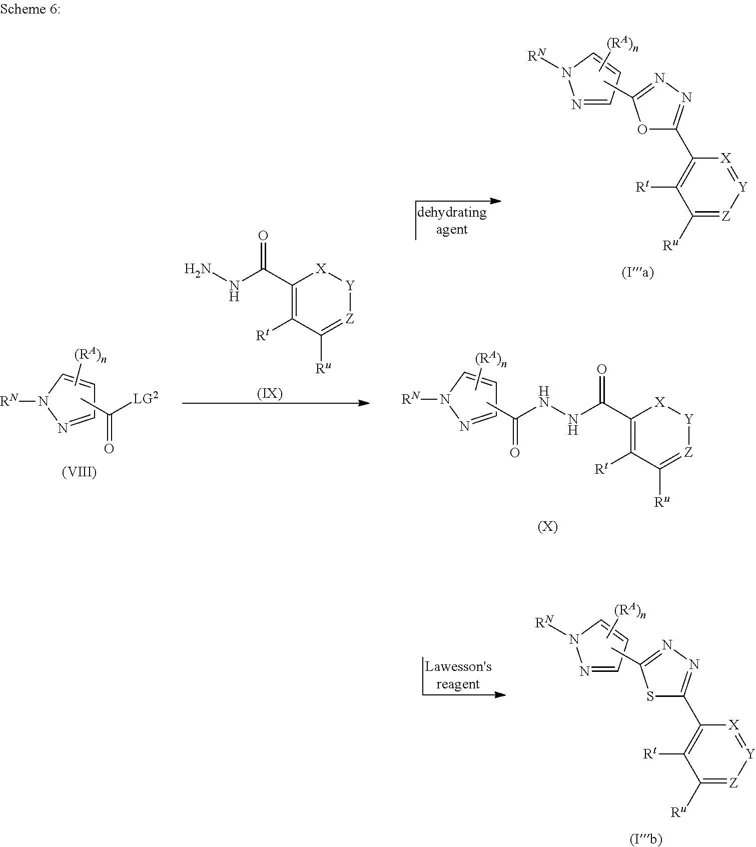

This procedure of scheme 6 is exemplified for the preparation examples 14 to 17 in the experimental section below.

Furthermore, compounds I with Q being a 4,5-dihydro-imidazol-1,2-diylmoiety, hereunder called compounds I′″, can also be prepared via cyclocondensation reactions, for instance, as shown in scheme 7, by cyclizing the amide XII with a dehydrating agent, such as e.g. phosphoryl chloride. As also depicted in scheme 7, the amide XII in turn may be obtained by reacting the pyrazole carboxylic acid derivative VIII, wherein the leaving group LG² is preferably Cl or Br, with a diamine XI. By oxidizing compounds I″″, e.g. with potassium permanganate, the corresponding imidazol-1,2-diyl derivatives are accessible.

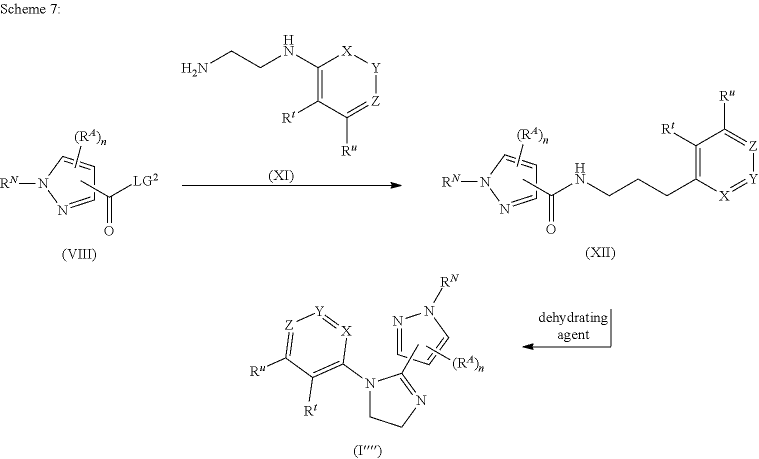

This procedure of scheme 7 is exemplified for the preparation examples 18 to 21 in the experimental section below.

Compounds I with Q being a [1,2,4]-triazol-3,5-diylmoiety, hereunder called compounds I′″″, are obtainable for example by a procedure analogous to the one outlined in scheme 6. Thus, as shown in scheme 8, the reaction of acylated imidohydrazide X′ with a dehydrating agent, such as e.g. phosphoryl chloride, yields a compound I′″″. The acylated imidohydrazide X′ in turn can be prepared e.g. as also shown in scheme 8 by acylation of the imidohydrazide IX′ with the pyrazole carboxylic acid derivative VIII, wherein LG² is a leaving group such as Cl, Br, I or triflate, in particular Cl or Br.

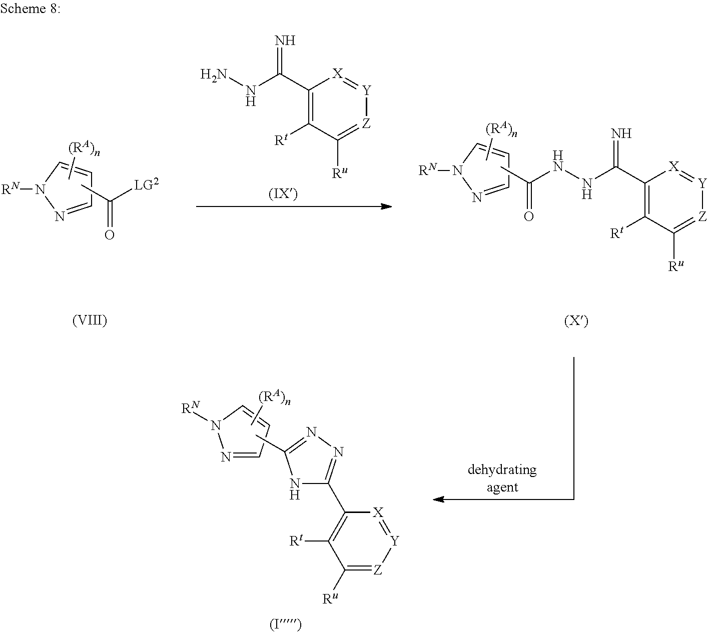

Alkylation in position 1, 2 or 4 of the triazole lead to an optional modification of compounds I″″, which can be accomplished by reacting it with alkylation agent, such as methyl iodide, preferably in the presence of a base such as sodium hydride.

This procedure of scheme 8 is exemplified for the preparation examples 35, 37 and 38 in the experimental section below.

Compounds I with Q being a 4H-[1,2,4]oxadiazol-5-on-3,4-diyl moiety, hereunder called compounds I″″″, are also accessible via cyclocondensation reactions. For instance, compounds I″″″ can be prepared according to the procedure depicted in Scheme 9 by first reacting the amine XIV in the presence of the base with the N-hydroxyimine of formula XIII having a leaving group LG² at the carbon atom of the imine, wherein LG² is preferably Cl or Br. Subsequent cyclization of the resulting N-hydroxyamidine XV with phosghen or a phosghen equivalent, such as 1,1′-carbonyldiimidazole, affords the intended compound of formula I wherein Q is 4H-[1,2,4]-oxadiazol-5-on-3,4-diyl.

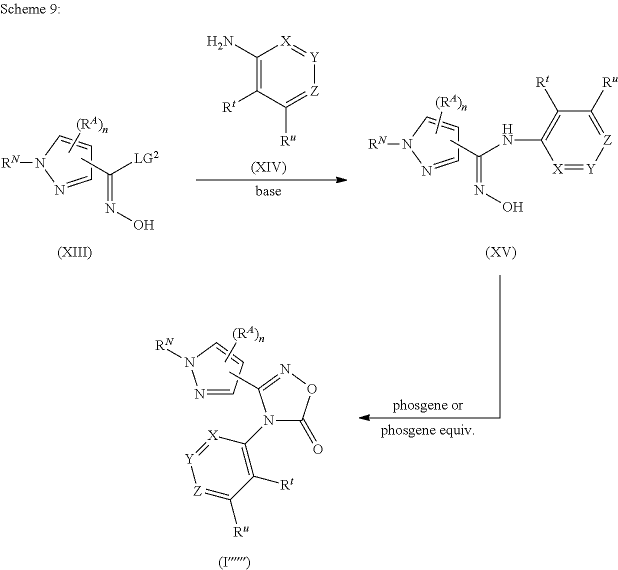

This procedure of scheme 9 is exemplified for the preparation example 39 in the experimental section below.

The aforementioned intermediates of formulae IV, V, VI, VII, VIII, IX, IX′, XI, XIII and XIV are known in the art or are commercially available or can be obtained via methods known from the literature.

As a rule, the compounds of the formula I can be prepared by the methods described above. If individual compounds can not be prepared via the above-described routes, they can be prepared by derivatization of other compounds I or by customary modifications of the synthesis routes described. For example, in individual cases, certain compounds I can advantageously be prepared from other compounds I by ester hydrolysis, amidation, esterification, ether cleavage, olefination, reduction, oxidation and the like.

The reaction mixtures are worked up in the customary manner, for example by mixing with water, separating the phases, and, if appropriate, purifying the crude products by chromatography, for example on alumina or on silica gel. Some of the intermediates and end products may be obtained in the form of colorless or pale brown viscous oils which are freed or purified from volatile components under reduced pressure and at moderately elevated temperature. If the intermediates and end products are obtained as solids, they may be purified by recrystallization or trituration.

Due to their excellent activity, the compounds of the general formula I may be used for controlling invertebrate pests.

Accordingly, the present invention provides a method for controlling invertebrate pests which method comprises treating the pests, their food supply, their habitat or their breeding ground or a cultivated plant, plant propagation materials (such as seed), soil, area, material or environment in which the pests are growing or may grow, or the materials, cultivated plants, plant propagation materials (such as seed), soils, surfaces or spaces to be protected from pest attack or infestation with a pesticidally effective amount of a compound of formula I or a salt or N-oxide thereof or a composition as defined above.

Preferably, the method of the invention serves for protecting plant propagation material (such as seed) and the plant which grows therefrom from invertebrate pest attack or infestation and comprises treating the plant propagation material (such as seed) with a pesticidally effective amount of a compound of formula I or an agriculturally acceptable salt or N-oxide thereof as defined above or with a pesticidally effective amount of an agricultural composition as defined above and below. The method of the invention is not limited to the protection of the “substrate” (plant, plant propagation materials, soil material etc.) which has been treated according to the invention, but also has a preventive effect, thus, for example, according protection to a plant which grows from a treated plant propagation materials (such as seed), the plant itself not having been treated.

In the sense of the present invention, “invertebrate pests” are preferably selected from arthropods and nematodes, more preferably from harmful insects, arachnids and nematodes, and even more preferably from insects, acarids and nematodes. In the sense of the present invention, “invertebrate pests” are most preferably insects preferably insects of the order Homoptera.

The invention further provides an agricultural composition for combating such invertebrate pests, which comprises such an amount of at least one compound of the general formula I or at least one agriculturally useful salt or N-oxide thereof and at least one inert liquid and/or solid agronomically acceptable carrier that has a pesticidal action and, if desired, at least one surfactant.

Such a composition may contain a single active compound of the formula I or a salt or N-oxide thereof or a mixture of several active compounds I or their salts according to the present invention. The composition according to the present invention may comprise an individual isomer or mixtures of isomers as well as individual tautomers or mixtures of tautomers.

The compounds of the formula I and the pestidicidal compositions comprising them are effective agents for controlling arthropod pests and nematodes. Invertebrate pests controlled by the compounds of formula I include for example

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusiani and Zeiraphera canadensis;
beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12 punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria;
dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa;
thrips (Thysanoptera), e.g. Dichromothrips corbetti, Frankliniella fusca, Frankliniella occidentalis, Frankliniella tritici, Scirtothrips citri, Thrips oryzae, Thrips palmi and Thrips tabaci;
hymenopterans (Hymenoptera), e.g. Athalia rosae, Atta cephalotes, Atta sexdens, Atta texana, Hoplocampa minuta, Hoplocampa testudinea, Monomorium pharaonis, Solenopsis geminata and Solenopsis invicta;
heteropterans (Heteroptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor;
homopterans (Homoptera), e.g. Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Bemisia tabaci, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus persicae, Myzus varians, Nasonovia ribisnigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Sogatella furcifera Trialeurodes vaporariorum, Toxoptera aurantiiand, and Viteus vitifolii;
termites (Isoptera), e.g. Calotermes flavicollis, Leucotermes flavipes, Reticulitermes flavipes, Reticulitermes lucifugus and Termes natalensis;
orthopterans (Orthoptera), e.g. Acheta domestica, Blatta orientalis, Blattella germanica, Forficula auricularia, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;
arachnoidea, such as arachnids (Acarina), e.g. of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and oligonychus pratensis;
siphonatera, e.g. Xenopsylla cheopsis, Ceratophyllus spp.

The compositions and compounds of formula I are useful for the control of nematodes, especially plant parasitic nematodes such as root knot nematodes, Meloidogyne hapla, Meloidogyne incognita, Meloidogyne javanica, and other Meloidogyne species;

cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Pin nematodes, Paratylenchus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

In a preferred embodiment of the invention the compounds of formula I are used for controlling insects or arachnids, in particular insects of the orders Lepidoptera, Coleoptera, Thysanoptera and Homoptera and arachnids of the order Acarina. The compounds of the formula I according to the present invention are particularly useful for controlling insects of the order Thysanoptera and Homoptera.

The compounds of formula I or the pesticidal compositions comprising them may be used to protect growing plants and crops from attack or infestation by invertebrate pests, especially insects, acaridae or arachnids by contacting the plant/crop with a pesticidally effective amount of compounds of formula I. The term “crop” refers both to growing and harvested crops.

The compounds of formula I can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineers Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, anti-foaming agents, anti-freezing agents, for seed treatment formulation also optionally colorants and/or binders and/or gelling agents.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone [NMP], N-octylpyrrolidone [NOP]), acetates (glycol diacetate), glycols, fatty acid dimethylamides, fatty acids and fatty acid esters. In principle, solvent mixtures may also be used.

Suitable emulsifiers are non-ionic and anionic emulsifiers (for example polyoxyethylene fatty alcohol ethers, alkylsulfonates and arylsulfonates).

Examples of dispersants are ligninsulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalene-sulfonic acid, alkylarylsulfonates, alkyl sulphates, alkylsulfonates, fatty alcohol sulfates, fatty acids and sulphated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

A suitable preservative is e.g. dichlorophen.

Seed treatment formulations may additionally comprise binders and optionally colorants.

Binders can be added to improve the adhesion of the active materials on the seeds after treatment. Suitable binders are block copolymers EO/PO surfactants but also polyvinylalcohols, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

An example of a gelling agent is carrageen (Satiagel®)

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). In this case, the active compound(s) are employed in a purity of from 90% to 100% by weight, preferably 95% to 100% by weight (according to NMR spectrum).

For seed treatment purposes, respective formulations can be diluted 2- to 10-fold leading to concentrations in the ready to use preparations of 0.01 to 60% by weight active compound by weight, preferably 0.1 to 40% by weight.

The compounds of formula I can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compound(s) according to the invention.

Aqueous use forms can be prepared from emulsion concentrates, pastes or wetable powders (sprayable powders, oil dispersions) by adding water. To prepare emulsions, pastes or oil dispersions, the substances, as such or dissolved in an oil or solvent, can be homogenized in water by means of a wetting agent, tackifier, dispersant or emulsifier. However, it is also possible to prepare concentrates composed of active substance, wetting agent, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound(s) may also be used successfully in the ultra-low-volume process (ULV), it being possible to apply formulations comprising over 95% by weight of active compound, or even to apply the active compound without additives.

The following are examples of formulations:

1. Products for dilution with water for foliar applications. For seed treatment purposes, such products may be applied to the seed diluted or undiluted.

### A) Water-Soluble Concentrates (SL, LS)

10 parts by weight of the active compound(s) are dissolved in 90 parts by weight of water or a water-soluble solvent. As an alternative, wetting agents or other auxiliaries are added. The active compound(s) dissolves upon dilution with water, whereby a formulation with 10% (w/w) of active compound(s) is obtained.

### B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

### C) Emulsifiable Concentrates (EC)

15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

### D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

### E) Suspensions (SC, OD, FS)

In an agitated ball mill, 20 parts by weight of the active compound(s) are comminuted with addition of 10 parts by weight of dispersants, wetting agents and 70 parts by weight of water or of an organic solvent to give a fine active compound(s) suspension. Dilution with water gives a stable suspension of the active compound(s), whereby a formulation with 20% (w/w) of active compound(s) is obtained.

### F) Water-Dispersible Granules and Water-Soluble Granules (WG, SG)

50 parts by weight of the active compound(s) are ground finely with addition of 50 parts by weight of dispersants and wetting agents and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

### G) Water-Dispersible Powders and Water-Soluble Powders (WP, SP, SS, WS)

75 parts by weight of the active compound(s) are ground in a rotor-stator mill with addition of 25 parts by weight of dispersants, wetting agents and silica gel. Dilution with water gives a stable dispersion or solution of the active compound(s), whereby a formulation with 75% (w/w) of active compound(s) is obtained.

### H) Gel-Formulation (GF)

In an agitated ball mill, 20 parts by weight of the active compound(s) are comminuted with addition of 10 parts by weight of dispersants, 1 part by weight of a gelling agent wetting agents and 70 parts by weight of water or of an organic solvent to give a fine active compound(s) suspension. Dilution with water gives a stable suspension of the active compound(s), whereby a formulation with 20% (w/w) of active compound(s) is obtained.

2. Products to be applied undiluted for foliar applications. For seed treatment purposes, such products may be applied to the seed diluted or undiluted.

### I) Dustable Powders (DP, DS)

5 parts by weight of the active compound(s) are ground finely and mixed intimately with 95 parts by weight of finely divided kaolin. This gives a dustable product having 5% (w/w) of active compound(s)

### J) Granules (GR, FG, GG, MG)

0.5 parts by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

### K) ULV Solutions (UL)

10 parts by weight of the active compound(s) are dissolved in 90 parts by weight of an organic solvent, for example xylene. This gives a product having 10% (w/w) of active compound(s), which is applied undiluted for foliar use.

The compounds of formula I are also suitable for the treatment of plant propagation materials (such as seed). Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

In a preferred embodiment a FS formulation is used for seed treatment. Typically, a FS formulation may comprise 1 to 800 g/l of active ingredient, 1 to 200 g/l surfactant, 0 to 200 g/l antifreezing agent, 0 to 400 g/l of binder, 0 to 200 g/l of a pigment and up to 1 liter of a solvent, preferably water.

Other preferred FS formulations of compounds of formula I for seed treatment comprise from 0.5 to 80% wt of the active ingredient, from 0.05 to 5% wt of a wetting agent, from 0.5 to 15% wt of a dispersing agent, from 0.1 to 5% wt of a thickener, from 5 to 20% wt of an anti-freeze agent, from 0.1 to 2% wt of an anti-foam agent, from 1 to 20% wt of a pigment and/or a dye, from 0 to 15% wt of a sticker/adhesion agent, from 0 to 75% wt of a filler/vehicle, and from 0.01 to 1% wt of a preservative.

Various types of oils, wetting agents, adjuvants, herbicides, fungicides, other pesticides, or bactericides may be added to the active ingredients, if appropriate just immediately prior to use (tank mix). These agents usually are admixed with the agents according to the invention in a weight ratio of 1:10 to 10:1.

The compounds of formula I are effective through both contact (via soil, glass, wall, bed net, carpet, plant parts or animal parts), and ingestion (bait, or plant part).

For use against ants, termites, wasps, flies, mosquitoes, crickets, or cockroaches, compounds of formula I are preferably used in a bait composition.

The bait can be a liquid, a solid or a semisolid preparation (e.g. a gel). Solid baits can be formed into various shapes and forms suitable to the respective application e.g. granules, blocks, sticks, disks. Liquid baits can be filled into various devices to ensure proper application, e.g. open containers, spraying devices, droplet sources, or evaporation sources. Gels can be based on aqueous or oily matrices and can be formulated to particular necessities in terms of stickiness, moisture retention or aging characteristics.

The bait employed in the composition is a product, which is sufficiently attractive to incite insects such as ants, termites, wasps, flies, mosquitoes, crickets etc. or cockroaches to eat it. The attractiveness can be manipulated by using feeding stimulants or sex pheromones. Food stimulants are chosen, for example, but not exclusively, from animal and/or plant proteins (meat-, fish- or blood meal, insect parts, egg yolk), from fats and oils of animal and/or plant origin, or mono-, oligo- or polyorganosaccharides, especially from sucrose, lactose, fructose, dextrose, glucose, starch, pectin or even molasses or honey. Fresh or decaying parts of fruits, crops, plants, animals, insects or specific parts thereof can also serve as a feeding stimulant. Sex pheromones are known to be more insect specific. Specific pheromones are described in the literature and are known to those skilled in the art.

Formulations of compounds of formula I as aerosols (e.g. in spray cans), oil sprays or pump sprays are highly suitable for the non-professional user for controlling pests such as flies, fleas, ticks, mosquitos or cockroaches. Aerosol recipes are preferably composed of the active compound, solvents such as lower alcohols (e.g. methanol, ethanol, propanol, butanol), ketones (e.g. acetone, methyl ethyl ketone), paraffin hydrocarbons (e.g. kerosenes) having boiling ranges of approximately 50 to 250° C., dimethylformamide, N-methylpyrrolidone, dimethyl sulphoxide, aromatic hydrocarbons such as toluene, xylene, water, furthermore auxiliaries such as emulsifiers such as sorbitol monooleate, oleyl ethoxylate having 3 to 7 mol of ethylene oxide, fatty alcohol ethoxylate, perfume oils such as ethereal oils, esters of medium fatty acids with lower alcohols, aromatic carbonyl compounds, if appropriate stabilizers such as sodium benzoate, amphoteric surfactants, lower epoxides, triethyl orthoformate and, if required, propellants such as propane, butane, nitrogen, compressed air, dimethyl ether, carbon dioxide, nitrous oxide, or mixtures of these gases.

The oil spray formulations differ from the aerosol recipes in that no propellants are used.

The compounds of formula I and their respective compositions can also be used in mosquito and fumigating coils, smoke cartridges, vaporizer plates or long-term vaporizers and also in moth papers, moth pads or other heat-independent vaporizer systems.

Methods to control infectious diseases transmitted by insects (e.g. malaria, dengue and yellow fever, lymphatic filariasis, and leishmaniasis) with compounds of formula I and its respective compositions also comprise treating surfaces of huts and houses, air spraying and impregnation of curtains, tents, clothing items, bed nets, tsetse-fly trap or the like. Insecticidal compositions for application to fibers, fabric, knitgoods, non-wovens, netting material or foils and tarpaulins preferably comprise a mixture including the insecticide, optionally a repellent and at least one binder. Suitable repellents for example are N,N-diethyl-meta-toluamide (DEET), N,N-diethylphenylacetamide (DEPA), 1-(3-cyclohexan-1-yl-carbonyl)-2-methylpiperine, (2-hydroxymethylcyclohexyl)acetic acid lactone, 2-ethyl-1,3-hexandiol, indalone, Methylneodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella). Suitable binders are selected for example from polymers and copolymers of vinyl esters of aliphatic acids (such as such as vinyl acetate and vinyl versatate), acrylic and methacrylic esters of alcohols, such as butyl acrylate, 2-ethylhexylacrylate, and methyl acrylate, mono- and diethylenically unsaturated hydrocarbons, such as styrene, and aliphatic diens, such as butadiene.

The impregnation of curtains and bednets is done in general by dipping the textile material into emulsions or dispersions of the active compounds of formula I or spraying them onto the nets.

Methods which can be employed for treating the seed are, in principle, all suitable seed treatment and especially seed dressing techniques known in the art, such as seed coating (e.g. seed pelleting), seed dusting and seed imbibition (e.g. seed soaking). Here, “seed treatment” refers to all methods that bring seeds and the compounds of formula I into contact with each other, and “seed dressing” to methods of seed treatment which provide the seeds with an amount of the compounds of formula I, i.e. which generate a seed comprising the compound of formula I. In principle, the treatment can be applied to the seed at any time from the harvest of the seed to the sowing of the seed. The seed can be treated immediately before, or during, the planting of the seed, for example using the “planters box” method. However, the treatment may also be carried out several weeks or months, for example up to 12 months, before planting the seed, for example in the form of a seed dressing treatment, without a substantially reduced efficacy being observed.

Expediently, the treatment is applied to unsown seed. As used herein, the term “unsown seed” is meant to include seed at any period from the harvest of the seed to the sowing of the seed in the ground for the purpose of germination and growth of the plant.

Specifically, a procedure is followed in the treatment in which the seed is mixed, in a suitable device, for example a mixing device for solid or solid/liquid mixing partners, with the desired amount of seed treatment formulations, either as such or after previous dilution with water, until the composition is distributed uniformly on the seed. If appropriate, this is followed by a drying step.

The compounds of formula I or the enantiomers diastereomers or veterinarily acceptable salts thereof are in particular also suitable for being used for combating parasites in and on animals.

A further object of the present invention is therefore also to provide new methods for controlling parasites in and on animals. Another object of the invention is to provide safer pesticides for animals. Another object of the invention is further to provide pesticides for animals that may be used in lower doses than existing pesticides. An another object of the invention is to provide pesticides for animals, which provide a long residual control of the parasites.

The invention also relates to compositions containing a parasiticidally effective amount of compounds of formula I or the enantiomers or veterinarily acceptable salts thereof and an acceptable carrier, for combating parasites in and on animals.

The present invention also provides a method for treating, controlling, preventing and protecting animals against infestation and infection by parasites, which comprises orally, topically or parenterally administering or applying to the animals a parasiticidally effective amount of compounds of formula I or the enantiomers or veterinarily acceptable salts thereof and an acceptable carrier or a composition comprising it.

The present invention also provides a non-therapeutic method for treating, controlling, preventing and protecting animals against infestation and infection by parasites, which comprises applying to a locus-P a parasiticidally effective amount of a compound of formula I or the enantiomers or veterinarily acceptable salts thereof and an acceptable carrier or a composition comprising it.

The invention also provides a process for the preparation of a composition for treating, controlling, preventing or protecting animals against infestation or infection by parasites which comprises including a parasiticidally effective amount of a compound of formula I or the enantiomers or veterinarily acceptable salts thereof and an acceptable carrier or a composition comprising it.

The invention relates further to the use of compounds of formula I for treating, controlling, preventing or protecting animals against infestation or infection by parasites.

The invention relates also to the use of a compound of formula I or the enantiomers or veterinarily acceptable salts thereof and an acceptable carrier or a composition comprising it, for the manufacture of a medicament for the therapeutic treatment of animals against infections or infestions by parasites.

Activity of compounds against agricultural pests does not suggest their suitability for control of endo- and ectoparasites in and on animals which requires, for example, low, nonemetic dosages in the case of oral application, metabolic compatibility with the animal, low toxicity, and a safe handling.

Surprisingly, it has been found that compounds of formula I are suitable for combating endo- and ectoparasites in and on animals. The compounds of formula I or the enantiomers or veterinarily acceptable salts thereof and compositions comprising them are suitable for systemic and/or non-systemic control of ecto- and/or endoparasites. They are active against all or some stages of development.

Compounds of formula I or the enantiomers or veterinarily acceptable salts thereof and compositions comprising them are preferably used for controlling and preventing infestations and infections in animals including warm-blooded animals (including humans) and fish. They are for example suitable for controlling and preventing infestations and infections in mammals such as cattle, sheep, swine, camels, deer, horses, pigs, poultry, rabbits, goats, dogs and cats, water buffalo, donkeys, fallow deer and reindeer, and also in fur-bearing animals such as mink, chinchilla and raccoon, birds such as hens, geese, turkeys and ducks and fish such as fresh- and salt-water fish such as trout, carp and eels.

Compounds of formula I or the enantiomers or veterinarily acceptable salts thereof and compositions comprising them are preferably used for controlling and preventing infestations and infections in domestic animals, such as dogs or cats.

Infestations in warm-blooded animals and fish include, but are not limited to, lice, biting lice, ticks, nasal bots, keds, biting flies, muscoid flies, flies, myiasitic fly larvae, chiggers, gnats, mosquitoes and fleas.

The compounds of formula I are especially useful for combating ectoparasites.

The compounds of formula I are especially useful for combating endoparasites.

The compounds of formula I are especially useful for combating parasites of the following orders and species, respectively:

fleas (Siphonaptera), e.g. Ctenocephalides felis, Ctenocephalides canis, Xenopsylla cheopis, Pulex irritans, Tunga penetrans, and Nosopsyllus fasciatus,
cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,
flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyia hominivorax, Cordylobia anthropophaga, Culicoides furens, Culex pipiens, Culex nigripalpus, Culex quinquefasciatus, Culex tarsalis, Culiseta inornata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Leptoconops torrens, Lucilia caprina, Lucilia cuprina, Lucilia sericata, Lycoria pectoralis, Mansonia spp., Musca domestica, Muscina stabulans, Oestrus ovis, Phlebotomus argentipes, Psorophora columbiae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola, and Tabanus similis,
lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus,
ticks and parasitic mites (Parasitiformes): ticks (Ixodida), e.g. Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Ornithodorus hermsi, Ornithodorus turicata and parasitic mites (Mesostigmata), e.g. Ornithonyssus bacoti and Dermanyssus gallinae,
Actinedida (Prostigmata) and Acaridida (Astigmata) e.g. Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., and Laminosioptes spp,
Bugs (Heteropterida): Cimex lectularius, Cimex hemipterus, Reduvius senilis, Triatoma spp., Rhodnius ssp., Panstrongylus ssp. and Arilus critatus,
Anoplurida, e.g. Haematopinus spp., Linognathus spp., Pediculus spp., Phtirus spp., and Solenopotes spp,
Mallophagida (suborders Arnblycerina and Ischnocerina), e.g. Trimenopon spp., Menopon spp., Trinoton spp., Bovicola spp., Werneckiella spp., Lepikentron spp., Trichodectes spp., and Felicola spp,

### Roundworms Nematoda:

Wipeworms and Trichinosis (Trichosyringida), e.g. Trichinellidae (Trichinella spp.), (Trichuridae) Trichuris spp., Capillaria spp,
Rhabditida, e.g. Rhabditis spp, Strongyloides spp., Helicephalobus spp, Strongylida, e.g. Strongylus spp., Ancylostoma spp., Necator americanus, Bunostomum spp. (Hookworm), Trichostrongylus spp., Haemonchus contortus, Ostertagia spp., Cooperia spp., Nematodirus spp., Dictyocaulus spp., Cyathostoma spp., Oesophagostomum spp., Stephanurus dentatus, Ollulanus spp., Chabertia spp., Stephanurus dentatus, Syngamus trachea, Ancylostoma spp., Uncinaria spp., Globocephalus spp., Necator spp., Metastrongylus spp., Muellerius capillaris, Protostrongylus spp., Angiostrongylus spp., Parelaphostrongylus spp. Aleurostrongylus abstrusus, and Dioctophyma renale,
Intestinal roundworms (Ascaridida), e.g. Ascaris lumbricoides, Ascaris suum, Ascaridia galli, Parascaris equorum, Enterobius vermicularis (Threadworm), Toxocara canis, Toxascaris leonine, Skrjabinema spp., and Oxyuris equi,
Camallanida, e.g. Dracunculus medinensis (guinea worm),
Spirurida, e.g. Thelazia spp. Wuchereria spp., Brugia spp., Onchocerca spp., Dirofilari spp.a, Dipetalonema spp., Setaria spp., Elaeophora spp., Spirocerca lupi, and Habronema spp.,
Thorny headed worms (Acanthocephala), e.g. Acanthocephalus spp., Macracanthorhynchus hirudinaceus and Oncicola spp,

### Planarians (Plathelminthes):

Flukes (Trematoda), e.g. Faciola spp., Fascioloides magna, Paragonimus spp., Dicrocoelium spp., Fasciolopsis buski, Clonorchis sinensis, Schistosoma spp., Trichobilharzia spp., Alaria alata, Paragonimus spp., and Nanocyetes spp,
Cercomeromorpha, in particular Cestoda (Tapeworms), e.g. Diphyllobothrium spp., Tenia spp., Echinococcus spp., Dipylidium caninum, Multiceps spp., Hymenolepis spp., Mesocestoides spp., Vampirolepis spp., Moniezia spp., Anoplocephala spp., Sirometra spp., Anoplocephala spp., and Hymenolepis spp.

The compounds of formula I and compositions containing them are particularly useful for the control of pests from the orders Diptera, Siphonaptera and Ixodida.

Moreover, the use of the compounds of formula I and compositions containing them for combating mosquitoes is especially preferred.

The use of the compounds of formula I and compositions containing them for combating flies is a further preferred embodiment of the present invention.

Furthermore, the use of the compounds of formula I and compositions containing them for combating fleas is especially preferred.

The use of the compounds of formula I and compositions containing them for combating ticks is a further preferred embodiment of the present invention.

The compounds of formula I and compositions containing them also are especially useful for combating endoparasites (roundworms nematoda, thorny headed worms and planarians).

The compounds of formula I and compositions containing them can be effective through both contact (via soil, glass, wall, bed net, carpet, blankets or animal parts) and ingestion (e.g. baits).

The present invention relates to the therapeutic and the non-therapeutic use of compounds of formula I and compositions containing them for controlling and/or combating parasites in and/or on animals.

The compounds of formula I and compositions containing them may be used to protect the animals from attack or infestation by parasites by contacting them with a parasitically effective amount of compounds of formula I and compositions containing them. As such, “contacting” includes both direct contact (applying the pesticidal mixtures/compositions containing the compounds of formula I according to the present invention directly on the parasite, which may include an indirect contact at its locus-P, and optionally also administrating the pesticidal mixtures/composition directly on the animal to be protected) and indirect contact (applying the compounds/compositions to the locus of the parasite). The contact of the parasite through application to its locus is an example of a non-therapeutic use of compounds of formula I.

“Locus-P” as used above means the habitat, food supply, breeding ground, area, material or environment in which a parasite is growing or may grow outside of the animal. The compounds of the invention can also be applied preventively to places at which occurrence of the pests or parasites are expected.

The compounds of formula I can be effective through both contact (via soil, glass, wall, bed net, carpet, blankets or animal parts) and ingestion (e.g. baits).

Administration can be carried out prophylactically, therapeutically or non-therapeutically.

Administration of the active compounds is carried out directly or in the form of suitable preparations, orally, topically/dermally or parenterally.

In general, “parasiticidally effective amount” means the amount of active ingredient needed to achieve an observable effect on growth, including the effects of necrosis, death, retardation, prevention, and removal, destruction, or otherwise diminishing the occurrence and activity of the target organism. The parasiticidally effective amount can vary for the various compounds/compositions used in the invention. A parasiticidally effective amount of the compositions will also vary according to the prevailing conditions such as desired parasiticidal effect and duration, target species, mode of application, and the like.

Generally it is favorable to apply the compounds of formula I in total amounts of 0.5 mg/kg to 100 mg/kg per day, preferably 1 mg/kg to 50 mg/kg per day.

### Formulations

For oral administration to warm-blooded animals, the compounds of formula I may be formulated as animal feeds, animal feed premixes, animal feed concentrates, pills, solutions, pastes, suspensions, drenches, gels, tablets, boluses and capsules. In addition, the compounds of formula I may be administered to the animals in their drinking water. For oral administration, the dosage form chosen should provide the animal with 0.01 mg/kg to 100 mg/kg of animal body weight per day of the formula I compound, preferably with 0.5 mg/kg to 100 mg/kg of animal body weight per day.

Alternatively, the compounds of formula I may be administered to animals parenterally, for example, by intraruminal, intramuscular, intravenous or subcutaneous injection. The compounds of formula I may be dispersed or dissolved in a physiologically acceptable carrier for subcutaneous injection. Alternatively, the compounds of formula I may be formulated into an implant for subcutaneous administration. In addition the compounds of formula I may be transdermally administered to animals. For parenteral administration, the dosage form chosen should provide the animal with 0.01 mg/kg to 100 mg/kg of animal body weight per day of the compounds of formula I.

The compounds of formula I may also be applied topically to the animals in the form of dips, dusts, powders, collars, medallions, sprays, shampoos, spot-on and pour-on formulations and in ointments or oil-in-water or water-in-oil emulsions. For topical application, dips and sprays usually contain 0.5 ppm to 5 000 ppm and preferably 1 ppm to 3 000 ppm of the compounds of formula I. In addition, the compounds of formula I may be formulated as ear tags for animals, particularly quadrupeds such as cattle and sheep.

Suitable preparations are:

Solutions such as oral solutions, concentrates for oral administration after dilution, solutions for use on the skin or in body cavities, pouring-on formulations, gels;
Emulsions and suspensions for oral or dermal administration; semi-solid preparations;
Formulations in which the active compound is processed in an ointment base or in an oil-in-water or water-in-oil emulsion base;
Solid preparations such as powders, premixes or concentrates, granules, pellets, tablets, boluses, capsules; aerosols and inhalants, and active compound-containing shaped articles.

Compositions suitable for injection are prepared by dissolving the active ingredient in a suitable solvent and optionally adding further ingredients such as acids, bases, buffer salts, preservatives, and solubilizers. The solutions are filtered and filled sterile. Suitable solvents are physiologically tolerable solvents such as water, alkanols such as ethanol, butanol, benzyl alcohol, glycerol, propylene glycol, polyethylene glycols, N-methylpyrrolidone, 2-pyrrolidone, and mixtures thereof.

The active compounds can optionally be dissolved in physiologically tolerable vegetable or synthetic oils which are suitable for injection.

Suitable solubilizers are solvents which promote the dissolution of the active compound in the main solvent or prevent its precipitation. Examples are polyvinylpyrrolidone, polyvinyl alcohol, polyoxyethylated castor oil, and polyoxyethylated sorbitan ester. Suitable preservatives are benzyl alcohol, trichlorobutanol, p-hydroxybenzoic acid esters, and n-butanol.

Oral solutions are administered directly. Concentrates are administered orally after prior dilution to the use concentration. Oral solutions and concentrates are prepared according to the state of the art and as described above for injection solutions, sterile procedures not being necessary.

Solutions for use on the skin are trickled on, spread on, rubbed in, sprinkled on or sprayed on.

Solutions for use on the skin are prepared according to the state of the art and according to what is described above for injection solutions, sterile procedures not being necessary.

Further suitable solvents are polypropylene glycol, phenyl ethanol, phenoxy ethanol, ester such as ethyl or butyl acetate, benzyl benzoate, ethers such as alkyleneglycol alkylether, e.g. dipropylenglycol monomethylether, ketons such as acetone, methylethylketone, aromatic hydrocarbons, vegetable and synthetic oils, dimethylformamide, dimethylacetamide, transcutol, solketal, propylencarbonate, and mixtures thereof.

It may be advantageous to add thickeners during preparation. Suitable thickeners are inorganic thickeners such as bentonites, colloidal silicic acid, aluminium monostearate, organic thickeners such as cellulose derivatives, polyvinyl alcohols and their copolymers, acrylates and methacrylates.

Gels are applied to or spread on the skin or introduced into body cavities. Gels are prepared by treating solutions which have been prepared as described in the case of the injection solutions with sufficient thickener that a clear material having an ointment-like consistency results. The thickeners employed are the thickeners given above. Pour-on formulations are poured or sprayed onto limited areas of the skin, the active compound penetrating the skin and acting systemically.

Pour-on formulations are prepared by dissolving, suspending or emulsifying the active compound in suitable skin-compatible solvents or solvent mixtures. If appropriate, other auxiliaries such as colorants, bioabsorption-promoting substances, antioxidants, light stabilizers, adhesives are added.

Suitable solvents are: water, alkanols, glycols, polyethylene glycols, polypropylene glycols, glycerol, aromatic alcohols such as benzyl alcohol, phenylethanol, phenoxyethanol, esters such as ethyl acetate, butyl acetate, benzyl benzoate, ethers such as alkylene glycol alkyl ethers such as dipropylene glycol monomethyl ether, diethylene glycol mono-butyl ether, ketones such as acetone, methyl ethyl ketone, cyclic carbonates such as propylene carbonate, ethylene carbonate, aromatic and/or aliphatic hydrocarbons, vegetable or synthetic oils, DMF, dimethylacetamide, N-alkylpyrrolidones such as N-methylpyrrolidone, N-butylpyrrolidone or N-octylpyrrolidone, 2-pyrrolidone, 2,2-dimethyl-4-oxy-methylene-1,3-dioxolane and glycerol formal.

Suitable colorants are all colorants permitted for use on animals and which can be dissolved or suspended.

Suitable absorption-promoting substances are, for example, DMSO, spreading oils such as isopropyl myristate, dipropylene glycol pelargonate, silicone oils and copolymers thereof with polyethers, fatty acid esters, triglycerides, fatty alcohols.

Suitable antioxidants are sulfites or metabisulfites such as potassium metabisulfite, ascorbic acid, butylhydroxytoluene, butylhydroxyanisole, tocopherol.

Suitable light stabilizers are, for example, novantisolic acid.

Suitable adhesives are, for example, cellulose derivatives, starch derivatives, polyacrylates, natural polymers such as alginates, gelatin.

Emulsions can be administered orally, dermally or as injections.

Emulsions are either of the water-in-oil type or of the oil-in-water type.

They are prepared by dissolving the active compound either in the hydrophobic or in the hydrophilic phase and homogenizing this with the solvent of the other phase with the aid of suitable emulsifiers and, if appropriate, other auxiliaries such as colorants, absorption-promoting substances, preservatives, antioxidants, light stabilizers, viscosity-enhancing substances.

Suitable hydrophobic phases (oils) are:

liquid paraffins, silicone oils, natural vegetable oils such as sesame oil, almond oil, castor oil, synthetic triglycerides such as caprylic/capric biglyceride, triglyceride mixture with vegetable fatty acids of the chain length C₈-C₁₂ or other specially selected natural fatty acids, partial glyceride mixtures of saturated or unsaturated fatty acids possibly also containing hydroxyl groups, mono- and diglycerides of the C₈-C₁₀ fatty acids, fatty acid esters such as ethyl stearate, di-n-butyryl adipate, hexyl laurate, dipropylene glycol perlargonate, esters of a branched fatty acid of medium chain length with saturated fatty alcohols of chain length C₁₆-C₁₈, isopropyl myristate, isopropyl palmitate, caprylic/capric acid esters of saturated fatty alcohols of chain length C₁₂-C₁₈, isopropyl stearate, ° leyl oleate, decyl oleate, ethyl oleate, ethyl lactate, waxy fatty acid esters such as synthetic duck coccygeal gland fat, dibutyl phthalate, diisopropyl adipate, and ester mixtures related to the latter, fatty alcohols such as isotridecyl alcohol, 2-octyldodecanol, cetylstearyl alcohol, oleyl alcohol, and fatty acids such as oleic acid and mixtures thereof.

Suitable hydrophilic phases are: water, alcohols such as propylene glycol, glycerol, sorbitol and mixtures thereof.

Suitable emulsifiers are:

non-ionic surfactants, e.g. polyethoxylated castor oil, polyethoxylated sorbitan monooleate, sorbitan monostearate, glycerol monostearate, polyoxyethyl stearate, alkylphenol polyglycol ether; ampholytic surfactants such as di-sodium N-lauryl-p-iminodipropionate or lecithin; anionic surfactants, such as sodium lauryl sulfate, fatty alcohol ether sulfates, mono/dialkyl polyglycol ether orthophosphoric acid ester monoethanolamine salt; cation-active surfactants, such as cetyltrimethylammonium chloride. Suitable further auxiliaries are: substances which enhance the viscosity and stabilize the emulsion, such as carboxymethylcellulose, methylcellulose and other cellulose and starch derivatives, polyacrylates, alginates, gelatin, gum arabic, polyvinylpyrrolidone, polyvinyl alcohol, copolymers of methyl vinyl ether and maleic anhydride, polyethylene glycols, waxes, colloidal silicic acid or mixtures of the substances mentioned.

Suspensions can be administered orally or topically/dermally. They are prepared by suspending the active compound in a suspending agent, if appropriate with addition of other auxiliaries such as wetting agents, colorants, bioabsorption-promoting substances, preservatives, antioxidants, light stabilizers.

Liquid suspending agents are all homogeneous solvents and solvent mixtures.

Suitable wetting agents (dispersants) are the emulsifiers given above.

Other auxiliaries which may be mentioned are those given above.

Semi-solid preparations can be administered orally or topically/dermally. They differ from the suspensions and emulsions described above only by their higher viscosity. For the production of solid preparations, the active compound is mixed with suitable excipients, if appropriate with addition of auxiliaries, and brought into the desired form. Suitable excipients are all physiologically tolerable solid inert substances. Those used are inorganic and organic substances. Inorganic substances are, for example, sodium chloride, carbonates such as calcium carbonate, hydrogencarbonates, aluminium oxides, titanium oxide, silicic acids, argillaceous earths, precipitated or colloidal silica, or phosphates. Organic substances are, for example, sugar, cellulose, foodstuffs and feeds such as milk powder, animal meal, grain meals and shreds, starches. Suitable auxiliaries are preservatives, antioxidants, and/or colorants which have been mentioned above.

Other suitable auxiliaries are lubricants and glidants such as magnesium stearate, stearic acid, talc, bentonites, disintegration-promoting substances such as starch or crosslinked polyvinylpyrrolidone, binders such as starch, gelatin or linear polyvinylpyrrolidone, and dry binders such as microcrystalline cellulose.

In general, “parasiticidally effective amount” means the amount of active ingredient needed to achieve an observable effect on growth, including the effects of necrosis, death, retardation, prevention, and removal, destruction, or otherwise diminishing the occurrence and activity of the target organism. The parasiticidally effective amount can vary for the various compounds/compositions used in the invention. A parasiticidally effective amount of the compositions will also vary according to the prevailing conditions such as desired parasiticidal effect and duration, target species, mode of application, and the like.

The compositions which can be used in the invention can comprise generally from about 0.001 to 95% of the compound of formula I.

Generally, it is favorable to apply the compounds of formula I in total amounts of 0.5 mg/kg to 100 mg/kg per day, preferably 1 mg/kg to 50 mg/kg per day.

Ready-to-use preparations contain the compounds acting against parasites, preferably ectoparasites, in concentrations of 10 ppm to 80% by weight, preferably from 0.1 to 65% by weight, more preferably from 1 to 50% by weight, most preferably from 5 to 40 percent by weight.

Preparations which are diluted before use contain the compounds acting against ectoparasites in concentrations of 0.5 to 90 percent by weight, preferably of 1 to 50 percent by weight.

Furthermore, the preparations comprise the compounds of formula I against endoparasites in concentrations of 10 ppm to 2 percent by weight, preferably of 0.05 to 0.9 percent by weight, very particularly preferably of 0.005 to 0.25 percent by weight.

In a preferred embodiment of the present invention, the compositions comprising the compounds of formula I are applied dermally/topically.

In a further preferred embodiment, the topical application is conducted in the form of compound-containing shaped articles such as collars, medallions, ear tags, bands for fixing at body parts, and adhesive strips and foils.

Generally, it is favorable to apply solid formulations which release compounds of formula I in total amounts of 10 mg/kg to 300 mg/kg, preferably 20 mg/kg to 200 mg/kg, most preferably 25 mg/kg to 160 mg/kg body weight of the treated animal in the course of three weeks.

For the preparation of the shaped articles, thermoplastic and flexible plastics as well as elastomers and thermoplastic elastomers are used. Suitable plastics and elastomers are polyvinyl resins, polyurethane, polyacrylate, epoxy resins, cellulose, cellulose derivatives, polyamides and polyester which are sufficiently compatible with the compounds of formula I. A detailed list of plastics and elastomers as well as preparation procedures for the shaped articles is given e.g. in WO 03/086075.

The active compounds can be applied solely or in a mixture with synergists or with other active compounds which act against pathogenic endo- and ectoparasites. For example, the active compounds of formula I can be applied in mixtures with synthetic coccidiosis compounds, polyetherantibiotics as Amprolium, Robenidin, Toltrazuril, Monensin, Salinomycin, Maduramicin, Lasalocid, Narasin or Semduramicin or with other pesticides which are described in the list M below.

Compositions to be used according to this invention may also contain other active ingredients, for example other pesticides, insecticides, herbicides, fungicides, other pesticides, or bactericides, fertilizers such as ammonium nitrate, urea, potash, and super-phosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients.

These agents can be admixed with the agents used according to the invention in a weight ratio of 1:10 to 10:1. Mixing the compounds of formula I or the compositions comprising them in the use form as pesticides with other pesticides frequently results in a broader pesticidal spectrum of action.

The following list M of pesticides together with which the compounds of formula I according to the invention can be used and with which potential synergistic effects might be produced, is intended to illustrate the possible combinations, but not to impose any limitation:

M.1. Organo(thio)phosphates compounds: acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-5-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;
M.2. Carbamates compounds: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate;
M.3. Pyrethroid compounds: acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zetacypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, metofluthrin, permethrin, phenothrin, prallethrin, profluthrin, pyrethrin (pyrethrum), resmethrin, silafluofen, tefluthrin, tetramethrin, tralomethrin, transfluthrin;
M.4. Juvenile hormone mimics: hydroprene, kinoprene, methoprene, fenoxycarb, pyriproxyfen;
M.5. Nicotinic receptor agonists/antagonists compounds: acetamiprid, bensultap, cartap hydrochloride, clothianidin, dinotefuran, imidacloprid, thiamethoxam, nitenpyram, nicotine, spinosad (allosteric agonist), spinetoram (allosteric agonist), thiacloprid, thiocyclam, thiosultap-sodium and AKD1022.
M.6. GABA gated chloride channel antagonist compounds: chlordane, endosulfan, gamma-HCH (lindane); ethiprole, fipronil, pyrafluprole, pyriprole
M.7. Chloride channel activators: abamectin, emamectin benzoate, milbemectin, lepimectin;
M.8. METI I compounds: fenazaquin, fenpyroximate, pyrimidifen, pyridaben, tebufenpyrad, tolfenpyrad, flufenerim, rotenone;
M.9. METI II and III compounds: acequinocyl, fluacyprim, hydramethylnon;
M.10. Uncouplers of oxidative phosphorylation: chlorfenapyr, DNOC;
M.11. Inhibitors of oxidative phosphorylation: azocyclotin, cyhexatin, diafenthiuron, fenbutatin oxide, propargite, tetradifon;
M.12. Moulting disruptors: cyromazine, chromafenozide, halofenozide, methoxyfenozide, tebufenozide;
M.13. Synergists: piperonyl butoxide, tribufos;
M.14. Sodium channel blocker compounds: indoxacarb, metaflumizone;
M.15. Fumigants: methyl bromide, chloropicrin sulfuryl fluoride;
M.16. Selective feeding blockers: crylotie, pymetrozine, flonicamid;
M.17. Mite growth inhibitors: clofentezine, hexythiazox, etoxazole;
M.18. Chitin synthesis inhibitors: buprofezin, bistrifluoron, chlorfluazuron, diflubenzuron, flucycloxuron, flufenoxuron, hexaflumuron, lufenuron, novaluron, noviflumuron, teflubenzuron, triflumuron;
M.19. Lipid biosynthesis inhibitors: spirodiclofen, spiromesifen, spirotetramat;
M.20. Octapaminergic agonists: amitraz;
M.21. Ryanodine receptor modulators: flubendiamide; (R)-, (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (M21.1);

### M.22. Isoxazoline,

4-[5-(3,5-Dichloro-phenyl)-5-trifluoromethyl-4,5-dihydro-isoxazol-3-yl]-2-methyl-N-(2,2,2-trifluoro-ethyl)-benzamide (M22.2), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (M22.3), 4-[5-(3,5-Dichloro-phenyl)-5-trifluoromethyl-4,5-dihydro-isoxazol-3-yl]-naphthalene-1-carboxylic acid [(2,2,2-trifluoro-ethylcarbamoyl)-methyl]-amide (M22.4) and 4-[5-(3,5-Dichlorophenyl)-5-trifluoromethyl-4,5-dihydro-isoxazol-3-yl]-N-[(methoxyimino)methyl]-2-methylbenzamide (M22.5), 4-[5-(3-Chloro-5-trifluoromethyl-phenyl)-5-trifluoromethyl-4,5-dihydro-isoxazol-3-yl]-2-methyl-N-[(2,2,2-trifluoro-ethylcarbamoyl)-methyl]-benzamide (M22.6);
4-[5-(3-Chloro-5-trifluoromethyl-phenyl)-5-trifluoromethyl-4,5-dihydro-isoxazol-3-yl]-naphthalene-1-carboxylic acid [(2,2,2-trifluoro-ethylcarbamoyl)-methyl]-amide (M22.7) and 5-[5-(3,5-Dichloro-4-fluoro-phenyl)-5-trifluoromethyl-4,5-dihydro-isoxazol-3-yl]-2-[1,2,4]triazol-1-yl-benzonitrile (M22.8);
M.23. Anthranilamide compounds: chloranthraniliprole, cyantraniliprole, 5-Bromo-2-(3-chloro-pyridin-2-yl)-2H-pyrazole-3-carboxylic acid [4-cyano-2-(1-cyclopropyl-ethylcarbamoyl)-6-methyl-phenyl]-amide (M23.1), 5-Bromo-2-(3-chloro-pyridin-2-yl)-2H-pyrazole-3-carboxylic acid [2-chloro-4-cyano-6-(1-cyclopropyl-ethylcarbamoyl)-phenyl]-amide (M23.2), 5-Bromo-2-(3-chloro-pyridin-2-yl)-2H-pyrazole-3-carboxylic acid [2-bromo-4-cyano-6-(1-cyclopropyl-ethylcarbamoyl)-phenyl]-amide(M23.3), 5-Bromo-2-(3-chloro-pyridin-2-yl)-2H-pyrazole-3-carboxylic acid [2-bromo-4-chloro-6-(1-cyclopropyl-ethylcarbamoyl)-phenyl]-amide(M23.4), 5-Bromo-2-(3-chloro-pyridin-2-yl)-2H-pyrazole-3-carboxylic acid [2,4-dichloro-6-(1-cyclopropyl-ethylcarbamoyl)-phenyl]-amide (M23.5), 5-Bromo-2-(3-chloro-pyridin-2-yl)-2H-pyrazole-3-carboxylic acid [4-chloro-2-(1-cyclopropyl-ethylcarbamoyl)-6-methyl-phenyl]-amide (M23.6), N′-(2-{[5-Bromo-2-(3-chloro-pyridin-2-yl)-2H-pyrazole-3-carbonyl]-amino}-5-chloro-3-methyl-benzoyl)-hydrazinecarboxylic acid methyl ester (M23.7), N′-(2-{[5-Bromo-2-(3-chloro-pyridin-2-yl)-2H-pyrazole-3-carbonyl]-amino}-5-chloro-3-methyl-benzoyl)-N′-methyl-hydrazinecarboxylic acid methyl ester (M23.8), N′-(2-{[5-Bromo-2-(3-chloro-pyridin-2-yl)-2H-pyrazole-3-carbonyl]-amino}-5-chloro-3-methyl-benzoyl)-N,N′-dimethyl-hydrazinecarboxylic acid methyl ester (M23.9), N′-(3,5-Dibromo-2-{[5-bromo-2-(3-chloro-pyridin-2-yl)-2H-pyrazole-3-carbonyl]-amino}-benzoyl)-hydrazinecarboxylic acid methyl ester (M23.10), N′-(3,5-Dibromo-2-{[5-bromo-2-(3-chloro-pyridin-2-yl)-2H-pyrazole-3-carbonyl]-amino}-benzoyl)-N′-methyl-hydrazinecarboxylic acid methyl ester (M23.11) and N′-(3,5-Dibromo-2-{[5-bromo-2-(3-chloro-pyridin-2-yl)-2H-pyrazole-3-carbonyl]-amino}-benzoyl)-N,N′-dimethyl-hydrazinecarboxylic acid methyl ester (M23.12);
M.24. Malononitrile compounds: 2-(2,2,3,3,4,4,5,5-octafluoropentyl)-2-(3,3,3-trifluoro-propyl)malononitrile (CF₂H—CF₂—CF₂—CF₂—CH₂—C(CN)₂—CH₂—CH₂—CF₃) (M24.1) and 2-(2,2,3,3,4,4,5,5-octafluoropentyl)-2-(3,3,4,4,4-pentafluorobutyl)-malonodinitrile (CF₂H—CF₂—CF₂—CF₂—CH₂—C(CN)₂—CH₂—CH₂—CF₂—CF₃) (M24.2);
M.25. Microbial disruptors: Bacillus thuringiensis subsp. Israelensi, Bacillus sphaericus, Bacillus thuringiensis subsp. Aizawai, Bacillus thuringiensis subsp. Kurstaki, Bacillus thuringiensis subsp. Tenebrionis;
M.26. Aminofuranone compounds:
4-{[(6-Bromopyrid-3-yl)methyl](2-fluoroethyl)amino}furan-2(5H)-on (M26),
4-{[(6-Fluoropyrid-3-yl)methyl](2,2-difluoroethyl)amino}furan-2(5H)-on (M26.2),
4-{[(2-Chloro 1,3-thiazolo-5-yl)methyl](2-fluoroethyl)amino}furan-2(5H)-on (M26.3),
4-{[(6-Chloropyrid-3-yl)methyl](2-fluoroethyl)amino}furan-2(5H)-on (M26.4),
4-{[(6-Chloropyrid-3-yl)methyl](2,2-difluoroethyl)amino}furan-2(5H)-on (M26.5),
4-{[(6-Chloro-5-fluoropyrid-3-yl)methyl](methyl)amino}furan-2(5H)-on (M26.6),
4-{[(5,6-Dichloropyrid-3-yl)methyl](2-fluoroethyl)amino}furan-2(5H)-on (M26.7),
4-{[(6-Chloro-5-fluoropyrid-3-yl)methyl](cyclopropyl)amino}furan-2(5H)-on),
4-{[(6-Chloropyrid-3-yl)methyl](cyclopropyl)amino}furan-2(5H)-on (M26.9) and
4-{[(6-Chloropyrid-3-yl)methyl](methyl)amino}furan-2(5H)-on (M26.10);
   M.27. Various compounds: aluminium phosphide, amidoflumet, benclothiaz, benzoximate, bifenazate, borax, bromopropylate, cyanide, cyenopyrafen, cyflumetofen, chinomethionate, dicofol, fluoroacetate, phosphine, pyridalyl, pyrifluquinazon, sulfur, organic sulfur compounds, tartar emetic, sulfoxaflor, N—R′-2,2-dihalo-1-R″cyclo-propanecarboxamide-2-(2,6-dichloro-α,α,α-trifluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, 4-But-2-ynyloxy-6-(3,5-dimethyl-piperidin-1-yl)-2-fluoro-pyrimidine (M27.1), Cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-[2-hydroxy-4,6a,12b-trimethyl-11-oxo-9-(3-pyridinyl)-2H,11H-naphtho[2,1-b]pyrano[3,4-e]pyran-3,6-diyl]ester(M27.2) and
   8-(2-Cyclopropylmethoxy-4-trifluoromethyl-phenoxy)-3-(6-trifluoromethyl-pyridazin-3-yl)-3-aza-bicyclo[3.2.1]octane(M27.3).

The commercially available compounds of the group M may be found in The Pesticide Manual, 14th Edition, British Crop Protection Council (2006) among other publications.

Paraoxon and their preparation have been described in Farm Chemicals Handbook, Volume 88, Meister Publishing Company, 2001. Flupyrazofos has been described in Pesticide Science 54, 1988, p. 237-243 and in U.S. Pat. No. 4,822,779. AKD 1022 and its preparation have been described in U.S. Pat. No. 6,300,348. The compounds (M22.6) and (M22.7) are known from WO 2009/126668 and the compound (M22.8) is known from WO 2009/051956. The anthranilamides M23.1 to M23.6 have been described in WO 2008/72743 and WO 2008/72783, those M23.7 to M23.12 in WO 2007/043677. The phthalamide M 21.1 is known from WO 2007/101540. The alkynylether compound M27.1 is described e.g. in JP 2006/131529. Organic sulfur compounds have been described in WO 2007/060839. The isoxazoline compounds M 22.1 to M 22.5 have been described in e.g. WO 2005/085216, WO 2007/079162 and WO 2007/026965 The aminofuranone compounds M 26.1 to M 26.10 have been described eg. in WO 2007/115644. The pyripyropene derivative M 27.2 has been described in WO 2008/66153 and WO 2008/108491. The pyridazin compound M 27.3 has been described in JP 2008/115155. Malononitrile compounds as those (M24.1) and (M24.2) have been described in WO 2002/089579, WO 2002/090320, WO 2002/090321, WO 2004/006677, WO 2005/068423, WO 2005/068432 and WO 2005/063694.

The following list F of fungicides together with which the compounds of formula I according to the invention can be used, is intended to illustrate the possible combinations, but does not limit them:

### F.1) Respiration Inhibitors

F.1-1) Inhibitors of complex III at Qo site (e.g. strobilurins)
strobilurins: azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrylic acid methyl ester and 2 (2-(3-(2,6-dichlorophenyl)-1-methyl-allylideneaminooxymethyl)-phenyl)-2-methoxyimino-N methyl-acetamide;
oxazolidinediones and imidazolinones: famoxadone, fenamidone;
F.I-2) Inhibitors of complex II (e.g. carboxamides):
carboxanilides: benodanil, bixafen, boscalid, carboxin, fenfuram, fenhexamid, fluopyram, flutolanil, furametpyr, isopyrazam, isotianil, mepronil, oxycarboxin, penflufen, penthiopyrad, sedaxane, tecloftalam, thifluzamide, tiadinil, 2-amino-4 methyl-thiazole-5-carboxanilide, N-(3′,4′,5′ trifluorobiphenyl-2-yl)-3-difluoromethyl-1-methyl-1H-pyrazole-4 carboxamide, N-(4′-trifluoromethylthiobiphenyl-2-yl)-3 difluoromethyl-1-methyl-1H pyrazole-4-carboxamide and N-(2-(1,3,3-trimethyl-butyl)-phenyl)-1,3-dimethyl-5 fluoro-1H-pyrazole-4 carboxamide;
F.I-3) Inhibitors of complex III at Qi site: cyazofamid, amisulbrom;
F.I-4) Other respiration inhibitors (complex I, uncouplers)
diflumetorim; tecnazen; ferimzone; ametoctradin; silthiofam;
nitrophenyl derivates: binapacryl, dinobuton, dinocap, fluazinam, nitrthal-isopropyl, organometal compounds: fentin salts, such as fentin-acetate, fentin chloride or fentin hydroxide;
F.II) Sterol biosynthesis inhibitors (SBI fungicides)
F.II-1) C14 demethylase inhibitors (DMI fungicides, e.g. triazoles, imidazoles) triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole; imidazoles: imazalil, pefurazoate, oxpoconazole, prochloraz, triflumizole; pyrimidines, pyridines and piperazines: fenarimol, nuarimol, pyrifenox, triforine;
F.II-2) Delta14-reductase inhibitors (Amines, e.g. morpholines, piperidines)
morpholines: aldimorph, dodemorph, dodemorph-acetate, fenpropimorph, tridemorph; piperidines: fenpropidin, piperalin;

spiroketalamines: spiroxamine;

F.II-3) Inhibitors of 3-keto reductase: hydroxyanilides: fenhexamid;
F.III) Nucleic acid synthesis inhibitors
F.III-1) R^{N}A, DNA synthesis
phenylamides or acyl amino acid fungicides: benalaxyl, benalaxyl-M, kiralaxyl, metalaxyl, metalaxyl-M (mefenoxam), ofurace, oxadixyl;
isoxazoles and iosothiazolones: hymexazole, octhilinone;
F.III-2) DNA topisomerase inhibitors: oxolinic acid;
F.III-3) Nucleotide metabolism (e.g. adenosin-deaminase)
hydroxy (2-amino)-pyrimidines: bupirimate;
F.IV) Inhibitors of cell division and or cytoskeleton
F.IV-1) Tubulin inhibitors: benzimidazoles and thiophanates: benomyl, carbendazim, fuberidazole, thiabendazole, thiophanate-methyl;
triazolopyrimidines: 5-chloro-7 (4-methylpiperidin-1-yl)-6-(2,4,6-trifluorophenyl)-[1,2,4]triazolo[1,5a]pyrimidine
F.IV-2) Other cell division inhibitors
benzamides and phenyl acetamides: diethofencarb, ethaboxam, pencycuron, fluopicolide, zoxamide;
F.IV-3) Actin inhibitors: benzophenones: metrafenone;
F.V) Inhibitors of amino acid and protein synthesis
F.V-1) Methionine synthesis inhibitors (anilino-pyrimidines)
anilino-pyrimidines: cyprodinil, mepanipyrim, nitrapyrin, pyrimethanil;
F.V-2) Protein synthesis inhibitors (anilino-pyrimidines)
antibiotics: blasticidin-S, kasugamycin, kasugamycin hydrochloride-hydrate, mildiomycin, streptomycin, oxytetracyclin, polyoxine, validamycin A;
F.VI) Signal transduction inhibitors
F.VI-1) MAP/Histidine kinase inhibitors (e.g. anilino-pyrimidines)
dicarboximides: fluoroimid, iprodione, procymidone, vinclozolin;
phenylpyrroles: fenpiclonil, fludioxonil;
F.VI-2) G protein inhibitors: quinolines: quinoxyfen;
F.VII) Lipid and membrane synthesis inhibitors
F.VII-1) Phospholipid biosynthesis inhibitors
organophosphorus compounds: edifenphos, iprobenfos, pyrazophos;
dithiolanes: isoprothiolane;
F.VII-2) Lipid peroxidation
aromatic hydrocarbons: dicloran, quintozene, tecnazene, tolclofos-methyl, biphenyl, chloroneb, etridiazole;
F.VII-3) Carboxyl acid amides (CAA fungicides)
cinnamic or mandelic acid amides: dimethomorph, flumorph, mandiproamid, pyrimorph;
valinamide carbamates: benthiavalicarb, iprovalicarb, pyribencarb, valifenalate and N-(1-(1-(4-cyano-phenyl)ethanesulfonyl)-but-2-yl) carbamic acid-(4-fluorophenyl) ester;
F.VII-4) Compounds affecting cell membrane permeability and fatty acides carbamates: propamocarb, propamocarb-hydrochlorid
F.VIII) Inhibitors with Multi Site Action
F.VIII-1) Inorganic active substances: Bordeaux mixture, copper acetate, copper hydroxide, copper oxychloride, basic copper sulfate, sulfur;
F.VIII-2) Thio- and dithiocarbamates: ferbam, mancozeb, maneb, metam, methasulphocarb, metiram, propineb, thiram, zineb, ziram;
F.VIII-3) Organochlorine compounds (e.g. phthalimides, sulfamides, chloronitriles): anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;
F.VIII-4) Guanidines: guanidine, dodine, dodine free base, guazatine, guazatine-acetate, iminoctadine, iminoctadine-triacetate, iminoctadine-tris(albesilate);
F.VIII-5) Ahtraquinones: dithianon;
F.IX) Cell wall synthesis inhibitors
F.IX-1) Inhibitors of glucan synthesis: validamycin, polyoxin B;
F.IX-2) Melanin synthesis inhibitors: pyroquilon, tricyclazole, carpropamide, dicyclomet, fenoxanil;
F.X) Plant defense inducers
F.X-1) Salicylic acid pathway: acibenzolar-5-methyl;
F.X-2) Others: probenazole, isotianil, tiadinil, prohexadione-calcium;
phosphonates: fosetyl, fosetyl-aluminum, phosphorous acid and its salts;
F.XI) Unknown mode of action:
bronopol, chinomethionat, cyflufenamid, cymoxanil, dazomet, debacarb, diclomezine, difenzoquat, difenzoquat-methylsulfate, diphenylamin, flumetover, flusulfamide, flutianil, methasulfocarb, oxin-copper, proquinazid, tebufloquin, tecloftalam, triazoxide, 2-butoxy-6-iodo-3-propylchromen-4-one, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N methyl formamidine, N′ (4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2 methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-chloro-phenyl)-2,3-dimethyl-isoxazolidin-3-yl]-pyridine (pyrisoxazole), 3-[5-(4-methyl-phenyl)-2,3-dimethyl-isoxazolidin-3-yl]-pyridine, 5-amino-2-isopropyl-3-oxo-4-ortho-tolyl-2,3-dihydro-pyrazole-1 carbothioic acid S-allyl ester, N-(6-methoxy-pyridin-3-yl)cyclopropanecar-boxylic acid amide, 5-chloro-1(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide;
F.XII) Growth regulators:
abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N 6 benzyladenine, paclobutrazol, prohexadione (prohexadione-calcium), prohydrojasmon, thidiazuron, triapenthenol, tributyl phosphorotrithioate, 2,3,5 tri iodobenzoic acid, trinexapac-ethyl and uniconazole;
F.XIII) Biological control agents
antifungal biocontrol agents: Bacillus substilis strain with NRRL No. B-21661 (e.g. RHAPSODY®, SERENADE® MAX and SERENADE® ASO from AgraQuest, Inc., USA), Bacillus pumilus strain with NRRL No. B-30087 (e.g. SONATA® and BALLAD® Plus from AgraQuest, Inc., USA), Ulocladium oudemansii (e.g. the product BOTRYZEN from BotriZen Ltd., New Zealand), Chitosan (e.g. ARMOUR-ZEN from BotriZen Ltd., New Zealand).

The invertebrate pest, i.e. arthropodes and nematodes, the plant, soil or water in which the plant is growing can be contacted with the compound(s) of formula I or composition(s) containing them by any application method known in the art. As such, “contacting” includes both direct contact (applying the compounds/compositions directly on the invertebrate pest or plant—typically to the foliage, stem or roots of the plant) and indirect contact (applying the compounds/compositions to the locus of the invertebrate pest or plant).

Moreover, invertebrate pests may be controlled by contacting the target pest, its food supply, habitat, breeding ground or its locus with a pesticidally effective amount of compounds of formula I. As such, the application may be carried out before or after the infection of the locus, growing crops, or harvested crops by the pest.

“Locus” in general means a habitat, breeding ground, cultivated plants, plant propagation material (such as seed), soil, area, material or environment in which a pest or parasite is growing or may grow.

In general “pesticidally effective amount” means the amount of active ingredient needed to achieve an observable effect on growth, including the effects of necrosis, death, retardation, prevention, and removal, destruction, or otherwise diminishing the occurrence and activity of the target organism. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

The compounds of formula I and the compositions comprising said compounds can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities). The compounds of are applied not only to the surrounding soil surface or into the under-floor soil in order to protect wooden materials but it can also be applied to lumbered articles such as surfaces of the under-floor concrete, alcove posts, beams, plywood, furniture, etc., wooden articles such as particle boards, half boards, etc. and vinyl articles such as coated electric wires, vinyl sheets, heat insulating material such as styrene foams, etc. In case of application against ants doing harm to crops or human beings, the ant controller of the present invention is applied to the crops or the surrounding soil, or is directly applied to the nest of ants or the like.

The compounds of formula I can also be applied preventively to places at which occurrence of the pests is expected.

The compounds of formula I may also be used to protect growing plants from attack or infestation by pests by contacting the plant with a pesticidally effective amount of compounds of formula I. As such, “contacting the plant” includes both direct contact (applying the compounds/compositions directly on the pest and/or plant—typically to the foliage, stem or roots of the plant) and indirect contact (applying the compounds/compositions to the locus of the pest and/or plant).

In the case of soil treatment or of application to the pests dwelling place or nest, the quantity of active ingredient ranges from 0.0001 to 500 g per 100 m², preferably from 0.001 to 20 g per 100 m².

Customary application rates in the protection of materials are, for example, from 0.01 g to 1000 g of active compound per m² treated material, desirably from 0.1 g to 50 g per m².

Insecticidal compositions for use in the impregnation of materials typically contain from 0.001 to 95% by weight, preferably from 0.1 to 45% by weight, and more preferably from 1 to 25% by weight of at least one repellent and/or insecticide.

For use in bait compositions, the typical content of active ingredient is from 0.001% by weight to 15% by weight, desirably from 0.001% by weight to 5% by weight of active compound.

For use in spray compositions, the content of active ingredient is from 0.001 to 80% by weight, preferably from 0.01 to 50% by weight and most preferably from 0.01 to 15% by weight.

For use in treating crop plants, the rate of application of the active ingredients of this invention may be in the range of 0.1 g to 4000 g per hectare, desirably from 5 g to 600 g per hectare, more desirably from 10 g to 300 g per hectare.

In the treatment of seed, the application rates of the active ingredients are generally from 0.1 g to 10 kg per 100 kg of seed, preferably from 1 g to 1 kg per 100 kg of seed, in particular from 1 g to 250 g per 100 kg of seed, in particular from 10 g to 150 g per 100 kg of seed.

The present invention is now illustrated in further detail by the following examples. However, the purpose of the following examples is only illustrative and is not intended to limit the present invention to them.

### I. PREPARATION EXAMPLES

The procedures described in the following synthesis examples were used to prepare further compounds of the formula I by appropriate modification of the starting materials. The resulting compounds, together with physical data, are listed below in Table I. Products were characterized by their masses ([m/z]) or retention times (RT [min.]), both determined by HPLC-MS (High Performance Liquid Chromatography Mass Spectrometry), or by their NMR spectra.

HPLC conditions for analyzing the compound of example 39: RP-18 column (Kinetex™ XB-C18, 1.7 μm, from Phenomenex, Germany), 50×2.0 mm; mobile phase: acetonitrile+0.1% by volume of trifluoroacetic acid (TFA)/water+0.1% by volume of TFA, using a gradient of 5:95 to 100:0 over 1.5 minutes at 60° C.; flow rate 0.8 mL/min to 1.0 ml/min.

HPLC conditions for analyzing the compounds of all other examples: RP-18 column (Chromolith® Speed ROD from Merck KgaA, Germany), 50×4.6 mm; mobile phase: acetonitrile+0.1% by volume of TFA/water+0.1% by volume of TFA, using a gradient of 5:95 to 100:0 over 5 minutes at 40° C., flow rate 1.8 ml/min.

MS conditions: quadrupole electrospray ionization, 80 V (positive mode).]

### Example 2

### 3-{3-[5-Methyl-1-(2,2,2-trifluoroethyl)-1H-pyrazol-4-yl]-[1,2,4]triazol-4-yl}pyridine

Triethylorthoformate (1.25 g, 11.8 mmol) and 3-aminopyridine (2.2 g, 23.6 mmol) were dissolved in acetonitrile (10 mL) and stirred at reflux for 1 hour. 1-(2,2,2-trifluoroethyl)-5-methyl-1H-pyrazole-4-carboxylic acid hydrazide (0.7 g, 75% purity, 2.4 mmol) and glacial acetic acid (0.35 ml, 6.1 mmol) were added and the reaction mixture was stirred at reflux for 3 days. Afterwards the solvent was removed under vacuum and the residue was purified by column chromatography to yield the title compound (0.43 g, yield: 56%, purity: 95%).

Examples 1, 3, 5, 7 to 13 and 23 were prepared in analogy to the procedure described for Example 2.

### Example 4

### 3-{2-[5-Methyl-1-(2,2,2-trifluoroethyl)-1H-pyrazol-4-yl]-oxazol-4-yl}pyridine

A mixture of 1-(2,2,2-trifluoroethyl)-5-methyl-1H-pyrazole-4-carboxamide (500 mg, 2.4 mmol) and 2-bromo-1-pyridin-3-ylethanone (483 mg, 2.4 mmol) was heated at 130° C. for 16 hours. The crude mixture was purified by column chromatography to yield the title compound (198 mg, yield: 25%, purity: 95%).

### Example 6

### 3-{2-[5-Methyl-1-(2,2,2-trifluoroethyl)-1H-pyrazol-4-yl-]thiazol-4-yl}pyridine

A solution of 1-(2,2,2-trifluoroethyl)-5-methyl-1H-pyrazole-4-thiocarboxylamide (119 mg, 0.53 mmol) and 2-bromo-1-pyridin-3-ylethanone (107 mg, 0.53 mmol) in ethanol (25 mL) was heated at 45° C. for 4 hours. The solvent was removed under vacuum and the remaining residue was purified by column chromatography to yield the title compound (163 mg, yield: 68%,purity: 90%).

### Example 14

### 3-{5-[5-Methyl-1-(2,2,2-trifluoroethyl)-1H-pyrazol-4-yl]-[1,3,4]oxadiazol-2-yl}pyridine

1-[5-Methyl-1-(2,2,2-trifluoroethyl)-1H-pyrazol-4-carbonyl]-2-[pyridin-3-carbonyl]-hydrazine (0.6 g, 1.8 mmol) was dissolved in phosphorylchloride (POCl₃) (5 mL) and toluene (10 mL). The solution was stirred at reflux overnight. The solvent was evaporated and the crude product was purified by preparative HPLC to give the title compound (340 mg, yield: 38%).

Example 16 was prepared in analogy to the procedure described for Example 14.

### Example 15

### 3-{5-[5-Methyl-1-(2,2,2-trifluoroethyl)-1H-pyrazol-4-yl]-[1,3,4]thiadiazol-2-yl}pyridine

1-[5-Methyl-1-(2,2,2-trifluoroethyl)-1H-pyrazol-4-carbonyl]-2-[pyridin-3-carbonyl]-hydrazine (0.6 g, 1.8 mmol) was dissolved in tetrahydrofuran (THF) (15 mL) and Lawesson's reagent was added (1.0 g, 2.7 mmol). The solution was stirred at reflux for 2 hours. The solvent was evaporated and the crude product was purified by preparative HPLC to give the title compound (370 mg, yield: 46%).

Example 17 was prepared in analogy to the procedure described for Example 15.

### Example 18

### 3-{2-[5-Methyl-1-(2,2,2-trifluoroethyl)-1H-pyrazol-4-yl]-4,5-dihydroimidazol-1-yl}pyridine

N-[5-Methyl-1-(2,2,2-trifluoroethyl)-1H-pyrazol-4-carbonyl]-N′-(pyridin-3-yl)-ethyl-1,2-diamine (1.5 g, 4.6 mmol) was dissolved in phosphorylchloride (POCl₃) (5 mL) and toluene (10 mL). The solution was stirred at reflux overnight. The solvent was evaporated and the crude product was purified by preparative HPLC to give the title compound (220 mg, yield: 16%).

Examples 19 and 41 were prepared in analogy to the procedure described for Example 18.

### Example 20

### 3-{2-[5-Methyl-1-(2,2,2-trifluoroethyl)-1H-pyrazol-4-yl]imidazol-1-yl}pyridine

3-{2-[5-Methyl-1-(2,2,2-trifluoroethyl)-1H-pyrazol-4-yl]-4,5-dihydroimidazol-1-yl}pyridine (0.7 g, 2.3 mmol) was dissolved in acetonitrile (20 mL) and potassium permanganate (0.72 g, 5.54 mmol) and aluminium oxide (1.4 g, 13.62 mmol) were added. The solution was stirred at room temperature overnight. The mixture was filtered and the solvent evaporated to give the crude product which was then purified by preparative HPLC to give the title compound (156 mg, yield: 23%).

Example 21 was prepared in analogy to the procedure described for Example 20.

### Example 25

### 3′-[5-methyl-1-(2,2,2-trifluoroethyl)-1H-pyrazol-4-yl]-[3,4′]bipyridinyl

To a mixture of 3′-bromo-[3,4′]bipyridinyl (500 mg, 2.15 mmol), 5-methyl-1-(2,2,2-trifluoroethyl)-1H-pyrazol-4-(pinacolato)boronate (622 mg, 2.15 mmol) and tetrakis(triphenylphosphine)palladium (Pd(PPh₃)₄) (150 mg) in dioxane (150 ml) was added a solution of potassium carbonate in water (50 ml, 2 M). The mixture was heated at 90° C. under nitrogen atmosphere overnight, cooled to room temperature and afterwards water was added to the mixture. Then the mixture was extracted with ethyl acetate, washed with brine and dried over sodium sulfate. The solution was concentrated, and the remaining residue was purified by preparative HPLC to give the title compound (300 mg, yield: 44%).

Examples 22, 24, 26-28 and 30-34 were prepared in analogy to the procedure described for Example 25.

### Example 29

### 5′-methyl-5-pyridin-3-yl-1′-(2,2,2-trifluoro-ethyl)-2H,1′H-[3,4′]bipyrazolyl

5-Pyridin-3-yl-2H-pyrazol-3-yl trifluoromethanesulfonate (0.7 g, 2.4 mmol) and 5-methyl-1-(2,2,2-trifluoroethyl)-1H-pyrazol-4-(pinacolato)boronate (0.7 g, 2.4 mmol) were dissolved in dioxane/water (4:1 (v/v), 25 mL), [1,1-Bis(diphenylphosphino)-ferrocene]-dichloropalladium(II) (Pd(dppf)Cl₂) (0.1 g) and potassium carbonate (1.0 g, 7.2 mmol) were added. The solution was stirred at 80° C. under nitrogen atmosphere overnight. The mixture was filtered and evaporated to give the crude product, then purified by preparative HPLC to give the title compound (210 mg, yield: 28%).

Example 36 was prepared in analogy to the procedure described for Example 29.

### Example 35

### 3-{5-[5-Methyl-1-(2,2,2-trifluoroethyl)-1H-pyrazol-4-yl]-4H-[1,2,4]triazol-3-yl}pyridine

1-[5-Methyl-1-(2,2,2-trifluoroethyl)-1H-pyrazol-4-carbimido]-2-[pyridin-3-carbonyl]-hydrazine (0.4 g, 1.2 mmol) was dissolved in POCl₃ (2 mL) and toluene (10 mL). The solution was stirred at reflux under nitrogen atmosphere for 5 hours. The solvent was evaporated and the crude product was purified by preparative HPLC to give the title compound (180 mg, yield 49%).

### Example 37 and Example 38

### 3-{4-Methyl-5-[5-methyl-1-(2,2,2-trifluoroethyl)-1H-pyrazol-4-yl]-4H-[1,2,4]triazol-3-yl}-pyridine and

### 3-{1-methyl-5-[5-methyl-1-(2,2,2-trifluoroethyl)-1H-pyrazol-4-yl]-1H-[1,2,4]triazol-3-yl}pyridine

3-{5-[5-Methyl-1-(2,2,2-trifluoroethyl)-1H-pyrazol-4-yl]-4H-[1,2,4]triazol-3-yl}pyridine (600 mg, 1.95 mmol) was dissolved in dimethylformamide (20 mL) and cooled in an ice bath under nitrogen atmosphere. Then sodium hydride (60% in mineral oil, 94 mg, 2.34 mmol) was added in portions and the reaction mixture was stirred at 0° C. for 30 min. Methyl iodide (560 mg, 4 mmol) was added and stirring was continued at room temperature for 3 hours. The reaction was quenched with an aqueous solution of ammonium chloride, extracted with ethyl acetate, dried over sodium sulfate, concentrated and purified by preparative HPLC to give the title compounds Example 37 (170 mg, yield: 27%) and Example 38 (95 mg, yield: 15%).

### Example 39

### 3-{3-[5-Methyl-1-(2,2,2-trifluoroethyl)-1H-pyrazol-4-yl]-4H-[1,2,4]oxadiazol-5-on-4-yl}pyridine

### Step 1: N-(Pyridin-3-yl)-N′-hydroxy-[5-methyl-1-(2,2,2-trifluoroethyl)-1H-pyrazol-4-yl]-amidine

To a solution of N-hydroxy-1-chloro-1-[5-methyl-1-(2,2,2-trifluoroethyl)-1H-pyrazol-4-yl]-methanimine (700 mg, 2.9 mmol) and pyridin-3-ylamine (282 mg, 3 mmol) in dichloromethane (30 mL), which had been cooled in an ice bath, was added triethylamine (1 g, 10 mmol) dropwise and the reaction mixture was stirred to room temperature for 3 hours. Afterwards stirring was continued at room temperature for 3 days. The reaction mixture obtained was directly introduced into the conversion of step 2.

### Step 2: 3-{3-[5-Methyl-1-(2,2,2-trifluoroethyl)-1H-pyrazol-4-yl]-4H-[1,2,4]oxadiazol-5-on-4-yl}pyridine

To the reaction mixture obtained in step 1 was added 1,1′-carbonyldiimidazole (3 g, 21 mmol) and then stirred under nitrogen atmosphere at room temperature for 3 hours. The reaction mixture was concentrated to give the crude product, which was purified by preparative thin layer chromatography twice and preparative HPLC once to give the title compound (70 mg, yield: 7%).

Characterization by ¹H-NMR (400 MHz, MeOD): δ 8.68-8.69 (m, 1H), 8.60 (s, 1H), 7.89-7.92 (m, 1H), 7.58-7.62 (m, 1H), 7.07 (s, 1H), 4.93-4.99 (m, 2H), 2.47 (s, 3H).

TABLE I
Compounds of formula la′
(Ia′)

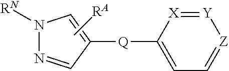

| | | | | | | | Physico- | |
|---|---|---|---|---|---|---|---|---|
| | | | | | | | chemical data: | |
| | | | | | | | r.t. | |
| Ex. | Q ^{a)} | R^{N} | R^{A} | X | Y | Z | [min] ^{b)} | m/z ^{c)} |
| 1 | [1,2,4]-triazol-3,4- | CH₃— | 3-CF₃— | CH | N | CH | 1.795 | 295.0 |
| | diyl | | | | | | | |
| 2 | [1,2,4]-triazol-3,4- | CF₃—CH₂— | 5-CH₃— | CH | N | CH | 1.691 | 308.9 |
| | diyl | | | | | | | |
| 3 | 5-methyl-[1,2,4]- | CF₃—CH₂— | 5-CH₃— | CH | N | CH | 1.745 | 322.9 |
| | triazol-3,4-diyl | | | | | | | |
| 4 | oxazol-2,4-diyl | CF₃—CH₂— | 5-CH₃— | CH | N | CH | 2.079 | 308.9 |
| 5 | 5-methyl-[1,2,4]- | CF₃—CH₂— | 5-CH₃— | N | CH | CH | 1.912 | 323.1 |
| | triazol-3,4-diyl | | | | | | | |
| 6^{d)} | thiazol-2,4-diyl | CF₃—CH₂— | 5-CH₃— | CH | N | CH | 2.188 | 325.0 |
| 7 | [1,2,4]-triazol-3,4- | CF₃—CH₂— | 5-CH₃— | CH | CH | N | 1.435 | 309.1 |
| | diyl | | | | | | | |
| 8 | [1,2,4]-triazol-3,4- | CF₃—CH₂— | 5-CH₃— | N | CH | CH | 1.920 | 309.1 |
| | diyl | | | | | | | |
| 9 | [1,2,4]-triazol-3,4- | CF₃—CH₂— | 5-CHF₂— | CH | N | CH | 2.071 | 345.1 |
| | diyl | | | | | | | |
| 10 | 5-methyl-[1,2,4]- | CF₃—CH₂— | 5-CHF₂— | CH | N | CH | 2.123 | 359.1 |
| | triazol-3,4-diyl | | | | | | | |
| 11 | [1,2,4]-triazol-3,4- | CF₃—CH₂— | 5-CHF₂— | N | CH | CH | 2.291 | 345.0 |
| | diyl | | | | | | | |
| 12 | 5-methyl-[1,2,4]- | CF₃—CH₂— | 5-CHF₂— | N | CH | CH | 2.340 | 359.1 |
| | triazol-3,4-diyl | | | | | | | |
| 13 | [1,2,4]-triazol-3,4- | CF₃—CH₂— | 5-CHF₂— | CH | CH | N | 1.825 | 345.1 |
| | diyl | | | | | | | |
| 14 | [1,3,4]-oxadiazol- | CF₃—CH₂— | 5-CH₃— | CH | N | CH | 2.253 | 310.1 |
| | 2,5-diyl | | | | | | | |
| 15 | [1,3,4]-thiadiazol- | CF₃—CH₂— | 5-CH₃— | CH | N | CH | 2.256 | 326.0 |
| | 2,5-diyl | | | | | | | |
| 16 | [1,3,4]-oxadiazol- | CF₃—CH₂— | 5-CH₃— | CH | N | N | 2.223 | 311.0 |
| | 2,5-diyl | | | | | | | |
| 17 | [1,3,4]-thiadiazol- | CF₃—CH₂— | 5-CH₃— | CH | N | N | 2.339 | 327.0 |
| | 2,5-diyl | | | | | | | |
| 18 | 4,5-dihydro- | CF₃—CH₂— | 5-CH₃— | CH | N | CH | 1.460 | 310.1 |
| | imidazol-2,1-diyl | | | | | | | |
| 19 | 4,5-dihydro- | CF₃—CH₂— | 5-CH₃— | CH | N | N | 1.130 | 311.1 |
| | imidazol-2,1-diyl | | | | | | | |
| 20 | imidazol-2,1-diyl | CF₃—CH₂— | 5-CH₃— | CH | N | CH | 1.584 | 308.0 |
| 21 | imidazol-2,1-diyl | CF₃—CH₂— | 5-CH₃— | CH | N | N | 1.309 | 309.1 |
| 22 | phenyl-1,3-diyl | CF₃—CH₂— | 5-CH₃— | CH | N | CH | 2.337 | 318.1 |
| 23 | [1,2,4]-triazol-4,3- | CF₃—CH₂— | 5-CH₃— | CH | N | N | 1.685 | 324.0 |
| | diyl | | | | | | | |
| 24 | pyridyl-2,3-diyl | CF₃—CH₂— | 5-CH₃— | CH | N | CH | 1.485 | 319.1 |
| 25 | pyridyl-3,4-diyl | CF₃—CH₂— | 5-CH₃— | CH | N | CH | 1.483 | 319.1 |
| 26 | phenyl-1,3-diyl | CF₃—CH₂— | 5-CH₃— | CH | N | N | 2.583 | 319.1 |
| 27 | pyridyl-2,6-diyl | CF₃—CH₂— | 5-CH₃— | CH | N | CH | 2.206 | 319.1 |
| 28 | pyridyl-3,5-diyl | CF₃—CH₂— | 5-CH₃— | CH | N | CH | 1.768 | 319.1 |
| 29 | 1H-pyrazol-3,5-diyl | CF₃—CH₂— | 5-CH₃— | CH | N | CH | 1.917 | 308.1 |
| 30 | pyridyl-4,3-diyl | CF₃—CH₂— | 5-CH₃— | CH | N | CH | 1.518 | 319.1 |
| 31 | pyridyl-3,2-diyl | CF₃—CH₂— | 5-CH₃— | CH | N | CH | 1.880 | 319.1 |
| 32 | pyridyl-2,4-diyl | CF₃—CH₂— | 5-CH₃— | CH | N | CH | 1.803 | 319.1 |
| 33 | pyridyl-4,2-diyl | CF₃—CH₂— | 5-CH₃— | CH | N | CH | 2.051 | 319.1 |
| 34^{e)} | phenyl-1,2-diyl | CF₃—CH₂— | 5-CH₃— | CH | N | N | 2.537 | 319.1 |
| 35 | 4H-[1,2,4]-triazol- | CF₃—CH₂— | 5-CH₃— | CH | N | CH | 1.854 | 309.1 |
| | 3,5-diyl | | | | | | | |
| 36 | 1H-pyrazol-3,5-diyl | CF₃—CH₂— | 5-CH₃— | CH | N | N | 2.041 | 309.1 |
| 37 | 4-methyl-[1,2,4]- | CF₃—CH₂— | 5-CH₃— | CH | N | CH | 1.921 | 323.1 |
| | triazol-3,5-diyl | | | | | | | |
| 38 | 1-methyl-[1,2,4]- | CF₃—CH₂— | 5-CH₃— | CH | N | CH | 2.027 | 323.1 |
| | triazol-3,5-diyl | | | | | | | |
| 39 | 4H-[1,2,4]- | CF₃—CH₂— | 5-CH₃— | CH | N | CH | 0.849 | 326.0 |
| | oxadiazol-5-on-3,4- | | | | | | | |
| | diyl | | | | | | | |
| 40 | [1,3,4]-oxadiazol- | (CH₃)₂—CH— | 5-CH₃— | CH | N | CH | 2.189 | 270.1 |
| | 2,5-diyl | | | | | | | |
| 41 | 4,5-dihydro- | (CH₃)₂—CH— | 5-CH₃— | CH | N | CH | 1.257 | 270.2 |
| | imidazol-2,1-diyl | | | | | | | |

^{a)} The first of the two attachment points identified in the names of radicals Q represents the position to which the pyrazole radical is linked and the second one represents the position to which the 6-membered heteroaromatic radical is linked. By way of example, pyridin-2-on-1,5-diyl is bound to the pyrazole radical and the 6-membered heteroaromatic radical via its positions 1 and 5, respectively.
^{b)} r.t. = HPLC retention time;
^{c)} m/z of the [M]⁺ peaks;
^{d)}salt of hydrobromic acid;
^{e)}salt of trifluoroacetic acid.

### II. EVALUATION OF PESTICIDAL ACTIVITY

II.1 Cotton Aphid (Aphis gossypii, Mixed Life Stages)

### Method a)

The active compounds were formulated in 50:50 (v/v) acetone:water and 100 ppm nonionic surfactant (Kinetic®).

Cotton plants at the cotyledon stage (one plant per pot) were infested by placing a heavily infested leaf from the main colony on top of each cotyledon. The aphids were allowed to transfer to the host plant overnight, and the leaf used to transfer the aphids was removed. The cotyledons were dipped in the test solution and allowed to dry. After 5 days, mortality counts were made.

In this test, the compounds of example 1 at 300 ppm showed a mortality of at least 75% in comparison with untreated controls.

### Method b)

The active compounds were formulated in cyclohexanone as a 10,0000 ppm solution supplied in 1.3 ml ABgene® tubes. These tubes were inserted into an automated electrostatic sprayer equipped with an atomizing nozzle and they served as stock solutions for which lower dilutions were made in 50% acetone:50% water (v/v). A nonionic surfactant (Kinetic®) was included in the solution at a volume of 0.01% (v/v).

Cotton plants at the cotyledon stage were infested with aphids prior to treatment by placing a heavily infested leaf from the main aphid colony on top of each cotyledon. Aphids were allowed to transfer overnight to accomplish an infestation of 80-100 aphids per plant and the host leaf was removed. The infested plants were then sprayed by an automated electrostatic plant sprayer equipped with an atomizing spray nozzle. The plants were dried in the sprayer fume hood, removed from the sprayer, and then maintained in a growth room under fluorescent lighting in a 24 hour photoperiod at 25° C. and 20-40% relative humidity. Aphid mortality on the treated plants, relative to mortality on untreated control plants, was determined after 5 days.

In this test, the compounds of examples 1, 14, 15, 18, 20 and 41, respectively, at 300 ppm showed a mortality of at least 75% in comparison with untreated controls.

II.2 Green Peach Aphid (Myzus persicae, Mixed Life Stages)

### Method a)

The active compounds were formulated in 50:50 (v/v) acetone:water and 100 ppm nonionic surfactant (Kinetic®).

Pepper plants in the 2^{nd} leaf-pair stage (variety ‘California Wonder’) were infested with approximately 40 laboratory-reared aphids by placing infested leaf sections on top of the test plants. The leaf sections were removed after 24 hours. The leaves of the intact plants were dipped into gradient solutions of the test compound and allowed to dry. Test plants were maintained under fluorescent light (24 hour photoperiod) at about 25° C. and 20-40% relative humidity. Aphid mortality on the treated plants, relative to mortality on check plants, was determined after 5 days.

In this test, the compounds of example 1 at 300 ppm showed a mortality of at least 90% in comparison with untreated controls.

### Method b)

The active compounds were formulated in cyclohexanone as a 10,0000 ppm solution supplied in 1.3 ml ABgene® tubes. These tubes were inserted into an automated electrostatic sprayer equipped with an atomizing nozzle and they served as stock solutions for which lower dilutions were made in 50% acetone:50% water (v/v). A nonionic surfactant (Kinetic®) was included in the solution at a volume of 0.01% (v/v).

Bell pepper plants at the first true-leaf stage were infested prior to treatment by placing heavily infested leaves from the main colony on top of the treatment plants. Aphids were allowed to transfer overnight to accomplish an infestation of 30-50 aphids per plant and the host leaves were removed. The infested plants were then sprayed by an automated electrostatic plant sprayer equipped with an atomizing spray nozzle. The plants were dried in the sprayer fume hood, removed, and then maintained in a growth room under fluorescent lighting in a 24 hour photoperiod at 25° C. and 20-40% relative humidity. Aphid mortality on the treated plants, relative to mortality on untreated control plants, was determined after 5 days.

In this test, the compounds of examples 1, 3, 14, 15, 18, 20, 40 and 41, respectively, at 300 ppm showed a mortality of at least 75% in comparison with untreated controls.

II.3 Cowpea Aphid (Aphis craccivora)

The active compounds were formulated in 50:50 (v/v) acetone:water. The test solution was prepared at the day of use.

Potted cowpea plants colonized with 100-150 aphids of various stages were sprayed after the pest population had been recorded. Population reduction was assessed after 24, 72, and 120 hours.

In this test, the compounds of examples 1, 2, 9, 14, 15, 18, 19, 20, 21, 33, 36, 39, 40 and 41, respectively, at 500 ppm showed a mortality of at least 75% in comparison with untreated controls.

II.4 Vetch Aphid (Megoura viciae)

The active compounds were formulated in 1:3 (v/v) DMSO:water with different concentrations of formulated compounds.

Bean leaf disks were placed into microtiterplates filled with 0.8% agar-agar and 2.5 ppm OPUS™. The leaf disks were sprayed with 2.5 μl of the test solution and 5 to 8 adult aphids were placed into the microtiterplates which were then closed and kept at 23±1° C. and 50±5% relative humidity under fluorescent light for 6 days. Mortality was assessed on the basis of vital, reproduced aphids. Aphid mortality and fecundity was then visually assessed.

In this test, the compounds of examples 1, 4, 15, 20, 21, 24, 26, 27, 33, 36, 39 and 40, respectively, at a concentration of the test solution of 2500 mg/L showed a mortality of at least 90%.

II.5 Boll Weevil (Anthonomus grandis)

The compounds were formulated in 75:25 (v/v) water:DMSO.

For evaluating control of boll weevil (Anthonomus grandis) the test unit consisted of 24-well-microtiter plates containing an insect diet and 20-30 A. grandis eggs. Different concentrations of formulated compounds were sprayed onto the insect diet at 20 μl, using a custom built micro atomizer, at two replications. After application, the microtiter plates were incubated at 23±1° C. and 50±5% relative humidity for 5 days. Egg and larval mortality was then visually assessed.

In this test, the compounds of examples 14, 15, 17, 34 and 38, respectively, at a concentration of the test solution of 2500 mg/L showed a mortality of at least 50%.

II.6 Activity Against Green Peach Aphid (Myzus persicae)

For evaluating control of green peach aphid (Myzus persicae) through systemic means the test unit consisted of 96-well-microtiter plates containing liquid artificial diet under an artificial membrane.

The compounds were formulated using a solution containing 75% v/v water and 25% v/v DMSO. Different concentrations of formulated compounds were pipetted into the aphid diet, using a custom built pipetter, at two replications. After application, 5 to 8 adult aphids were placed on the artificial membrane inside the microtiter plate wells. The aphids were then allowed to suck on the treated aphid diet and incubated at about 23+1° C. and about 50+5% relative humidity for 3 days. Aphid mortality and fecundity was then visually assessed.

In this test, the compounds of examples 1, 11, 12, 13, 15, 18, 20, 21, 22, 33, 36, 39 and 41, respectively, at 2500 ppm showed 100% mortality in comparison with untreated controls.

II.7 Silverleaf Whitefly (Bemisia argentifolii, Adult)

The active compounds were formulated in cyclohexanone as a 10,0000 ppm solution supplied in 1.3 ml ABgene® tubes. These tubes were inserted into an automated electrostatic sprayer equipped with an atomizing nozzle and they served as stock solutions for which lower dilutions were made in 50% acetone:50% water (v/v). A nonionic surfactant (Kinetic®) was included in the solution at a volume of 0.01% (v/v).

Cotton plants at the cotyledon stage (one plant per pot) were sprayed by an automated electrostatic plant sprayer equipped with an atomizing spray nozzle. The plants were dried in the sprayer fume hood and then removed from the sprayer. Each pot was placed into a plastic cup and 10 to 12 whitefly adults (approximately 3-5 days old) were introduced. The insects were collected using an aspirator and 0.6 cm, nontoxic Tygon® tubing (R-3603) connected to a barrier pipette tip. The tip, containing the collected insects, was then gently inserted into the soil containing the treated plant, allowing insects to crawl out of the tip to reach the foliage for feeding. Cups were covered with a reusable screened lid (150-micron mesh polyester screen PeCap from Tetko, Inc.). Test plants were maintained in a growth room at 25° C. and 20-40% relative humidity for 3 days, avoiding direct exposure to fluorescent light (24 hour photoperiod) to prevent trapping of heat inside the cup. Mortality was assessed 3 days after treatment, compared to untreated control plants.

In this test, the compound of example 20, 21 and 41, respectively, at 500 ppm showed a mortality of at least 75% in comparison with untreated controls.

II.8 Activity Against Diamondback Moth (Plutella xylostella)

The active compounds were formulated in 50:50 acetone:water and 0.1% (vol/vol) Alkamuls® EL 620 surfactant. A 6 cm leaf disk of cabbage leaves was dipped in the test solution for 3 seconds and allowed to air dry in a Petri plate lined with moist filter paper. The leaf disk was inoculated with 10 third instar larvae and kept at 25-27° C. and 50-60% relative humidity for 3 days. Mortality was assessed after 72 hours of treatment.

In this test, the compounds of examples 9, 11 and 12, respectively, at a concentration of the test solution of 500 ppm showed a mortality of at least 75% in comparison with untreated controls.

II.9 Activity in the Hydroponic Tests Against Green Peach Aphids (Myzus persicae)

Green pepper plants (Capsicum annuum L., variety ‘California Wonder’) were grown in the greenhouse from seed to the second true leaf stage (BBCH 12) in Scott's Metro-Mix® 360 (1 to 2 plants per 2¼″ square pot). Cotyledon leaves were removed and roots were rinsed in tap water until free of soil. The roots were kept moist under a layer of wet paper toweling until all plants had been prepared.

A 3,400 ppm stock solution was prepared of each test compound using reagent grade acetone as the solvent. Subsequent dilutions of 100 and 10 ppm were prepared from this stock with final dilutions in deionized water in 100 ml amber glass bottles. One bare root plant was placed in each bottle using a foam plug section to centrally secure the stem in the bottleneck. The bare roots were fully-immersed in the test suspensions. Host plants were placed in a plant growth room under continuous GroLux® fluorescent lighting (40 Watt), for 24 hours at 25±2° C. and 20-40% relative humidity.

After exposure of the bare roots to the test suspensions, pieces of pepper plants infested with green peach aphid (Myzus persicae) were placed on top of the test foliage. Insects were allowed to transfer from the host leaves to accomplish an infestation of 40-50 insects per plant. The assay was allowed to run for 3 days in the same growth room as used previously. Assessments included estimates of aphid population density reduction relative to the average density of aphids on the untreated control plants. Phytotoxic responses of the host plants were also recorded at this time.

In this test, compounds of examples 15, 18 and 20, respectively, at 100 ppm showed a mortality of at least 75% in comparison with untreated controls.

II.10 Activity in the Hydroponic Tests Against Cotton Aphids (Aphis gossypii)

Cotton plants (Gossypium hirsutum, variety ‘Sure Grow 747’) were grown in the greenhouse from seed to the second true leaf stage (BBCH 12) in Scott's Metro-Mix® 360 (1 to 2 plants per 2¼″ square pot). Cotyledon leaves were removed and roots were rinsed in tap water until free of soil. The roots were kept moist under a layer of wet paper toweling until all plants had been prepared.

A 3,400 ppm stock solution was prepared of each test compound using reagent grade acetone as the solvent. Subsequent dilutions of 100 and 10 ppm were prepared from this stock with final dilutions in deionized water in 100 ml amber glass bottles. One bare root plant was placed in each bottle using a foam plug section to centrally secure the stem in the bottleneck. The bare roots were fully-immersed in the test suspensions. Host plants were placed in a plant growth room under continuous GroLux® fluorescent lighting (40 Watt), for 24 hours at 25±2° C. and 20-40% relative humidity.

After exposure of the bare roots to the test suspensions, pieces of cotton plants infested with cotton aphids (Aphis gossypi) were placed on top of the test foliage. Insects were allowed to transfer from the host leaves to accomplish an infestation of 40-50 insects per plant. The assay was allowed to run for 3 days in the same growth room as used previously. Assessments included estimates of aphid population density reduction relative to the average density of aphids on the untreated control plants. Phytotoxic responses of the host plants were also recorded at this time.

In this test, compounds of examples 18 and 20, respectively, at 100 ppm showed a mortality of at least 75% in comparison with untreated controls.

1-27. (canceled)

28. A method for controlling invertebrate pests which method comprises treating the pests, their food supply, their habitat or their breeding ground or a plant, seed, soil, area, material or environment in which the pests are growing or may grow, or the materials, plants, seeds, soils, surfaces or spaces to be protected from pest attack or infestation with a pesticidally effective amount of a pyrazole compound of formula I, a salt thereof, an N-oxide thereof or a tautomer thereof, or a salt of said N-oxide or tautomer: 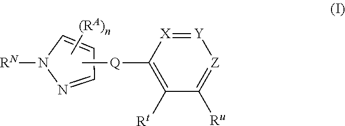
wherein
X is N or CH;
Y is N or CH;
Z is N or CH;
provided that either only one of X, Y and Z is N or only two adjacent groups of X, Y and Z are N,
R^{A} is selected from the group consisting of halogen, CN, NO₂, C₁-C₁₀-alkyl, C₂-C₁₀-alkenyl and C₂-C₁₀-alkynyl, wherein the last three mentioned radicals may be unsubstituted, may be partially or fully halogenated or may carry 1, 2 or 3 identical or different substituents R^{x},
and also from the group consisting of OR^{a}, C(V)R^{b}, C(V)OR^{c}, S(O)ₘR^{d} with m being 0, 1 for 2, NR^{e}R^{f}, heterocyclyl, phenyl, hetaryl, C₃-C₁₀-cycloalkyl and C₅-C₁₀-cycloalkenyl, wherein the last five mentioned radicals may be unsubstituted or may carry 1, 2, 3, 4 or 5 identical or different substituents R^{y};
n is 0, 1 or 2; and
R^{N} is selected from the group consisting of hydrogen, CN, NO₂, C₁-C₁₀-alkyl, C₂-C₁₀-alkenyl and C₂-C₁₀-alkynyl, wherein the three last mentioned radicals may be unsubstituted, may be partially or fully halogenated or may carry 1, 2 or 3 identical or different substituents R^{x};
and also from the group consisting of OR^{a}, C(V)R^{b}, C(V)OR^{c}, S(O)ₘR^{d}, NR^{e}R^{f}, C(V)NR^{g}R^{h}, S(O)ₘNR^{e}R^{f}, C(V)NRⁱNR^{e}R^{f}, C₁-C₅-alkylen-OR^{a}, C₁-C₅-alkylen-CN, C₁-C₅-alkylen-C(V)R^{b}, C₁-C₅-alkylen-C(V)OR^{c}, C₁-C₅-alkylen-NR^{e}R^{f}, C₁-C₅-alkylen-C(V)NR^{g}R^{h}, C₁-C₅-alkylen-S(O)ₘR^{d}, C₁-C₅-alkylen-S(O)ₘNR^{e}R^{f}, C₁-C₅-alkylen-NRⁱNR^{e}R^{f}, heterocyclyl, hetaryl, C₃-C₁₀-cycloalkyl, C₅-C₁₀-cycloalkenyl, heterocyclyl-C₁-C₅-alkyl, hetaryl-C₁-C₅-alkyl, C₃-C₁₀-cycloalkyl-C₁-C₅-alkyl, C₅-C₁₀-cycloalkenyl-C₁-C₅-alkyl, phenyl-C₁-C₅-alkyl and phenyl, wherein the rings of the ten last mentioned radicals may be unsubstituted or may carry 1, 2, 3, 4 or 5 identical or different substituents R^{y};
m is 0, 1 or 2;
V is O or S;
Q is a bivalent 5- or 6-membered carbocyclic radical or a 5- or 6-membered heterocyclic radical having one heteroatom moiety which is selected from the group consisting of O, S, N and N—R^{QN} as ring member and 0, 1 or 2 further heteroatom moieties N as ring members and also having 2, 3, 4 or 5 carbon atoms as ring members where the carbon atom ring members may be unsubstituted or 1, 2 or 3 of the carbon atom ring members carry a radical R^{Q} as a substituent, provided that the pyrazole radical and the 6-membered heteroaromatic radical are bound in ortho- or meta-position of Q with respect to each other, if Q is a 6-membered radical, and where
RQ^{N} is selected from the group consisting of hydrogen, C₁-C₄-alkyl and C₁-C₄-haloalkyl,
R^{Q} is selected from the group consisting of hydrogen, halogen, CN, C₁-C₄-alkyl, C₁-C₄-haloalkyl, C₁-C₄-alkoxy and C₁-C₄-haloalkoxy or together with the carbon atom, to which it is bound, may form a carbonyl group or a thiocarbonyl group;
R^{u} and R^{t} are independently of each other selected from the group consisting of hydrogen, halogen, C₁-C₄-alkyl, C₁-C₃-haloalkyl, C₁-C₄-alkoxy, C₁-C₃-haloalkoxy, C₁-C₄-alkylthio, C₁-C₃-haloalkylthio, C₁-C₄-alkylsulfinyl, C₁-C₃-haloalkylsulfinyl, C₁-C₄-alkylsulfonyl, C₁-C₃-haloalkylsulfonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
and wherein
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{x} are independently of each other selected from the group consisting of cyano, nitro, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₁₀-alkylcarbonyl, C₃-C₆-cycloalkyl, 5- to 7-membered heterocyclyl, phenyl, C₃-C₆-cycloalkoxy, 3- to 6-membered heterocyclyloxy and phenoxy, wherein the last 6 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy;
R^{y} is selected from the group consisting of halogen, cyano, nitro, C₁-C₄-alkyl, C₁-C₄-haloalkyl, C₁-C₄-alkoxy, C₁-C₄-haloalkoxy, S(O)ₘR^{d}, S(O)ₘNR^{e}R^{f}, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₃-C₆-cycloalkyl, 5- to 7-membered heterocyclyl, hetaryl, phenyl, C₃-C₆-cycloalkoxy, 3- to 6-membered heterocyclyloxy, hetaryloxy and phenoxy, wherein the last 8 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy.

29. The method as claimed in claim 28, wherein Q in formula I is a 5-membered heterocyclic radical having the formula Q-1, Q-2, Q-3, Q-4 or Q-5 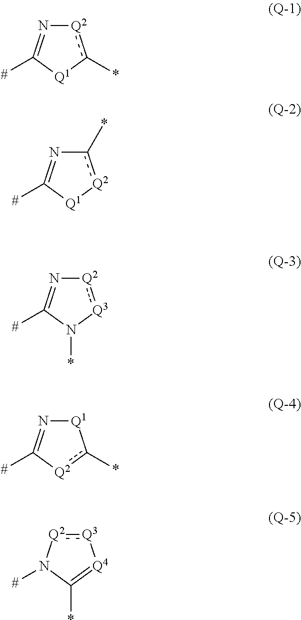
wherein
# denotes the point of attachment to the pyrazole radical of formula I and
* denotes the point of attachment to the 6-membered heteroaromatic radical of formula I, and wherein [symbol]
indicates a single bond or a double bond
Q¹ is O, S or N—R^{QN}, where R^{QN} is as defined in claim 1,
Q₂ is N or C—R^{Q2}, if [symbol] indicates a double bond, or
Q² is O, a carbonyl group or CH—R^{Q2}, if [symbol] indicates a single bond;
Q³ is N or C—R^{Q3}, if [symbol] indicates a double bond, or
Q³ is a carbonyl group or CH—R^{Q3}, if [symbol] indicates a single bond;
Q⁴ is N or C—R^{Q4},
where R^{Q2}, R^{Q3} and R^{Q4} are independently of each other hydrogen or are as defined for R^{Q} claim 28.

30. The method as claimed in claim 29, wherein Q is a radical Q-1, Q-2 or Q3.

31. The method as claimed in claim 30, wherein Q is a radical selected from the group consisting of oxazol-2,4-diyl, thiazol-2,4-diyl, [1,3,4]-oxadiazol-2,5-diyl, [1,3,4]-thiadiazol-2,5-diyl, 4H-[1,2,4]triazol-3,5-diyl, 4-methyl-[1,2,4]triazol-3,5-diyl, [1,2,4]-triazol-3,4-diyl, 5-methyl-[1,2,4]-triazol-3,4-diyl, imidazol-1,2-diyl, 4,5-dihydro-imidazol-1,2-diyl and 4,5-dihydro-[1,2,4]-oxadiazol-3,4-diyl.

32. The method as claimed in claim 29, wherein Q is a radical Q-4 or Q5.

33. The method as claimed in claim 32, wherein Q is a radical selected from the group consisting of 1H-pyrazol-3,5-diyl, 1-methyl-pyrazol-3,5-diyl, 1-methyl[1,2,4]-triazol-3,5-diyl, [1,2,4]-triazol-3,4-diyl and 5-methyl-[1,2,4]-triazol-3,4-diyl.

34. The method as claimed in claim 28, wherein Q of formula I is a 6-membered carbocyclic or heterocyclic radical having the formula Q-6, Q-7, Q-8, Q-9, Q-10, Q-11, Q-12 or Q-13: 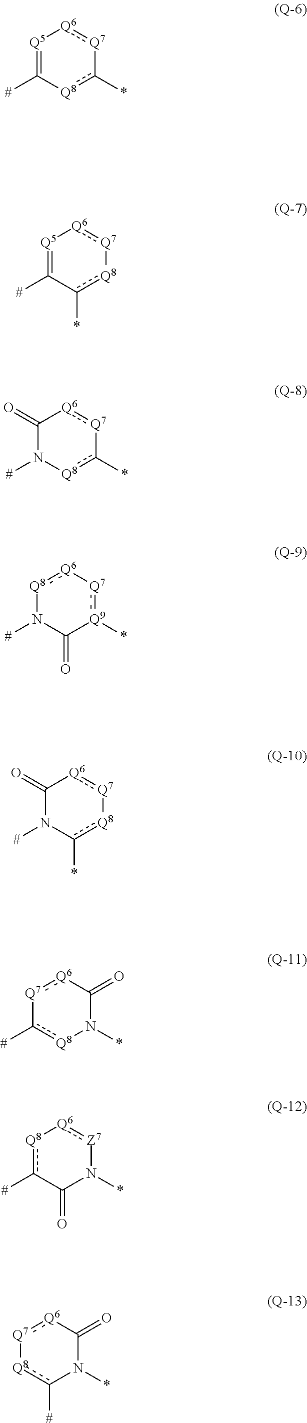
wherein
# denotes the point of attachment to the pyrazole radical of formula I and
* denotes the point of attachment to the 6-membered heteroaromatic radical of formula I, and wherein [symbol]
indicates a single bond or a double bond
Q⁵ is N or C—R^{Q5},
Q⁶ is N or C—R^{Q6}, if [symbol] indicates a double bond, or
Q⁶ is a carbonyl group or CH—R^{Q6}, if [symbol] indicates a single bond;
Q⁷ is N or C—R^{Q7}, if [symbol] indicates a double bond, or
Q⁷ is a carbonyl group or CH—R^{Q7}, if [symbol] indicates a single bond;
Q⁸ is N or C—R^{Q8}, if [symbol] indicates a double bond, or
Q⁸ is a carbonyl group or CH—R^{Q8}, if [symbol] indicates a single bond;
Q⁹ is C, if [symbol] indicates a double bond, or
Q⁹ is N or CH, if [symbol] indicates a single bond;
provided that only one of Q⁶, Q⁷ and Q⁸ is N or a carbonyl group,
where R^{Q5}, R^{Q6}, R^{Q7} and R^{Q8} are independently of each other hydrogen or are as defined for R^{Q} claim 28.

35. The method as claimed in claim 34, wherein Q is a radical Q-6 or Q7.

36. The method as claimed in claim 35, wherein Q is a radical selected from the group consisting of 1,2-phenylen, 1,3-phenylen, pyridin-2,3-diyl, pyridin-3,4-diyl, pyridin-2,4-diyl, pyridin-3,5-diyl and pyridin-2,6-diyl.

37. The method as claimed in claim 28, wherein R^{N} of formula I is selected from the group consisting of C₁-C₆-alkyl, C₁-C₆-haloalkyl, heterocyclyl-C₁-C₄-alkyl, C₁-C₄-alkoxy-C₁-C₄-alkyl, C₁-C₄-alkylene-CN, C₃-C₆-cycloalkyl, and C₃-C₆-cycloalkyl-C₁-C₄-alkyl, where the cycloalkyl moiety is in the last two mentioned radicals is unsubstituted or carries 1 or 2 radicals selected from the group consisting of halogen, CN and C₁-C₂-haloalkyl.

38. The method as claimed in claim 28, wherein R^{A} of formula I, if present, is selected from the group consisting of hydrogen, halogen, NO₂, C₁-C₄-alkyl, C₁-C₄-haloalkyl, C₃-C₆-cycloalkyl and C₃-C₆-halocycloalkyl.

39. The method as claimed in claim 28, wherein R^{t} and R^{u} of formula I are selected independently of each other from the group consisting of hydrogen, halogen, methyl, difluoromethyl, trifluoromethyl, methoxy, difluoromethoxy and trifluoromethoxy.

40. The method as claimed in claim 28, wherein the radicals R^{t} and R^{u} of formula I are hydrogen.

41. The method as claimed in claim 28, wherein X of formula I is CH, Y of formula I is N and Z of formula I is N.

42. The method as claimed in claim 28, wherein X of formula I is CH, Y of formula I is N and Z of formula I is CH.

43. The method as claimed in claim 41, wherein R^{t} of formula I is hydrogen and R^{u} of formula I is selected from the group consisting of hydrogen, halogen, methyl, difluoromethyl, trifluoromethyl, methoxy, difluoromethoxy and trifluoromethoxy.

44. The method as claimed in claim 43, wherein R^{u} is hydrogen.

45. The method as claimed in claim 28, wherein the compound of formula I is of the formula Ia: 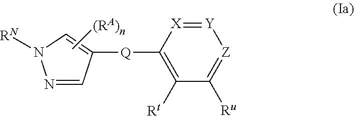
wherein, n is 0 or 1.

46. The method as claimed in claim 45, wherein X of formula Ia is CH, Y of formula Ia is N and Z of formula Ia is N.

47. The method as claimed in claim 45, wherein X of formula Ia is CH, Y of formula Ia is N and Z of formula Ia is CH.

48. The method as claimed in claim 28, wherein the invertebrate pests are arthropod pests and/or nematodes.

49. The method as claimed in claim 48, wherein the invertebrate pests are insects.

50. The method as claimed in claim 49, wherein the invertebrate pests are insects of the order Homoptera.

51. A method for protecting plant propagation material and/or the plants which grow therefrom, which method comprises treating the plant propagation material with a pesticidally effective amount of a compound of the formula I, 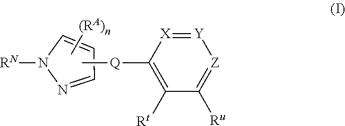
wherein
X is N or CH;
Y is N or CH;
Z is N or CH;
provided that either only one of X, Y and Z is N or only two adjacent groups of X, Y and Z are N,
R^{A} is selected from the group consisting of halogen, CN, NO₂, C₁-C₁₀-alkyl, C₂-C₁₀-alkenyl and C₂-C₁₀-alkynyl, wherein the last three mentioned radicals may be unsubstituted, may be partially or fully halogenated or may carry 1, 2 or 3 identical or different substituents R^{x},
and also from the group consisting of OR^{a}, C(V)R^{b}, C(V)OR^{c}, S(O)ₘR^{d} with m being 0, 1 for 2, NR^{e}R^{f}, heterocyclyl, phenyl, hetaryl, C₃-C₁₀-cycloalkyl and C₅-C₁₀-cycloalkenyl, wherein the last five mentioned radicals may be unsubstituted or may carry 1, 2, 3, 4 or 5 identical or different substituents R^{y};
n is 0, 1 or 2; and
R^{N} is selected from the group consisting of hydrogen, CN, NO₂, C₁-C₁₀-alkyl, C₂-C₁₀-alkenyl and C₂-C₁₀-alkynyl, wherein the three last mentioned radicals may be unsubstituted, may be partially or fully halogenated or may carry 1, 2 or 3 identical or different substituents R^{x},
and also from the group consisting of OR^{a}, C(V)R^{b}, C(V)OR^{c}, S(O)ₘR^{d}, NR^{e}R^{f}, C(V)NR^{g}R^{h}, S(O)ₘNR^{e}R^{f}, C(V)NRⁱNR^{e}R^{f}, C₁-C₅-alkylen-OR^{a}, C₁-C₅-alkylen-CN, C₁-C₅-alkylen-C(V)R^{b}, C₁-C₅-alkylen-C(V)OR^{c}, C₁-C₅-alkylen-NR^{e}R^{f}, C₁-C₅-alkylen-C(V)NR^{g}R^{h}, C₁-C₅-alkylen-S(O)ₘR^{d}, C₁-C₅-alkylen-S(O)ₘNR^{e}R^{f}, C₁-C₅-alkylen-NRⁱNR^{e}R^{f}, heterocyclyl, hetaryl, C₃-C₁₀-cycloalkyl, C₅-C₁₀-cycloalkenyl, heterocyclyl-C₁-C₅-alkyl, hetaryl-C₁-C₅-alkyl, C₃-C₁₀-cycloalkyl-C₁-C₅-alkyl, C₅-C₁₀-cycloalkenyl-C₁-C₅-alkyl, phenyl-C₁-C₅-alkyl and phenyl, wherein the rings of the ten last mentioned radicals may be unsubstituted or may carry 1, 2, 3, 4 or 5 identical or different substituents R^{Y};
m is 0, 1 or 2;
V is O or S;
Q is a bivalent 5- or 6-membered carbocyclic radical or a 5- or 6-membered heterocyclic radical having one heteroatom moiety which is selected from the group consisting of O, S, N and N—R^{QN} as ring member and 0, 1 or 2 further heteroatom moieties N as ring members and also having 2, 3, 4 or 5 carbon atoms as ring members where the carbon atom ring members may be unsubstituted or 1, 2 or 3 of the carbon atom ring members carry a radical R^{Q} as a substituent, provided that the pyrazole radical and the 6-membered heteroaromatic radical are bound in ortho- or meta-position of Q with respect to each other, if Q is a 6-membered radical, and where
R^{QN} is selected from the group consisting of hydrogen, C₁-C₄-alkyl and C₁-C₄-haloalkyl,
R^{Q} is selected from the group consisting of hydrogen, halogen, CN, C₁-C₄-alkyl, C₁-C₄-haloalkyl, C₁-C₄-alkoxy and C₁-C₄-haloalkoxy or together with the carbon atom, to which it is bound, may form a carbonyl group or a thiocarbonyl group;
R^{u} and R^{t} are independently of each other selected from the group consisting of hydrogen, halogen, C₁-C₄-alkyl, C₁-C₃-haloalkyl, C₁-C₄-alkoxy, C₁-C₃-haloalkoxy, C₁-C₄-alkylthio, C₁-C₃-haloalkylthio, C₁-C₄-alkylsulfinyl, C₁-C₃-haloalkylsulfinyl, C₁-C₄-alkylsulfonyl, C₁-C₃-haloalkylsulfonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
and wherein
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C4-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{x} are independently of each other selected from the group consisting of cyano, nitro, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₁₀-alkylcarbonyl, C₃-C₆-cycloalkyl, 5- to 7-membered heterocyclyl, phenyl, C₃-C₆-cycloalkoxy, 3- to 6-membered heterocyclyloxy and phenoxy, wherein the last 6 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy;
R^{y} is selected from the group consisting of halogen, cyano, nitro, C₁-C₄-alkyl, C₁-C₄-haloalkyl, C₁-C₄-alkoxy, C₁-C₄-haloalkoxy, S(O)ₘR^{d}, S(O)ₘNR^{e}R^{f}, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₃-C₆-cycloalkyl, 5- to 7-membered heterocyclyl, hetaryl, phenyl, C₃-C₆-cycloalkoxy, 3- to 6-membered heterocyclyloxy, hetaryloxy and phenoxy, wherein the last 8 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy; or
a tautomer or an N-oxide or an agriculturally acceptable salt thereof.

52. Plant propagation material treated with at least one compound of formula I 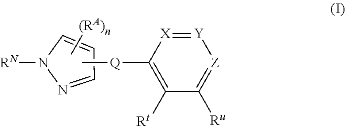
wherein
X is N or CH;
Y is N or CH;
Z is N or CH;
provided that either only one of X, Y and Z is N or only two adjacent groups of X, Y and Z are N,
R^{A} is selected from the group consisting of halogen, CN, NO₂, C₁-C₁₀-alkyl, C₂-C₁₀-alkenyl and C₂-C₁₀-alkynyl, wherein the last three mentioned radicals may be unsubstituted, may be partially or fully halogenated or may carry 1, 2 or 3 identical or different substituents
and also from the group consisting of OR^{a}, C(V)R^{b}, C(V)OR^{c}, S(O)ₘR^{d} with m being 0, 1 for 2, NR^{e}R^{f}, heterocyclyl, phenyl, hetaryl, C₃-C₁₀-cycloalkyl and C₅-C₁₀-cycloalkenyl, wherein the last five mentioned radicals may be unsubstituted or may carry 1, 2, 3, 4 or 5 identical or different substituents R^{y};
n is 0, 1 or 2; and
R^{N} is selected from the group consisting of hydrogen, CN, NO₂, C₁-C₁₀-alkyl, C₂-C₁₀-alkenyl and C₂-C₁₀-alkynyl, wherein the three last mentioned radicals may be unsubstituted, may be partially or fully halogenated or may carry 1, 2 or 3 identical or different substituents R^{x},
and also from the group consisting of OR^{a}, C(V)R^{b}, C(V)OR^{c}, S(O)ₘR^{d}, NR^{e}R^{f}, C(V)NR^{g}R^{h}, S(O)ₘNR^{e}R^{f}, C(V)NRⁱNR^{e}R^{f}, C₁-C₅-alkylen-OR^{a}, C₁-C₅-alkylen-CN, C₁-C₅-alkylen-C(V)R^{b}, C₁-C₅-alkylen-C(V)OR^{c}, C₁-C₅-alkylen-NR^{e}R^{f}, C₁-C₅-alkylen-C(V)NR^{g}R^{h}, C₁-C₅-alkylen-S(O)ₘR^{d}, C₁-C₅-alkylen-S(O)ₘNR^{e}R^{f}, C₁-C₅-alkylen-NRⁱNR^{e}R^{h}, heterocyclyl, hetaryl, C₃-C₁₀-cycloalkyl, C₅-C₁₀-cycloalkenyl, heterocyclyl-C₁-C₅-alkyl, hetaryl-C₁-C₅-alkyl, C₃-C₁₀-cycloalkyl-C₁-C₅-alkyl, C₅-C₁₀-cycloalkenyl-C₁-C₅-alkyl, phenyl-C₁-C₅-alkyl and phenyl, wherein the rings of the ten last mentioned radicals may be unsubstituted or may carry 1, 2, 3, 4 or 5 identical or different substituents R^{y};
m is 0, 1 or 2;
V is O or S;
Q is a bivalent 5- or 6-membered carbocyclic radical or a 5- or 6-membered heterocyclic radical having one heteroatom moiety which is selected from the group consisting of O, S, N and N—R^{QN} as ring member and 0, 1 or 2 further heteroatom moieties N as ring members and also having 2, 3, 4 or 5 carbon atoms as ring members where the carbon atom ring members may be unsubstituted or 1, 2 or 3 of the carbon atom ring members carry a radical R^{Q} as a substituent, provided that the pyrazole radical and the 6-membered heteroaromatic radical are bound in ortho- or meta-position of Q with respect to each other, if Q is a 6-membered radical, and where
R^{QN} is selected from the group consisting of hydrogen, C₁-C₄-alkyl and C₁-C₄-haloalkyl,
R^{Q} is selected from the group consisting of hydrogen, halogen, CN, C₁-C₄-alkyl, C₁-C₄-haloalkyl, C₁-C₄-alkoxy and C₁-C₄-haloalkoxy or together with the carbon atom, to which it is bound, may form a carbonyl group or a thiocarbonyl group;
R^{u} and R^{t} are independently of each other selected from the group consisting of hydrogen, halogen, C₁-C₄-alkyl, C₁-C₃-haloalkyl, C₁-C₄-alkoxy, C₁-C₃-haloalkoxy, C₁-C₄-alkylthio, C₁-C₃-haloalkylthio, C₁-C₄-alkylsufinyl, C₁-C₃-haloalkylsulfinyl, C₁-C₄-alkylsulfonyl, C₁-C₃-haloalkylsulfonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
and wherein
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{x} are independently of each other selected from the group consisting of cyano, nitro, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₁₀-alkylcarbonyl, C₃-C₆-cycloalkyl, 5- to 7-membered heterocyclyl, phenyl, C₃-C₆-cycloalkoxy, 3- to 6-membered heterocyclyloxy and phenoxy, wherein the last 6 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy;
R^{y} is selected from the group consisting of halogen, cyano, nitro, C₁-C₄-alkyl, C₁-C₄-haloalkyl, C₁-C₄-alkoxy, C₁-C₄-haloalkoxy, S(O)ₘR^{d}, S(O)ₘNR^{e}R^{f}, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₃-C₆-cycloalkyl, 5- to 7-membered heterocyclyl, hetaryl, phenyl, C₃-C₆-cycloalkoxy, 3- to 6-membered heterocyclyloxy, hetaryloxy and phenoxy, wherein the last 8 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy;
or a tautomer, an N-oxide or an agriculturally acceptable salt thereof.

53. A pyrazole compound of formula I 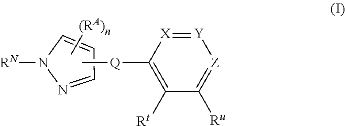
wherein
X is N or CH;
Y is N or CH;
Z is N or CH;
provided that either only one of X, Y and Z is N or only two adjacent groups of X, Y and Z are N,
R^{A} is selected from the group consisting of halogen, CN, NO₂, C₁-C₁₀-alkyl, C₂-C₁₀-alkenyl and C₂-C₁₀-alkynyl, wherein the last three mentioned radicals may be unsubstituted, may be partially or fully halogenated or may carry 1, 2 or 3 identical or different substituents R^{x},
and also from the group consisting of OR^{a}, C(V)R^{b}, C(V)OR^{c}, S(O)ₘR^{d} with m being 0, 1 or 2, NR^{e}R^{f}, heterocyclyl, phenyl, hetaryl, C₃-C₁₀-cycloalkyl and C₅-C₁₀-cycloalkenyl, wherein the last five mentioned radicals may be unsubstituted or may carry 1, 2, 3, 4 or 5 identical or different substituents R^{y};
n is 0, 1 or 2; and
R^{N} is selected from the group consisting of hydrogen, CN, NO₂, C₁-C₁₀-alkyl, C₂-C₁₀-alkenyl and C₂-C₁₀-alkynyl, wherein the three last mentioned radicals may be unsubstituted, may be partially or fully halogenated or may carry 1, 2 or 3 identical or different substituents R^{x},
and also from the group consisting of OR^{a}, C(V)R^{b}, C(V)OR^{C}, S(O)ₘR^{d}, NR^{e}R^{f}, C(V)NR^{g}R^{h}, S(O)ₘNR^{e}R^{f}, C(V)NRⁱNR^{e}R^{f}, C₁-C₅-alkylen-OR^{a}, C₁-C₅-alkylen-CN, C₁-C₅-alkylen-C(V)R^{b}, C₁-C₅-alkylen-C(V)OR^{c}, C₁-C₅-alkylen-NR^{e}R^{f}, C₁-C₅-alkylen-C(V)NR^{g}R^{h}, C₁-C₅-alkylen-S(O)ₘR^{d}, C₁-C₅-alkylen-S(O)ₘNR^{e}R^{f}, C₁-C₅-alkylen-NRⁱNR^{e}R^{f}, heterocyclyl, hetaryl, C₃-C₁₀-cycloalkyl, C₅-C₁₀-cycloalkenyl, heterocyclyl-C₁-C₅-alkyl, hetaryl-C₁-C₅-alkyl, C₃-C₁₀-cycloalkyl-C₁-C₅-alkyl, C₅-C₁₀-cycloalkenyl-C₁-C₅-alkyl, phenyl-C₁-C₅-alkyl and phenyl, wherein the rings of the ten last mentioned radicals may be unsubstituted or may carry 1, 2, 3, 4 or 5 identical or different substituents R^{y};
m is 0, 1 or 2;
V is O or S;
Q is a bivalent 5- or 6-membered carbocyclic radical or a 5- or 6-membered heterocyclic radical having one heteroatom moiety which is selected from the group consisting of O, S, N and N—R^{QN} as ring member and 0, 1 or 2 further heteroatom moieties N as ring members and also having 2, 3, 4 or 5 carbon atoms as ring members where the carbon atom ring members may be unsubstituted or 1, 2 or 3 of the carbon atom ring members carry a radical R^{Q} as a substituent, provided that the pyrazole radical and the 6-membered heteroaromatic radical are bound in ortho- or meta-position of Q with respect to each other, if Q is a 6-membered radical, and where
R^{QN} is selected from the group consisting of hydrogen, C₁-C₄-alkyl and C₁-C₄-haloalkyl,
R^{Q} is selected from the group consisting of hydrogen, halogen, CN, C₁-C₄-alkyl, C₁-C₄-haloalkyl, C₁-C₄-alkoxy and C₁-C₄-haloalkoxy or together with the carbon atom, to which it is bound, may form a carbonyl group or a thiocarbonyl group;
R^{u} and R^{t} are independently of each other selected from the group consisting of hydrogen, halogen, C₁-C₄-alkyl, C₁-C₃-haloalkyl, C₁-C₄-alkoxy, C₁-C₃-haloalkoxy, C₁-C₄-alkylthio, C₁-C₃-haloalkylthio, C₁-C₄-alkylsulfinyl, C₁-C₃-haloalkylsulfinyl, C₁-C₄-alkylsulfonyl, C₁-C₃-haloalkylsulfonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
and wherein
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄ alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{x} are independently of each other selected from the group consisting of cyano, nitro, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₁₀-alkylcarbonyl, C₃-C₆-cycloalkyl, 5- to 7-membered heterocyclyl, phenyl, C₃-C₆-cycloalkoxy, 3- to 6-membered heterocyclyloxy and phenoxy, wherein the last 6 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy;
R^{y} is selected from the group consisting of halogen, cyano, nitro, C₁-C₄-alkyl, C₁-C₄-haloalkyl, C₁-C₄-alkoxy, C₁-C₄-haloalkoxy, S(O)ₘR^{d}, S(O)ₘNR^{e}R^{f}, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₃-C₆-cycloalkyl, 5- to 7-membered heterocyclyl, hetaryl, phenyl, C₃-C₆-cycloalkoxy, 3- to 6-membered heterocyclyloxy, hetaryloxy and phenoxy, wherein the last 8 mentioned radicals may be unsubstituted or may carry 1, 2, 3, 4 or 5 radicals selected from the group consisting of halogen, cyano, nitro, C₁-C₄-alkyl, C₁-C₄-haloalkyl, C₁-C₄-alkoxy and C₁-C₄-haloalkoxy.
a salt, N-oxide, or tautomer thereof or a salt of said N-oxide or tautomer,
provided that the pyrazole radical and the 6-membered heteroaromatic radical are bound in meta-position of Q with respect to each other, if Q is a pyridazine radical, provided further that the pyrazole radical and the 6-membered heteroaromatic radical are bound in ortho-position of Q with respect to each other, if Q is a phenyl radical, the pyrazole radical carries a pyridyl radical as substituent R^{A} or R^{N} and only one of X, Y and Z is N, provided further that the pyrazole radical and the 6-membered heteroaromatic radical are bound in ortho-position of Q with respect to each other, if Q and the 6-membered heteroaromatic radical together form a 1-pyridin-4-yl-pyridin-2-on-5-yl radical,
except for 3-[5-(1H-pyrazol-4-yl)[1,2,4]-oxadiazol-3-yl]-pyridine, 2-[3-(2-pyridin-2-yl-5-methyl-2,3-dihydro-1H-pyrazol-3-on-4-yl)-5-methyl-2H-pyrazol-2-yl]-pyridine, 3-{4-[3-(3-methoxy-5-methyl-phenyl)-1-cyanomethyl-1H-pyrazol-4-yl]-pyridin-2-yl}-pyridine, 3-{4-[5-(3-methoxy-5-methyl-phenyl)-1-cyanomethyl-1H-pyrazol-4-yl]-pyridin-2-yl}-pyridine and 2-[4-(1-phenyl-1H-pyrazol-4-yl)-pyrimidin-2-yl]-pyridine, the salts thereof, the N-oxides thereof, the tautomers thereof and the salts of said N-oxides or tautomers.
